(19) United States
(12) Patent Application Publication
(10) Pub. No.: US 2026/0249350 A1
(43) Pub. Date: Aug. 27, 2026

(54) METHODS FOR MANUFACTURING ADDITIVE MANUFACTURING COMPONENTS

(71) Applicant: VALLS BESITZ GMBH, Berlin (DE)

(72) Inventor: Isaac VALLS ANGLÉS, Rubí (ES)

(73) Assignee: VALLS BESITZ GMBH, Berlin (DE)

(21) Appl. No.: 18/879,207

(22) PCT Filed: Jul. 6, 2023
(86) PCT No.: PCT/EP2023/068790

§ 371 Date: Dec. 26, 2024

(30) Foreign Application Priority Data
Jul. 6, 2022 (ES) P202230617

(51) Int. Cl. B22F 1/142; B22F 10/14; B22F 10/18; B22F 10/28; B33Y 10/00; B33Y 40/10; B33Y 80/00; C22C 9/02; C22C 9/04; C22C 9/06; C22C 9/08; C22C 14/00; C22C 19/05; C22C 19/07; C22C 21/08; C22C 21/18; C22C 23/02; C22C 29/06; C22C 29/08; C22C 29/10; C22C 30/00; C22C 33/02; C22C 38/00; C22C 38/02; C22C 38/04; C22C 38/06; C22C 38/08; C22C 38/10; C22C 38/12; C22C 38/14; C22C 38/16; C22C 38/20; C22C 38/22; C22C 38/24; C22C 38/26; C22C 38/28; C22C 38/30; C22C 38/32; C22C 38/38; C22C 38/42; C22C 38/44; C22C 38/46; C22C 38/50; C22C 38/52; C22C 38/58

(52) U.S. Cl. CPC B22F 1/142; B22F 10/14; B22F 10/18; B22F 10/28; B33Y 10/00; B33Y 40/10; B33Y 80/00; C22C 9/02; C22C 9/04; C22C 9/06; C22C 9/08; C22C 14/00; C22C 19/055; C22C 19/058; C22C 19/07; C22C 21/08; C22C 21/18; C22C 23/02; C22C 29/067; C22C 29/08; C22C 29/10; C22C 30/00; C22C 33/0261; C22C 38/001; C22C 38/002; C22C 38/005; C22C 38/008; C22C 38/02; C22C 38/04; C22C 38/06; C22C 38/08; C22C 38/105; C22C 38/12; C22C 38/14; C22C 38/16; C22C 38/20; C22C 38/22; C22C 38/24; C22C 38/26; C22C 38/28; C22C 38/30; C22C 38/32; C22C 38/38; C22C 38/42; C22C 38/44; C22C 38/46; C22C 38/50; C22C 38/52; C22C 38/58; B22F 2301/052; B22F 2301/058; B22F 2301/10; B22F 2301/15; B22F 2301/205; B22F 2301/35; B22F 2302/10; B22F 2998/10; B22F 2999/00

(57) ABSTRACT

The present invention relates to a method for manufacturing components from materials comprising metals, alloys, ceramics, organic components particularly suitable for the manufacture of components, complex pieces and/or parts. The method is specially indicated to manufacture highly performant components in a cost-effective way. The method also allows the reproduction of bio-mimetic structures and other advanced structures for topological performance optimization.

### FIELD OF THE INVENTION

The present invention relates to methods which are particularly suitable for manufacturing components from materials comprising metals, alloys, ceramics, organic components and/or mixtures thereof. The invention further relates to the components manufactured by these methods.

### STATE OF THE ART

There are many inventions related to the manufacture of components with complex geometries from metallic materials, particularly due to the development of the additive manufacturing (AM) technologies. However, most of the existing manufacturing methods are very cost intensive and do not achieve the required properties for some of the manufactured components.

For example, WO2021165545A1 discloses several manufacturing methods, some of them which may be particularly suitable for the manufacture of components with complex geometries. However, with the methods disclosed in the present applications outstanding mechanical properties can be achieved often not only surpassing the properties achievable with MAM, but significantly higher than the properties achievable with any manufacturing method (including forging).

### DETAILED DESCRIPTION OF THE INVENTION

The methods described in this document are particularly suitable for the manufacture of components from materials comprising metals, alloys, ceramics, organic components and/or mixtures thereof. The singular characteristics of the methods disclosed, make it possible to obtain components with outstanding mechanical properties, enhanced quality, and specific and optimized design characteristics and geometries, especially when it comes to components with internal features that are practically impossible to obtain by other methods. In addition, the invention makes it also possible to obtain parts and components (or parts of components) that are free of defects. These methods can also lead to a significant reduction in costs, e.g. the cost per manufactured component. The inventor has found that under certain processing conditions the methods disclosed also shows an excellent cost efficiency ratio. Often, due to the characteristics of the methods described the inventor has also found that present invention contributes to reduce environmental footprint and impact, and especially increasing sustainability and reducing emissions. The components can be manufactured, for example, with the methods as defined in claims 1 and 32 to 35.

An aspect of the disclosure provides a method of manufacturing high performance metal comprising components (also referred as “components” or “manufactured components” throughout this aspect of the disclosure) including, but not limited to, pieces, large structured components, particularly those with high solicitations, power transmission elements, tools, power generation/transformation elements, components for the transportation industry, components for the aerospace industry, components for the rail transportation industry, components for the automotive industry, components for the marine transportation industry, components for the food processing industry, components for the pharmaceutical industry, components for the packaging industry, components for the electronics industry, components for the appliance industry, components for the material transformation industry, dies and/or molds, among others, the method comprising the steps of:
providing a powder or powder mixture;
applying a treatment to the powder or powder mixture; and
shaping the treated powder or powder mixture using a metal additive manufacturing (MAM) method.

In some embodiments, the method may further comprise other additional steps, including, but not limited to, one or more of the following steps: applying a pressure and/or temperature treatment; applying a debinding treatment; applying a fixing step for setting the % C, % O, % N, % H and/or % B levels in the metallic part of the component; applying a consolidation treatment; applying a densification treatment; applying a thermomechanical treatment, a surface conditioning and/or a machining. Additionally or alternatively, the method may further comprise other additional steps, some of which are discussed later in this document.

The method of manufacturing metal comprising components disclosed in this document can be used to manufacture the entire component or at least part of the component. In this respect, for some applications of the method, it may be advantageous to manufacture the component in different parts which can be assembled together. In an embodiment, the method is used to manufacture at least part of the component. In another embodiment, the method is used to manufacture the entire component. The inventor has also found that for some applications, it may be advantageous to manufacture the component from different materials. In an embodiment, the manufactured component comprises at least two different materials. In another embodiment, the manufactured component comprises at least three different materials.

With respect to the powder or powder mixture provided (also referred to as the “powder material” or “starting material” throughout this aspect of the disclosure), a wide variety of particulate materials can be used to manufacture different types of components. Some examples of the types of powders that can be used include, but are not limited to, simple powders, elemental powders, pure metal powders, simple alloy powders, master alloy powders, pre-alloyed powders, partially pre-alloyed powders, alloyed powders and/or mixtures thereof. In an embodiment, the powder or powder mixture provided comprises at least a metal or a metal-based alloy. In another embodiment, the powder or powder mixture provided consist of a metal or a metal-based alloy. Some examples of metals and/or metal-based alloys that may be advantageously used include, but are not limited to, iron, iron-based alloys, carbonyl iron, steels, stainless steels, nickel, nickel-based alloys, copper, copper-based alloys, chromium, chromium-based alloys, cobalt, cobalt-based alloys, molybdenum, molybdenum-based alloys, manganese, manganese-based alloys, aluminium, aluminium-based alloys, tungsten, tungsten-based alloys, titanium, titanium-based alloys, lithium, lithium-based alloys, magnesium, magnesium-based alloys, niobium, niobium-based alloys, zirconium, zirconium-based alloys, silicon, silicon-based alloys, tin, tin-based alloys, tantalum, tantalum-based alloys, zinc, zinc-based alloys, lead, lead-based alloys, gold, gold-based alloys, silver, silver-based alloys and/or mixtures thereof. However, the composition of the powder or powder mixture provided is not limited to these materials. In an embodiment, the metal and/or metal-based alloy is in powder form. As described above, the starting material can be a single powder (e.g., a metal or metal-based alloy in powder form) or a powder mixture (e.g., a mixture of at least two powders of different composition, size and/or morphology). In an embodiment, the starting material is a powder comprising a metal. In another embodiment, the starting material is a powder comprising a metal-based alloy. In another embodiment, the starting material is a metal in powder form. In another embodiment, the starting material is a metal-based alloy in powder form. In another embodiment, the starting material comprises at least a metal or a metal-based alloy in powder form. In another embodiment, the starting material is a powder mixture comprising at least a metal or a metal-based alloy. In another embodiment, the starting material is a powder mixture comprising at least a metal or a metal-based alloy in powder form. In another embodiment, the starting material is a powder mixture comprising at least a metal. In another embodiment, the starting material is a powder mixture comprising at least a metal in powder form. In another embodiment, the starting material is a powder mixture comprising at least a metal-based alloy. In another embodiment, the starting material is a powder mixture comprising at least a metal-based alloy in powder form. In another embodiment, the starting material is a powder mixture comprising the overall composition of a metal-based alloy. In another embodiment, the starting material is a powder mixture having the overall composition of a metal-based alloy. In another embodiment, the starting material is a powder mixture comprising at least a critical powder that is a metal or a metal-based alloy. In another embodiment, the starting material is a powder mixture comprising at least a critical powder that is a metal. In another embodiment, the starting material is a powder mixture comprising at least a critical powder that is a metal-based alloy. Some examples of metals and metal-based alloys that be advantageously used are described above. The feature “critical powder” is defined throughout this document in the form of different alternatives that are explained in detail below. In an embodiment, a critical powder is a powder that is at least 0.06% by weight of all the metallic powders in the powder mixture. In an alternative embodiment, a critical powder is a powder that is at least 0.6% by weight of all the metallic powders in the powder mixture. In another alternative embodiment, a critical powder is a powder that is at least 1.2% by weight of all the metallic powders in the powder mixture. In another alternative embodiment, a critical powder is a powder that is at least 2.6% by weight of all the metallic powders in the powder mixture. In another alternative embodiment, a critical powder is a powder that is at least 6% by weight of all the metallic powders in the powder mixture. In another alternative embodiment, a critical powder is a powder that is at least 11% by weight of all the metallic powders in the powder mixture. In another alternative embodiment, a critical powder is a powder that is at least 21% by weight of all the metallic powders in the powder mixture. In another alternative embodiment, a critical powder is a powder that is at least 36% by weight of all the metallic powders in the powder mixture. In another alternative embodiment, a critical powder is a powder that is at least 52% by weight of all the metallic powders in the powder mixture. In another alternative embodiment, the percentages disclosed above are based on the total weight of the powder mixture (including the weight of other non-metallic components that may be present in the powder or powder mixture such as for example, reinforcement particles, polymers or polymeric materials, binders and/or resins). All the embodiments disclosed above can be combined among them and with any other embodiment disclosed in this document that relates to “a critical powder” in any combination, provided that they are not mutually exclusive. In an embodiment, the starting material comprises at least a relevant powder that is a metal or a metal-based alloy. In another embodiment, the starting material comprises at least a relevant powder that is a metal. In another embodiment, the starting material comprises at least a relevant powder that is a metal-based alloy. The feature “relevant powder” is defined throughout this document in the form of different alternatives that are explained in detail below. In an embodiment, a powder is considered relevant when the weight percentage of that powder in the powder mixture is 2% by weight or more. In an alternative embodiment, a powder is considered relevant when the weight percentage of that powder in the powder mixture is 5.5% by weight or more. In another alternative embodiment, a powder is considered relevant when the weight percentage of that powder in the powder mixture is 10.5% by weight or more. In another alternative embodiment, a powder is considered relevant when the weight percentage of that powder in the powder mixture is 15.5% by weight or more. In another alternative embodiment, a powder is considered relevant when the weight percentage of that powder in the powder mixture is 25.5% by weight or more. In another alternative embodiment, a powder is considered relevant when the weight percentage of that powder in the powder mixture is 55.5% by weight or more. In another alternative embodiment, there is only one relevant powder, being the one with the highest weight percentage in the mixture. In another alternative embodiment, a relevant powder is any of the powders or powder mixtures disclosed throughout this document. All the embodiments disclosed above can be combined among them and with any other embodiment disclosed in this document that relates to “a relevant powder” in any combination, provided that they are not mutually exclusive. In an embodiment, the powder or powder mixture provided comprises at least a metal or a metal-based alloy in powder form selected from: iron, iron-based alloy, carbonyl iron, steel, stainless steel, nickel, nickel-based alloy, copper, copper-based alloy, chromium, chromium-based alloy, cobalt, cobalt-based alloy, molybdenum, molybdenum-based alloy, manganese, manganese-based alloy, aluminium, aluminium-based alloy, tungsten, tungsten-based alloy, titanium, titanium-based alloy, lithium, lithium-based alloy, magnesium, magnesium-based alloy, niobium, niobium-based alloy, zirconium, zirconium-based alloy, silicon, silicon-based alloy, tin, tin-based alloy, tantalum, tantalum-based alloy, zinc, zinc-based alloy, lead, lead-based alloy, gold, gold-based alloy, silver, silver-based alloy and/or mixtures thereof. In another embodiment, the powder or powder mixture provided comprises at least a metal or a metal-based alloy selected from: iron, steel, nickel, nickel-based alloy, copper, copper-based alloy, aluminium, aluminium-based alloy, titanium, titanium-based alloy, lithium, lithium-based alloy, magnesium, magnesium-based alloy and/or mixtures thereof. In another embodiment, the powder or powder mixture provided comprises at least a metal or a metal-based alloy in powder form selected from: iron, steel, nickel, nickel-based alloy, aluminium, aluminium-based alloy, titanium, titanium-based alloy and/or mixtures thereof. In an embodiment, the powder or powder mixture provided comprises at least a metal or a metal-based alloy selected from: iron, iron-based alloy, carbonyl iron, steel, stainless steel, nickel, nickel-based alloy, copper, copper-based alloy, chromium, chromium-based alloy, cobalt, cobalt-based alloy, molybdenum, molybdenum-based alloy, manganese, manganese-based alloy, aluminium, aluminium-based alloy, tungsten, tungsten-based alloy, titanium, titanium-based alloy, lithium, lithium-based alloy, magnesium, magnesium-based alloy, niobium, niobium-based alloy, zirconium, zirconium-based alloy, silicon, silicon-based alloy, tin, tin-based alloy, tantalum, tantalum-based alloy, zinc, zinc-based alloy, lead, lead-based alloy, gold, gold-based alloy, silver, silver-based alloy and/or mixtures thereof. In another embodiment, the powder or powder mixture provided comprises at least a metal or a metal-based alloy selected from: iron, steel, nickel, nickel-based alloy, copper, copper-based alloy, aluminium, aluminium-based alloy, titanium, titanium-based alloy, lithium, lithium-based alloy, magnesium, magnesium-based alloy and/or mixtures thereof. In another embodiment, the powder or powder mixture provided comprises at least a metal or a metal-based alloy in powder form selected from: iron, steel, nickel, nickel-based alloy, aluminium, aluminium-based alloy, titanium, titanium-based alloy and/or mixtures thereof. For certain applications, the use of a powder or a powder mixture having an overall composition corresponding to that of a metal-based alloy is preferred. In an embodiment, the powder provided is a metal-based alloy powder. In another embodiment, the powder mixture provided has a mean composition corresponding to that of a metal-based alloy. In another embodiment, the powder or powder mixture provided comprises the overall composition of a metal-based alloy in powder form selected from: an iron-based alloy, a steel, a stainless steel, a nickel-based alloy, a copper-based alloy, a chromium-based alloy, a cobalt-based alloy, a molybdenum-based alloy, a manganese-based alloy, an aluminium-based alloy, a tungsten-based alloy, a titanium-based alloy, a lithium-based alloy, a magnesium-based alloy, a niobium-based alloy, a zirconium-based alloy, a silicon-based alloy, a tin-based alloy, a tantalum-based alloy, a zinc-based alloy, a lead-based alloy, a gold-based alloy, a silver-based alloy and/or mixtures thereof. In another embodiment, the powder or powder mixture provided comprises the overall composition of a metal-based alloy selected from: a steel, a nickel-based alloy, a copper-based alloy, an aluminium-based alloy, a titanium-based alloy, a lithium-based alloy and/or mixtures thereof. In another embodiment, the powder or powder mixture provided comprises the overall composition of a metal-based alloy selected from: a steel, a nickel-based alloy, an aluminium-based alloy, a titanium-based alloy and/or mixtures thereof. In another embodiment, the powder or powder mixture provided has the overall composition of a metal-based alloy selected from: an iron-based alloy, a steel, a stainless steel, a nickel-based alloy, a copper-based alloy, a chromium-based alloy, a cobalt-based alloy, a molybdenum-based alloy, a manganese-based alloy, an aluminium-based alloy, a tungsten-based alloy, a titanium-based alloy, a lithium-based alloy, a magnesium-based alloy, a niobium-based alloy, a zirconium-based alloy, a silicon-based alloy, a tin-based alloy, a tantalum-based alloy, a zinc-based alloy, a lead-based alloy, a gold-based alloy, a silver-based alloy and/or mixtures thereof. In another embodiment, the powder or powder mixture provided comprises the overall composition of a metal-based alloy in powder form selected from: a steel, a nickel-based alloy, a copper-based alloy, an aluminium-based alloy, a titanium-based alloy, a lithium-based alloy and/or mixtures thereof. In another embodiment, the powder or powder mixture provided has the overall composition of a metal-based alloy selected from: a steel, a nickel-based alloy, a copper-based alloy, an aluminium-based alloy, a titanium-based alloy, a lithium-based alloy and/or mixtures thereof. In another embodiment, the powder or powder mixture provided has the overall composition of a metal-based alloy selected from: a steel, a nickel-based alloy, an aluminium-based alloy, a titanium-based alloy and/or mixtures thereof. Additionally, in some embodiments, it may be advantageous to add other substances or materials to the powder or powder mixture prior to applying the treatment. Some examples of substances or materials that may be added to the powder or powder mixture include, but are not limited to, organic materials, polymers, polymeric materials, binders, resins, fluxes, dry coaters, fluidizers, surface functionalized nanoparticles, lubricants, additives, nanoparticle additives, graphite, ceramic materials, reinforcement particles, ceramic particles, whiskers, graphene, nanotubes, carbon nanotubes and/or mixtures thereof. In some particular embodiments, the addition of at least one of the above substances or materials may be carried out after the application of the treatment, but before the application of the forming step. In an embodiment, an organic material is added to the powder or powder mixture. In another embodiment, a polymer or polymeric material is added to the powder or powder mixture. In another embodiment, a binder is added to the powder or powder mixture. In another embodiment, fluxes, lubricants and/or additives are added to the powder or powder mixture. In another embodiment, graphite is added to the powder or powder mixture. In another embodiment, a ceramic material is added to the powder or powder mixture. In another embodiment, whiskers are added to the powder or powder mixture. In another embodiment, nanotubes are added to the powder or powder mixture. In another embodiment, carbon nanotubes are added to the powder or powder mixture. In another embodiment, reinforcement particles are added to the powder or powder mixture. In some particular embodiments, the addition of at least one of the above substances or materials is carried out after the treatment has been applied to the powder or powder mixture, but before the forming step. Throughout this document, unless otherwise stated, the term “ceramic” includes ceramic materials that can be found in nature in the form of minerals, processed ceramics, technical ceramics, etc. The feature “reinforcement particles” is defined throughout this document in the form of different alternatives that are explained in detail below. In an embodiment, the reinforcement particles refer to a material comprising inorganic fibers. In another embodiment, the reinforcement particles refer to a material comprising glass fibers. In another embodiment, the reinforcement particles refer to a material comprising carbon fibers. In another embodiment, the reinforcement particles refer to a material comprising basalt fibers. In another embodiment, the reinforcement particles refer to a material comprising asbestos fibers. In another embodiment, the reinforcement particles refer to a material comprising ceramic fibers. In another embodiment, the reinforcement particles refer to a material comprising at least one material selected from: inorganic fibers, glass fibers, carbon fibers, basalt fibers, asbestos fibers, ceramic fibers and/or mixtures thereof. In another embodiment, the reinforcement particles refer to a material comprising at least one material selected from: inorganic fibers, glass fibers, carbon fibers, basalt fibers, ceramic fibers and/or mixtures thereof. In an embodiment, the ceramic fibers are at least 50% by volume oxides. In another embodiment, the ceramic fibers are at least 50% by volume carbides. In another embodiment, the ceramic fibers are at least 50% by volume borides. In another embodiment, the ceramic fibers are at least 50% by volume nitrides. In an alternative embodiment, the percentages disclosed above are by weight (wt %). In an embodiment, the ceramic fibers comprise a silicon carbide. In another embodiment, the reinforcement particles refer to a material comprising inorganic fillers. In another embodiment, the reinforcement particles refer to a material comprising mineral fillers. In another embodiment, the reinforcement particles refer to a material comprising organic fibers. In another embodiment, the reinforcement particles refer to a material comprising natural fibers. In another embodiment, the reinforcement particles refer to a material comprising at least one material selected from: inorganic fillers, mineral fillers, organic fibers, natural fibers and/or mixtures thereof. The amount of reinforcement particles added may be important in the manufacture of some components. In an embodiment, a sufficient amount of reinforcement particles is added to the powder or powder mixture. The feature “sufficient amount” is defined throughout this document in the form of different alternatives that are explained in detail below. In an embodiment, a sufficient amount is 2.2% by volume or more. In an alternative embodiment, a sufficient amount is 6% by volume or more. In another alternative embodiment, a sufficient amount is 12% by volume or more. In another alternative embodiment, a sufficient amount is 22% by volume or more. In another alternative embodiment, a sufficient amount is 42% or more. In another alternative embodiment, a sufficient amount is 52% by volume or more. In another alternative embodiment, a sufficient amount is 62% by volume or more. In another alternative embodiment, a sufficient amount is 78% by volume or less. In another alternative embodiment, a sufficient amount is 68% by volume or less. In another alternative embodiment, a sufficient amount is 48% by volume or less. In another alternative embodiment, a sufficient amount is 28% by volume or less. In another alternative embodiment, the percentages disclosed above are by weight (wt %). All the embodiments disclosed above can be combined among them and with any other embodiment disclosed in this document that relates to “reinforcement particles” in any combination, provided that they are not mutually exclusive. All the embodiments disclosed above can be combined among them and with any other embodiment disclosed in this document in any combination, provided that they are not mutually exclusive, for example, in an embodiment, a method of manufacturing metal comprising components, which method comprises the steps of: providing a powder or powder mixture; applying a treatment to the powder or powder mixture, wherein the treatment of the powder or powder mixture comprises applying energy into the powder or powder mixture through mechanical action; and shaping the treated powder or powder mixture using a metal additive manufacturing (MAM) method.

As described above, the metal comprising components can be manufactured from a wide variety of powders or powder mixtures. Some examples of the overall composition of powders or powder mixtures (in this context, the overall composition refers to the sum of the compositions of all metallic powders, this means, the sum, element by element, of the contribution of each content for all the metal powders in the mixture) that can be advantageously used are described below. In the meaning of this document, when the reference is made to compositions, the use of terms such as “below”, “above”, “or more”, “from”, “to”, “up to”, “at least”, “greater than”, “less than”, “more than” and the like, refers to compositional ranges that can be subsequently broken down into sub-ranges and combined with other upper and/or lower limits disclosed in any combination, provided that they are not mutually exclusive. In an embodiment, the overall composition of the powder or powder mixture provided has the following elements and limitations, all percentages being indicated in weight percent: % C: 0.25-0.8; Mn: 0-1.15; % Si: 0-0.35; % Cr: 0.1 max; % Mo: 1.5-6.5; % V: 0-0.6; % W: 0-4; Ni: 0-4; % Co: 0-3; the rest consisting of iron and trace elements. Throughout this document, unless the context clearly indicates otherwise, the term “trace elements” refers to several elements, including, but not limited to, H, He, Xe, F, S, P, Cu, Pb, Co, Ta, Zr, Nb, Hf, Cs, Y, Sc, Mn, Ni, Mo, W, C, N, B, O, Cr, Fe, Ne, Na, Cl, Ar, K, Br, Kr, Sr, Tc, Ru, Rh, Ti, Pd, Ag, I, Ba, Re, Os, Ir, Pt, Au, Hg, TI, Po, At, Rn, Fr, Ra, Ac, Th, Pa, U, Np, Pu, Am, Cm, Bk, Cf, Es, Fm, Md, No, Lr, La, Ce, Pr, Nd, Pm, Sm, Eu, Gd, Tb, Dy, Ho, Er, Tm, Yb, Lu, Rf, Db, Sg, Bh, Hs, Li, Be, Mg, Ca, Rb, Zn, Cd, Al, Ga, In, Ge, Sn, Bi, Sb, As, Se, Te, Ds, Rg, Cn, Nh, Fl, Mc, Lv, Ts, Og and Mt. In an embodiment, the trace elements comprise at least one of the elements listed above. In this document, for a given alloy, trace elements include all the elements listed above after excluding those elements listed in the composition of the given alloy. In different embodiments, the content of any trace element is preferably less than 1.8 wt %, less than 0.8 wt %, less than 0.3 wt %, less than 0.1 wt %, less than 0.09 wt %, and even less than 0.03 wt %. Trace elements may be intentionally added to attain a particular functionality to the alloy, such as reducing the cost of production and/or its presence may be unintentional and related mostly to the presence of impurities in the alloying elements and scraps used for the production of the alloy. There are several applications wherein the presence of trace elements may be detrimental for the overall properties of the steel. In different embodiments, the sum of all trace elements is less than 2.0 wt %, less than 1.4 wt %, less than 0.8 wt %, less than 0.4 wt %, less than 0.2 wt %, less than 0.1 wt %, and even less than 0.06 wt %. There are even some embodiments for a given application wherein trace elements are preferred being absent from the alloy. In contrast, there are several applications wherein the presence of trace elements may be preferred. In different embodiments, the sum of all trace elements is above 0.0012 wt %, above 0.012 wt %, above 0.06 wt %, above 0.12 wt %, and even above 0.55 wt %. In an embodiment, % C is above 0.31 wt %. In another embodiment, % C is above 0.36 wt %. In an embodiment, % C is less than 0.69 wt %. In another embodiment, % C is less than 0.48 wt %. In an embodiment, % Mn is above 0.16 wt %. In another embodiment, % Mn is above 0.21 wt %. In an embodiment, % Mn is less than 1.18 wt %. In another embodiment, % Mn is less than 0.94 wt %. In an embodiment, % Si is above 0.01 wt %. In another embodiment, % Si is above 0.12 wt %. In an embodiment, % Si is less than 0.52 wt %. In another embodiment, % Si is less than 0.27 wt %. In an embodiment, % Cr is above 0.0016 wt %. In another embodiment, % Cr is above 0.0021 wt %. In an embodiment, % Cr is less than 0.09 wt %. In another embodiment, % Cr is less than 0.04 wt %. In an embodiment, % Mo is above 1.86 wt %. In another embodiment, % Mo is above 2.1 wt %. In an embodiment, % Mo is less than 4.9 wt %. In another embodiment, % Mo is less than 3.4 wt %. In an embodiment, % V is above 0.12 wt %. In another embodiment, % V is above 0.21 wt %. In an embodiment, % V is less than 0.48 wt %. In another embodiment, % V is less than 0.23 wt %. In an embodiment, % W is above 0.28 wt %. In another embodiment, % W is above 0.66 wt %. In an embodiment, % W is less than 3.4 wt %. In another embodiment, % W is less than 2.9 wt %. In an embodiment, % Ni is above 0.32 wt %. In another embodiment, % Ni is above 0.56 wt %. In an embodiment, % Ni is less than 3.9 wt %. In another embodiment, % Ni is less than 3.4 wt %. In an embodiment, % Co is above 0.08 wt %. In another embodiment, % Co is above 0.16 wt %. In an embodiment, % Co is less than 2.4 wtwt %. In another embodiment, % Co is less than 1.9 wt %. In another embodiment, the overall composition of the powder or powder mixture provided has the following elements and limitations, all percentages being indicated in weight percent: % C: 0.25-0.55; % Mn: 0.10-1.2; % Si: 0.10-1.20; % Cr: 2.5-5.50; % Mo: 1.00-3.30; % V: 0.30-1.20; the rest consisting of iron and trace elements (as defined in this document). In an embodiment, % C is above 0.31 wtwt %. In another embodiment, % C is above 0.36 wt %. In an embodiment, % C is less than 0.49 wt %. In another embodiment, % C is less than 0.28 wt %. In an embodiment, % Mn is above 0.16 wt %. In another embodiment, % Mn is above 0.26 wt %. In an embodiment, % Mn is less than 0.96 wt %. In another embodiment, % Mn is less than 0.46 wt %. In an embodiment, % Si is above 0.16 wt %. In another embodiment, % Si is above 0.22 wt %. In an embodiment, % Si is less than 0.94 wt %. In another embodiment, % Si is less than 0.48 wt %. In an embodiment, % Cr is above 2.86 wt %. In another embodiment, % Cr is above 3.16 wt %. In an embodiment, % Cr is less than 4.9 wt %. In another embodiment, % Cr is less than 3.4 wt %. In an embodiment, % Mo is above 1.16 wt %. In another embodiment, % Mo is above 1.66 wt %. In an embodiment, % Mo is less than 2.9 wt %. In another embodiment, % Mo is less than 2.4 wt %. In an embodiment, % V is above 0.42 wt %. In another embodiment, % V is above 0.61 wt %. In an embodiment, % V is less than 0.98 wt %. In another embodiment, % V is less than 0.64 wt %. In another embodiment, the overall composition of the powder or powder mixture provided has the following elements and limitations, all percentages being indicated in weight percent: % C: 0.15-2.35; % Mn: 0.10-2.5; % Si: 0.10-1.0; % Cr: 0.2-17.50; % Mo: 0-1.4; % V: 0-1; % W: 0-2.2; % Ni: 0-4.3; the rest consisting of iron and trace elements (as defined in this document). In an embodiment, % C is above 0.21 wt %. In another embodiment, % C is above 0.42 wt %. In an embodiment, % C is less than 1.94 wt %. In another embodiment, % C is less than 1.48 wt %. In an embodiment, % Mn is above 0.18 wt %. In another embodiment, % Mn is above 0.26 wt %. In an embodiment, % Mn is less than 1.96 wt %. In another embodiment, % Mn is less than 1.46 wt %. In an embodiment, % Si is above 0.16 wt %. In another embodiment, % Si is above 0.22 wt %. In an embodiment, % Si is less than 0.94 wt %. In another embodiment, % Si is less than 0.48 wt %. In an embodiment, % Cr is above 0.56 wt %. In another embodiment, % Cr is above 1.12 wt %. In an embodiment, % Cr is less than 9.8 wt %. In another embodiment, % Cr is less than 6.4 wt %. In an embodiment, % Mo is above 0.17 wt %. In another embodiment, % Mo is above 0.56 wt %. In an embodiment, % Mo is less than 0.9 wt %. In another embodiment, % Mo is less than 0.68 wt %. In an embodiment, % V is above 0.12 wt %. In another embodiment, % V is above 0.21 wt %. In an embodiment, % V is less than 0.94 wt %. In another embodiment, % V is less than 0.59 wt %. In an embodiment, % W is above 0.18 wt %. In another embodiment, % W is above 0.56 wt %. In an embodiment, % W is less than 1.92 wt %. In another embodiment, % W is less than 1.44 wt %. In an embodiment, % Ni is above 0.02 wt %. In another embodiment, % Ni is above 0.26 wt %. In an embodiment, % Ni is less than 3.9 wt %. In another embodiment, % Ni is less than 3.4 wt %. In another embodiment, the overall composition of the powder or powder mixture provided has the following elements and limitations, all percentages being indicated in weight percent: % C: 0-0.4; % Mn: 0.1-1; % Si: 0-0.8; % Cr: 0-5.25; % Mo: 0-1.0; % V: 0-0.25; % Ni: 0-4.25; % Al: 0-1.25; the rest consisting of iron and trace elements (as defined in this document). In an embodiment, % C is above 0.08 wt %. In another embodiment, % C is above 0.12 wt %. In an embodiment, % C is less than 0.34 wt %. In another embodiment, % C is less than 0.29 wt %. In an embodiment, % Mn is above 0.18 wt %. In another embodiment, % Mn is above 0.26 wt %. In an embodiment, % Mn is less than 0.96 wt %. In another embodiment, % Mn is less than 0.46 wt %. In an embodiment, % Si is above 0.006 wt %. In another embodiment, % Si is above 0.02 wt %. In an embodiment, % Si is less than 0.64 wt %. In another embodiment, % Si is less than 0.44 wt %. In an embodiment, % Cr is above 0.16 wt %. In another embodiment, % Cr is above 0.62 wt %. In an embodiment, % Cr is less than 4.96 wt %. In another embodiment, % Cr is less than 3.94 wt %. In an embodiment, % Mo is above 0.07 wt %. In another embodiment, % Mo is above 0.16 wt %. In an embodiment, % Mo is less than 0.84 wt %. In another embodiment, % Mo is less than 0.64 wt %. In an embodiment, % V is above 0.02 wt %. In another embodiment, % V is above 0.09 wt %. In an embodiment, % V is less than 0.14 wt %. In another embodiment, % V is less than 0.09 wt %. In an embodiment, % Ni is above 0.12 wt %. In another embodiment, % Ni is above 0.16 wt %. In an embodiment, % Ni is less than 3.9 wt %. In another embodiment, % Ni is less than 3.4 wt %. In an embodiment, % Al is above 0.02 wt %. In another embodiment, % Al is above 0.16 wt %. In an embodiment, % Al is less than 0.94 wt %. In another embodiment, % Al is less than 0.46 wt %. In another embodiment, the overall composition of the powder or powder mixture provided has the following elements and limitations, all percentages being indicated in weight percent: % C: 0.77-1.40; % Si: 0-0.70; % Cr: 3.5-4.5; % Mo: 3.2-10; % V: 0.9-3.60; % W: 0-18.70; % Co: 0-10.50; the rest consisting of iron and trace elements (as defined in this document). In an embodiment, % C is above 0.91 wt %. In another embodiment, % C is above 1.06 wt %. In an embodiment, % C is less than 1.24 wt %. In another embodiment, % C is less than 0.94 wt %. In an embodiment, % Si is above 0.06 wt %. In another embodiment, % Si is above 0.12 wt %. In an embodiment, % Si is less than 0.44 wt %. In another embodiment, % Si is less than 0.34 wt %. In an embodiment, % Cr is above 3.86 wt %. In another embodiment, % Cr is above 4.06 wt %. In an embodiment, % Cr is less than 4.34 wt %. In another embodiment, % Cr is less than 4.24 wt %. In an embodiment, % Mo is above 3.6 wt %. In another embodiment, % Mo is above 4.2 wt %.

In an embodiment, % Mo is less than 8.4 wt %. In another embodiment, % Mo is less than 7.8 wt %. In an embodiment, % V is above 1.08 wt %. In another embodiment, % V is above 1.21 wt %. In an embodiment, % V is less than 2.94 wt %. In another embodiment, % V is less than 2.44 wt %. In an embodiment, % W is above 0.31 wt %. In another embodiment, % W is above 0.56 wt %. In an embodiment, % W is less than 14.4 wt %. In another embodiment, % W is less than 9.4 wt %. In an embodiment, % Co is above 0.01 wt %. In another embodiment, % Co is above 0.16 wt %. In an embodiment, % Co is less than 8.44 wt %. In another embodiment, % Co is less than 6.4 wt %. In another embodiment, the overall composition of the powder or powder mixture provided has the following elements and limitations, all percentages being indicated in weight percent: % C: 0.03 max; % Mn:0.1 max; % Si:0.1 max; % Mo:3.0-5.2; % Ni:18-19; % Co:0-12.5; % Ti: 0-2; the rest consisting of iron and trace elements (as defined in this document). In an embodiment, % C is above 0.0001 wt %. In another embodiment, % C is above 0.0003 wt %. In an embodiment, % C is less than 0.01 wt %. In another embodiment, % C is less than 0.001 wt %. In an embodiment, % Mn is above 0.00001 wt %. In another embodiment, % Mn is above 0.0003 wt %. In an embodiment, % Mn is less than 0.01 wt %. In another embodiment, % Mn is less than 0.008 wt %. In an embodiment, % Si is above 0.00002 wt %. In another embodiment, % Si is above 0.0004 wt %. In an embodiment, % Si is less than 0.011 wt %. In another embodiment, % Si is less than 0.004 wt %. In an embodiment, % Mo is above 3.52 wt %. In another embodiment, % Mo is above 4.12 wt %. In an embodiment, % Mo is less than 4.94 wt %. In another embodiment, % Mo is less than 4.44 wt %. In an embodiment, % Ni is above 18.26 wt %. In another embodiment, % Ni is above 18.56 wt %. In an embodiment, % Ni is less than 18.87 wt %. In another embodiment, % Ni is less than 18.73 wt %. In an embodiment, % Co is above 0.01 wt %. In another embodiment, % Co is above 0.26 wt %. In an embodiment, % Co is less than 9.44 wt %. In another embodiment, % Co is less than 7.4 wt %. In an embodiment, % Ti is above 0.08 wt %. In another embodiment, % Ti is above 0.12 wt %. In an embodiment, % Ti is less than 1.84 wt %. In another embodiment, % Ti is less than 1.44 wt %. In another embodiment, the overall composition of the powder or powder mixture provided has the following elements and limitations, all percentages being indicated in weight percent: % C: 1.5-1.85; % Mn: 0.15-0.5; % Si: 0.15-0.45; % Cr:3.5-5.0; % Mo:0-6.75; % V:4.5-5.25; % W:11.5-13.00; % Co:0-5.25; the rest consisting of iron and trace elements (as defined in this document). In an embodiment, % C is above 1.56 wt %. In another embodiment, % C is above 1.66 wt %. In an embodiment, % C is less than 1.78 wt %. In another embodiment, % C is less than 1.74 wt %. In an embodiment, % Mn is above 0.21 wt %. In another embodiment, % Mn is above 0.26 wt %. In an embodiment, % Mn is less than 0.41 wt %. In another embodiment, % Mn is less than 0.29 wt %. In an embodiment, % Si is above 0.18 wt %. In another embodiment, % Si is above 0.21 wt %. In an embodiment, % Si is less than 0.39 wt %. In another embodiment, % Si is less than 0.34 wt %. In an embodiment, % Cr is above 3.66 wt %. In another embodiment, % Cr is above 3.86 wt %. In an embodiment, % Cr is less than 4.92 wt %. In another embodiment, % Cr is less than 3.92 wt %. In an embodiment, % V is above 4.62 wt %. In another embodiment, % V is above 4.86 wt %. In an embodiment, % V is less than 5.18 wt %. In another embodiment, % V is less than 4.94 wt %. In an embodiment, % W is above 11.61 wt %. In another embodiment, % W is above 11.86 wt %. In an embodiment, % W is less than 12.94 wt %. In another embodiment, % W is less than 12.48 wt %. In an embodiment, % Co is above 0.1 wt %. In another embodiment, % Co is above 0.26 wt %. In an embodiment, % Co is less than 4.44 wt %. In another embodiment, % Co is less than 3.4 wt %. In another embodiment, the overall composition of the powder or powder mixture provided has the following elements and limitations, all percentages being indicated in weight percent: % C: 0-0.6; % Mn: 0-1.5; % Si: 0-1; % Cr:11.5-17.5; % Mo:0-1.5; % V:0-0.2; % Ni: 0-6.0; the rest consisting of iron and trace elements (as defined in this document). In an embodiment, % C is above 0.02 wt %. In another embodiment, % C is above 0.12 wt %. In an embodiment, % C is less than 0.48 wt %. In another embodiment, % C is less than 0.44 wt %. In an embodiment, % Mn is above 0.01 wt %. In another embodiment, % Mn is above 0.16 wt %. In an embodiment, % Mn is less than 1.22 wt %. In another embodiment, % Mn is less than 0.93 wt %. In an embodiment, % Si is above 0.08 wt %. In another embodiment, % Si is above 0.11 wt %. In an embodiment, % Si is less than 0.89 wt %. In another embodiment, % Si is less than 0.46 wt %. In an embodiment, % Cr is above 11.86 wt %. In another embodiment, % Cr is above 12.56 wt %. In an embodiment, % Cr is less than 16.94 wt %. In another embodiment, % Cr is less than 14.96 wt %. In an embodiment, % Mo is above 0.09 wt %. In another embodiment, % Mo is above 0.28 wt %. In an embodiment, % Mo is less than 1.22 wt %. In another embodiment, % Mo is less than 0.94 wt %. In an embodiment, % V is above 0.0018 wt %. In another embodiment, % V is above 0.009 wt %. In an embodiment, % V is less than 0.14 wt %. In another embodiment, % V is less than 0.09 wt %. In an embodiment, % Ni is above 0.09 wt %. In another embodiment, % Ni is above 0.16 wt %. In an embodiment, % Ni is less than 4.48 wt %. In another embodiment, % Ni is less than 3.92 wt %. In another embodiment, the overall composition of the powder or powder mixture provided has the following elements and limitations, all percentages being indicated in weight percent: % C: 0.015 max; % Mn: 0.5-1.25; % Si: 0.2-1; % Cr:11-18; % Mo:0-3.25; % Ni:3.0-9.5; % Ti:0-1.40; % Al:0-1.5; % Cu:0-5; the rest consisting of iron and trace elements (as defined in this document). In an embodiment, % C is above 0.002 wt %. In an embodiment, % C is above 0.0036 wt %. In an embodiment, % C is less than 0.001 wt %. In an embodiment, % C is less than 0.003 wt %. In an embodiment, % Mn is above 0.61 wt %. In an embodiment, % Mn is above 0.77 wt %. In an embodiment, % Mn is less than 1.18 wt %. In an embodiment, % Mn is less than 0.96 wt %. In an embodiment, % Si is above 0.28 wt %. In an embodiment, % Si is above 0.31 wt %. In an embodiment, % Si is less than 0.89 wt %. In an embodiment, % Si is less than 0.46 wt %. In an embodiment, % Cr is above 11.58 wt %. In an embodiment, % Cr is above 12.62 wt %. In an embodiment, % Cr is less than 16.92 wt %. In an embodiment, % Cr is less than 14.92 wt %. In an embodiment, % Mo is above 0.19 wt %. In an embodiment, % Mo is above 0.28 wt %. In an embodiment, % Mo is less than 2.82 wt %. In an embodiment, % Mo is less than 1.88 wt %. In an embodiment, % Ni is above 3.64 wt %. In an embodiment, % Ni is above 5.62 wt %. In an embodiment, % Ni is less than 8.82 wt %. In an embodiment, % Ni is less than 8.21 wt %. In an embodiment, % Ti is above 0.08 wt %. In an embodiment, % Ti is above 0.12 wt %. In an embodiment, % Ti is less than 1.34 wt %. In an embodiment, % Ti is less than 1.22 wt %. In an embodiment, % Al is above 0.06 wt %. In an embodiment, % Al is above 0.14 wt %. In an embodiment, % Al is less than 1.24 wt %. In an embodiment, % Al is less than 1.12 wt %. In an embodiment, % Cu is above 0.09 wt %. In an embodiment, % Cu is above 0.12 wt %. In an embodiment, % Cu is less than 4.38 wt %. In another embodiment, % Cu is less than 3.82 wt %. In another embodiment, the overall composition of the powder or powder mixture provided has the following elements and limitations, all percentages being indicated in weight percent: % Cr: 10-14; % Ni: 5.6-12.5; % Ti: 0.4-2.8% Mo: 0-4.4; % B: 0-4; % Co: 0-12; % Mn: 0-2; % Cu: 0-2; % Al: 0-1; % Nb: 0-0.5; % Ce: 0-0.3; % Si: 0-2; % C, % N, % P, % S, % O each 0.09% max; % C+% N+% P+% S+% O: 0-0.3; % La+% Cs+% Nd+% Gd+% Pr+% Ac+% Th+% Tb+% Dy+% Ho+% Er+% Tm+% Yb+% Y+% Lu+% Sc+% Zr+% Hf: 0-0.4; % V+% Ta+% W: 0-0.8; the rest consisting of iron and trace elements (as defined in this document). For some applications, the chromium content may be very critical. Too much % Cr may lead to low fracture toughness and too low % Cr may lead to poor corrosion resistance. For some applications, the effect of % Cr on stress corrosion cracking may also be pronounced, but in intercorrelation with other alloying elements. In different embodiments, % Cr is 10.6 wt % or higher, 11.2 wt % or higher, 11.6 wt % or higher, 12.1 wt % or higher, 12.6 wt % or higher and even 13.2 wt % or higher. In different embodiments, % Cr is 13.4 wt % or lower, 12.9 wt % or lower, 12.4 wt % or lower and even 11.9 wt % or lower. For some applications, the boron content may be very critical. Too much % B may lead to low fracture toughness and too low % B may lead to poor wear resistance. For some applications, the effect of % B on high temperature yielding may also be pronounced, but in intercorrelation with other alloying elements. In different embodiments, % B is 35 ppm or higher, 120 ppm or higher, 0.02 wt % or higher, 0.12 wt % or higher, 0.6 wt % or higher and even 1.2 wt % or higher. In different embodiments, % B is 1.9 wt % or lower, 0.9 wt % or lower, 0.4 wt % or lower and even 0.09 wt % or lower. For some applications, the titanium content may be very critical. Too much % Ti may lead to low fracture toughness and too low % Ti may lead to poor yield strength. For some applications, the effect of % Ti on wear resistance may also be pronounced, but in intercorrelation with other alloying elements. In different embodiments, % Ti is 0.7 wt % or higher, 1.6 wt % or higher, 1.8 wt % or higher, 2.1 wt % or higher and even 2.55 wt % or higher. In different embodiments, % Ti is 2.4 wt % or lower, 1.9 wt % or lower, 1.4 wt % or lower and even 0.9 wt % or lower. For some applications, the nickel content may be very critical. Too much % Ni may lead to low yield strength and too low % Ni may lead to poor elongation at fracture. For some applications, the effect of % Ni on stress corrosion cracking may also be pronounced, but in intercorrelation with other alloying elements. In different embodiments, % Ni is 6.1 wt % or higher, 7.1 wt % or higher, 8.6 wt % or higher, 10.6 wt % or higher, 11.1 wt % or higher and even 11.5 wt % or higher. In different embodiments, % Ni is 11.9 wt % or lower, 11.4 wt % or lower, 10.9 wt % or lower and even 9.9 wt % or lower. For some applications, the molybdenum content may be very critical. Too much % Mo may lead to low fracture toughness and too low % Mo may lead to poor yield strength. For some applications, the effect of % Mo on stress corrosion cracking may also be pronounced, but in intercorrelation with other alloying elements. In different embodiments, % Mo is 0.26 wt % or higher, 0.76 wt % or higher, 1.2 wt % or higher, 1.6 wt % or higher, 2.1 wt % or higher and even 3.2 wt % or higher. In different embodiments, % Mo is 3.9 wt % or lower, 2.9 wt % or lower, 1.9 wt % or lower and even 0.9 wt % or lower. In another embodiment, % Mo is not intentionally present or present as a trace element only. In another embodiment, % Mo is not present. For some applications, the cobalt content may be very critical. Too much % Co may lead to low yield strength and too low % Co may lead to poor corrosion resistance/fracture toughness combination. For some applications, the effect of % Co on stress corrosion cracking may also be pronounced, but in intercorrelation with other alloying elements. In different embodiments, % Co is 0.6 wt % or higher, 2.2 wt % or higher, 3.6 wt % or higher, 6.1 wt % or higher, 7.6 wt % or higher and even 10.2 wt % or higher. In different embodiments, % Co is 9.9 wt % or lower, 8.9 wt % or lower, 7.9 wt % or lower and even 3.9 wt % or lower. In another embodiment, % Co is not intentionally present or present as a trace element only. In another embodiment, % Co is not present. For some applications, while a bit of % Mn can improve certain mechanical properties, too much % Mn may lead to deterioration of mechanical properties. In different embodiments, % Mn is 0.12 wt % or higher, 0.31 wt % or higher, 0.52 wt % or higher, 0.61 wt % or higher, 0.76 wt % or higher and even 1.2 wt % or higher. In different embodiments, % Mn is 1.4 wt % or lower, 0.9 wt % or lower, 0.29 wt % or lower and even 0.09 wt % or lower. In another embodiment, % Mn is not intentionally present or present as a trace element only. In another embodiment, % Mn is not present. For some applications, while a bit of % Cu can improve yield strength, too much % Cu may lead to deterioration of mechanical properties. In different embodiments, % Cu is 0.12 wt % or higher, 0.31 wt % or higher, 0.52 wt % or higher, 0.61 wt % or higher, 0.76 wt % or higher and even 1.2 wt % or higher. In different embodiments, % Cu is 1.4 wt % or lower, 0.9 wt % or lower, 0.29 wt % or lower and even 0.09 wt % or lower. In another embodiment, % Cu is not intentionally present or present as a trace element only. In another embodiment, % Cu is not present. For some applications, while a bit of % Si can improve certain mechanical properties, too much % Si may lead to deterioration of mechanical properties. In different embodiments, % Si is 0.12 wt % or higher, 0.31 wt % or higher, 0.52 wt % or higher, 0.61 wt % or higher, 0.76 wt % or higher and even 1.2 wt % or higher. In different embodiments, % Si is 1.4 wt % or lower, 0.9 wt % or lower, 0.29 wt % or lower and even 0.09 wt % or lower. In another embodiment, % Si is not intentionally present or present as a trace element only. In another embodiment, % Si is not present.

For some applications, while a bit of % Al can improve the yield strength, too much % Al may lead to deterioration of fracture toughness. In different embodiments, % Al is 0.01 wt % or higher, 0.06 wt % or higher, 0.12 wt % or higher, 0.22 wt % or higher, 0.31 wt % or higher and even 0.51 wt % or higher. In different embodiments, % Al is 0.4 wt % or lower, 0.24 wt % or lower, 0.09 wt % or lower and even 0.04 wt % or lower. In another embodiment, % Al is not intentionally present or present as a trace element only. In another embodiment, % Al is not present. For some applications, while a bit of % Nb can improve the yield strength, too much % Nb may lead to deterioration of fracture toughness. In different embodiments, % Nb is 0.01 wt % or higher, 0.04 wt % or higher, 0.06 wt % or higher, 0.12 wt % or higher, 0.22 wt % or higher and even 0.31 wt % or higher. In different embodiments, % Nb is 0.29 wt % or lower, 0.14 wt % or lower, 0.09 wt % or lower and even 0.04 wt % or lower. In another embodiment, % Nb is not intentionally present or present as a trace element only. In another embodiment, % Nb is not present. For some applications, while a bit of % Ce can improve toughness related properties by lowering the content of some harmful oxides, too much % Ce may lead to exactly the contrary. In different embodiments, % Ce is 0.01 wt % or higher, 0.0006 wt % or higher, 0.001 wt % or higher, 0.006 wt % or higher, 0.01 wt % or higher and even 0.12 wt % or higher. In different embodiments, % Ce is 0.09 wt % or lower, 0.04 wt % or lower, 0.009 wt % or lower, 0.004 wt % or lower and even 0.0009 wt % or lower. In another embodiment, % Ce is not intentionally present or present as a trace element only. In another embodiment, % Ce is not present. For some applications, a certain content of the sum % La+% Cs+% Nd+% Gd+% Pr+% Ac+% Th+% Tb+% Dy+% Ho+% Er+% Tm+% Yb+% Y+% Lu+% Sc+% Zr+% Hf may be advantageous. In different embodiments, the sum of % La+% Cs+% Nd+% Gd+% Pr+% Ac+% Th+% Tb+% Dy+% Ho+% Er+% Tm+% Yb+% Y+% Lu+% Sc+% Zr+% Hf is 0.01 wt % or higher, 0.0006 wt % or higher, 0.001% or higher, 0.006 wt % or higher, 0.01 wt % or higher and even 0.12 wt % or higher. For some applications, while a bit of the sum of % La+% Cs+% Nd+% Gd+% Pr+% Ac+% Th+% Tb+% Dy+% Ho+% Er+% Tm+% Yb+% Y+% Lu+% Sc+% Zr+% Hf can improve toughness related properties by lowering the content of some harmful oxides, too much of the sum of % La+% Cs+% Nd+% Gd+% Pr+% Ac+% Th+% Tb+% Dy+% Ho+% Er+% Tm+% Yb+% Y+% Lu+% Sc+% Zr+% Hf may lead to exactly the contrary. In different embodiments, the sum of % La+% Cs+% Nd+% Gd+% Pr+% Ac+% Th+% Tb+% Dy+% Ho+% Er+% Tm+% Yb+% Y+% Lu+% Sc+% Zr+% Hf is 0.09 wt % or lower, 0.04% or lower, 0.009 wt % or lower, 0.004 wt % or lower and even 0.0009 wt % or lower. In another embodiment, the sum of % La+% Cs+% Nd+% Gd+% Pr+% Ac+% Th+% Tb+% Dy+% Ho+% Er+% Tm+% Yb+% Y+% Lu+% Sc+% Zr+% Hf is not intentionally present or present as a trace element only. In another embodiment, the sum of % La+% Cs+% Nd+% Gd+% Pr+% Ac+% Th+% Tb+% Dy+% Ho+% Er+% Tm+% Yb+% Y+% Lu+% Sc+% Zr+% Hf is not present. For some applications, the elements % C, % N, % P, % S, % O are very detrimental and should be kept as low as possible. In different embodiments, at least one of % C, % N, % P, % S, % O is 0.04 wt % or lower, 0.009 wt % or lower, 0.004 wt % or lower, 0.0019 wt % or lower, 0.0009 wt % or lower and even 0.0004 wt % or lower. In another embodiment, at least one of % C, % N, % P, % S, % O is not intentionally present or present as a trace element only. In another embodiment, at least one of % C, % N, % P, % S, % O is not present. In an embodiment, % C is not present in the composition. In another embodiment, % C is a trace element. In an embodiment, % O is not present in the composition. In another embodiment, % O is a trace element. In an embodiment, % N is not present in the composition. In another embodiment, % N is a trace element. In an embodiment, % P is not present in the composition. In another embodiment, % P is a trace element. In an embodiment, % S is not present in the composition. In another embodiment, % S is a trace element. For some applications, the presence of % C, % N, % P, % S, % O may be very detrimental and should be kept as low as possible. In different embodiments, each of % C, % N, % P, % S, % O is 0.04 wt % or lower, 0.009 wt % or lower, 0.004 wt % or lower, 0.0019 wt % or lower, 0.0009 wt % or lower and even 0.0004 wt % or lower. In another embodiment, each of % C, % N, % P, % S, % O is not intentionally present or present as a trace element only. In another embodiment, each of % C, % N, % P, % S, % O is not present. For some applications, the sum % C+% N+% P+% S+% O can be intentionally added. In different embodiments, the sum of % C+% N+% P+% S+% O is 0.0006 wt % or higher, 0.001 wt % or higher, 0.006 wt % or higher, 0.01 wt % or higher and even 0.12 wt % or higher. For some applications, while a bit of the sum of % C+% N+% P+% S+% O can improve mechanical strength related properties, too much of the sum of % C+% N+% P+% S+% O may lead to massive fracture toughness deterioration. In different embodiments, the sum of % C+% N+% P+% S+% O is 0.09 wt % or lower, 0.04 wt % or lower, 0.009 wt % or lower, 0.004 wt % or lower and even 0.0009 wt % or lower. In another embodiment, the sum of % C+% N+% P+% S+% O is not intentionally present or present as a trace element only. In an embodiment, the sum of % C+% N+% P+% S+% O is not present. For some applications, a certain content of the sum of % V+% Ta+% W may be advantageous. In different embodiments, the sum of % V+% Ta+% W is 0.06 wt % or higher, 0.12 wt % or higher, 0.32 wt % or higher, 0.42 wt % or higher and even 0.52 wt % or higher. For some applications, while a bit of the sum of % V+% Ta+% W can improve wear resistance related properties, too much of the sum of % V+% Ta+% W may lead to deterioration of toughness related properties. In different embodiments, the sum of % V+% Ta+% W is 0.49 wt % or lower, 0.24 wt % or lower, 0.14 wt % or lower, 0.09 wt % or lower and even 0.009 wt % or lower. In another embodiment, the sum of % V+% Ta+% W is not intentionally present or present as a trace element only. In another embodiment, the sum of % V+% Ta+% W is not present. In an embodiment, % V is not present in the composition. In an embodiment, % V is a trace element. In an embodiment, % Ta is not present in the composition. In an embodiment, % Ta is a trace element. In an embodiment, % W is not present in the composition. In an embodiment, % W is a trace element. In another embodiment, the overall composition of the powder or powder mixture provided has the following elements and limitations, all percentages being indicated in weight percent: % Mo: 0-6.8; % W: 0-6.9; % Moeq: 0-6.8; % Ceq: 0.16-1.8; % C: 0-1.29; % N: 0.11-2.09; % B: 0-0.14; % Si: 0-1.5; % Mn: 0-24; % Ni: 0-18.9; % Cr: 12.1-38; % Ti: 0-2.4; % Al: 0-14; % V: 0-4; % Nb: 0-4; % Zr: 0-3; % Hf: 0-3; % Ta: 0-3; % S: 0-0.098; % P: 0-0.098; % Pb: 0-0.9; % Cu: 0-3.9; % Bi: 0-0.08; % Se: 0-0.08; % Co: 0-14; % REE: 0-4; % Y: 0-1.86; % Sc: 0-0.96; % Cs: 0-1.4; % O: 0.00012-0.899; % Y+% Sc+% REE: 0.0022-3.9%; the rest consisting of iron and trace elements (as defined in this document); wherein % Ceq=% C+0.86*% N+1.2*% B and % Moeq=% Mo+%*% W. For some applications, the presence of % Mo is desirable, while in other applications it is rather an impurity. In different embodiments, % Mo is above 0.16 wt %, above 0.51 wt %, above 1.6 wt %, above 2.1 wt %, above 2.6 wt %, and even above 4.1 wt %. On the other hand, for certain applications, excessive % Mo seems to deteriorate some mechanical properties. In different embodiments, % Mo is less than 5.9 wt %, less than 5.4 wt %, less than 4.4 wt %, and even less than 2.9 wt %. Obviously, there are cases where the desired nominal content is 0 wt % or nominal absence of the element as occurs with all optional elements for certain applications. For some applications, the presence of % W is desirable, while in other applications it is rather an impurity. In different embodiments, % W is above 0.09 wt %, above 0.21 wt %, above 1.1 wt %, above 1.56 wt %, above 2.1 wt %, and even above 2.56 wt %. On the other hand, for some applications, excessive % W seems to deteriorate some mechanical properties. In different embodiments, % W is less than 5.8 wt %, less than 5.2 wt %, less than 4.2 wt %, less than 2.8 wt %, and even less than 1.4 wt %. Obviously, there are cases where the desired nominal content is 0 wt % or nominal absence of the element as occurs with all optional elements for certain applications. For some applications, % Mo can be partially replaced with % W. This replacement takes place in terms of % Moeq. For some applications, the presence of % Moeq is desirable, while in other applications, it is rather an impurity. In different embodiments, % Moeq is above 0.5 wt %, above 1.6 wt %, above 1.8 wt %, above 2.1 wt %, and even above 4.1 wt %. On the other hand, for some applications too high levels of % Moeq will lead to situations where required mechanical properties cannot be achieved. In different embodiments, % Moeq is less than 6.2 wt %, less than 5.7 wt %, less than 4.7 wt %, less than 3.8 wt %, less than 3.4 wt %, and even less than 2.9 wt %. For some applications, higher % Ceq contents are preferred. In different embodiments, % Ceq is above 0.26 wt %, above 0.51 wt %, above 0.89 wt %, above 1.06 wt %, and even above 1.26 wt %. On the other hand, for certain applications, an excessively high equivalent carbon (% Ceq) content of may adversely affect some mechanical properties of the manufactured component. In different embodiments, % Ceq is less than 1.4 wt %, less than 1.24 wt %, less than 0.94 wt %, less than 0.7 wt %, and even less than 0.47 wt %. For some applications, the presence of % C is desirable, while in other applications it is rather an impurity. In different embodiments, % C is above 0.12 wt %, above 0.26 wt %, above 0.36 wt %, above 0.52 wt %, above 0.72 wt %, above 0.92 wt %, and even above 1.06 wt %. On the other hand, for certain applications, excessive % C seems to deteriorate some mechanical properties. In different embodiments, % C is less than 1.1 wt %, less than 0.98 wt %, less than 0.64 wt %, less than 0.48 wt %, and even less than 0.01 wt %. Obviously, there are cases where the desired nominal content is 0 wt % or nominal absence of the element as occurs with all optional elements for certain applications. For some applications, higher % N contents are preferred. In different embodiments, % N is above 0.16 wt %, above 0.21 wt %, above 0.91 wt %, above 1.26 wt %, and even above 1.61 wt %. On the other hand, for certain applications, an excessively high nitrogen (% N) content may adversely affect some of the mechanical properties of the manufactured component. In different embodiments, % N is less than 1.9 wt %, less than 1.44 wt %, less than 0.9 wt %, less than 0.4 wt %, and even less than 0.24 wt %. The inventor has found that for certain applications, lower levels of % N may be advantageous, particularly with certain % Mn and % C contents. In an embodiment, % N<0.11 wt %, % Mn>16%-48 wt %, and % C>0.4 wt %. In another embodiment, % N<0.0019 wt %, % Mn>21%-39 wt %, and % C>0.52 wt %. For some applications, particularly when % N>0.4, it may be important to control the content of 30*% C+% Ni+2*% Mn/3+% Cu/3+20*(% N-0.4). In different embodiments, 30*% C+% Ni+2*% Mn/3+% Cu/3+20*(% N-0.4) is greater than 7.2, greater than 11.6, greater than 12.2 and even greater than 16. On the other hand, for certain applications, an excessively high content may adversely affect some mechanical properties of the manufactured component. In different embodiments, 30*% C+% Ni+2*% Mn/3+% Cu/3+20*(% N-0.4) is smaller than 99, smaller than 79, smaller than 64, smaller than 59 and even smaller than 44. For some applications, the presence of % B is desirable, while in other applications it is rather an impurity. In different embodiments, % B is above 0.0002 wt %, above 0.0006 wt %, above 0.006 wt %, above 0.02 wt %, above 0.09 wt %, and even above 0.1 wt %. On the other hand, for certain applications, excessive % B seems to deteriorate some mechanical properties. In different embodiments, % B is less than 0.12 wt %, less than 0.09 wt %, less than 0.04 wt %, and even less than 0.009 wt %. Obviously, there are cases where the desired nominal content is 0 wt % or nominal absence of the element as occurs with all optional elements for certain applications. On the other hand, for certain applications, excessive % Si seems to deteriorate some mechanical properties. In different embodiments, % Si is 1.9 wt % or less, less than 0.96 wt %, less than 0.74 wt %, less than 0.48 wt %, and even less than 0.19 wt %. For some applications, particularly low levels are preferred. In different embodiments, % Si is less than 0.09 wt %, less than 0.03 wt %, less than 0.009 wt %, and even less than 0.003 wt %. Obviously, there are cases where the desired nominal content is 0 wt % or nominal absence of the element as occurs with all optional elements for certain applications. For some applications, the presence of % Mn is desirable, while in other applications it is rather an impurity. In different embodiments, % Mn is above 0.2 wt %, above 0.6 wt %, above 2.6 wt %, above 5.1 wt %, above 8.1 wt %, above 10.6 wt %, and even above 18.1 wt %. On the other hand, for certain applications, excessive % Mn seems to deteriorate some mechanical properties. In different embodiments, % Mn is less than 17.9 wt %, less than 14 wt %, less than 9.4 wt %, and even less than 6.9 wt %. For certain applications, even lower % Mn contents are preferred. In different embodiments, % Mn is less than 4.9 wt %, less than 3.9 wt %, less than 2.4 wt %, and even less than 1.4 wt %. Obviously, there are cases where the desired nominal content is 0 wt % or nominal absence of the element as occurs with all optional elements for certain applications. For some applications, the presence of % Ni is desirable, while in other applications it is rather an impurity. In different embodiments, % Ni is above 0.1 wt %, above 0.6 wt %, above 2.1 wt %, above 3.6 wt %, above 5.1 wt %, and even above 10.1 wt %. On the other hand, for certain applications, excessive % Ni seems to deteriorate some mechanical properties. In different embodiments, % Ni is less than 14 wt %, less than 11.9 wt %, less than 7.4 wt %, and even less than 5.9 wt %. For certain applications, even lower % Ni contents are preferred. In different embodiments, % Ni is less than 4.9 wt %, less than 3.9 wt %, less than 2.2 wt %, and even less than 1.2 wt %. Obviously, there are cases where the desired nominal content is 0 wt % or nominal absence of the element as occurs with all optional elements for certain applications. For some applications, a certain content of % Ni+% Mn is desirable. In different embodiments, % Ni+% Mn is above 1.2 wt %, above 2.1 wt %, above 3.2 wt %, and even above 4.2 wt %. On the other hand, for certain applications, excessive % Ni+% Mn seems to deteriorate some mechanical properties. In different embodiments, % Ni+% Mn is less than 29 wt %, less than 24 wt %, less than 19 wt %, less than 16 wt %, and even less than 14 wt %. For some applications, higher levels of % Cr are preferred. In different embodiments, % Cr is above 12.5 wt %, above 15.1 wt %, above 18.6 wt %, above 20.6 wt %, above 26 wt %, and even above 30.6 wt %. On the other hand, for certain applications, an excessively high chromium (% Cr) content may adversely affect some mechanical properties of the manufactured component. In different embodiments, % Cr is less than 34 wt %, less than 29 wt %, less than 26 wt %, less than 24 wt %, and even less than 19.6 wt %. On the other hand, for some applications even lower levels may be preferred. In different embodiments, % Cr is less than 18.4 wt %, less than 16.9 wt %, less than 16.2 wt %, less than 15.4 wt %, and even less than 14.9 wt %. For some applications, % Cr and % N can be partially replaced when certain levels of % Mn and % C are present in the composition. In an embodiment, % Cr<9.9 wt %, and % Mn>22 wt %, and % N<0.4 wt %, and % C>0.52 wt %. For some applications, the presence of % Ti is desirable, while in other applications it is rather an impurity. In different embodiments, % Ti is above 0.12 wt %, above 0.51 wt %, above 0.81 wt %, above 1.1 wt %, above 1.6 wt %, and even above 1.8 wt %. On the other hand, for certain applications, excessive % Ti seems to deteriorate some mechanical properties. In different embodiments, % Ti is less than 1.9 wt %, less than 1.4 wt %, less than 0.9 wt %, less than 0.5 wt %, and even less than 0.14 wt %. Obviously, there are cases where the desired nominal content is 0 wt % or nominal absence of the element as occurs with all optional elements for certain applications. For some applications, the presence of % Al is desirable, while in other applications it is rather an impurity. In different embodiments, % Al is above 0.001 wt %, above 0.16 wt %, above 1.1 wt %, above 2.6 wt %, above 5.1 wt %, and even above 10.6 wt %. On the other hand, for certain applications, an excessively high aluminium (% Al) content may adversely affect some mechanical properties of the manufactured component. In different embodiments, % Al is less than 12 wt %, less than 9.4 wt %, less than 7.4 wt %, less than 5.9 wt %, and even less than 4.9 wt %. For some applications, lower % Al contents are preferred. In different embodiments, % Al is less than 3.4 wt %, less than 2.9 wt %, less than 2.2 wt %, less than 1.5 wt %, and even less than 0.9 wt %. Obviously, there are cases where the desired nominal content is 0 wt % or nominal absence of the element as occurs with all optional elements for certain applications. On the other hand, for certain applications, excessive % V seems to deteriorate some mechanical properties. In different embodiments, % V is less than 2.94 wt %, less than 1.48 wt %, less than 0.94 wt %, less than 0.4 wt %, and even less than 0.19 wt %. Obviously, there are cases where the desired nominal content is 0 wt % or nominal absence of the element as occurs with all optional elements for certain applications. For some applications, a certain content of % Al+% Ti+% V is desirable. In different embodiments, % Al+% Ti+% V is above 0.001 wt %, above 0.52 wt %, and even above 1.6 wt %. On the other hand, for certain applications, excessive % Al+% Ti+% V seems to deteriorate some mechanical properties. In different embodiments, % Al+% Ti+% V is less than 5.9 wt %, less than 4 wt %, and even less than 2.4 wt %. For some applications, the presence of % Nb is desirable, while in other applications it is rather an impurity. In different embodiments, % Nb is above 0.06 wt %, above 0.1 wt %, above 0.26 wt %, above 0.6 wt %, above 1.6 wt %, and even above 2.1 wt %. On the other hand, for certain applications, an excessively high niobium (% Nb) content may adversely affect some mechanical properties of the manufactured component. In different embodiments, % Nb is less than 2.9 wt %, less than 1.4 wt %, less than 0.9 wt %, less than 0.4 wt %, and even less than 0.1 wt %. Obviously, there are cases where the desired nominal content is 0 wt % or nominal absence of the element as occurs with all optional elements for certain applications. For some applications, a certain content of % Cr+% Mo+1.5*% Si+0.5*% Nb+5*% V+3*% Al is desirable to improve mechanical strength related properties. In different embodiments, % Cr+% Mo+1.5*% Si+0.5*% Nb+5*% V+3*% Al is above 11.6 wt % above 13.1 wt % above 16 wt %, and even above 21 wt %. On the other hand, excessive % Cr+% Mo+1.5*% Si+0.5*% Nb+5*% V+3*% Al may lead to massive deterioration of the toughness. In different embodiments, % Cr+% Mo+1.5*% Si+0.5*% Nb+5*% V+3*% Al is less than 99 wt %, less than 69 wt %, less than 59 wt %, less than 49 wt %, and even less than 34 wt %. For some applications, the presence of % Zr is desirable, while in other applications it is rather an impurity. In different embodiments, % Zr is above 0.09 wt %, above 0.12 wt %, above 0.36 wt %, above 0.6 wt %, and even above 1.6 wt %. On the other hand, for certain applications, excessive % Zr seems to deteriorate some mechanical properties. In different embodiments, % Zr is less than 2.4 wt %, less than 1.8 wt %, less than 0.9 wt %, less than 0.4 wt %, and even less than 0.08 wt %. Obviously, there are cases where the desired nominal content is 0 wt % or nominal absence of the element as occurs with all optional elements for certain applications. On the other hand, for certain applications, excessive % Hf seems to deteriorate some mechanical properties. In different embodiments, % Hf is less than 2.2 wt %, less than 1.8 wt %, less than 0.9 wt %, less than 0.4 wt %, and even less than 0.08 wt %. Obviously, there are cases where the desired nominal content is 0 wt % or nominal absence of the element as occurs with all optional elements for certain applications. On the other hand, for certain applications, excessive % Ta seems to deteriorate some mechanical properties. In different embodiments, % Ta is less than 2.2 wt %, less than 1.8 wt %, less than 0.9 wt %, less than 0.4 wt %, and even less than 0.08 wt %. Obviously, there are cases where the desired nominal content is 0 wt % or nominal absence of the element as occurs with all optional elements for certain applications. For some applications, a certain content of % Zr+% Hf+% Ta is desirable. In different embodiments, % Zr+% Hf+% Ta is above 0.001 wt %, above 0.16 wt %, and even above 1.26 wt %. On the other hand, for certain applications, excessive % Zr+% Hf+% Ta seems to deteriorate some mechanical properties. In different embodiments, % Zr+% Hf+% Ta is less than 5.4 wt %, less than 4 wt %, and even less than 2.4 wt %. For some applications, the presence of % Cu is desirable, while in other applications it is rather an impurity. In different embodiments, % Cu is above 0.1 wt %, above 0.29 wt %, above 0.6 wt %, above 1.2 wt %, and even above 1.6 wt %. On the other hand, for certain applications, an excessively high copper (% Cu) content may adversely affect some mechanical properties of the manufactured component. In different embodiments, % Cu is less than 2.8 wt %, less than 1.9 wt %, less than 1.2 wt %, less than 0.9 wt %, and even less than 0.39 wt %. Obviously, there are cases where the desired nominal content is 0 wt % or nominal absence of the element as occurs with all optional elements for certain applications. For some applications, a certain content of % Ni+% Co+% Cu is desirable. In different embodiments, % Ni+% Co+% Cu is above 1.2 wt %, above 2.1 wt %, above 3.2 wt %, and even above 4.2 wt %. On the other hand, for certain applications, an excessively high content may adversely affect some mechanical properties of the manufactured component. In different embodiments, % Ni+% Co+% Cu is less than 24 wt %, less than 16 wt %, less than 14 wt %, and even less than 9 wt %. On the other hand, for certain applications, excessive % Bi seems to deteriorate some mechanical properties. In different embodiments, % Bi is less than 0.05 wt %, less than 0.02 wt %, less than 0.009 wt %, less than 0.005 wt %, and even less than 0.0009 wt %. Obviously, there are cases where the desired nominal content is 0 wt % or nominal absence of the element as occurs with all optional elements for certain applications. On the other hand, for certain applications, excessive % Se seems to deteriorate some mechanical properties. In different embodiments, % Se is less than 0.04 wt %, less than 0.01 wt %, less than 0.009 wt %, less than 0.004 wt %, and even less than 0.0008 wt %. Obviously, there are cases where the desired nominal content is 0 wt % or nominal absence of the element as occurs with all optional elements for certain applications. For some applications, % Se can be at least partially replaced by % Te. For some applications, the presence of % Pb is desirable, while in other applications it is rather an impurity. In different embodiments, % Pb is above 0.001 wt %, above 0.009 wt %, above 0.06 wt %, above 0.1 wt %, and even above 0.26 wt %. On the other hand, for certain applications, excessively high lead (% Pb) content may adversely affect some mechanical properties of the manufactured component. In different embodiments, % Pb is less than 0.6 wt %, less than 0.4 wt %, less than 0.19 wt %, less than 0.09 wt %, and even less than 0.009 wt %. Obviously, there are cases where the desired nominal content is 0 wt % or nominal absence of the element as occurs with all optional elements for certain applications. For some applications, a certain content of % Pb+% Bi+% Se is desirable. In different embodiments, % Pb+% Bi+% Se is above 0.0001 wt %, above 0.001 wt %, and even above 0.06 wt %. On the other hand, for certain applications, an excessively high content may adversely affect some mechanical properties of the manufactured component. In different embodiments, % Pb+% Bi+% Se is less than 0.44 wt %, less than 0.19 wt %, and even less than 0.15 wt %. On the other hand, for certain applications excessive % P seems to deteriorate some mechanical properties. In different embodiments, % P is less than 0.02 wt %, less than 0.008 wt %, less than 0.005 wt %, less than 0.0004 wt %, and even less than 0.00008 wt %. Obviously, there are cases where the desired nominal content is 0 wt % or nominal absence of the element as occurs with all optional elements for certain applications. For some applications, a certain content of % Pb+% Bi+% Se+% Cu+% P is desirable. In different embodiments, % Pb+% Bi+% Se+% Cu+% P is above 0.0001 wt %, above 0.09 wt %, and even above 0.12 wt %. On the other hand, for certain applications, an excessively high content may adversely affect some mechanical properties of the manufactured component. In different embodiments, % Pb+% Bi+% Se+% Cu+% P is 0.94 wt %, less than 0.4 wt %, and even less than 0.3 wt %. On the other hand, for certain applications excessive % S seems to deteriorate some mechanical properties. In different embodiments, % S is less than 0.04 wt %, less than 0.009 wt %, less than 0.004 wt %, less than 0.0008 wt %, and even less than 0.00009 wt %. Obviously, there are cases where the desired nominal content is 0 wt % or nominal absence of the element as occurs with all optional elements for certain applications. For some applications, a certain content of % P+% S is desirable. In different embodiments, % P+% S is above 0.0001 wt %, above 0.001 wt %, and even above 0.009 wt %. On the other hand, for certain applications, an excessively high content may adversely affect some mechanical properties of the manufactured component. In different embodiments, % P+% S is 0.1 wt %, less than 0.04 wt %, and even less than 0.015 wt %. For some applications, the presence of % Co is desirable, while in other applications it is rather an impurity. In different embodiments, % Co is above 0.1 wt %, above 0.6 wt %, above 2.1 wt %, above 4.1 wt %, above 5.6 wt %, and even above 10.6 wt %. On the other hand, for certain applications, excessive % Co seems to deteriorate some mechanical properties. In different embodiments, % Co is less than 11.4 wt %, less than 9.9 wt %, less than 4.9 wt %, less than 3.4 wt %, and even less than 2.9 wt %. For some applications, lower % Co contents are preferred. In different embodiments, % Co is less than 2.4 wt %, less than 1.9 wt %, less than 1.2 wt %, less than 0.8 wt %, and even less than 0.38 wt %. Obviously, there are cases where the desired nominal content is 0 wt % or nominal absence of the element as occurs with all optional elements for certain applications. For some applications, a certain content of % Ni+% Co+% Cu+% Mn is desirable to improve some mechanical properties. In different embodiments, % Ni+% Co+% Cu+% Mn is above 1.2 wt %, above 2.1 wt %, above 3.2 wt %, and even above 4.2 wt %. On the other hand, for certain applications, an excessively high content may adversely affect some mechanical properties of the manufactured component. In different embodiments, % Ni+% Co+% Cu+% Mn is less than 29 wt %, less than 24 wt %, less than 19 wt %, less than 16 wt %, and even less than 14 wt %. For some applications, the presence of % Y is desirable, while in other applications it is rather an impurity. In different embodiments, % Y is above 0.009 wt %, above 0.02 wt %, above 0.16 wt %, above 0.26 wt %, above 0.6 wt %, and even above 1.26 wt %. On the other hand, for certain applications, excessive % Y seems to deteriorate some mechanical properties. In different embodiments, % Y is less than 1.4 wt %, less than 1.2 wt %, less than 0.8 wt %, less than 0.2 wt %, and even less than 0.09 wt %. Obviously, there are cases where the desired nominal content is 0 wt % or nominal absence of the element as occurs with all optional elements for certain applications. For some applications, the presence of % Sc is desirable, while in other applications it is rather an impurity. In different embodiments, % Sc is above 0.001 wt %, above 0.04 wt %, above 0.12 wt %, above 0.21 wt %, and even above 0.6 wt %. On the other hand, for certain applications, excessive % Sc seems to deteriorate some mechanical properties. In different embodiments, % Sc is less than 0.74 wt %, less than 0.4 wt %, less than 0.18 wt %, less than 0.02 wt %, and even less than 0.04 wt %. Obviously, there are cases where the desired nominal content is 0 wt % or nominal absence of the element as occurs with all optional elements for certain applications. On the other hand, for certain applications, excessive % Cs seems to deteriorate some mechanical properties. In different embodiments, % Cs is less than 0.94 wt %, less than 0.44 wt %, less than 0.19 wt %, less than 0.09 wt %, and even less than 0.004 wt %. Obviously, there are cases where the desired nominal content is 0 wt % or nominal absence of the element as occurs with all optional elements for certain applications. For some applications, higher % O contents are preferred. In different embodiments, % O is above 0.006 wt %, above 0.01 wt %, above 0.09 wt %, above 0.26 wt %, and even above 0.41 wt %. On the other hand, for certain applications, excessively high oxygen (% O) content may adversely affect some mechanical properties of the manufactured component. In different embodiments, % O is less than 0.49 wt %, less than 0.24 wt %, less than 0.09 wt %, less than 0.04 wt %, and even less than 0.0024 wt %. For some applications, the presence of % REE (as defined in this document) is desirable, while in other applications it is rather an impurity. In different embodiments, % REE is above 0.09 wt %, above 0.16 wt %, above 0.21 wt %, above 1.1 wt %, and even above 1.6 wt %. On the other hand, for certain applications, excessive % REE may adversely affect some mechanical properties of the manufactured component. In different embodiments, % REE is less than 2.9 wt %, less than 1.4 wt %, less than 0.9 wt %, less than 0.4 wt %, less than 0.2 wt %, and even less than 0.09 wt %. Obviously, there are cases where the desired nominal content is 0 wt % or nominal absence as occurs with all optional elements for certain applications. For some applications, a certain content of % Sc+% Y+% REE is desirable. In different embodiments, % Y+% Sc +% REE is above 0.21 wt %, above 0.56 wt %, above 1.26 wt %, above 2.1 wt %, and even above 2.56 wt %. On the other hand, for certain applications, excessive % Y+% Sc+% REE seems to deteriorate some mechanical properties. In different embodiments, % Y+% Sc+% REE is less than 2.9 wt %, less than 1.9 wt %, less than 1.4 wt %, and even less than 0.4 wt %. For some particular applications, even lower levels of % Y+% Sc +% REE are preferred. In an embodiment, % Y+% Sc+% REE<0.0022 wt %. It should also be noted that everywhere in the document “<” includes the case where the element is not present. For some applications, it may be important to control the following parameter PARD-1=(% Ni+% Mn)/(% Y+% Sc+% REE). In different embodiments, PARD-1 is greater than 0.6, greater than 2, greater than 6, greater than 13, greater than 22, greater than 52, greater than 102 and even greater than 502. For some applications, PARD-1 is preferred below a certain value. In different embodiments, PARD-1 is less than 4900, less than 2900, less than 1998, less than 1490, less than 990 and even less than 590. In the cases where PARD-1 is important, this parameter can take very large values when % Y, % Sc and % REE are not present or are present in very small quantities and those values are out of the preferred range for PARD-1 disclosed above—for example, a material comprising % Ni=8.1 wt %; % Mn=6.7 wt %; and with no % Y, % Sc or % REE present, which means a PARD-1=(8.1+6.7)/0 that is clearly out of the preferred range for PARD-1. The same applies to any other parameter in this document comprising a division in its definition and where the denominator of the division might be a very small value or even zero. For some applications, it may be important to control the following parameter PARD-2=(% Ni+% Mn)/% N. In different embodiments, PARD-2 is greater than 1.2, greater than 2.6, greater than 4.1, greater than 5.2, greater than 6.2 and even greater than 8.2. For some applications, PARD-2 is preferred below a certain value. In different embodiments, PARD-2 is less than 199, less than 99, less than 49, less than 39, less than 24 and even less than 19. For some applications, it may be important to control the following parameter PARD-3=% Cr/% N. In different embodiments, PARD-3 is greater than 2.1, greater than 5.2, greater than 8.6, greater than 12.5, greater than 16.2 and even greater than 20.2. For some applications, PARD-3 is preferred below a certain value. In different embodiments, PARD-3 is less than 249, less than 149, less than 99, less than 89, less than 74, less than 64 and even less than 48. For some applications, it may be important to control the following parameter PARD-4=% Cr/(% Y+% Sc+% REE). In different embodiments, PARD-4 is greater than 0.2, greater than 1.2, greater than 3.1, greater than 3.3, greater than 4.1, greater than 22, greater than 41 and even greater than 56. For some applications, PARD-4 is preferred below a certain value. In different embodiments, PARD-4 is less than 7900, less than 4900, less than 2990, less than 1400 and even less than 990. For some applications, it may be important to control the following parameter PARD-5=(% Ni+% Mn)/(% N+% Y+% Sc+% REE). In different embodiments, PARD-5 is greater than 0.1, greater than 0.6, greater than 0.9, greater than 1.2, greater than 2.2, greater than 3.2 and even greater than 5.2. For some applications, PARD-5 is preferred below a certain value. In different embodiments, PARD-5 is less than 199, less than 99, less than 74, less than 59, less than 49, less than 38 and even less than 24. For some applications, it may be important to control the following parameter PARD-6=% Cr/(% N+% Y+% Sc+% REE). In different embodiments, PARD-6 is greater than 0.7, greater than 1.2, greater than 2.6, greater than 3.6, greater than 9.6, greater than 12 and even greater than 16. For some applications, PARD-6 is preferred below a certain value. In different embodiments, PARD-6 is less than 199, less than 99, less than 74, less than 59, less than 49, less than 38 and even less than 24. For some applications, it may be important to control the following parameter PARD-7=ABS (% Cr/% N-(% Ni+% Mn)/(% Y+% Sc+% REE)). In different embodiments, PARD-7 is greater than 2, greater than 4.6, greater than 7.6, greater than 10.5, greater than 12 and even greater than 18. For some applications, PARD-7 is preferred below a certain value. In different embodiments, PARD-7 is less than 199, less than 99, less than 74, less than 59, less than 49, less than 38 and even less than 24. The feature “% REE” is defined throughout this document in the form of different alternatives that are explained in detail below. In an embodiment, % REE is at least one element selected from actinide and lanthanide elements. In an alternative embodiment, % REE is any actinide element. In another alternative embodiment, % REE is any lanthanide element. In another alternative embodiment, % REE is the sum of % La+% Ce+% Pr+% Nd+% Pm+% Sm+% Eu+% Gd+% Tb+% Dy+% Ho+% Er+% Tm+% Yb+% Lu. In another alternative embodiment, % REE is the sum of % Ac+% Th+% Pa+% U+% Np+% Pu+% Am+% Cm+% Bk+% Cf+% Es+% Fm+% Md+% No+% Lr. In another alternative embodiment, % REE is the sum of lanthanides and actinides. In another alternative embodiment, % REE is % La. In another alternative embodiment, % REE is % Ac. In another alternative embodiment, % REE is % Ce. In another alternative embodiment, % REE is % Nd. In another alternative embodiment, % REE is % Gd. In another alternative embodiment, % REE is % Sm. In another alternative embodiment, % REE is % Pr. In another alternative embodiment, % REE is % Pm. In another alternative embodiment, % REE is % Eu. In another alternative embodiment, % REE is % Tb. In another alternative embodiment, % REE is % Dy. In another alternative embodiment, % REE is % Ho. In another alternative embodiment, % REE is % Er. In another alternative embodiment, % REE is % Tm. In another alternative embodiment, % REE is % Yb. In another alternative embodiment, % REE is % Lu. In another alternative embodiment, % REE is replaced partially or totally by % Cs. All the embodiments disclosed above can be combined among them and with any other embodiment disclosed in this document that relates to “% REE” in any combination, provided that they are not mutually exclusive. In another embodiment, the overall composition of the powder or powder mixture provided has the following elements and limitations, all percentages being indicated in weight percent: % Mg: 0.006-10.6; % Si: 0.006-23; % Ti: 0.002-0.35; % Cr: 0.01-0.40; % Mn-0.002-1.8; % Fe: 0.006-1.5; % Ni: 0-3.0; % Cu: 0.006-10.7; % Zn: 0.006-7.8; % Sn: 0-7; % Zr:0-0.5; the rest consisting of aluminium and trace elements (as defined in this document). In an embodiment, % Mg is above 0.009 wt %. In another embodiment, % Mg is above 1.62 wt %. In an embodiment, % Mg is less than 8.38 wt %. In an embodiment, % Mg is less than 4.82 wt %. In another embodiment, % Si is above 0.02 wt %. In another embodiment, % Si is above 1.64 wt %. In an embodiment, % Si is less than 19.8 wt %. In another embodiment, % Si is less than 9.8 wt %. In an embodiment, Ti is above 0.008 wt %. In another embodiment, % Ti is above 0.12 wt %. In an embodiment, % Ti is less than 0.29 wt %. In another embodiment, % Ti is less than 0.24 wt %. In an embodiment, % Cr is above 0.03 wt %. In another embodiment, % Cr is above 0.12 wt %. In an embodiment, % Cr is less than 0.34 wt %. In another embodiment, % Cr is less than 0.23 wt %. In an embodiment, % Mn is above 0.01 wt %. In another embodiment, % Mn is above 0.21 wt %. In an embodiment, % Mn is less than 1.38 wt %. In another embodiment, % Mn is less than 0.96 wt %. In an embodiment, % Fe is above 0.01 wt %. In another embodiment, % Fe is above 0.57 wt %. In an embodiment, % Fe is less than 1.38 wt %. In another embodiment, % Fe is less than 0.96 wt %. In an embodiment, % Ni is above 0.01 wt %. In another embodiment, % Ni is above 0.41 wt %. In an embodiment, % Ni is less than 2.46 wt %. In another embodiment, % Ni is less than 1.92 wt %. In an embodiment, % Cu is above 0.08 wt %. In another embodiment, % Cu is above 0.16 wt %. In an embodiment, % Cu is less than 8.38 wt %. In another embodiment, % Cu is less than 4.82 wt %. In an embodiment, % Zn is above 0.09 wt %. In another embodiment, % Zn is above 0.16 wt %. In an embodiment, % Zn is less than 6.38 wt %. In another embodiment, % Zn is less than 3.82 wt %. In an embodiment, % Sn is above 0.001 wt %. In another embodiment, % Sn is above 0.12 wt %. In an embodiment, % Sn is less than 4.38 wt %. In another embodiment, % Sn is less than 3.42 wt %. In an embodiment, % Zr is above 0.009 wt %. In another embodiment, % Zr is above 0.06 wt %. In an embodiment, % Zr is less than 0.38 wt %. In another embodiment, % Zr is less than 0.24 wt %. In another embodiment, the overall composition of the powder or powder mixture provided has the following elements and limitations, all percentages being indicated in weight percent: % Zn:0-40; % Ni:0-31; % Al:0-13; % Sn:0-10; % Fe:0-5.5; % Si:0-4; % Pb:0-4; % Mn:0-3; % Co:0-2.7; % Be:0-2.75; % Cr:0-1; the rest consisting of copper and trace elements (as defined in this document). In an embodiment, % Zn is above 0.29 wt %. In another embodiment, % Zn is above 1.26 wt %. In an embodiment, % Zn is less than 26.38 wt %. In another embodiment, % Zn is less than 13.42 wt %. In an embodiment, % Ni is above 0.1 wt %. In another embodiment, % Ni is above 2.61 wt %. In an embodiment, % Ni is less than 24.46 wt %. In another embodiment, % Ni is less than 16.92 wt %. In an embodiment, % Al is above 0.6 wt %. In another embodiment, % Al is above 2.14 wt %. In an embodiment, % Al is less than 8.24 wt %. In another embodiment, % Al is less than 5.12 wt %. In an embodiment, % Sn is above 0.01 wt %. In another embodiment, % Sn is above 0.32 wt %. In an embodiment, % Sn is less than 6.38 wt %. In another embodiment, % Sn is less than 4.42 wt %. In an embodiment, % Fe is above 0.1 wt %. In another embodiment, % Fe is above 0.67 wt %. In an embodiment, % Fe is less than 3.38 wt %. In another embodiment, % Fe is less than 2.96 wt %. In an embodiment, % Si is above 0.2 wt %. In another embodiment, % Si is above 0.64 wt %. In an embodiment, % Si is less than 2.8 wt %. In another embodiment, % Si is less than 1.8 wt %. In an embodiment, % Pb is above 0.002 wt %. In another embodiment, % Pb is above 0.4 wt %. In an embodiment, % Pb is less than 2.8 wt %. In another embodiment, % Pb is less than 1.4 wt %. In an embodiment, % Mn is above 0.001 wt %. In another embodiment, % Mn is above 0.26 wt %. In an embodiment, % Mn is less than 2.38 wt %. In another embodiment, % Mn is less than 0.94 wt %. In an embodiment, % Co is above 0.0001 wt %. In another embodiment, % Co is above 0.16 wt %. In an embodiment, % Co is less than 2.18 wt %. In another embodiment, % Co is less than 0.84 wt %. In an embodiment, % Be is above 0.0006 wt %. In another embodiment, % Be is above 0.12 wt %. In an embodiment, % Be is less than 1.84 wt %. In another embodiment, % Be is less than 0.44 wt %. In another embodiment, % Cr is above 0.003 wt %. In an embodiment, % Cr is above 0.22 wt %. In another embodiment, % Cr is less than 0.44 wt %. In another embodiment, % Cr is less than 0.19 wt %. In another embodiment, the overall composition of the powder or powder mixture provided has the following elements and limitations, all percentages being indicated in weight percent: % Be:0.15-3.0; % Co: 0-3; % Ni: 0-2.2; % Pb: 0-0.6; % Fe: 0-0.25; % Si: 0-0.35; % Sn: 0-0.25, % Zr 0-0.5; the rest consisting of copper and trace elements (as defined in this document). In an embodiment, % Be is above 0.21 wt %. In another embodiment, % Be is above 0.52 wt %. In an embodiment, % Be is less than 2.44 wt %. In another embodiment, % Be is less than 1.44 wt %. In an embodiment, % Co is above 0.001 wt %. In another embodiment, % Co is above 0.12 wt %. In an embodiment, % Co is less than 2.18 wt %. In another embodiment, % Co is less than 0.84 wt %. In an embodiment, % Ni is above 0.001 wt %. In another embodiment, % Ni is above 0.61 wt %. In an embodiment, % Ni is less than 1.46 wt %. In another embodiment, % Ni is less than 0.92 wt %. In an embodiment, % Pb is above 0.009 wt %. In another embodiment, % Pb is above 0.26 wt %. In an embodiment, % Pb is less than 0.48 wt %. In another embodiment, % Pb is less than 0.29 wt %. In an embodiment, % Fe is above 0.001 wt %. In another embodiment, % Fe is above 0.09 wt %. In an embodiment, % Fe is less than 0.19 wt %. In another embodiment, % Fe is less than 0.14 wt %. In an embodiment, % Si is above 0.002 wt %. In another embodiment, % Si is above 0.04 wt %. In an embodiment, % Si is less than 0.24 wt %. In another embodiment, % Si is less than 0.09 wt %. In an embodiment, % Sn is above 0.001 wt %. In another embodiment, % Sn is above 0.03 wt %. In an embodiment, % Sn is less than 0.23 wt %. In another embodiment, % Sn is less than 0.08 wt %. In an embodiment, % Zr is above 0.009 wt %. In another embodiment, % Zr is above 0.08 wt %. In an embodiment, % Zr is less than 0.38 wt %. In another embodiment, % Zr is less than 0.19 wt %. In another embodiment, the overall composition of the powder or powder mixture provided has the following elements and limitations, all percentages being indicated in weight percent: % Cr: 9-33; % W: 0-26; % Mo: 0-29; % C: 0-3.5; % Fe: 0-9; % Ni: 0-35; % Si: 0-3.9; Mn: 0-2.5; % B: 0-1; % V: 0-4.2; % Nb/% Ta: 0-5.5; the rest consisting of cobalt and trace elements (as defined in this document). In an embodiment, % Cr is above 12.6 wt %. In another embodiment, % Cr is above 16.6 wt %. In an embodiment, % Cr is less than 24.8 wt %. In another embodiment, % Cr is less than 14.9 wt %. In an embodiment, % W is above 2.64 wt %. In another embodiment, % W is above 8.6 wt %. In an embodiment, % W is less than 19.8 wt %. In another embodiment, % W is less than 12.9 wt %. In an embodiment, % Mo is above 3.16 wt %. In another embodiment, % Mo is above 10.6 wt %. In an embodiment, % Mo is less than 19.8 wt %. In another embodiment, % Mo is less than 13.9 wt %. In an embodiment, % C is above 0.001 wt %. In another embodiment, % C is above 0.02 wt %. In an embodiment, % C is less than 1.88 wt %. In another embodiment, % C is less than 0.88 wt %. In an embodiment, % Fe is above 0.1 wt %. In another embodiment, % Fe is above 0.59 wt %. In an embodiment, % Fe is less than 6.8 wt %. In another embodiment, % Fe is less than 4.42 wt %. In an embodiment, % Ni is above 0.01 wt %. In another embodiment, % Ni is above 1.26 wt %. In an embodiment, % Ni is less than 18.8 wt %. In another embodiment, % Ni is less than 9.8 wt %. In an embodiment, % Si is above 0.02 wt %. In another embodiment, % Si is above 0.09 wt %. In an embodiment, % Si is less than 1.94 wt %. In another embodiment, % Si is less than 0.94 wt %. In an embodiment, % Mn is above 0.0001 wt %. In another embodiment, % Mn is above 0.16 wt %. In an embodiment, % Mn is less than 2.18 wt %. In another embodiment, % Mn is less than 0.88 wt %. In an embodiment, % B is above 0.0001 wt %. In another embodiment, % B is above 0.006 wt %. In an embodiment, % B is less than 0.42 wt %. In another embodiment, % B is less than 0.18 wt %. In an embodiment, % V is above 0.01 wt %. In another embodiment, % V is above 0.26 wt %. In an embodiment, % V is less than 2.42 wt %. In another embodiment, % V is less than 1.48 wt %. In an embodiment, % Nb/% Ta is above 0.01 wt %. In another embodiment, % Nb/% Ta is above 0.26 wt %. In an embodiment, % Nb/% Ta is less than 1.42 wt %. In another embodiment, % Nb/% Ta is less than 0.88 wt %. In another embodiment, the overall composition of the powder or powder mixture provided has the following elements and limitations, all percentages being indicated in weight percent: % Fe:0-42; % Cu:0-34; % Cr:0-31; % Mo:0-24; % Co:0-18; % W:0-14; % Nb:0-5.5; % Mn:0-5.25; % Al:0-5; Ti:0-3; % Zn:0-1; % Si:0-1; % C:0-0.3; % S:0.01 max; the rest consisting of nickel and trace elements (as defined in this document). In an embodiment, % Fe is above 1.64 wt %. In another embodiment, % Fe is above 4.58 wt %. In an embodiment, % Fe is less than 26.8 wt %. In another embodiment, % Fe is less than 14.42 wt %. In an embodiment, % Cu is above 1.14 wt %. In another embodiment, % Cu is above 2.58 wt %. In an embodiment, % Cu is less than 16.8 wt %. In another embodiment, % Cu is less than 9.42 wt %. In an embodiment, % Cr is above 0.64 wt %. In another embodiment, % Cr is above 3.58 wt %. In an embodiment, % Cr is less than 14.8 wt %. In another embodiment, % Cr is less than 6.42 wt %. In an embodiment, % Mo is above 1.12 wt %. In another embodiment, % Mo is above 4.58 wt %. In an embodiment, % Mo is less than 12.8 wt %. In another embodiment, % Mo is less than 4.42 wt %. In an embodiment, % Co is above 0.12 wt %. In another embodiment, % Co is above 1.58 wt %. In an embodiment, % Co is less than 9.8 wt %. In another embodiment, % Co is less than 3.42 wt %. In an embodiment, % W is above 0.22 wt %. In another embodiment, % W is above 1.58 wt %. In an embodiment, % W is less than 9.8 wt %. In another embodiment, % W is less than 4.42 wt %. In an embodiment, % Nb is above 0.002 wt %. In another embodiment, % Nb is above 0.58 wt %. In an embodiment, % Nb is less than 3.8 wt %. In another embodiment, % Nb is less than 1.42 wt %. In an embodiment, % Al is above 0.002 wt %. In another embodiment, % Al is above 0.28 wt %. In an embodiment, % Al is less than 3.4 wt %. In another embodiment, % Al is less than 1.42 wt %. In an embodiment, % Ti is above 0.006 wt %. In another embodiment, % Ti is above 0.18 wt %. In an embodiment, % Ti is less than 3.8 wt %. In another embodiment, % Ti is less than 1.22 wt %. In an embodiment, % Zn is above 0.009 wt %. In another embodiment, % Zn is above 0.08 wt %. In an embodiment, % Zn is less than 0.68 wt %. In another embodiment, % Zn is less than 0.19 wt %. In an embodiment, % Si is above 0.09 wt %. In another embodiment, % Si is above 0.14 wt %. In an embodiment, % Si is less than 0.48 wt %. In another embodiment, % Si is less than 0.19 wt %. In an embodiment, % C is above 0.02 wt %. In another embodiment, % C is above 0.09 wt %. In an embodiment, % C is less than 0.19 wt %. In another embodiment, % C is less than 0.12 wt %. In an embodiment, % S is above 0.0002 wt %. In another embodiment, % S is above 0.0004 wt %. In an embodiment, % S is less than 0.009 wt %. In another embodiment, % S is less than 0.0009 wt %. In another embodiment, the overall composition of the powder or powder mixture provided has the following elements and limitations, all percentages being indicated in weight percent: % V:0-14.5; % Mo:O-13; % Cr:O-12; % Sn:O-11.5; % Al:0-8; % Mn:0-8; % Zr:0-7.5; % Cu:0-3; % Nb:0-2.5; % Fe: 0-2.5; % Ta:0-1.5; % Si:0-0.5; % C:0.1 max; % N:0.05 max; % O: 0.2 max; % H:0.03 max; the rest consisting of titanium and trace elements (as defined in this document). In an embodiment, % V is above 0.02 wt %. In another embodiment, % V is above 0.68 wt %. In an embodiment, % V is less than 9.8 wt %. In another embodiment, % V is less than 4.42 wt %. In an embodiment, % Mo is above 0.36 wt %. In another embodiment, % Mo is above 2.68 wt %. In an embodiment, % Mo is less than 8.8 wt %. In another embodiment, % Mo is less than 6.42 wt %. In an embodiment, % Cr is above 0.16 wt %. In another embodiment, % Cr is above 3.68 wt %. In an embodiment, % Cr is less than 9.8 wt %. In another embodiment, % Cr is less than 4.42 wt %. In an embodiment, % Sn is above 0.06 wt %. In another embodiment, % Sn is above 0.62 wt %. In an embodiment, % Sn is less than 6.8 wt %. In another embodiment, % Sn is less than 2.42 wt %. In an embodiment, % Al is above 0.006 wt %. In another embodiment, % Al is above 0.42 wt %. In an embodiment, % Al is less than 4.8 wt %. In another embodiment, % Al is less than 2.42 wt %. In an embodiment, % Mn is above 0.02 wt %. In another embodiment, % Mn is above 0.12 wt %. In an embodiment, % Mn is less than 6.8 wt %. In another embodiment, % Mn is less than 4.42 wt %. In an embodiment, % Zr is above 0.008 wt %. In another embodiment, % Zr is above 0.02 wt %. In an embodiment, % Zr is less than 4.8 wt %. In another embodiment, % Zr is less than 2.42 wt %. In an embodiment, % Cu is above 0.0008 wt %. In another embodiment, % Cu is above 0.06 wt %. In an embodiment, % Cu is less than 1.8 wt %. In another embodiment, % Cu is less than 0.42 wt %. In an embodiment, % Nb is above 0.0009 wt %. In another embodiment, % Nb is above 0.02 wt %. In an embodiment, % Nb is less than 0.64 wt %. In another embodiment, % Nb is less than 0.42 wt %. In an embodiment, % Fe is above 0.009 wt %. In another embodiment, % Fe is above 0.04 wt %. In an embodiment, % Fe is less than 1.64 wt %. In another embodiment, % Fe is less than 0.92 wt %. In an embodiment, % Ta is above 0.0007 wt %. In another embodiment, % Ta is above 0.002 wt %. In an embodiment, % Ta is less than 0.44 wt %. In another embodiment, % Ta is less than 0.19 wt %. In an embodiment, % Si is above 0.0001 wt %. In another embodiment, % Si is above 0.02 wt %. In an embodiment, % Si is less than 0.34 wt %. In another embodiment, % Si is less than 0.09 wt %. In an embodiment, % C is above 0.00001 wt %. In another embodiment, % C is above 0.002 wt %. In an embodiment, % C is less than 0.03 wt %. In another embodiment, % C is less than 0.09 wt %. In an embodiment, % N is above 0.000001 wt %. In another embodiment, % N is above 0.0002 wt %. In an embodiment, % N is less than 0.003 wt %. In another embodiment, % N is less than 0.008 wt %. In an embodiment, % O is above 0.00002 wt %. In another embodiment, % O is above 0.001 wt %. In an embodiment, % O is less than 0.04 wt %. In another embodiment, % O is less than 0.09 wt %. In an embodiment, % H is above 0.000001 wt %. In another embodiment, % H is above 0.0002 wt %. In an embodiment, % H is less than 0.003 wt %. In another embodiment, % H is less than 0.008 wt %. In another embodiment, the overall composition of the powder or powder mixture provided has the following elements and limitations, all percentages being indicated in weight percent: % Al:O-10; % Zn: 0-6; % Y:0-5.2; % Cu:O-3; % Ag: 0-2.5, % Th:0-3.3; Si:0-1.1; % Mn:0-0.75; the rest consisting of magnesium and trace elements (as defined in this document). In an embodiment, % Al is above 0.2 wt %. In another embodiment, % Al is above 1.68 wt %. In an embodiment, % Al is less than 7.8 wt %. In another embodiment, % Al is less than 4.42 wt %. In an embodiment, % Zn is above 0.04 wt %. In another embodiment, % Zn is above 0.16 wt %. In an embodiment, % Zn is less than 4.8 wt %. In another embodiment, % Zn is less than 2.34 wt %. In an embodiment, % Y is above 0.26 wt %. In another embodiment, % Y is above 0.56 wt %. In an embodiment, % Y is less than 3.8 wt %. In another embodiment, % Y is less than 2.44 wt %. In an embodiment, % Cu is above 0.06 wt %. In another embodiment, % Cu is above 0.12 wt %. In an embodiment, % Cu is less than 1.8 wt %. In another embodiment, % Cu is less than 1.44 wt %. In an embodiment, % Ag is above 0.008 wt %. In another embodiment, % Ag is above 0.009 wt %. In an embodiment, % Ag is less than 0.8 wt %. In another embodiment, % Ag is less than 0.44 wt %. In an embodiment, % Th is above 0.006 wt %. In another embodiment, % Th is above 0.02 wt %. In an embodiment, % Th is less than 0.84 wt %. In another embodiment, % Th is less than 0.44 wt %. In an embodiment, % Si is above 0.06 wt %. In another embodiment, % Si is above 0.2 wt %. In an embodiment, % Si is less than 0.44 wt %. In another embodiment, % Si is less than 0.24 wt %. In an embodiment, % Mn is above 0.004 wt %. In another embodiment, % Mn is above 0.02 wt %. In an embodiment, % Mn is less than 0.44 wt %. In another embodiment, % Mn is less than 0.14 wt %. However, the overall composition of the powder or powder mixture provided is not limited to the materials described above. In an alternative embodiment, the compositions disclosed in this paragraph refer to the composition of at least one of the powders comprised in the powder mixture. All the embodiments disclosed above can be combined among them and with any other embodiment disclosed in this document in any combination, provided that they are not mutually exclusive. In an embodiment, the use of terms such “bellow”, “above”, “or more”, “from”, “up to”, “at least”, “greater than”, “higher than”, “more than”, “less than” and the like throughout the disclosure, include the number recited.

With respect to the composition of the powder or powder mixture provided, the levels of certain elements in the powder or powder mixture provided may be particularly important for the properties of some components. The inventor has surprisingly found that for some applications of the method, components with improved mechanical properties such as for example, mechanical strength, elongation and/or toughness can be manufactured starting from powder materials having a proper % C, % O, % N, % H and/or % B content.

As described above, for some applications of the method, it may be advantageous to use powders or powder mixtures having a proper carbon (% C) content. In an embodiment, the powder or powder mixture provided comprises a proper % C content. The feature “proper % C content” is defined throughout this document in in the form of different alternatives that are explained in detail below. In different embodiments, a proper % C content is a carbon content of 0.0001 wt % or more, 0.1 wt % or more, 0.21 wt % or more, 0.41 wt % or more, 1.16 wt % or more, 1.56 wt % or more and even 2.1 wt % or more. On the other hand, an excessively high carbon content may be detrimental for some applications. In different embodiments, a proper % C content is a carbon content of 3.9 wt % or less, 2.4 wt % or less, 1.9 wt % or less, 1.4 wt % or less, 0.9 wt % or less, 0.49 wt % or less and even 0.08 wt % or less. In another embodiment, at least one of the powders in the mixture comprises a proper % C content (as defined in this document). All the embodiments disclosed above can be combined among them and with any other embodiment disclosed in this document that relates to “proper % C content” in any combination, provided that they are not mutually exclusive. All the values and ranges of the different embodiments disclosed above can be combined among them and with any other embodiment disclosed in this document in any combination, provided that they are not mutually exclusive for example, in an embodiment, the powder or powder mixture provided comprises a proper % C content, wherein a proper % C content is a carbon content between 0.0001 and 3.9 wt %; or for example, in another embodiment, between 0.1 wt % and 2.4 wt %; or for example, in another embodiment, between 0.21 and 1.9 wt %.

Additionally or alternatively, for some applications of the method, it may be advantageous to use powders or powder mixtures having a proper oxygen (% O) content. In an embodiment, the powder or powder mixture provided comprises a proper % O content. The feature “proper % O content” is defined throughout this document in the form of different alternatives that are explained in detail below. In different embodiments, a proper % O content is an oxygen content of 0.01 ppm or more, 0.6 ppm or more, 20 ppm or more, 110 ppm or more, 210 ppm or more, 410 ppm or more, 1100 ppm or more, 2600 ppm or more and even 5100 ppm or more. On the other hand, an excessively high oxygen content may be detrimental for some applications. In different embodiments, a proper % O content is an oxygen content of 49000 ppm or less, 29000 ppm or less, 9000 ppm or less, 5900 ppm or less, 3400 ppm or less, 900 ppm or less, and even 590 ppm or less. In another embodiment, at least one of the powders in the mixture comprises a proper % O content (as defined in this document). All the embodiments disclosed above can be combined among them and with any other embodiment disclosed in this document that relates to “proper % O content” in any combination, provided that they are not mutually exclusive. All the values and ranges of the different embodiments disclosed above can be combined among them and with any other embodiment disclosed in this document in any combination, provided that they are not mutually exclusive, for example, in an embodiment, the powder or powder mixture provided comprises a proper % O content, wherein a proper % O content is an oxygen content between 0.01 and 49000 ppm; or for example, in another embodiment, between 0.6 and 29000 ppm; or for example, in another embodiment, between 20 and 9000 ppm.

Additionally or alternatively, for some applications of the method, it may be advantageous to use powders or powder mixtures having a proper nitrogen (% N) content. In an embodiment, the powder or powder mixture provided comprises a proper % N content. The feature “proper % N content” is defined throughout this document in the form of different alternatives that are explained in detail below. In different embodiments, a proper % N content is a nitrogen content of 0.01 ppm or more, 0.6 ppm or more, 1.2 ppm or more, 56 ppm or more, 110 ppm or more, 260 ppm or more, 560 ppm or more, 1100 ppm or more and even 2600 ppm or more. On the other hand, an excessively high nitrogen content may be detrimental for some applications. In different embodiments, a proper % N content is a nitrogen content of 2.9 wt % or less, 0.8 wt % or less, 0.29 wt % or less, 0.12 wt % or less, 19400 ppm or less, 3900 ppm or less, 940 ppm or less, 440 ppm or less, 190 ppm or less and even 49 ppm or less. In another embodiment, at least one of the powders in the mixture comprises a proper % N content (as defined in this document). All the embodiments disclosed above can be combined among them and with any other embodiment disclosed in this document that relates to “proper % N content” in any combination, provided that they are not mutually exclusive. All the values and ranges of the different embodiments disclosed above can be combined among them and with any other embodiment disclosed in this document in any combination, provided that they are not mutually exclusive, for example, in an embodiment, the powder or powder mixture provided comprises a proper % N content, wherein a proper % N content is a nitrogen content between 0.01 ppm and 2.9 wt %; or for example, in another embodiment, between 0.6 and 19400 ppm.

Additionally or alternatively, for some applications of the method, it may be advantageous to use powders or powder mixtures having a proper hydrogen (% H) content. In an embodiment, the powder or powder mixture provided comprises a proper % H content. The feature “proper % H content” is defined throughout this document in the form of different alternatives that are explained in detail below. In different embodiments, a proper % H content is a hydrogen content of 0.01 ppm or more, 0.1 ppm or more, 2 ppm or more, 16 ppm or more, 110 ppm or more, 310 ppm or more and even 510 ppm or more. On the other hand, an excessively high hydrogen content may be detrimental for some applications. In different embodiments, a proper % H content is a hydrogen content of 8400 ppm or less, 790 ppm or less, 390 ppm or less, 9 ppm or less, and even 4 ppm or less. In another embodiment, at least one of the powders in the mixture comprises a proper % H content (as defined in this document). All the embodiments disclosed above can be combined among them and with any other embodiment disclosed in this document that relates to “proper % H content” in any combination, provided that they are not mutually exclusive. All the values and ranges of the different embodiments disclosed above can be combined among them and with any other embodiment disclosed in this document in any combination, provided that they are not mutually exclusive, for example, in an embodiment, the powder or powder mixture provided comprises a proper % H content, wherein a proper % H content is a hydrogen content between 0.01 and 8400 ppm; or for example, in another embodiment, between 0.1 and 4900 ppm; or for example, in another embodiment, between 2 and 1900 ppm.

Additionally or alternatively, for some applications of the method, it may be advantageous to use powders or powder mixtures having a proper boron (% B) content. In an embodiment, the powder or powder mixture provided comprises a proper % B content. In another embodiment, at least one of the powders in the mixture comprises a proper % B content. The feature “proper % B content” is defined throughout this document in the form of different alternatives that are explained in detail below. In different embodiments, a proper % B content is a boron content of 0.01 ppm or more, 0.2 ppm or more, 6 ppm or more, 21 ppm or more, 61 ppm or more, 160 ppm or more, 660 ppm or more, 1600 ppm or more and even 3600 ppm or more. On the other hand, an excessively high boron content may be detrimental for some applications. In different embodiments, a proper % B content is a boron content of 0.9 wt % or less, 0.39 wt % or less, 44000 ppm or less, 24000 ppm or less, 14000 ppm or less, 7900 ppm or less, 3400 ppm or less, 490 ppm or less, and even 89 ppm or less. In another embodiment, at least one of the powders in the mixture comprises a proper % B content (as defined in this document). All the embodiments disclosed above can be combined among them and with any other embodiment disclosed in this document that relates to “proper % B content” in any combination, provided that they are not mutually exclusive. All the values and ranges of the different embodiments disclosed above can be combined among them and with any other embodiment disclosed in this document in any combination, provided that they are not mutually exclusive, for example, in an embodiment, the powder or powder mixture provided comprises a proper % B content, wherein a proper % B content is a boron content between 0.01 and 44000 ppm or for example, in another embodiment, between 0.2 and 24000 ppm or for example, in another embodiment, between 6 and 7900 ppm. All the embodiments disclosed above can be combined among them and with any other embodiment disclosed in this document in any combination, provided that they are not mutually exclusive.

Additionally or alternatively, for certain particular applications, where for example an increase of hardness and strength, an enhanced wear and corrosion resistance, a grain refinement, among others are required, it may be advantageous to admix a nitrogen comprising material with the powder o powder mixture provided. In an embodiment, the amount of nitrogen comprising material is selected in terms of the total weight % of nitrogen in the manufactured component. In an alternative embodiment, the amount of nitrogen comprising material is selected in terms of the total weight % of nitrogen in at least one of the materials comprised in the manufactured component. In another alternative embodiment, the amount of nitrogen comprising material is selected in terms of the total weight % of nitrogen in the material after the mixing is made. In different embodiments, the amount of nitrogen comprising material is selected so as to have 0.02 wt % or more nitrogen, 0.12 wt % or more nitrogen, 0.22 wt % or more nitrogen, 0.41 wt % or more nitrogen, 0.52 wt % or more nitrogen, 0.76 wt % or more nitrogen, 1.1 wt % or more nitrogen and even 2.1 wt % or more nitrogen. For certain applications, excessively high levels should be avoided. In different embodiments, the amount of nitrogen comprising material is selected so as to have 3.9 wt % or less nitrogen, 2.9 wt % or less nitrogen, 1.9 wt % or less nitrogen, 1.4 wt % or less nitrogen, 0.9 wt % or less nitrogen, 0.69 wt % or less nitrogen and even 0.49 wt % or less nitrogen. On the other hand, for some applications the use of higher levels of nitrogen may be preferred. In different embodiments, a higher nitrogen content means a content of at least 10% more, at least 15% more, at least 20% more, at least 50% more and even 200% more than the amounts indicated above. In an embodiment, the nitrogen comprising material is a nitride and/or a mixture of nitrides. For some applications, the use of carbo-nitrides, chromium nitrides, iron nitrides, molybdenum nitrides, tungsten nitrides, vanadium nitrides, niobium nitrides, tantalum nitrides, titanium nitrides and/or mixtures thereof may be advantageous especially, for example, for those cases where wear resistance is a decisive performance factor. The incorporation of nitrogen can form hard nitride-type precipitates within the microstructure, which act as barriers against wear mechanisms such as abrasive or adhesive wear. For very especial applications and proceeding in this way provides a completed unexpected high strength-elongation combination. In an embodiment, the nitrogen comprising material is a carbo-nitride. In an embodiment, the nitrogen comprising material comprises a carbo-boro-oxo-nitride. In an embodiment, the nitrogen comprising material comprises a carbo-nitride. In an embodiment, the nitrogen comprising material comprises a carbo-boro-oxo-nitride where carbon, boron and/or oxygen can be missing. In an embodiment, the nitrogen comprising material comprises a carbo-boro-oxo-nitride where carbon, boron and/or oxygen can be missing which is stable under standard conditions. In an embodiment, the nitrogen comprising material comprises a carbo-boro-oxo-nitride where carbon, boron and/or oxygen can be missing which is stable at 800° C. under standard pressure in an argon atmosphere with 0.5 ppm oxygen. In an embodiment, the nitrogen comprising material comprises a carbo-boro-oxo-nitride where carbon, boron and/or oxygen can be missing which is stable at 900° C. under standard pressure in an argon atmosphere with 0.5 ppm oxygen. In an embodiment, the nitrogen comprising material comprises a carbo-boro-oxo-nitride where carbon, boron and/or oxygen can be missing which is stable at 1000° C. under standard pressure in an argon atmosphere with 0.5 ppm oxygen. In an embodiment, the nitrogen comprising material comprises a carbo-boro-oxo-nitride where carbon, boron and/or oxygen can be missing which is stable at 1100° C. under standard pressure in an argon atmosphere with 0.5 ppm oxygen. In an embodiment, the nitrogen comprising material comprises a carbo-boro-oxo-nitride where carbon, boron and/or oxygen can be missing, and which also comprises % Cr. In an embodiment, the nitrogen comprising material comprises a chromium nitride which is stable under standard conditions. In an embodiment, the nitrogen comprising material comprises a chromium nitride which is stable at 800° C. under standard pressure in an argon atmosphere with 0.5 ppm oxygen. In an embodiment, the nitrogen comprising material comprises a chromium nitride which is stable at 900° C. under standard pressure in an argon atmosphere with 0.5 ppm oxygen. In an embodiment, the nitrogen comprising material comprises a chromium nitride which is stable at 1000° C. under standard pressure in an argon atmosphere with 0.5 ppm oxygen. In an embodiment, the nitrogen comprising material comprises a chromium nitride which is stable at 1100° C. under standard pressure in an argon atmosphere with 0.5 ppm oxygen. In an embodiment, the nitrogen comprising material comprises the right chromium nitride content. In different embodiments, the right chromium nitride content is a chromium nitride content of 0.094 wt % or more, 0.94 wt % or more, 1.4 wt % or more, 1.9 wt % or more, 2.9 wt % or more, 4.3 wt % or more and even 5.6% or more. For certain applications, an excessively high content of chromium nitride may be detrimental. In different embodiments, the right chromium nitride content is a chromium nitride content of 18.3 wt % or less, 13.6 wt % or less, 8.9 wt % or less, 6.6 wt % or less, and even 4.2 wt % or less. In an embodiment, the nitrogen comprising material comprises a carbo-boro-oxo-nitride where carbon, boron and/or oxygen can be missing, and which also comprises % Fe.

In an embodiment, the nitrogen comprising material comprises an iron nitride which is stable under standard conditions. In an embodiment, the nitrogen comprising material comprises a carbo-boro-oxo-nitride where carbon, boron and/or oxygen can be missing, and which also comprises % Mo. In an embodiment, the nitrogen comprising material comprises a molybdenum nitride which is stable under standard conditions. In an embodiment, the nitrogen comprising material comprises a carbo-boro-oxo-nitride where carbon, boron and/or oxygen can be missing, and which also comprises % W. In an embodiment, the nitrogen comprising material comprises a tungsten nitride which is stable under standard conditions. In an embodiment, the nitrogen comprising material comprises a carbo-boro-oxo-nitride where carbon, boron and/or oxygen can be missing, and which also comprises % V. In an embodiment, the nitrogen comprising material comprises a vanadium nitride which is stable under standard conditions. In an embodiment, the nitrogen comprising material comprises a carbo-boro-oxo-nitride where carbon, boron and/or oxygen can be missing, and which also comprises % Nb. In an embodiment, the nitrogen comprising material comprises a niobium nitride which is stable under standard conditions. In an embodiment, the nitrogen comprising material comprises a carbo-boro-oxo-nitride where carbon, boron and/or oxygen can be missing, and which also comprises % Ti. In an embodiment, the nitrogen comprising material comprises a titanium nitride which is stable under standard conditions. All the embodiments disclosed above can be combined among them and with any other embodiment disclosed in this document in any combination, provided that they are not mutually exclusive.

Certain characteristics of the powder material may be important in the manufacture of some components. In this respect, the inventor has found that the use of powders or powder mixtures of a proper size may be advantageous to, among others, the part density, the surface roughness and/or the dimensional accuracy achievable in the manufacture of some components. The use of powders or powder mixtures of a proper size may be also advantageous to reduce or minimize the occurrence of internal construction flaws. In an embodiment, the powder material is a powder or powder mixture of the proper size. In another embodiment, the powder material is a powder of the proper size. In another embodiment, the powder material comprises at least one powder of the proper size. In another alternative embodiment, the powder material has the proper size. In different embodiments, the proper size means a size of 0.8 microns or more, 2.1 microns or more, 26 microns or more, 56 microns or more, 106 microns or more and even 156 microns or more. For certain applications, powders having larger sizes may be preferred. In different embodiments, the proper size means a size of 210 microns or more, 410 microns or more, 610 microns or more, 810 microns or more and even 1100 microns or more. On the other hand, the use of powders with excessively large particle sizes may be detrimental to the manufacture of some components. In different embodiments, the proper size means a size of 9900 microns or less, 1990 microns or less, 1390 microns or less, 940 microns or less, 440 microns or less, and even 240 microns or less. Smaller particle sizes may be preferred for the manufacture of some components. In different embodiments, the proper size means a size of 180 microns or less, 80 microns or less, 40 microns or less, 24 microns or less, 9 microns or less, and even 0.6 microns or less. For some applications, even smaller powders may be preferred. In different embodiments, the proper size means a size of 890 nanometers or less, 640 nanometers or less, 490 nanometers or less, 390 nanometers or less, and even 340 nanometers or less. On the other hand, particles that are too small should be avoided for some applications of the method. In different embodiments, the proper size means a size of 0.01 nanometers or more, 0.1 nanometers or more, 6 nanometers or more, 21 nanometers or more, 61 nanometers or more and even 151 nanometers or more. The feature “size” of a particulate material is defined throughout this document in the form of different alternatives that are explained in detail below. In an embodiment, the size refers to D50. In an alternative embodiment, the size refers to D10. In another alternative embodiment, the size refers to D90. In another alternative embodiment, the size refers to the moment-ratio diameter D[3,2]. In another alternative embodiment, the size refers to the moment-ratio diameter D[4,3]. In another alternative embodiment, the size refers to smallest mesh that lets only 10% of the material retained. In another alternative embodiment, the size refers to the smallest mesh that allows 50% of the material to pass through. In another alternative embodiment, the size refers to the mean size. In another alternative embodiment, the size refers to the size of the smallest powder. In another alternative embodiment, the size refers to the size of the largest powder. Throughout this document, unless otherwise stated, the mean value refers to the arithmetic mean value. All the embodiments disclosed above can be combined among them and with any other embodiment disclosed in this document that relates to “the size of a particulate material” in any combination, provided that they are not mutually exclusive. The feature “D50” is defined throughout this document in the form of different alternatives that are explained in detail below. In an embodiment, D50 refers to the particle size at which 50% of the sample's volume is comprised of smaller particles in the cumulative distribution of particle size. In an alternative embodiment, D50 refers to the particle size at which 50% of the sample's mass is comprised of smaller particles in the cumulative distribution of particle size. All the embodiments disclosed above can be combined among them and with any other embodiment disclosed in this document that relates to “D50” in any combination, provided that they are not mutually exclusive. The feature “D10” is defined throughout this document in the form of different alternatives that are explained in detail below. In an embodiment, D10 refers to the particle size at which 10% of the sample's volume is comprised of smaller particles in the cumulative distribution of particle size. In an alternative embodiment, D10 refers to the particle size at which 10% of the sample's mass is comprised of smaller particles in the cumulative distribution of particle size. All the embodiments disclosed above can be combined among them and with any other embodiment disclosed in this document that relates to “D10” in any combination, provided that they are not mutually exclusive. The feature “D90” is defined throughout this document in the form of different alternatives that are explained in detail below. In an embodiment, D90 refers to the particle size at which 90% of the sample's volume is comprised of smaller particles in the cumulative distribution of particle size. In an alternative embodiment, D90 refers to the particle size at which 90% of the sample's mass is comprised of smaller particles in the cumulative distribution of particle size. All the embodiments disclosed above can be combined among them and with any other embodiment disclosed in this document that relates to “D90” in any combination, provided that they are not mutually exclusive. In an embodiment, the above disclosed values of size are measured by laser diffraction. The feature “D[3,2]” is defined throughout this document as the surface weighted mean diameter, also known as the Sauter's mean diameter, expressed as the diameter of a sphere that has the same volume/surface area ratio as a particle of interest. The feature “D[4,3]” is defined throughout this document as the volume weighted mean diameter, also known as the De Brouckere's mean diameter expressed as the mean of a particle size distribution weighted by the volume. In an embodiment, the above disclosed values of size are measured by laser diffraction according to ISO 13320-2020. In an alternative embodiment, the size is measured by dynamic light scattering according to ISO 22412:2017. In another alternative embodiment, the size is measured by dynamic light scattering (DLS). In another alternative embodiment, the size is measured by dynamic image analysis (DIA). In another alternative embodiment, the size is measured by sieving. In an embodiment, the moment-ratio diameters D[3,2] and D[4,3] are calculated according to ISO 9276-2:2014. All the values and ranges of the different embodiments disclosed above can be combined among them and with any other embodiment disclosed in this document in any combination, provided that they are not mutually exclusive, for example, in an embodiment, the D50 of the powder or powder mixture provided has a proper size, wherein a proper size is a size between 0.01 nanometers and 9990 microns; or for example, in another embodiment, between 0.8 and 1990 microns; or for example, in another embodiment, between 210 and 1990 microns, being D50 the particle size at which 50% of the sample's volume is comprised of smaller particles in the cumulative distribution of particle size measured by laser diffraction. For some applications, the use of powder mixtures comprising at least two powders with different particle sizes may be particularly advantageous. Additionally or alternatively, the shape of the powder may be important in the manufacture of some components. In this respect, the inventor has found that for some applications of the method, components with a surprisingly good dimensional accuracy can be manufactured at low cost starting from irregular powders or powder mixtures comprising at least one irregular powder. In an embodiment, the powder material is an irregular powder or powder mixture. In another embodiment, the powder material comprises at least one irregular powder. The feature “irregular powder” is defined throughout this document in the form of different alternatives that are explained in detail below. In an embodiment, an irregular powder refers to a powder having a sphericity of 0.79 or less. In an alternative embodiment, an irregular powder refers to a powder having a sphericity of 0.74 or less. In another alternative embodiment, an irregular powder refers to a powder having a sphericity of 0.69 or less. In another alternative embodiment, an irregular powder refers to a powder having a sphericity of 0.59 or less. In another alternative embodiment, an irregular powder refers to a powder having a sphericity of 0.44 or less. All the embodiments disclosed above can be combined among them and with any other embodiment disclosed in this document that relates to “an irregular powder” in any combination, provided that they are not mutually exclusive. On the other hand, the inventor has also found that for some applications, the use of spherical powders or powder mixtures comprising at least one spherical powder may, among others, help to title tolerances of some manufactured components. In an embodiment, the powder material is a spherical powder or powder mixture. In another embodiment, the powder material comprises at least one spherical powder. The feature “spherical powder” is defined throughout this document in the form of different alternatives that are explained in detail below. In an embodiment, a spherical powder refers to a powder having a sphericity of 0.66 or greater. In an alternative embodiment, a spherical powder refers to a powder having a sphericity of 0.81 or greater. In another alternative embodiment, a spherical powder refers to a powder having a sphericity of 0.86 or greater. In another alternative embodiment, a spherical powder refers to a powder having a sphericity of 0.96 or greater. In another alternative embodiment, a spherical powder refers to a powder having a sphericity of 1. All the embodiments disclosed above can be combined with any other embodiment disclosed in this document that relates to “a spherical powder” in any combination, provided that they are not mutually exclusive. For some applications, it may be advantageous to ensure the presence of some spherical particles in the powder or powder mixture provided. In different embodiments, the percentage of spherical particles is 21% or more, 36% or more, 51% or more, 81% or more, 91% or more and even 98% or more. On the other hand, an excessive percentage of spherical particles may be disadvantageous for the manufacture of certain components. In different embodiments, the percentage of spherical particles is 89% or less, 74% or less, 59% or less, and even 44% or less. The feature” sphericity “of a powder is defined throughout this document in the form of different alternatives that are explained in detail below. In an embodiment, the sphericity refers to a dimensionless parameter defined as the ratio between the surface area of a sphere having the same volume as the particle and the surface area of the particle. In an alternative embodiment, the sphericity (ψ) is calculated using the formula: ψ=[π^{1/3}*(6*Vp)^{2/3}]/Ap. In this formula, π refers to the mathematical constant commonly defined as the ratio of the circumference of a circle to its diameter, Vp is the volume of the particle and Ap is the surface area of the particle. In an embodiment, the sphericity is measured by light scattering diffraction. In an alternative embodiment, the sphericity is measured by dynamic image analysis (DIA). In another alternative embodiment, the sphericity is measured using static image analysis by means microscopy and image processing. In an embodiment, the diameter of quasi-spherical shapes refers to the equivalent diameter. All the embodiments disclosed above can be combined with any other embodiment disclosed in this document that relates to “sphericity” in any combination, provided that they are not mutually exclusive. The feature “equivalent diameter” is defined throughout this document in the form of different alternatives that are explained in detail below. In an embodiment, the equivalent diameter is the diameter of a circle of equivalent area. In an alternative embodiment, the equivalent diameter is the diameter of a sphere of equivalent area. In another alternative embodiment, the equivalent diameter is the diameter of a circle having the same area as the particle's projection. In another alternative embodiment, the equivalent diameter is the diameter of a sphere of equivalent volume. In another alternative embodiment, the equivalent diameter is the diameter of a sphere having the same settling rate as the particle under conditions of Stokes' law. In another alternative embodiment, the equivalent diameter is the diameter of a sphere of equivalent area/volume ratio. In another alternative embodiment, the equivalent diameter is the diameter of a cylinder of equivalent volume. All the embodiments disclosed above can be combined among them and with any other embodiment disclosed in this document that relates to “equivalent diameter” in any combination, provided that they are not mutually exclusive. Some examples of technologies that can be used to obtain the powders include, but are not limited to, atomization (e.g., centrifugal atomization, water atomization, gas atomization, . . . ), droplet atomization (e.g., ultrasonic, piezoelectric, plasma gun, . . . ), oxide reduction, mechanical action, comminution, grinding, crushing, attrition, milling (e.g., ball milling, . . . ), energy breaking and/or combinations thereof. In an embodiment, the powder material comprises at least one powder obtained by atomization. In another embodiment, the powder material comprises at least one powder obtained by water atomization. In another embodiment, the powder material comprises at least one powder obtained by gas atomization. In another embodiment, the powder material comprises at least one powder obtained by droplet atomization. In another embodiment, the powder material comprises at least one powder obtained by oxide reduction. In another embodiment, the powder material comprises at least one powder obtained by mechanical action. In another embodiment, the powder material comprises at least one mechanically comminuted powder. In another embodiment, the powder material comprises at least one powder obtained by grinding. In another embodiment, the powder material comprises at least one powder obtained by ball milling. In another embodiment, the powder material comprises at least one powder obtained by kinetic energy breaking. In another embodiment, the powder material comprises at least one powder obtained by controlled crushing. In another embodiment, the powder material comprises at least one powder obtained by comminution. In another embodiment, the powder material comprises at least one powder rounded by a plasma treatment. Alternatively, for some applications of the method, what is disclosed above about at least one powder can be extended in different embodiments, to at least 2 powders, at least 4 powders, at least 6 powders and even to all the powders of the powder material. All the embodiments disclosed above can be combined among them and with any other embodiment disclosed in this document in any combination, provided that they are not mutually exclusive.

According to the method of the present aspect of the disclosure, the powder or powder mixture provided may then be subjected to a treatment prior to the forming step. In an embodiment, the method comprises the step of—applying energy into the powder or powder mixture through mechanical action. Surprisingly the inventor has found that this treatment in combination with the metal additive manufacturing (MAM) methods and the consolidation treatments disclosed in this document, often results in surprising microstructures with outstanding properties that can be capitalized for various applications. The inventor has also found that some of the strategies developed for the treatment of the powder or powder mixture disclosed in this document are also of great interest for other particulate materials and may also be used in other applications and/or manufacturing methods and thus can constitute and invention in its own. A treatment of particulate materials such as powders or powder mixtures is disclosed, which treatment comprises the application of energy into the powder or powder mixture through mechanical action (also referred to as the “treatment of the powder or powder mixture” or “treatment”).

The powder or powder mixture provided may then be introduced into a container comprising a processing material, such that the powder or powder mixture to be treated (also referred to as the “processed material”) is at least partially in direct contact with the container and/or the processing material. In an embodiment, the treatment comprising the application of energy through mechanical action to the powder or powder mixture is performed in a container comprising a processing material. The treatment comprises introducing the processed material into a container comprising a processing material and applying motion (e.g., rotary motion, vibratory motion, . . . which can be applied to the processing material, processed material and/or container), such that at least part of the collision energy is effectively transferred to at least some of the particles of the processed material. In an embodiment, the treatment of the powder or powder mixture comprises introducing the powder or powder mixture into a container, that comprises a processing material, and applying, a rotary motion and/or vibration. This may cause, among others, the collision between at least part of the processed material, the processing material and/or the container. In an embodiment, the treatment of the powder or powder mixture comprises introducing energy into the powder due to the impact between the processed material, the processing material and/or the container. This treatment may cause, among others, structural changes, physical changes, chemical reactions and/or phase transformations, including, but not limited to, mixing, inter-particle diffusion, welding, cold welding, fracturing, and/or re-welding of at least some of the particles of the powder or powder mixture. In an embodiment, the treatment of the powder or powder mixture is applied such that welding of at least some of the particles occurs. In another embodiment, the treatment of the powder or powder mixture comprises inter-particle diffusion. In another embodiment, the treatment of the powder or powder mixture comprises inter-particle diffusion and/or welding. In this regard, the inventor has found that for some applications of the method, it may be particularly important to ensure that the manufactured component comprises a certain number of atoms from the treated material. In different embodiments, the manufactured component comprises at least 16%, at least 26%, at least 46%, and even at least 66% of the atoms of the treated powder or powder mixture. All the embodiments disclosed above can be combined among them and with any other embodiment disclosed in this document in any combination, provided that they are not mutually exclusive, for example, in an embodiment, the metal comprising component comprises at least 16% of the atoms of the treated powder or powder mixture. In an alternative embodiment, and for especial applications, the inventor has also found that this solid-state treatment its especially suitable for materials with high melting points or those prone to chemical reactions or segregation in the liquid state and/or alloys that are not easily obtainable by conventional methods, among others.

The treatment comprising the introduction of energy through mechanical action into the powder or powder mixture may advantageously be performed in different types of containers (e.g., vessels, vials, jars, bowls, mills, attritors, . . . ). In this regard, containers of different geometric shapes can be used. As non-limiting examples, the geometry of the container may be selected from cylindrical, spherical, and/or conical. In some embodiments, containers having other geometries including, but not limited to, polygonal, cubic, cuboidal, pyramidal, pentagonal, hexagonal, octahedral, and/or ellipsoidal can also be used. For some treatments, the internal shape of the container may be important to, among others, optimize the energy introduced into the powder or powder mixture. Some examples of the types of internal shapes that can be used include, but are not limited to, flat-ended types, round-ended types and concave-ended types, among others. In terms of composition, the above mentioned containers can be manufactured from various materials, including, but not limited to, composite materials, metallic materials (e.g., steel, stainless steel, tempered steel; . . . ), metal-based composites (e.g., hardmetal, tungsten carbide, . . . ), ceramic materials (e.g., silicon nitride (Si₃N₄), zirconium oxide (Zr0₂), corundum, agate, . . . ), ceramic-based composites, organic materials (e.g., polymeric materials, polymer-based composites, . . . ), and/or mixtures thereof. In an embodiment, the container is made of a material comprising a metal or a metal alloy. In another embodiment, the container is made of a material comprising a ceramic material. In another embodiment, the container is made of a material comprising an organic material. In another embodiment, the container is made of a material comprising a composite. However, the geometry and/or composition of the container is not limited to the geometries and/or compositions described above.

For some treatments, the speed of rotation of the container may be particularly important and particularly may be advantageous in some applications where diffusion is required to promote homogenization and/or alloying in the powder or powder mixture. In this respect, the inventor has found that the right selection of the speed may, among others, help to improve processability and even to reduce the manufacturing time for some treatments. In different embodiments, the speed is 46 rpm or more, 81 rpm or more, 106 rpm or more, 160 rpm or more, 310 rpm or more, 460 rpm or more and even 610 rpm or more. On the other hand, excessive speed may be disadvantageous for some treatments. Increasing the value of maximum speed, may result in an increase of the temperature that accelerates the transformation process and results in the decomposition of supersaturated solid solutions or other metastable phases formed during treatment. Additionally, the high temperatures generated may also contaminate the powders. In different embodiments, the speed is 11900 rpm or less, 1490 rpm or less, 990 rpm or less, 790 rpm or less, 690 rpm or less, 340 rpm or less, and even 240 rpm or less. All the values and ranges of the different embodiments disclosed above can be combined among them and with any other embodiment disclosed in this document in any combination, provided that they are not mutually exclusive, for example, in an embodiment, the rotation speed of the container is between 46 and 11900 rpm; or for example, in another embodiment, between 46 and 1490 rpm; or for example, in another embodiment, between 81 and 1490 rpm.

For some treatments, the circulation rate, defined as the number of circulations of the container a particle of the powder or powder mixture makes per container revolution, may be an important parameter for controlling the process. In different embodiments, the circulation rate is 0.1 or more, 0.6 or more, 1.1 or more, 2.1 or more, 6 or more and even 11 or more. On the other hand, excessive circulation rates may be disadvantageous for some treatments. In different embodiments, the circulation rate is 290 or less, 90 or less, 29 or less, 19 or less, and even 9 or less. All the values and ranges of the different embodiments disclosed above can be combined among them and with any other embodiment disclosed in this document in any combination, provided that they are not mutually exclusive, for example, in an embodiment the circulation rate is between 0.1 and 290; or for example, in another embodiment, between 0.1 and 90; or for example, in another embodiment, between 0.6 and 90.

For some treatments, the velocity of the processing material may be particularly important. In this respect, the inventor has found that the right selection of the velocity may, among others, have an impact on the mean dislocation density for some treatments. In different embodiments, the velocity of the processing material is 0.001 m/s or more, 0.01 m/s or more, 0.1 m/s or more, 0.16 m/s or more, 0.51 m/s or more, 3.1 m/s or more, 5.1 m/s or more and even 21 m/s or more. On the other hand, excessive velocities may be disadvantageous for some treatments. In different embodiments, the velocity of the processing material is 290 m/s or less, 89 m/s or less, 49 m/s or less, 19 m/s or less, 9 m/s or less, and even 2.9 m/s or less. All the values and ranges of the different embodiments disclosed above can be combined among them and with any other embodiment disclosed in this document in any combination, provided that they are not mutually exclusive, for example, in an embodiment, the velocity of the processing material is between 0.001 and 49 m/s; or for example, in another embodiment, between 0.01 and 49 m/s; or for example, in another embodiment, between 0.1 and 19 m/s. The velocity of the processing material values disclosed above may be calculated, for example, using any of the different alternatives that are detailed below. In an embodiment, the velocity of the processing material is calculated as described in Lai M O, Lu L. Mechanical alloying. Boston MA: Kluwer Academic. In an alternative embodiment, the velocity of the processing material is calculated as described in Abdellaouni M, Gaffet E. Acta Mater 1996, 44:725-34. In another alternative embodiment, the velocity of the processing material is calculated as described in Mrty B S. Ranganathan S. Internat. Mater Rev 1998, 43:101-41. The average impact frequency defined as the average number of impacts of each element of the processing material (e.g. ball, barrel, rod, cylinder, cylpeb, bead, satellite, pellet . . . ) may also be important for certain treatments. In different embodiments, the average impact frequency is 0.01 Hz or more, 0.1 Hz or more, 6 Hz or more, 51 Hz or more, 301 Hz or more, 1100 Hz or more, and even 3100 Hz or more. On the other hand, excessive impact frequencies may be disadvantageous for certain treatments. In different embodiments, the average impact frequency is 39000 Hz or less, 19000 Hz or less, 9000 Hz or less, 900 Hz or less, 490 Hz or less, 190 Hz or less and even 90 Hz or less. The average impact frequency values disclosed above may be calculated, for example, using any of the different alternatives that are detailed below. In an embodiment, the average impact frequency is calculated as described in Lai M O, Lu L. Mechanical alloying. Boston MA: Kluwer Academic. In an alternative embodiment, the average impact frequency is calculated as described in Abdellaouni M, Gaffet E. Acta Mater 1996, 44:725-34. In another alternative embodiment, the average impact frequency is calculated as described in Mrty B S. Ranganathan S. Internat. Mater Rev 1998, 43:101-41. All the values and ranges of the different embodiments disclosed above can be combined among them and with any other embodiment disclosed in this document in any combination, provided that they are not mutually exclusive, for example, in an embodiment, the average impact frequency is between 0.01 and 39000 Hz; or for example, in another embodiment,between 0.1 and 19000 Hz; or for example, in another embodiment, between 0.1 and 9000 Hz; or for example, in another embodiment, between 6 and 900 Hz. As explained above, the velocity of the processing material and/or the average impact frequency may be important parameters when performing certain treatments. In this regard, the inventor has found that for some applications, a particularly suitable selection of the velocity of the processing material and the average impact frequency, may result in a surprising sphericity ratio of the particles and a suitable level of PAD1 parameter, among others. All the values and ranges of the different embodiments disclosed above can be combined among them and with any other embodiment disclosed in this document in any combination, provided that they are not mutually exclusive, for example, in an embodiment, the velocity of the processing material is between 0.001 and 290 m/s and the average impact frequency is between 0.01 and 39000 Hz; or for example, in another embodiment, the velocity of the processing material is between 0.01 and 49 m/s and the average impact frequency is between 0.1 and 19000 Hz.

The inventor has found that for some treatments, the right selection of the processing material may lead to a surprising increase in the energy introduced into the powder, without a disproportionate increase in the costs of the process. Processing material comprising elements of various shapes can be advantageously used including, but not limited to balls, barrels, rods, cylinders, cylpebs, beads, satellites, pellets and/or combinations thereof. In an embodiment, the processing material comprises milling elements. In another embodiment, the processing material comprises balls. In another embodiment, the processing material comprises beads. In another embodiment, the processing material comprises satellites. In another embodiment, the processing material comprises rods. In another embodiment, the processing material comprises barrels. In another embodiment, the processing material comprises pellets. However, the processing material are not limited to the geometries described above. For some treatments, the composition of the processing material may be of great importance to the performance of the process. Some examples of materials that can be used to manufacture the processing materials include, but are not limited to, metallic materials (e.g., metal-based alloys, steel, carbon steel, stainless steel, chromium steel, tempered steel, . . . ), metallic based composites (e.g., hardmetal, tungsten carbide, . . . ), ceramic materials (e.g., alumina (Al₂O₃), silicon nitride (Si₃N₄), zirconium oxide (ZrO₂), Burundum™, steatite, agate, fused zirconium silicate, corundum, sintered corundum, . . . ), ceramic based composites, glass, organic materials (e.g., nylon, . . . ), polymer based composites and/or combinations thereof. All the embodiments disclosed above can be combined among them and with any other embodiment disclosed in this document in any combination, provided that they are not mutually exclusive, for example, in an embodiment, at least part of the processing material is composed of ceramic and/or metallic balls, cylinders, cylpebs, rods and/or combinations thereof.

The inventor has surprisingly found that for some treatments, the size of the processing material may have a significant effect on the performance of the process, particularly in terms of the energy introduced into the powder or powder mixture, among others. As explained above, some treatments may benefit from processing materials having spherically or quasi-spherically shaped elements (e.g., balls, beads, satellites, . . . ). In an embodiment, the processing material, or at least part of the processing material, has spherical shape. The feature “spherical shape” is defined throughout this document in the form of different alternatives that are explained in detail below. In an embodiment, spherical shape refers to a sphericity of 0.66 or greater. In an alternative embodiment, spherical shape refers to a sphericity of 0.81 or greater. In another alternative embodiment, spherical shape refers to a sphericity of 0.86 or greater. In another alternative embodiment, a spherical shape refers to a sphericity of 0.96 or greater. In another alternative embodiment, spherical shape refers to a sphericity of 1. For some treatments, the diameter of the spherical processing materials may be particularly important to process efficiency. In different embodiments, the diameter of the processing material is 1.2 mm or more, 3.1 mm or more, 5.1 mm or more, 6.6 mm or more, 7.6 mm or more, 8.1 mm or more, 10.1 mm or more and even 31 mm or more. On the other hand, oversized processing materials may be particularly detrimental to the efficiency of some treatments. In different embodiments, the diameter of the processing material is 89 mm or less, 29 mm or less, 14 mm or less, 9 mm or less, and even 3.9 mm or less. All the values and ranges of the different embodiments disclosed above can be combined among them and with any other embodiment disclosed in this document in any combination, provided that they are not mutually exclusive, for example, in an embodiment, the processing material has a spherical shape with a mean diameter between 1.2 and 89 mm; or for example, in another embodiment, between 1.2 and 29 mm; or for example, in another embodiment, between 3.1 and 29 mm. The feature “diameter of the processing material” is defined throughout this document in the form of different alternatives that are explained in detail below. In an embodiment, the diameter of the processing material refers to the mean diameter. In an alternative embodiment, the diameter of the processing material refers to the equivalent diameter of the processing material. In another alternative embodiment, the diameter of the processing material refers to the diameter of the processing material having the largest diameter. In another alternative embodiment, the diameter of the processing material refers to the diameter of the processing material having the smallest diameter. All the embodiments disclosed above can be combined among them and with any other embodiment disclosed in this document that relates to “the diameter of the processing materials” in any combination, provided that they are not mutually exclusive, for example, in an embodiment, at least part of the processing material has spherical shape with a sphericity of 0.66 or greater, a diameter between 1.2 mm and 89 mm, and the rotation speed of the container is between 46 and 11900 rpm. For some treatments, it may be advantageous to use processing materials having cylindrically-shaped elements (e.g., rods, cylinders, cylpebs, pellets, . . . ). In an embodiment, the processing material, or at least part of the processing material, has a cylindrical shape. For some treatments, the length and/or diameter of the cylindrical processing materials may be particularly important, among others, to process efficiency. In different embodiments, the length and/or diameter of the processing material is 149 mm or less, 119 mm or less, 99 mm or less, 89 mm or less, 74 mm or less, 49 mm or less, and even 34 mm or less. On the other hand, processing materials that are too small may reduce the effectiveness of some treatments. In different embodiments, the length and/or diameter of the processing material is 0.1 mm or more, 6.1 mm or more, 12.1 mm or more, 16.1 mm or more, 21 mm or more, 56 mm or more and even 66 mm or more. The feature “length of the processing material” is defined throughout this document in the form of different alternatives that are explained in detail below. In an embodiment, the length of the processing material refers to the mean length. In an alternative embodiment, the length of the processing material refers to the length of the processing material having the longest length. In another alternative embodiment, the length of the processing material refers to the length of the processing material having the shortest length. All the values and ranges of the different embodiments disclosed above can be combined among them and with any other embodiment disclosed in this document in any combination, provided that they are not mutually exclusive, for example, the treatment according to an embodiment wherein the processing material has a cylindrical shape with a mean diameter and/or length between 0.1 and 149 mm; or for example, in another embodiment between 0.1 and 119 mm; or for example, in another embodiment, between 6.1 and 119 mm. In some embodiments, it may be advantageous to use a processing material consisting of materials of different size, shape and/or composition.

The inventor has found that for some treatments, the ratio of processing material-to-container volume, which is calculated as: the volume occupied by the processing material divided by the volume of the container, all volumes being measured in m³, may be important for the performance of the process especially when it comes to the time required to achieve a particular phase in the powder or powder mixture being treated and in particular for the quality of the treated powders, among others. In different embodiments, the ratio of processing material-to-container volume is 1:190 or more, 1:51 or more, 1:21 or more, 1:16 or more, 1:9 or more, 1:6 or more, 1:2 or more and even 1:1.5 or more. On the other hand, too large ratios seem to be disadvantageous for some treatments. In different embodiments, the ratio of processing material-to-container volume is 1:1.2 or less, 1:3 or less, 1:14 or less, 1:26 or less, and even 1:61 or less. All the values and ranges of the different embodiments disclosed above can be combined among them and with any other embodiment disclosed in this document in any combination, provided that they are not mutually exclusive, for example, in an embodiment, the ratio of the processing material-to-container volume is between 1:190 and 1:61; or for example, in another embodiment, between 1:51 and 1:161; or for example, in another embodiment, between 1:51 and 1:26. For some treatments, it may be important to determine the percentage of the volume of the container occupied by the processing material, which is calculated as: the volume occupied by the processing material divided by the volume of the container and multiplied by 100, all volumes being measured in m³. In different embodiments, the percentage of the volume of the container occupied by the processing material is 6% or more, 11% or more, 16% or more, 26% or more, 36% or more, 46% or more and even 66% or more. On the other hand, excessive occupancy percentages may lead to a reduction in the energy introduced into the powder or powder mixture for some treatments. In different embodiments, the percentage of the volume of the container occupied by the processing material is 84% or less, 69% or less, 54% or less, 49% or less, 34% or less, and even 24% or less. All the values and ranges of the different embodiments disclosed above can be combined among them and with any other embodiment disclosed in this document in any combination, provided that they are not mutually exclusive, for example, in an embodiment, the percentage of the volume of the container occupied by the processing material is between 6% and 84%; or for example, in another embodiment, between 6% and 69%; or for example, in another embodiment, between 11% and 69%. For some treatments, it may be more important to determine the percentage of the volume of the container occupied by the processed material, which is calculated as: the volume occupied by the powder or powder mixture divided by the volume of the container and multiplied by 100, all volumes being measured in m³. In different embodiments, the percentage of the volume of the container occupied by the processed material is 3% or more, 8% or more 12% or more, 21% or more, 31% or more, 41% or more and even 56% or more. On the other hand, excessive ratios may result in a reduction of the energy introduced into the powder or powder mixture for some treatments. In different embodiments, the percentage of the volume of the container occupied by the processed material is 81% or less, 64% or less, 48% or less, 44% or less, 29% or less, and even 19% or less. All the values and ranges of the different embodiments disclosed above can be combined among them and with any other embodiment disclosed in this document in any combination, provided that they are not mutually exclusive, for example, in an embodiment, the percentage of the volume of the container occupied by the processed material is between 3%, and 81%; or for example, in another embodiment, between 3%, and 64%; or for example, in another embodiment, between 8% and 64%.

For some treatments, the volume ratio of processed material-to-processing material, which is calculated as the volume occupied by the powder or powder mixture divided by the volume occupied by the processing material, all volumes being measured in m³, may be important to the performance of the process. In different embodiments, the volume ratio of processed material-to-processing material is 0.29 or more, 0.41 or more, 0.56 or more, 0.81 or more and even 1.1 or more. On the other hand, excessive ratios may be detrimental to the efficiency of some treatments. In different embodiments, the volume ratio of processed material-to-processing material is 2.4 or less, 1.4 or less, 0.94 or less, 0.79 or less, 0.49 or less, and even 0.34 or less. All the values and ranges of the different embodiments disclosed above can be combined among them and with any other embodiment disclosed in this document in any combination, provided that they are not mutually exclusive, for example, in an embodiment, the volume ratio of processed material-to-processing material is between 0.29 and 2.4; or for example, in another embodiment, between 0.29 and 1.4; or for example, in another embodiment, between 0.41 and 1.4.

The inventor has found that for some treatments, a right selection of the volume occupied by the processing material and processed material to the volume of the container, which is calculated as: the volume occupied by the processing material and the powder or powder mixture, divided by the volume of the container and multiplied by 100, all volumes being measured in m³, may lead to a surprising increase in the efficiency. In different embodiments, the volume occupied by the processing and processed material-to-container is 31% or more, 36% or more, 41% or more, 46% or more, 51% or more, 56% or more and even 61% or more. On the other hand, excessive ratios may be disadvantageous for some treatments. In different embodiments, the volume occupied by the processing and processed material-to-container 74% or less, 64% or less, 59% or less, 49% or less, and even 44% or less. All the values and ranges of the different embodiments disclosed above can be combined among them and with any other embodiment disclosed in this document in any combination, provided that they are not mutually exclusive, for example, in an embodiment, the volume occupied by the processing and processed material-to-container is between 31% and 74%; or for example, in another embodiment, between 36% and 74%; or for example, in another embodiment, between 41% and 64%.

For some applications, the weight of the processing material may be important to the performance of the treatment especially, among others, when it comes to controlling the number of collisions per unit time and consequently the energy transferred to the powder or powder mixture. In different embodiments, the weight of the processing material is 0.6 g or more, 3.1 g or more, 4.6 g or more, 16 g or more, 26 g or more, 36 g or more, 51 g or more and even 76 g or more. On the other hand, using a processing material with an excessive weight may lead to a disproportionate increase in processing costs for some treatments. In different embodiments, the weight of the processing material is 4900 g or less, 248 g or less, 179 g or less, 119 g or less, 89 g or less, 49 g or less, 39 g or less, 29 g or less, 14 g or less, and even 9 g or less. The feature “weight of the processing material” is defined throughout this document in the form of different alternatives that are explained in detail below. In an embodiment, the weight of the processing material refers to the weight of each element of the processing material (e.g., ball, cylinder, cylpebs, rod, bead, satellite, pellet, . . . ) individually. In an alternative embodiment, the weight of the processing material refers to the mean weight. In another alternative embodiment, the weight of the processing material refers to the weight of the processing material having the highest weight. In another alternative embodiment, the weight of the processing material refers to the weight of the processing material having the lowest weight. All the values and ranges of the different embodiments disclosed above can be combined among them and with any other embodiment disclosed in this document in any combination, provided that they are not mutually exclusive, for example, in an embodiment the mean weight of the processing material is between 0.6 and 4900 g; or for example, in another embodiment, the mean weight of the processing material is between 3.1 and 248 g; or for example, in another embodiment, the mean weight of the processing material is between 3.1 and 89 g; or for example, in another embodiment, the weight of each element of the processing material individually is between 0.6 and 4900 g; or for example, in another embodiment, the weight of each element of the processing material individually is between 3.1 and 248 g; or for example, in another embodiment, the weight of each element of the processing material individually is between 3.1 and 89 g.

For some treatments, it may be more important to have a certain weight ratio of processing material-to-processed material, calculated as: the weight of processing material divided by the weight of the powder or powder mixture, all weights being in grams (g). In different embodiments, the weight ratio of processing material-to-processed material is 7:1 or more, 11:1 or more, 14:1 or more, 16:1 or more, 21:1 or more, 41:1 or more, 61:1 or more, 101:1 or more and even 201:1 or more. On the other hand, excessive ratios may result in a reduction of the effectiveness in some treatments. In different embodiments, the weight ratio of processing material-to-processing material is 490:1 or less, 340:1 or less, 190:1 or less, 99:1 or less, and even 49:1 or less. All the values and ranges of the different embodiments disclosed above can be combined among them and with any other embodiment disclosed in this document in any combination, provided that they are not mutually exclusive, for example, in an embodiment, the weight ratio of processing material-to-processed material is between 7:1 and 490:1; or for example, in another embodiment, between 7:1 and 340:1; or for example, in another embodiment, between 11:1 and 340:1.

All the embodiments disclosed above can be combined among them and with any other embodiment disclosed in this document in any combination, provided that they are not mutually exclusive, for example, in an embodiment, the percentage of the volume of the container occupied by the processing material, which is calculated as the volume occupied by the processing material divided by the volume of the container and multiplied by 100, all volumes being measured in m³, is between 6% and 84%, and wherein the percentage of the volume of the container occupied by the powder or powder mixture, which is calculated as: the volume occupied by the powder or powder mixture divided by the volume of the container and multiplied by 100, all volumes being measured in m³, is between 3% and 81%, and wherein the weight ratio of processing material-to-processed material, calculated as the weight of processing material divided by the weight of the powder or powder mixture, all weights being in grams, is between 490:1 and 7:1 With respect to the duration of the treatment, the inventor has found that for some treatments, the right selection of the treatment time may lead to a surprising increase in process efficiency, without an excessive increase in cost. The required treatment time varies depending on factors such as the speed of rotation, the ratio of processed material to processing material, and the treatment temperature, among others. In different embodiments, the treatment time is 1.2 minutes or more, 16 minutes or more, 1.2 hours or more, 11 hours or more, 36 hours or more, 61 hours or more, 121 hours or more, 210 hours or more and even 610 hours or more. On the other hand, too long treatment times may lead to a disproportionate increase in costs. In different embodiments, the treatment time is 2590 hours or less, 980 hours or less, 440 hours or less, 140 hours or less, 90 hours or less, 47 hours or less, and even 29 hours or less. All the values and ranges of the different embodiments disclosed above can be combined among them and with any other embodiment disclosed in this document in any combination, provided that they are not mutually exclusive, for example, in an embodiment the duration of the treatment is between 1.2 minutes and 2590 hours; or for example, in another embodiment, between 16 minutes and 980 hours; or for example, in another embodiment, between 1.2 and 980 hours.

For some treatments, the atmosphere in the container may be important especially, among others, in those cases where the processed material contamination plays a predominant role. Different types of atmospheres can be advantageously used including, but not limited to, a normal atmosphere (air), an inert atmosphere (e.g., helium, argon, . . . ), a reactive atmosphere (e.g., reducing atmosphere, . . . ), and/or mixtures thereof. In this respect, the inventor has found that the use of a properly designed atmosphere (as defined in this document) may be particularly advantageous for the treatment of certain particulate materials. In an embodiment, the atmosphere in the container is a properly designed atmosphere (as defined in this document). For some treatments, it may be advantageous to use of a certain vacuum during at least part of the treatment especially when it comes to reducing the presence or occurrence of amorphous phases during processing, among others. In different embodiments, the vacuum applied in the container is 510 mbar or better, 106 mbar or better, of 11 mbar or better, of 0.96 mbar or better, of 1.1*10⁻² mbar or better, of 1.1*10⁻³ mbar or better, of 1.1*10⁻⁴ mbar or better and even of 1.1*10⁻⁵ mbar or better. On the other hand, excessive vacuum levels may lead to a disproportionate increase in cost for some treatments.

In different embodiments, the vacuum applied in the container is 1.6*10⁻¹⁰ mbar or worse, 1.6*10⁻⁸ mbar or worse, 1.6*10⁻⁶ mbar or worse and even 1.6*10⁻⁴ mbar or worse. Throughout this document, unless otherwise stated, pressure values expressed in mbar are absolute pressure values and pressure values expressed in bar and/or MPa are relative pressure values. For some treatments, a certain pressurization of the container during at least part of the treatment may help to increase the efficiency by means of enhanced plastic deformation, accelerated diffusion kinetics, reduction of agglomeration and promoting effective mixing and reducing the formation of localized regions with non-uniform composition, among others. In an embodiment, the treatment comprises the application of pressure. In different embodiments, the pressure applied (as defined in this document) in the container is 0.12 MPa or more, 0.6 MPa or more, 1.6 MPa or more and even 4.1 MPa or more. On the other hand, excessive pressures can be disadvantageous for certain treatments where high friction, heat generation and increased energy consumption, among others, are undesirable effects. On the other hand, excessive pressures may be disadvantageous for some treatments. In different embodiments, the pressure applied (as defined in this document) in the container is 9.8 MPa or less, 4.9 MPa or less, and even 1.8 MPa or less. The feature “pressure applied” is defined throughout this document in the form of different alternatives that are explained in detail below. In an embodiment, the pressure applied refers to the mean pressure applied. In an alternative embodiment, the pressure applied refers to the minimum pressure applied. In another alternative embodiment, the pressure applied refers to the minimum pressure applied, where the minimum pressure is calculated excluding any pressure which is applied for less than a critical time (as defined in this document). In another alternative embodiment, the pressure applied refers to the maximum pressure applied. In another alternative embodiment, the pressure applied refers to the maximum pressure applied, wherein the maximum pressure is calculated excluding any pressure which is applied for less than a critical time (as defined in this document). In another alternative embodiment, the pressure applied refers to the mean pressure applied, wherein the mean pressure is calculated excluding any pressure which is applied for less than a critical time (as defined in this document). In an embodiment, the pressure is applied for at least a critical time (as defined in this document). In another embodiment, the pressure is applied for a relevant time. In an embodiment, the pressure is applied in a continuous way (continuously). In another embodiment, the pressure is applied continuously for a relevant time (as defined in this document). In another embodiment, the pressure is applied in a stepwise manner (as defined in this document). In another embodiment, the pressure is increased and/or released more than once during the treatment. All the embodiments disclosed above can be combined with any other embodiment disclosed in this document that relates to “pressure applied” in any combination, provided that they are not mutually exclusive. The feature “critical time” is defined throughout this document in the form of different alternatives that are explained in detail below. In an embodiment, a critical time is 1 second. In an alternative embodiment, a critical time is 3 seconds. In another alternative embodiment, a critical time is 11 seconds. In another alternative embodiment, a critical time is 16 seconds. In another alternative embodiment, a critical time is 26 seconds. In another alternative embodiment, a critical time is 56 seconds. All the embodiments disclosed above can be combined with any other embodiment disclosed in this document that relates to a “critical time” in any combination, provided that they are not mutually exclusive. The feature “relevant time” is defined throughout this document in the form of different alternatives that are explained in detail below. In an embodiment, a relevant time is at least 1 second. In an alternative embodiment, a relevant time is at least 4 seconds. In another alternative embodiment, a relevant time is at least 12 seconds. In another alternative embodiment, a relevant time is at least 19 seconds. In another alternative embodiment, a relevant time is at least 56 seconds. In another alternative embodiment, a relevant time is at least 4 minutes. In another alternative embodiment, a relevant time is at least 6 minutes. All the embodiments disclosed above can be combined with any other embodiment disclosed in this document that relates to a “relevant time” in any combination, provided that they are not mutually exclusive.

The inventor has found that for some treatments, the application of particularly low temperatures during at least part of the treatment of the powder or powder mixture, may be particularly advantageous to improve the quality of the treated material. In an embodiment, the treatment comprises the application of temperature. In different embodiments, the temperature applied (as defined in this document) is −20° C. or less, −50° C. or less, −80° C. or less, −150° C. or less, −190° C. or less, and even −220° C. or less. On the other hand, excessively low temperatures may reduce the efficiency of some treatments. In different embodiments, the temperature applied (as defined in this document) is −270° C. or more, −240° C. or more, −199° C. or more and even −140° C. or more. For some treatments, a certain relation between the composition and the temperature applied (as defined in this document) may be advantageous, among others, to increase the energy introduced into the powder or powder mixture. In different embodiments, the temperature applied (as defined in this document) is 0.06*Tm or more, 0.16*Tm or more, 0.21*Tm or more and even 0.26*Tm or more, wherein Tm is the melting temperature in Kelvin of the powder or powder mixture (as defined in this document) provided. On the other hand, excessive temperatures may be disadvantageous for some treatments. In different embodiments, the temperature applied (as defined in this document) is 0.74*Tm or less, 0.64*Tm or less, 0.54*Tm or less, 0.49*Tm or less, 0.39*Tm or less, and even 0.29*Tm or less, wherein Tm is the melting temperature in Kelvin of the powder or powder mixture (as defined in this document) provided. In an embodiment, the temperature is applied continuously. In another embodiment, the temperature is applied continuously for a relevant time (as defined in this document). In another embodiment, the temperature is applied in a stepwise manner. In another embodiment, the temperature is increased and/or released more than once during the treatment. The feature “temperature applied” is defined throughout this document in the form of different alternatives that are explained in detail below. In an embodiment, the temperature applied refers to the mean temperature applied. In an alternative embodiment, the temperature applied refers to the minimum temperature applied, wherein the minimum temperature is calculated excluding any temperature which is applied for less than a critical time (as defined in this document). In another alternative embodiment, the temperature applied refers to the maximum temperature applied, wherein the maximum temperature is calculated excluding any temperature which is applied for less than a critical time (as defined in this document). In another alternative embodiment, the temperature applied refers to the mean temperature applied, wherein the mean temperature is calculated excluding any temperature which is applied for less than a critical time (as defined in this document). In an embodiment, the temperature is applied for at least a critical time (as defined in this document). In another embodiment, the temperature is applied for a relevant time (as defined in this document). All the embodiments disclosed above can be combined among them and with any other embodiment disclosed in this document that relates to the “temperature applied” in any combination, provided that they are not mutually exclusive. The feature “melting temperature of the powder mixture” is defined throughout this document in the form of different alternatives that are explained in detail below. In an embodiment, the melting temperature of the powder mixture refers to the melting temperature of the metallic powder with the lowest melting point in the powder mixture. In an alternative embodiment, the melting temperature of the powder mixture refers to the melting temperature of the metallic relevant powder (metallic powder which is a relevant powder as defined in this document) with the lowest melting point in the powder mixture. In another alternative embodiment, the melting temperature of the powder mixture refers to the melting temperature of the metallic critical powder (metallic powder which is a critical powder as defined in this document) with the lowest melting point in the powder mixture. In another alternative embodiment, the melting temperature of the powder mixture refers to the melting temperature of the metallic powder with the highest volume fraction in the powder mixture. In another alternative embodiment, the melting temperature of the powder mixture refers to the melting temperature of the metallic powder with the highest weight fraction in the powder mixture. In another alternative embodiment, the melting temperature of the powder mixture refers to the melting temperature of the metallic powder with the lowest volume fraction in the powder mixture. In another alternative embodiment, the melting temperature of the powder mixture refers to the melting temperature of the metallic powder with the lowest weight fraction in the powder mixture. In another alternative embodiment, the melting temperature of the powder mixture refers to the melting temperature of the metallic powder with the highest melting point in the powder mixture. In another alternative embodiment, the melting temperature of the powder mixture refers to the melting temperature of the metallic relevant powder (metallic powder which is a relevant powder as defined in this document) with the highest melting point in the powder mixture. In another alternative embodiment, the melting temperature of the powder mixture refers to the melting temperature of the metallic critical powder (metallic powder which is a critical powder as defined in this document) with the highest melting point in the powder mixture. In another alternative embodiment, the melting temperature of the powder mixture refers to the arithmetic mean melting temperature of all the metallic powders in the powder mixture. In another alternative embodiment, the melting temperature of the powder mixture refers to the weighted arithmetic mean melting temperature of all the metallic powders in the powder mixture (mass-weighted arithmetic mean, where the weights are the weight fractions). In another alternative embodiment, the melting temperature of the powder mixture refers to the volume-weighted arithmetic mean melting temperature of all the metallic powders in the powder mixture (volume-weighted arithmetic mean, where the weights are the volume fractions). Throughout this document, unless otherwise stated, the melting temperature Tm of a metallic powder (particles with the same nominal composition) refers to the temperature at which the first metal liquid forms under equilibrium conditions. All the embodiments disclosed above can be combined among them and with any other embodiment disclosed in this document that relates to “the melting temperature of the powder mixture” in any combination, provided that they are not mutually exclusive, for example, in an embodiment, Tm is the melting temperature in Kelvin of the metallic powder with the lowest melting point; or for example, in another embodiment, Tm is the melting temperature in Kelvin of the metallic powder, which is at least 2.6% by weight of all the metallic powders in the powder mixture, with the lowest melting point, wherein the melting temperature of such metallic powder is the temperature at which the first metal liquid forms under equilibrium conditions; or for example, in another embodiment, Tm is the melting temperature in Kelvin of the metallic powder, which is at least 6% by weight of all the metallic powders in the powder mixture, with the lowest melting point, wherein the melting temperature of such metallic powder is the temperature at which the first metal liquid forms under equilibrium conditions; or for example, in another embodiment, Tm is the melting temperature in Kelvin of the metallic powder with the highest melting point, wherein the melting temperature of such metallic powder is the temperature at which the first metal liquid forms under equilibrium conditions; or for example, in another embodiment, Tm is the melting temperature in Kelvin of the metallic powder, which is at least 2.6% by weight of all the metallic powders in the powder mixture, with the highest melting point, wherein the melting temperature of such metallic powder is the temperature at which the first metal liquid forms under equilibrium conditions; or for example, in another embodiment, Tm is the melting temperature in Kelvin of the metallic powder, which is at least 6% by weight of all the metallic powders in the powder mixture, with the highest melting point, wherein the melting temperature of such metallic powder is the temperature at which the first metal liquid forms under equilibrium conditions. All the embodiments disclosed above can be combined among them and with any other embodiment disclosed in this document in any combination, provided that they are not mutually exclusive, for example, in an embodiment, the treatment of the powder or powder mixture comprises the application of a vacuum between 510 and 1.6*10⁻¹⁰ mbar and/or the application of a pressure between 0.12 and 9.8 MPa, during at least part of the treatment and/or the application of a temperature between 0.16*Tm and 0.74*Tm, being Tm the melting temperature in Kelvin of the powder or powder mixture provided.

For some treatments, it may be important to quantify the energy introduced into the powder or powder mixture, for example, to assess the efficiency of the treatment. The amount of energy introduced into the powder or powder mixture, may also be important for the properties that can be achieved in some components and even for improving the processability of certain materials. The energy introduced into the powder can be calculated, for example as described in Magini et al; (Energy transfer in Mechanical alloying, overview, Materials Transactions, JIM, Vo. 36, No 2, 1995, pp 123 to 133) or in a similar fashion for other systems. In different embodiments, the energy introduced into the powder or powder mixture is 11 J/(g*hit) or more, 26 J/(g*hit) or more, 52 J/(g*hit) or more, 76 J/(g*hit) or more and even 102 J/(g*hit) or more. On the other hand, excessive energy levels may, among others, affect the efficiency and/or the cost associated with the implementation of some treatments. In different embodiments, the energy introduced into the powder or powder mixture is 490 J/(g*hit) or less, 290 J/(g*hit) or less, 190 J/(g*hit) or less, and even 90 J/(g*hit) or less. All the values and ranges of the different embodiments disclosed above can be combined among then and with any other embodiment disclosed in this document in any combination, provided that they are not mutually exclusive, for example, in an embodiment, the energy introduced into the powder or powder mixture is between 11 and 490 J/(g*hit); or for example, in another embodiment, between 11 and 290 J/(g*hit); or for example, in another embodiment, between 26 and 290 J/(g*hit). The inventor has found that for some treatments, it may be important to quantify the raw energy introduced into the powder or powder mixture, for example, to assess the efficiency of the treatment, among others. In different embodiments, the raw energy introduced is 1.1-10⁻⁵ J/hit or more, 1.1-10⁻⁴ J/hit or more, 1.1.10-3 J/hit or more, 1.1.10⁻² J/hit or more, and even 1.1.10⁻¹ J/hit or more. On the other hand, excessively high values may be detrimental in some treatments. In different embodiments, the raw energy introduced is 20 J/hit or less, 9 J/hit or less, 0.9 J/hit or less, and even 0.39 J/hit or less. All the values and ranges of the different embodiments disclosed above can be combined among then and with any other embodiment disclosed in this document in any combination, provided that they are not mutually exclusive, for example, in an embodiment, the raw energy introduced into the powder or powder mixture is between 1.1-10⁻⁵ and 20 J/hit; or for example, in another embodiment, between 1.1-10⁻⁴ and 20 J/hit; or for example, in another embodiment, between 1.1-10⁻⁴ and 9 J/hit. The values of raw energy introduced disclosed above may be calculated, for example, using any of the different alternatives that are detailed below. In an embodiment, the raw energy introduced is calculated as described in Lai M O, Lu L. Mechanical alloying. Boston MA: Kluwer Academic. In an alternative embodiment, the raw energy introduced is calculated as described in Abdellaouni M, Gaffet E. Acta Mater 1996, 44:725-34. In another alternative embodiment, the raw energy introduced is calculated as described in Mrty B S. Ranganathan S. Internat. Mater Rev 1998, 43:101-41. For some treatments, it may be advantageous to quantify the energy introduced into the powder or powder mixture through KA1 and/or KA2 parameters. In an embodiment, the step of applying a treatment to the powder or powder mixture comprises a right value of the parameter KA1 (with the values disclosed below). The inventor has found that for some treatments, it may be particularly advantageous to ensure that the parameter KA1 has a right value, being KA1=EEC/(V_{powder}*ρ_{powder}); wherein: EEC is the electrical energy consumed during the processing of the powder expressed in MJ; V_{powder} is the volume of powder in the container (e.g., mill, attritor, . . . ), expressed in dm³; ρ_{powder} is the mean density of the powder in the container (e.g., mill, attritor, . . . ), expressed in kg/dm³. In different embodiments, a right value of KA1 is 2.88 or more, 26 or more, 42 or more, 82 or more, 210 or more, 410 or more, 1200 or more and even 2800 or more. On the other hand, KA1 should not be too high in some treatments. In different embodiments, a right value of KA1 is 4900 or less, 2880 or less, 2400 or less, 1200 or less, 480 or less, 190 or less, and even 39 or less. All the values and ranges of the different embodiments disclosed above can be combined among then and with any other embodiment disclosed in this document in any combination, provided that they are not mutually exclusive, for example, in an embodiment, the step of applying a treatment to the powder or powder mixture comprises a value of parameter KA1 between 2.88 and 4900; or for example, in another embodiment, between 2.8 and 2880; or for example, in another embodiment, between 26 and 2880; or for example, in another embodiment, between 26 and 1200. In an embodiment the electrical energy consumption is measured by means a power meter. In an alternative embodiment, the electrical power consumption is obtained indirectly through measurement of the circulating current flow and the applied voltage. In an embodiment ρ_{powder} is the mean density of the powder or of the powder mixture obtained by means the Archimedes' principle. In an alternative embodiment ρ_{powder} is the mean density of the powder or of the powder mixture obtained by means the Archimedes' principle according to ASTM B311-17. Throughout this document, unless the context clearly indicates otherwise, measurements are performed under standard conditions. All the embodiments disclosed above can be combined among them and with any other embodiment disclosed in this document in any combination, provided that they are not mutually exclusive, for example, in an embodiment, the step of applying a treatment to the powder or powder mixture comprises a value of the parameter KA1 between 2.88 and 4900, being KA1=EEC/(V_{powder}*ρ_{powder}); wherein: EEC is the electrical energy consumed while processing the powder or powder mixture in MJ; V_{powder} is the volume of the powder or powder mixture in the container in dm³, and ρ_{powder} is the mean density of the powder or powder mixture in the container in kg/dm³. In an embodiment, the step of applying a treatment to the powder or powder mixture comprises a right value of the parameter KA2 (with the values disclosed below). For some treatments, it may be particularly advantageous to ensure that parameter KA2 has a right value, being KA2=Coeff*1/(V_{powder}*ρ_{powder}+V_{processing material}·ρ_{processing material})*EEC, wherein EEC is the electrical energy consumed while processing the powder expressed in MJ; V_{powder} is the volume of powder in the container (e.g., mill, attritor, . . . ), expressed in dm³; ρ_{powder} is the mean density of the powder in the container (e.g., mill, attritor, . . . ), expressed in kg/dm³; V_{processing material} is the volume of the processing material (e.g., balls, . . . ) in the container (e.g., mill, attritor), expressed in dm³; ρ_{processing material} is the mean density of the processing material (e.g., balls, . . . ) in the container (e.g., mill, attritor, . . . ), expressed in kg/dm³; and Coeff is a parameter selected, in different embodiments, from 0.89, 0.84, 0.79, 0.64 and even 0.52. In different embodiments, a right value of KA2 is 0.3 or more, 2.6 or more, 4.2 or more, 8.2 or more, 41 or more, 410 or more and even 2880 or more. On the other hand, KA2 should not be excessively high in some treatments. In different embodiments, a right value of KA2 is 4900 or less, 1900 or less, 490 or less, 290 or less, 120 or less, 48 or less, and even 4 or less. All the values and ranges of the different embodiments disclosed above can be combined among then and with any other embodiment disclosed in this document in any combination, provided that they are not mutually exclusive, for example, in an embodiment, the step of applying a treatment to the powder or powder mixture comprises a value of parameter KA2 between 0.3 and 4900, between 0.3 and 1900, wherein Coeff is 0.89; or for example, in another embodiment, between 2.6 and 4900, wherein Coeff is 0.84; or for example, in another embodiment, between 2.6 and 1900, wherein Coeff is 0.79. In an embodiment the electrical energy consumption is measured by means a power meter. In an alternative embodiment, the electrical power consumption is obtained indirectly through measurement of the circulating current flow and the applied voltage. In an embodiment ρ_{powder} is the mean density of the powder or of the powder mixture obtained by means the Archimedes' principle. In an alternative embodiment ρ_{powder} is the mean density of the powder or of the powder mixture obtained by means the Archimedes' principle according to ASTM B311-17. In an embodiment the V_{processing material} and the ρ_{processing material} are measured by means the Archimedes' principle according to ASTM B311-17. Throughout this document, unless the context clearly indicates otherwise, measurements are performed under standard conditions. All the embodiments disclosed above can be combined among them and with any other embodiment disclosed in this document in any combination, provided that they are not mutually exclusive, for example, in an embodiment, the step of applying a treatment to the powder or powder mixture comprises a value of the parameter KA2 between 0.3 and 4900, being KA2=Coeff*1/(V_{powder}*ρ_{powder}+V_{processing material}*ρ_{processing material})*EEC, wherein EEC is the electrical energy consumed while processing the powder or powder mixture in MJ; V_{powder} is the volume of the powder or powder mixture in the container in dm³; ρ_{powder} is the mean density of the powder or powder mixture in the container in Kg/dm³; V_{processing material} is the volume of the processing material in the container in dm³; ρ_{processing material} is the mean density of the processing material in the container in Kg/dm³, and Coeff is 0.89.

Mean dislocation density (MDD) may be important, among others, to the performance of certain manufactured components. For some applications, instead of setting the treatment parameters based on the energy introduced into the powder, it may be particularly advantageous to ensure certain levels of dislocation densities during the application of the method. In this respect, the inventor has surprisingly found that setting the mean dislocation density to certain values given below, often results in manufactured components with excellent properties that can be capitalized for, among others, highly demanding applications. The correlation between treatment parameters and dislocation density levels depends on the particular material treated. It is a routinary task for the skilled person to do this translation (setting the treatment parameters to ensure a certain level of dislocation density) once the material to be treated has been selected for example, requiring high mechanical strength and refined microstructures (grain refinement). In different embodiments, the mean dislocation density is 1.2*10¹² m⁻² or more, 1.2*10¹³ m⁻² or more, 1.2*10¹⁴ m⁻² or more, 5.5*10¹⁴ m⁻² or more, 1.2*10¹⁵ m⁻² or more, 5.5*10¹⁵ m⁻² or more and even 1.2*10¹⁶ m⁻² or more. On the other hand, the mean dislocation density should not be set to an excessively high value in some treatments. In different embodiments, the mean dislocation density is 9.8*10¹⁸ m⁻² or less, 9.8*10¹⁷ m⁻² or less, 9.8*10¹⁶ m⁻² or more, 4.8*10¹⁶ m⁻² or less, and even 9.8*10¹⁵ m⁻² or less. In an embodiment, the mean dislocation density values disclosed above refer to the mean dislocation density of the particles of the treated powder or powder mixture which are contained in the component (often, at certain stages during the whole method, the particles of the treated powder or powder mixture are bond to each other in a way that it is difficult or even impossible to discriminate between them, but that does not pose a significant challenge in the determination of the mean dislocation density which can be determined for separate powder particles and also for components resulting of the consolidation of such powder particles) before, during and/or after the application of any step of the method performed after the treatment of the powder or powder mixture. In an alternative embodiment, the mean dislocation density values disclosed above refer to the mean dislocation density at least in some areas of the component surface. For certain particular applications, it may be also advantageous to ensure a certain mean dislocation density of the particles of the powder or powder mixture during and/or at the end of the step of applying a treatment to the powder or powder mixture. In another alternative embodiment, the mean dislocation density values disclosed above refer to the mean dislocation density of the particles of the powder or powder mixture during and/or at the end of the step of applying a treatment to the powder or powder mixture. In any event, the skilled person will know how to set the desired values of the mean dislocation density as given above by modifying the parameters of the method steps. All the values and ranges of the different embodiments disclosed above can be combined among then and with any other embodiment disclosed in this document in any combination, provided that they are not mutually exclusive, for example, in an embodiment, the mean dislocation density (MDD) of the powder or powder mixture after applying the treatment is between 1.2*10¹² and 9.8*10¹⁸ m⁻²; or for example in another embodiment, the mean dislocation density (MDD) of the particles of the treated powder or powder mixture which are contained in the component at any step of the method after the treatment of the powder or powder mixture is between 1.2*10¹² and 9.8*10¹⁸ m⁻²; or for example in another embodiment, the mean dislocation density (MDD) at least in some areas of the component surface is between 1.2*10¹² and 9.8*10¹⁸ m⁻². On the other hand, the inventor has found that for some applications in addition to setting the mean dislocation densities to the values given above it may be advantageous to also quantify the energy introduced into the powder as described in the preceding paragraphs of this document. The inventor has found that in some treatments, it may be advantageous to perform the treatment of the powder or powder mixture, such that there is a significant increase in the mean dislocation density, which means higher mean dislocation densities after applying such treatment. In an embodiment, there is a significant increase of the mean dislocation density during the treatment of the powder or powder mixture. For certain applications, it may be surprisingly advantageous that during the whole method there is a significant increase in the mean dislocation density (as defined in this document) of the particles of the treated powder or powder mixture which are contained in the component (often, at certain stages during the whole method, the particles of the treated powder or powder mixture are bond to each other in a way that it is difficult or even impossible to discriminate between them, but that does not pose a significant challenge in the determination of the mean dislocation density which can be determined for separate powder particles and also for components resulting of the consolidation of such powder particles). In an embodiment, there is a significant increase in the mean dislocation density (as defined in this document) during the application of the method steps. For certain particular applications, it may be particularly advantageous that the significant increase in the mean dislocation density (as defined in this document) takes place at least in some areas of the component surface. In an embodiment, there is a significant increase in the mean dislocation density (as defined in this document) at least in some areas of the component surface. The feature “significant increase of the mean dislocation density” is defined throughout this document in the form of different alternatives that are explained in detail below. In an embodiment, significant increase of the mean dislocation density refers to an increase of 1.5 times or more. In an alternative embodiment, significant increase of the mean dislocation density refers to an increase of 2.1 times or more. In another alternative embodiment, significant increase of the mean dislocation density refers to an increase of 5.1 times or more. In another alternative embodiment, significant increase of the mean dislocation density refers to an increase of 7.7 times or more. In another alternative embodiment, significant increase of the mean dislocation density refers to an increase of 10.2 times or more. In another alternative embodiment, significant increase of the mean dislocation density refers to an increase of 15.2 times or more. In another alternative embodiment, significant increase of the mean dislocation density refers to an increase of 26 times or more. All the embodiments disclosed above can be combined with any other embodiment disclosed in this document that relates to a “significant increase of the mean dislocation density” in any combination, provided that they are not mutually exclusive, for example, in an embodiment, there is a significant increase of 1.5 times or more in the mean dislocation density at least in some areas of the component surface; or for example, in another embodiment, there is a significant increase of 1.5 times or more in the mean dislocation density during the application of the method steps; or for example, in another embodiment, there is a significant increase of 1.5 times or more in the mean dislocation density during the treatment of the powder or powder mixture. The inventor has found that for some applications, it may be surprisingly advantageous that during the whole method there is a significant increase in the mean dislocation density (as defined in this document), and afterwards a significant decrease in the mean dislocation density (as defined in this document) of the particles of the treated powder or powder mixture which are contained in the component (often, at certain stages during the whole method, the particles of the treated powder or powder mixture are bond to each other in a way that it is difficult or even impossible to discriminate between them, but that does not pose a significant challenge in the determination of the mean dislocation density which can be determined for separate powder particles and also for components resulting of the consolidation of such powder particles). In an embodiment, there is a significant increase in the mean dislocation density (as defined in this document), and afterwards a significant decrease in the mean dislocation density (as defined in this document) during the application of the method steps. For certain applications, it may be particularly advantageous that the significant increase and subsequent significant decrease in the mean dislocation density (as defined in this document) takes place at least in some areas of the component surface. In an embodiment, there is a significant increase in the mean dislocation density (as defined in this document), and afterwards a significant decrease in the mean dislocation density (as defined in this document) at least in some areas of the component surface. For certain particular applications, it may be particularly advantageous that there is a significant increase in the mean dislocation density (as defined in this document), and afterwards a significant decrease in the mean dislocation density (as defined in this document) of the particles of the powder or powder mixture during the step of applying a treatment to the powder or powder mixture. In an embodiment, there is a significant increase in the mean dislocation density (as defined in this document), and afterwards a significant decrease in the mean dislocation density (as defined in this document) during the step of applying a treatment to the powder or powder mixture. The feature “significant decrease of the mean dislocation density” is defined throughout this document in the form of different alternatives that are explained in detail below. In an embodiment, a significant decrease refers to a decrease of 0.67 times or more. In an alternative embodiment, a significant decrease refers to a decrease of 0.48 times or more. In another alternative embodiment, a significant decrease refers to a decrease of 0.19 times or more. In another alternative embodiment, a significant decrease refers to a decrease of 0.13 times or more. In another alternative embodiment, a significant decrease refers to a decrease of 0.098 times or more. In another alternative embodiment, a significant decrease refers to a decrease of 0.066 times or more. In another alternative embodiment, a significant decrease refers to a decrease of 0.038 times or more. All the embodiments disclosed above can be combined with any other embodiment disclosed in this document that relates to “a significant decrease of the mean dislocation density” in any combination, provided that they are not mutually exclusive. All the embodiments disclosed above can be combined among them and with any other embodiment disclosed in this document in any combination, provided that they are not mutually exclusive, for example, in an embodiment, there is a significant increase of 1.5 times or more, and afterwards a significant decrease of 0.038 times or more in the mean dislocation density during the application of the method steps; or for example, in another embodiment, there is a significant increase of 1.5 times or more, and afterwards a significant decrease of 0.038 times or more in the mean dislocation density at least in some areas of the component surface; or for example, in another embodiment, there is a significant increase of 1.5 times or more, and afterwards a significant decrease of 0.038 times or more in the mean dislocation density during the treatment of the powder or powder mixture. The inventor has found that for some applications, it may be surprisingly advantageous that during the whole method there is a significant increase in the mean dislocation density (as defined in this document), and afterwards a significant decrease in the mean dislocation density (as defined in this document), and finally a significant increase in the mean dislocation density (as defined in this document) of the particles of the treated powder or powder mixture which are contained in the component (often, at certain stages during the whole method, the particles of the treated powder or powder mixture are bond to each other in a way that it is difficult or even impossible to discriminate between them, but that does not pose a significant challenge in the determination of the mean dislocation density which can be determined for separate powder particles and also for components resulting of the consolidation of such powder particles). In an embodiment, there is a significant increase in the mean dislocation density (as defined in this document), afterwards a significant decrease in the mean dislocation density (as defined in this document), and finally a significant increase in the mean dislocation density (as defined in this document) during the application of the method steps. For certain applications, it may be particularly advantageous that the significant increase, subsequent significant decrease and final significant increase in the mean dislocation density (as defined in this document) takes place at least in some areas of the component surface. In an embodiment, there is a significant increase in the mean dislocation density (as defined in this document), afterwards a significant decrease in the mean dislocation density (as defined in this document), and finally a significant increase in the mean dislocation density (as defined in this document) at least in some areas of the component surface. For certain particular applications, it may be particularly advantageous that there is a significant increase in the mean dislocation density (as defined in this document), afterwards a significant decrease in the mean dislocation density (as defined in this document), and finally a significant increase in the mean dislocation density (as defined in this document) of the particles of the powder or powder mixture during the step of applying a treatment to the powder or powder mixture. In an embodiment, there is a significant increase in the mean dislocation density (as defined in this document), afterwards a significant decrease in the mean dislocation density (as defined in this document), and finally a significant increase in the mean dislocation density (as defined in this document) during the step of applying a treatment to the powder or powder mixture. The dislocation density values indicated, and their increase or decrease may be calculated, for example, using any of the different alternatives that are detailed below. In an embodiment, the dislocation density is evaluated by Williamson-Hall method. In an alternative embodiment, the dislocation density is evaluated by Williamson Hall method modified by Ungar and Borbely method. In another alternative embodiment, the dislocation density is evaluated by Warren-Averbach method. In another alternative embodiment, the dislocation density is evaluated by Warren-Averbach method modified by Ungar. Both models can be executed in the same fashion as in doi:10.3390/ma13235355 (Muiruri et al.). The above disclosed values of mean dislocation density (MDD) can alternatively be obtained by techniques involving destructive testing (DT) of the component (or at least part of the component). In different embodiments, the mean dislocation density (MDD) can alternatively be measured by Transmission Electron Microscopy (TEM) or by Scanning Electron Microscopy (SEM) with Electron Backscatter Diffraction (EBSD) technique or by X-ray diffraction (XRD) or by High-Resolution X-ray Diffraction (HRXRD) or by neutron diffraction techniques or by microhardness testing or by Atomic Force Microscopy (AFM) or by Neutron Diffraction or even by ultrasonic measurements. Throughout this document, unless otherwise stated, dislocation density refers to mean dislocation density. All the embodiments disclosed above can be combined among them and with any other embodiment disclosed in this document in any combination, provided that they are not mutually exclusive, for example, in an embodiment, there is a significant increase of 1.5 times or more, afterwards a significant decrease of 0.038 times or more, and finally a significant increase of 1.5 times or more in the mean dislocation density during the application of the method steps; or for example, in another embodiment, there is a significant increase of 1.5 times or more, afterwards a significant decrease of 0.038 times or more, and finally a significant increase of 1.5 times or more in the mean dislocation density at least in some areas of the component surface; or for example, in another embodiment, there is a significant increase of 1.5 times or more, afterwards a significant decrease of 0.038 times or more, and finally a significant increase of 1.5 times or more in the mean dislocation density during the treatment of the powder or powder mixture.

For some applications, it has been found that it may be advantageous to control the parameter PAD1 during the treatment of the powder or powder mixture, wherein PAD1=1*10^{-b 6}*√MDD, being MDD the mean dislocation density in m⁻². In different embodiments, PAD1 is 11 or more, 20 or more, 30 or more, 35 or more, 40 or more, 50 or more, 70 or more and even 105 or more. On the other hand, excessive values should be disadvantageous. In different embodiments, PDA1 is 390 or less, 280 or less, 190 or less, 140 or less, 98 or less, and even 84 or less. In an embodiment, the values of the parameter PDA1 disclosed above refer to the values of the parameter PDA1 before, during and/or after the application of any step of the method after the treatment of the powder or powder mixture. In an alternative embodiment, the values of the parameter PDA1 disclosed above refer to the values of the parameter PDA1 at least in some areas of the component surface. For certain particular applications, it may be also advantageous to ensure a value of the parameter PAD1 during and/or at the end of the step of applying a treatment to the powder or powder mixture. In another alternative embodiment, the values of the parameter PDA1 disclosed above refer to the values of the parameter PDA1 during and/or at the end of the step of applying a treatment to the powder or powder mixture. In any event, the skilled person will know how to set the desired values of the values of the parameter PDA1 as given above by modifying the parameters of the method steps. All the embodiments disclosed above can be combined among them and with any other embodiment disclosed in this document in any combination, provided that they are not mutually exclusive, for example, in an embodiment, the value of the parameter PAD1 during the application of the method steps is between 11 and 390, being PAD1=1*10⁻⁶*√MDD, wherein MDD is the mean dislocation density in m⁻²; or for example, in another embodiment, the value of the parameter PAD1 at least in some areas of the component surface is between 11 and 390, being PAD1=1*10⁻⁶*√MDD, wherein MDD is the mean dislocation density in m⁻²; or for example, in another embodiment, the value of the parameter PAD1 after the application of the treatment is between 11 and 390, being PAD1=1*10⁻⁶*√MDD, wherein MDD is the mean dislocation density in m⁻². The inventor has found that for some applications, it may be advantageous to treat the powder or powder mixture so that there is a significant increase in PAD1 (as defined in this document), which means higher PAD1 values after applying such treatment. In an embodiment, there is a significant increase in PAD1 (as defined in this document) during the treatment of the powder or powder mixture. For certain applications, it may be surprisingly advantageous that during the whole method there is a significant increase in PAD1 (as defined in this document). In an embodiment, there is a significant increase in PAD1 (as defined in this document) during the application of the method steps. For certain particular applications, it may be particularly advantageous that the significant increase in PAD1 (as defined in this document) takes place at least in some areas of the component surface. In an embodiment, there is a significant increase in PAD1 (as defined in this document) at least in some areas of the component surface. The feature “significant increase in PAD1” is defined throughout this document in the form of different alternatives that are explained in detail below. In an embodiment, a significant increase in PAD1, means adding 2 to the value of PAD1. In an alternative embodiment, a significant increase in PAD1, means adding 5 to the value of PAD1. In another alternative embodiment, a significant increase in PAD1, means adding 8 to the value of PAD1. In another alternative embodiment, a significant increase in PAD1, means adding 10 to the value of PAD1. In another alternative embodiment, a significant increase in PAD1, means adding 20 to the value of PAD1. In another alternative embodiment, a significant increase in PAD1, means adding 30 to the value of PAD1. All the embodiments disclosed above can be combined with any other embodiment disclosed in this document that relates to a “significant increase in PAD1” in any combination, provided that they are not mutually exclusive. The inventor has found that for some applications, it may be surprisingly advantageous that during the whole method there is a significant increase in PAD1 (as defined in this document), and afterwards a significant decrease in PAD1 (as defined in this document). In an embodiment, there is a significant increase in PAD1 (as defined in this document) and afterwards a significant decrease in PAD1 (as defined in this document) during the application of the method steps. For certain applications, it may be particularly advantageous that the significant increase and subsequent significant decrease in PAD1 (as defined in this document) takes place at least in some areas of the component surface. In an embodiment, there is a significant increase in PAD1 (as defined in this document), and afterwards a significant decrease in PAD1 (as defined in this document) at least in some areas of the component surface. For certain particular applications, it may be particularly advantageous that there is a significant increase in PAD1 (as defined in this document), and afterwards a significant decrease in PAD1 (as defined in this document) during the step of applying a treatment to the powder or powder mixture. In an embodiment, there is a significant increase in PAD1 (as defined in this document), and afterwards a significant decrease in PAD1 (as defined in this document) during the step of applying a treatment to the powder or powder mixture. The feature “significant decrease in PAD1” is defined throughout this document in the form of different alternatives that are explained in detail below. In an embodiment, significant decrease in PAD1, means subtracting 2 from the value of PAD1. In an alternative embodiment, significant decrease in PAD1, means subtracting 5 from the value of PAD1. In another alternative embodiment, significant decrease in PAD1, means subtracting 8 from the value of PAD1. In another alternative embodiment, significant decrease in PAD1, means subtracting 10 from the value of PAD1. In another alternative embodiment, significant decrease in PAD1, means subtracting 20 from the value of PAD1. In another alternative embodiment, significant decrease in PAD1, means subtracting 30 from the value of PAD1. All the embodiments disclosed above can be combined with any other embodiment disclosed in this document that relates to “a significant decrease in PAD1” in any combination, provided that they are not mutually exclusive. The inventor has found that for some applications, it may be surprisingly advantageous that during the whole method there is a significant increase in PAD1 (as defined in this document), afterwards a significant decrease in PAD1 (as defined in this document), and finally a significant increase in PAD1 (as defined in this document). In an embodiment, there is a significant increase in PAD1 (as defined in this document), afterwards a significant decrease in PAD1 (as defined in this document), and finally a significant increase in PAD1 (as defined in this document) during the application of the method steps. For certain applications, it may be particularly advantageous that the significant increase, subsequent significant decrease, and final significant increase in PAD1 (as defined in this document) takes place at least in some areas of the component surface. In an embodiment, there is a significant increase in PAD1 (as defined in this document), afterwards a significant decrease in PAD1 (as defined in this document), and finally a significant increase in PAD1 (as defined in this document) at least in some areas of the component surface. For certain particular applications, it may be particularly advantageous that there is a significant increase in PAD1 (as defined in this document), afterwards a significant decrease PAD1 (as defined in this document), and finally a significant increase in PAD1 (as defined in this document) during the step of applying a treatment to the powder or powder mixture. In an embodiment, there is a significant increase in PAD1 (as defined in this document), afterwards a significant decrease in PAD1 (as defined in this document), and finally a significant increase in PAD1 (as defined in this document) during the step of applying a treatment to the powder or powder mixture. All the embodiments disclosed above can be combined among them and with any other embodiment disclosed in this document in any combination, provided that they are not mutually exclusive, for example, in an embodiment, there is a significant increase in the value of PAD1 during the application of the method steps, wherein a significant increase in PAD1 means adding 2 to the value of PAD1, being PAD1=1*10⁻⁶*√MDD, wherein MDD is the mean dislocation density in m⁻²; or for example in another embodiment, there is a significant increase and afterwards a significant decrease in the value of PAD1, being PAD1=1*10^{-6*√}MDD, wherein MDD is the mean dislocation density in m⁻², during the application of the method steps, wherein a significant increase in PAD1 means adding 2 to the value of PAD1 and a significant decrease in PAD1 means subtracting 2 from to the value of PAD1.

The inventor has found that there are numerous applications which can also benefit from the treatment disclosed in the preceding paragraphs, such as for example, but not limited to, the development of certain materials, some of which are disclosed later in this document.

For certain particular applications of the method, the treatment of the powder or powder mixture may be optional, and thus can be avoided. In an embodiment, the step of applying energy into the powder or powder mixture through mechanical action is skipped.

All the embodiments disclosed above can be combined among them and with any other embodiment disclosed in this document in any combination, provided that they are not mutually exclusive, for example, in an embodiment, a method of manufacturing metal comprising components, which method comprises the steps of: providing a powder or powder mixture comprising at least a metal or a metal-based alloy; optionally, applying a treatment to the powder or powder mixture, wherein the treatment of the powder or powder mixture comprises applying energy into the powder or powder mixture through mechanical action such that welding occurs; and shaping the treated powder or powder mixture using a metal additive manufacturing (MAM) method.

Very surprisingly, the inventor has found that in for some applications of the method, for % C, % O, % N, % H and/or % B elements, contrary to what is normally believed, it is not only the final values of these elements that matters, but it is capital to control their levels in different steps of the method. In this regard, for some applications, having powders with an appropriate % C, % O, % N, % H and/or % B content (as defined in this document) during and/or after the treatment may, among others, help to control the yield strength of some manufactured components. In an embodiment, the powder or powder mixture has an appropriate % C, % O, % N, % H and/or % B content at any time during the treatment of the powder or powder mixture. In any event, the skilled person will know how to set the desired values of the content of % C, % O, % N, % H and/or % B elements as given below.

For some applications, treated powders having an appropriate carbon (% C) content may be preferred. In an embodiment, the treated powder or powder mixture comprises an appropriate % C content. The feature “appropriate % C content” is defined throughout this document in the form of different alternatives that are explained in detail below. In different embodiments, an appropriate % C content is a carbon content of 0.1 wt % or more, 0.19 wt % or more, 0.36 wt % or more, 1.06 wt % or more, 1.36 wt % or more and even 2.1 wt % or more. On the other hand, an excessively high carbon content may be detrimental for some applications. In different embodiments, an appropriate % C content is a carbon content of 3.9 wt % or less, 2.19 wt % or less, 1.69 wt % or less, 1.19 wt % or less, 0.79 wt % or less, and even 0.39 wt % or less. For some applications, at least one of the powders having an appropriate carbon content (as defined in this document) may be preferred. In another embodiment, at least one of the treated powders in the mixture comprises an appropriate % C content. All the embodiments disclosed above can be combined among them and with any other embodiment disclosed in this document that relates to “appropriate % C content” in any combination, provided that they are not mutually exclusive. All the values and ranges of the different embodiments disclosed above can be combined among them and with any other embodiment disclosed in this document in any combination, provided that they are not mutually exclusive, for example, in an embodiment, the treated powder or powder mixture comprises an appropriate % C content, wherein an appropriate % C content is a carbon content between 0.1 wt % and 3.9 wt %; or for example, in another embodiment, between 0.1 wt % and 2.19 wt %; or for example, in another embodiment, between 0.19 wt % and 2.19 wt %.

Additionally or alternatively, for some applications, treated powders having an appropriate oxygen (% O) content may be preferred. In an embodiment, the treated powder or powder mixture comprises an appropriate % O content. The feature “appropriate % O content” is defined throughout this document in the form of different alternatives that are explained in detail below. In different embodiments, an appropriate % O content is an oxygen content of 160 ppm or more, 310 ppm or more, 910 ppm or more, 2100 ppm or more and even 5100 ppm or more. On the other hand, an excessively high oxygen content may be detrimental for some applications. In different embodiments, an appropriate % O content is an oxygen content of 49000 ppm or less, 24000 ppm or less, 6000 ppm or less, 3900 ppm or less, 1400 ppm or less, 600 ppm or less, and even 390 ppm or less. For some applications, at least one of the powders having an appropriate oxygen content (as defined in this document) may be preferred. In another embodiment, at least one of the treated powders in the mixture comprises an appropriate % O content. All the embodiments disclosed above can be combined among them and with any other embodiment disclosed in this document that relates to “appropriate % O content” in any combination, provided that they are not mutually exclusive. All the values and ranges of the different embodiments disclosed above can be combined among them and with any other embodiment disclosed in this document in any combination, provided that they are not mutually exclusive, for example, in an embodiment, the treated powder or powder mixture comprises an appropriate % O content, wherein an appropriate % O content is an oxygen content between 160 and 49000 ppm; or for example, in another embodiment, between 160 and 24000 ppm.

Additionally or alternatively, for some applications, treated powders having an appropriate nitrogen (% N) content may be preferred. In an embodiment, the treated powder or powder mixture comprises an appropriate % N content. In another embodiment, at least one of the treated powders in the mixture comprises an appropriate % N content. The feature “appropriate % N content” is defined throughout this document in the form of different alternatives that are explained in detail below. In different embodiments, an appropriate % N content is a nitrogen content of 16 ppm or more, 56 ppm or more, 160 ppm or more, 360 ppm or more, 560 ppm or more and even 2600 ppm or more. On the other hand, an excessively high nitrogen content may be detrimental for some applications. In different embodiments, an appropriate % N content is a nitrogen content of 19400 ppm or less, 4900 ppm or less, 1900 ppm or less, 840 ppm or less, 390 ppm or less, and even 190 ppm or less. For some applications, at least one of the powders having an appropriate nitrogen content (as defined in this document) may be preferred. In another embodiment, at least one of the treated powders in the mixture comprises an appropriate % N content. All the embodiments disclosed above can be combined among them and with any other embodiment disclosed in this document that relates to “appropriate % N content” in any combination, provided that they are not mutually exclusive. All the values and ranges of the different embodiments disclosed above can be combined among them and with any other embodiment disclosed in this document in any combination, provided that they are not mutually exclusive, for example, in an embodiment, the treated powder or powder mixture comprises an appropriate % N content, wherein an appropriate % N content is a nitrogen content between 16 and 19400 ppm; or for example, in another embodiment, between 16 and 4900 ppm.

Additionally or alternatively, for some applications, treated powders having an appropriate hydrogen (% H) content may be preferred. In an embodiment, the treated powder or powder mixture comprises an appropriate % H content. In another embodiment, at least one of the treated powders in the mixture comprises an appropriate % H content. The feature “appropriate % H content” is defined throughout this document in the form of different alternatives that are explained in detail below. In different embodiments, an appropriate % H content is a hydrogen content of 0.01 ppm or more, 0.6 ppm or more, 1 ppm or more, 12 ppm or more, 61 ppm or more, 210 ppm or more and even 510 ppm or more. On the other hand, an excessively high hydrogen content may be detrimental for some applications. In different embodiments, an appropriate % H content is a hydrogen content of 8400 ppm or less, 3400 ppm or less, 1400 ppm or less, 590 ppm or less, and even 290 ppm or less. For some applications, at least one of the powders having an appropriate hydrogen content (as defined in this document) may be preferred. In another embodiment, at least one of the treated powders in the mixture comprises an appropriate % H content. All the embodiments disclosed above can be combined among them and with any other embodiment disclosed in this document that relates to “appropriate % H content” in any combination, provided that they are not mutually exclusive. All the values and ranges of the different embodiments disclosed above can be combined among them and with any other embodiment disclosed in this document in any combination, provided that they are not mutually exclusive, for example, in an embodiment, the treated powder or powder mixture comprises an appropriate % H content, wherein an appropriate % H content is a hydrogen content between 0.01 and 8400 ppm; or for example, in another embodiment, between 6 and 3400 ppm.

Additionally or alternatively, for some applications, treated powders having an appropriate boron (% B) content may be preferred. In an embodiment, the treated powder or powder mixture comprises an appropriate % B content. In another embodiment, at least one of the treated powders in the mixture comprises an appropriate % B content. The feature “appropriate % B content” is defined throughout this document in the form of different alternatives that are explained in detail below. In different embodiments, an appropriate % B content is a boron content of 0.01 ppm or more, 0.6 ppm or more, 3 ppm or more, 31 ppm or more, 126 ppm or more, 560 ppm or more, 1100 ppm or more and even 3600 ppm or more. On the other hand, an excessively high boron content may be detrimental for some applications. In different embodiments, an appropriate % B content is a boron content of 44000 ppm or less, 19000 ppm or less, 9000 ppm or less, 1900 ppm or less, 790 ppm or less, 390 ppm or less, and even 89 ppm or less. For some applications, at least one of the powders having an appropriate boron content (as defined in this document) may be preferred. In another embodiment, at least one of the treated powders in the mixture comprises an appropriate % B content. All the embodiments disclosed above can be combined among them and with any other embodiment disclosed in this document that relates to “appropriate % B content” in any combination, provided that they are not mutually exclusive. All the values and ranges of the different embodiments disclosed above can be combined among them and with any other embodiment disclosed in this document in any combination, provided that they are not mutually exclusive, for example, in an embodiment, the treated powder or powder mixture comprises an appropriate % B content, wherein an appropriate boron content is a boron content between 0.01 and 44000 ppm; or for example, in another embodiment, between 0.6 and 19000 ppm.

All the embodiments disclosed above can be combined among them and with any other embodiment disclosed in this document in any combination provided that they are not mutually exclusive.

Optionally, the method may further comprise a step wherein at least one additional powder is added to the treated powder or powder mixture. In an embodiment, the method further comprises the step of: adding at least one powder to the treated powder or powder mixture. In this respect, the inventor has found that the amount of energy used to mix these materials should be controlled. In an embodiment, the amount of energy used to perform the mixing of the treated powder or powder mixture with the added powder or powders is less than the amount of energy used in the treatment of the powder or powder mixture. In such cases, optionally, the method may further comprise a step wherein a treatment which comprises applying energy through mechanical action (as described above) is applied to the mixture of the treated powder or powder mixture and the added powder or powders. In an embodiment, the method further comprises the step of: applying a treatment to the mixture of the treated powder or powder mixture and the added powder.

All the embodiments disclosed above can be combined among them and with any other embodiment disclosed in this document in any combination, provided that they are not mutually exclusive, for example, in an embodiment, a method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; adding at least one more powder to the treated powder or powder mixture; and shaping the treated powder or powder mixture using a metal additive manufacturing (MAM) method; or for example in another embodiment, a method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; adding at least one more powder to the treated powder or powder mixture; applying a treatment comprising applying energy through mechanical action into the mixture of the treated powder or powder mixture with the at least one more powder added; and shaping the treated powder or powder mixture using a metal additive manufacturing (MAM) method.

Optionally, the method may further comprise a step wherein the treated powder or powder mixture is preconditioned to ensure a certain % C, % O, % N, % H and/or % B content prior to apply the forming step. In an embodiment, the method further comprises the step of: applying a preconditioning step to the treated powder or powder mixture. The inventor has found that the preconditioning step may be particularly important for some mechanical properties of certain manufactured components such as, for example, mechanical strength, elongation and/or toughness, among others. In any event, the skilled person will know how to set the desired values of the content of % C, % O, % N, % H and/or % B elements as given below. This preconditioning step may advantageously be performed at any time prior to the forming step (e.g., after the treatment of the powder or powder mixture).

As described above, for some applications of the method, it may be important to ensure a certain carbon (% C) content after the preconditioning step. In an embodiment, the treated powder or powder mixture comprises a certain % C content prior to apply the metal additive manufacturing (MAM) method. The feature “certain % C content” is defined throughout this document in the form of different alternatives that are explained in detail below. In different embodiments, a certain % C content is a carbon content of 0.01 ppm or more, 0.6 ppm or more, 60 ppm or more, 260 ppm or more, 0.096 wt % or more, 0.16 wt % or more, 0.31 wt % or more, 1.06 wt % or more, 1.26 wt % or more and even 2.1 wt % or more. On the other hand, an excessively high carbon content may be detrimental for some applications of the method. In different embodiments, a certain % C content is a carbon content of 3.9 wt % or less, 2.19 wt % or less, 1.49 wt % or less, 1.09 wt % or less, 0.69 wt % or less, and even 0.38 wt % or less. For some applications, at least one of the powders having a certain carbon content (as defined in this document) may be preferred. In another embodiment, at least one of the treated powders in the mixture comprises a certain % C content. All the embodiments disclosed above can be combined among them and with any other embodiment disclosed in this document that relates to “certain % C content” in any combination, provided that they are not mutually exclusive. All the values and ranges of the different embodiments disclosed above can be combined among them and with any other embodiment disclosed in this document in any combination, provided that they are not mutually exclusive, for example, in an embodiment, the treated powder or powder mixture comprises a certain % C content, wherein a certain % C content is a carbon content between 0.01 ppm and 3.9 wt %; or for example, in another embodiment, between 0.6 ppm and 2.19 wt %; or for example, in another embodiment, between 60 ppm and 2.19 wt % after the preconditioning step.

Additionally or alternatively, for some applications of the method, it may be important to ensure a certain oxygen (% O) content after the preconditioning step. In an embodiment, the treated powder or powder mixture comprises a certain % O content prior to apply the metal additive manufacturing (MAM) method. The feature “certain % O content” is defined throughout this document in the form of different alternatives that are explained in detail below. In different embodiments, a certain % O content is an oxygen content of 0.01 ppm or more, 0.6 ppm or more, 56 ppm or more, 210 ppm or more, 610 ppm or more, 1600 ppm or more and even 5100 ppm or more. On the other hand, an excessively high oxygen content may be detrimental for some applications of the method. In different embodiments, a certain % O content is an oxygen content of 23900 ppm or less, 11900 ppm or less, 4900 ppm or less, 1200 ppm or less, 790 ppm or less, 490 ppm or less, and even 340 ppm or less. For some applications at least one of the powders having a certain oxygen content (as defined in this document) may be preferred. In another embodiment, at least one of the treated powders in the mixture comprises a certain % O content. All the embodiments disclosed above can be combined among them and with any other embodiment disclosed in this document that relates to “certain % O content” in any combination, provided that they are not mutually exclusive. All the values and ranges of the different embodiments disclosed above can be combined among them and with any other embodiment disclosed in this document in any combination, provided that they are not mutually exclusive, for example, in an embodiment, the treated powder or powder mixture comprises a certain % O content, wherein a certain % O content is an oxygen content between 0.01 and 23900 ppm; or for example, in another embodiment, between 0.6 and 11900 ppm; or for example, in another embodiment, between 56 and 4900 ppm.

Additionally or alternatively, for some applications of the method, it may be important to ensure a certain nitrogen (% N) content after the preconditioning step. In an embodiment, the treated powder or powder mixture comprises a certain % N content prior to apply the metal additive manufacturing (MAM) method. The feature “certain % N content” is defined throughout this document in the form of different alternatives that are explained in detail below. In different embodiments, a certain % N content is a nitrogen content of 0.01 ppm or more, 0.6 ppm or more, 6 ppm or more, 36 ppm or more, 110 ppm or more, 310 ppm or more, 510 ppm or more and even 2600 ppm or more. On the other hand, an excessively high nitrogen content may be detrimental for some applications of the method. In different embodiments, a certain % N content is a nitrogen content of 0.44 wt % or less, 0.19 wt % or less, 11900 ppm or less, 3900 ppm or less, 1200 ppm or less, 740 ppm or less, 340 ppm or less, and even 140 ppm or less. For some applications, at least one of the powders having a certain nitrogen content (as defined in this document) may be preferred. In another embodiment, at least one of the treated powders in the mixture comprises a certain % N content. All the embodiments disclosed above can be combined among them and with any other embodiment disclosed in this document that relates to “certain % N content” in any combination, provided that they are not mutually exclusive. All the values and ranges of the different embodiments disclosed above can be combined among them and with any other embodiment disclosed in this document in any combination, provided that they are not mutually exclusive, for example, in an embodiment, the treated powder or powder mixture comprises a certain % N content, wherein a certain % N content is a nitrogen content between 0.01 ppm and 0.44 wt %; or for example, in another embodiment, between 0.6 ppm and 0.19 wt %; or for example, in another embodiment, between 6 and 11900 ppm.

Additionally or alternatively, for some applications of the method, it may be important to ensure a certain hydrogen (% H) content after the preconditioning step. In an embodiment, the treated powder or powder mixture comprises a certain % H content prior to apply the metal additive manufacturing (MAM) method. The feature “certain % H content” is defined throughout this document in the form of different alternatives that are explained in detail below. In different embodiments, a certain % H content is a hydrogen content of 0.01 ppm or more, 0.6 ppm or more, 1 ppm or more, 6 ppm or more, 51 ppm or more, 110 ppm or more and even 510 ppm or more. On the other hand, an excessively high hydrogen content may be detrimental for some applications of the method. In different embodiments, a certain % H content is a hydrogen content of 29000 ppm or less, 6400 ppm or less, 1900 ppm or less, 890 ppm or less, 390 ppm or less, and even 140 ppm or less. For some applications, at least one of the powders having a certain hydrogen content (as defined in this document) may be preferred. In another embodiment, at least one of the treated powders in the mixture comprises a certain % H content. All the embodiments disclosed above can be combined among them and with any other embodiment disclosed in this document that relates to “certain % H content” in any combination, provided that they are not mutually exclusive. All the values and ranges of the different embodiments disclosed above can be combined among them and with any other embodiment disclosed in this document in any combination, provided that they are not mutually exclusive, for example, in an embodiment, the treated powder or powder mixture comprises a certain % H content, wherein a certain % H content is an hydrogen content between 0.01 and 29000 ppm; or for example, in another embodiment, between 0.6 and 6400 ppm; or for example, in another embodiment, between 1 and 1900 ppm.

Additionally or alternatively, for some applications of the method, it may be important to ensure a certain boron (% B) content after the preconditioning step. In an embodiment, the treated powder or powder mixture comprises a certain % B content prior to apply the metal additive manufacturing (MAM) method. The feature “certain % B content” is defined throughout this document in the form of different alternatives that are explained in detail below. In different embodiments, a certain % B content is a boron content of 0.01 ppm or more, 0.6 ppm or more, 1 ppm or more, 21 ppm or more, 106 ppm or more, 360 ppm or more, 810 ppm or more and even 3600 ppm or more. On the other hand, an excessively high boron content may be detrimental for some applications of the method. In different embodiments, a certain % B content is a boron content of 0.9 wt % or less, 0.14 wt % or less, 340000 ppm or less, 14000 ppm or less, 4900 ppm or less, 1200 ppm or less, 690 ppm or less, 290 ppm or less, and even 84 ppm or less. For some applications, at least one of the powders having a certain boron content (as defined in this document) may be preferred. In another embodiment, at least one of the treated powders in the mixture comprises a certain % B content. All the embodiments disclosed above can be combined among them and with any other embodiment disclosed in this document that relates to “certain % B content” in any combination, provided that they are not mutually exclusive. All the values and ranges of the different embodiments disclosed above can be combined among them and with any other embodiment disclosed in this document in any combination, provided that they are not mutually exclusive, for example, in an embodiment, the treated powder or powder mixture comprises a certain % B content, wherein a certain % B content is an boron content between 0.01 ppm and 0.9 wt %; or for example, in another embodiment, between 0.6 ppm and 0.14 wt; or for example, in another embodiment, between 1 and 34000 ppm.

Optionally, the method may further comprise a step wherein the sphericity of the powders (or at least of part of the powders) is modified (also referred to as the spheroidization treatment) prior to applying the forming step. In an embodiment, the method further comprises the step of: applying a spheroidization treatment. In this respect, the inventor has surprisingly found that the introduction of a mechanical spheroidization process is of great advantage for the final achievable mechanical properties of some components, in particular for those properties related to toughness, fatigue life, elastic limit, surface roughness and/or dimensional accuracy. The spheroidization treatment may be advantageously be performed at any time between the treatment of the powder or powder mixture and the forming step. Often, it may be advantageous to perform the spheroidization treatment simultaneously (sequentially) with other method steps (e.g. in some embodiments, the spheroidization treatment can be performed during the treatment of the powder or powder mixture and/or can be integrated with the preconditioning treatment). In an embodiment, the spheroidization step is performed simultaneously (sequentially) with other method steps. In different embodiments, the increase in sphericity after the application of the spheroidization step is at least 6%, at least 12%, at least 26%, at least 41%, and even at least 52%. In this regard, the inventor has also found that for some applications of the method, it may be particularly advantageous to start from powders of low sphericity (as defined in this document), and to obtain powders of right sphericity (as defined in this document) after the spheroidization step. In different embodiments, a low sphericity is a sphericity of 69% or less, of 59% or less, of 49% or less, and even of 29% of less. In different embodiments, a right sphericity after the spheroidization step is 71% or more, 82% or more, 92% or more and even 96% or more. For some applications, the spheroidization of the powder can be advantageously performed by mechanical action and without significantly increasing the temperature of the powder. In different embodiments, the temperature in the spheroidization step is 0.75*Tm or less, 0.49*Tm or less, 0.34*Tm or less, 0.24*Tm or less, and even 0.14*Tm or less, wherein Tm is the melting temperature in Kelvin of the powder being processed. A non-limiting example is the action of placing the powder between two flat parallel plates which have a relative movement between them in the plane of parallelism, often of a circular nature (spiral, complex repetitive movement, each plate having a different movement, . . . ). In an alternative embodiment a system which uses high speed mixer blending and impacting can be used to treat the powder or the powder mixture in order to promote the powder surface modification. Other examples may include the use of vibromechanical mills, the application of chemical treatments or techniques, or even the use of coatings. Frequently, each powder may be processed individually in the spheroidization treatment, but in certain specific embodiments, two or more powders can be processed simultaneously, in such cases Tm refers to the melting temperature in Kelvin of the powder mixture (as defined in this document) being processed. In an embodiment, the values of the temperature in the spheroidization treatment disclosed above should be met by at least one of the powders in the mixture. In an alternative embodiment, the values of the temperature in the spheroidization treatment disclosed above should be met by at least two of the powders in the mixture. In another alternative embodiment, the values of the temperature in the spheroidization treatment disclosed above should be met by all the powders in the mixture. In an embodiment, the temperature in the spheroidization step means the maximum temperature reached in the spheroidization step. In an alternative embodiment, the temperature in the spheroidization step means the maximum temperature reached in the spheroidization step wherein the maximum temperature is calculated excluding any temperature which is applied for less than a critical time (as defined in this document). In another alternative embodiment, the temperature in the spheroidization step means the mean temperature reached in the spheroidization step. In another alternative embodiment, the temperature in the spheroidization step means the minimum temperature reached in the spheroidization step. In another alternative embodiment, the temperature in the spheroidization step means the minimum temperature reached in the spheroidization step, wherein the minimum temperature is calculated excluding any temperature which is applied for less than a critical time (as defined in this document). In an alternative embodiment, the temperature is applied for a relevant time. For some applications, the spheroidization of the powders can also be carried out at high temperatures (temperatures higher than those disclosed above). In such cases, for example, plasma, induction plasma, inductively coupled plasma, direct-current plasma jet, high-temperature remelting spheroidization technologies or even fluidized bed spheroidization may be used. However, the spheroidization treatment is not limited to the technologies described above. All the embodiments disclosed above can be combined among them and with any other embodiment disclosed in this document in any combination, provided that they are not mutually exclusive, for example, in an embodiment, the method further comprises the step of: applying a spheroidization treatment to the treated powder or powder mixture, which spheroidization treatment is performed at any time between the treatment of the powder or powder mixture and the shaping of the treated powder or powder mixture using a metal additive manufacturing (MAM) method, and wherein the temperature in the spheroidization treatment is 0.75*Tm or less, being Tm the melting temperature in Kelvin of the powder being processed.

In some embodiments, it may also be advantageous to add other substances or materials to the treated powder or powder mixture prior to applying the metal additive manufacturing (MAM) method. Some examples of substances or materials that can be added to the powder or powder mixture include, but are not limited to, metallic materials, metals, metal-based alloys, organic materials, polymers, polymeric materials, binders, resins, fluxes, lubricants, additives, dry coaters, fluidizers, nanoparticle additives, surface functionalized nanoparticles, graphite, ceramic materials, reinforcement particles, ceramic particles, whiskers, graphene, nanotubes, carbon nanotubes and/or mixtures thereof. These substances or materials may be added at any time prior to the application of the spheroidization treatment and/or after the spheroidization treatment.

As explained above, the component, or at least part of the component, can then be formed using a metal additive manufacturing (MAM) method (this step is also referred to as the “forming step”). In this document, the definition of metal additive manufacturing (MAM) method includes any near net shape manufacturing method described throughout this document. In particular, the definition of metal additive manufacturing (MAM) method includes those methods in which the component, or at least part of the component, is manufactured using a mold or capsule, or part of the mold or capsule, that is subsequently filled and subjected to pressure and/or temperature and also includes those methods in which the component is manufactured by means of an additive manufacturing (AM) technology. In an embodiment, the treated powder or powder mixture is formed into a component, or into a part of a component, using a metal additive manufacturing (MAM) method.

With regard to the forming step, the inventor has found that for some applications of the method, the use of metal additive manufacturing (MAM) methods at the right temperature, for example, in certain embodiments where the manufactured components are metallic molds or dies, leads to a very surprising increase in the efficiency, further increasing the durability of the manufactured components disproportionately to the increase of cost. In addition, it has also been found that the use of metal additive manufacturing (MAM) methods at the right temperature may result in some components having exceptionally small grain sizes. In an embodiment, the temperature used in the metal additive manufacturing (MAM) method is the right temperature. The feature “right temperature” is defined throughout this document in the form of different alternatives that are explained in detail below. In different embodiments, the right temperature is a temperature of 0.08*Tm or more, 0.13*Tm or more and even 0.26*Tm or more, wherein Tm is the melting temperature in Kelvin of the powder or powder mixture (as defined in this document) provided. On the other hand, excessive temperatures may cause an undesirable increase in cost for certain applications of the method. In different embodiments, the right temperature is a temperature of 0.74*Tm or less, 0.69*Tm or less, 0.59*Tm or less, 0.54*Tm or less, 0.48*Tm or less, and even 0.39*Tm or less, wherein Tm is the melting temperature in Kelvin of the powder or powder mixture (as defined in this document) provided. All the values and ranges of the different embodiments disclosed above can be combined among them and with any other embodiment disclosed in this document in any combination, provided that they are not mutually exclusive, for example, in an embodiment, the metal additive manufacturing (MAM) method is performed at a right temperature, wherein a right temperature is a temperature between 0.08*Tm and 0.74*Tm, being Tm the melting temperature in Kelvin of the powder or powder mixture provided; or for example, in another embodiment, the metal additive manufacturing (MAM) method is performed at a right temperature, wherein a right temperature is a temperature between 0.08*Tm and 0.69Tm, being Tm the melting temperature in Kelvin of the powder or powder mixture provided; or for example, in another embodiment, the metal additive manufacturing (MAM) method is performed at a right temperature, wherein a right temperature is a temperature between, 0.13*Tm and 0.69*Tm, being Tm the melting temperature in Kelvin of the powder or powder mixture provided, or for example, in another embodiment, the metal additive manufacturing (MAM) method is performed at a right temperature, wherein a right temperature is a temperature between 0.08*Tm and 0.74*Tm being Tm the melting temperature in Kelvin of the metallic powder with the lowest melting point in the powder of powder mixture provided; or for example, in another embodiment, the metal additive manufacturing (MAM) method is performed at a right temperature, wherein a right temperature is a temperature between 0.08*Tm and 0.69Tm, being Tm the melting temperature in Kelvin of the metallic powder with the lowest melting point in the powder of powder mixture provided; or for example, in another embodiment, the metal additive manufacturing (MAM) method is performed at a right temperature, wherein a right temperature is a temperature between 0.13*Tm and 0.69*Tm, being Tm the melting temperature in Kelvin of the metallic powder with the lowest melting point in the powder of powder mixture provided; or for example, in another embodiment, the metal additive manufacturing (MAM) method is performed at a right temperature, wherein a right temperature is a temperature between 0.08*Tm and 0.74*Tm being Tm the melting temperature in Kelvin of the metallic powder with the lowest melting point in the powder of powder mixture provided, wherein the melting temperature of such metallic powder is the temperature at which the first metal liquid forms under equilibrium conditions; or for example, in another embodiment, the metal additive manufacturing (MAM) method is performed at a right temperature, wherein a right temperature is a temperature between 0.08*Tm and 0.69Tm, being Tm the melting temperature in Kelvin of the metallic powder with the lowest melting point in the powder of powder mixture provided, wherein the melting temperature of such metallic powder is the temperature at which the first metal liquid forms under equilibrium conditions; or for example, in another embodiment, the metal additive manufacturing (MAM) method is performed at a right temperature, wherein a right temperature is a temperature between 0.13*Tm and 0.69*Tm, being Tm the melting temperature in Kelvin of the metallic powder with the lowest melting point in the powder of powder mixture provided, wherein the melting temperature of such metallic powder is the temperature at which the first metal liquid forms under equilibrium conditions In some embodiments, it may be advantageous to determine the lower limit of the right temperature using the following formula:

$$A * [ ( \frac{Tm - Tm ( Fe )}{{Tm ( Fe )}^{3}} ) + Tm ( Fe ) ]$$

wherein Tm (Fe) is the melting temperature of iron (under equilibrium conditions) expressed in Kelvin and A is a parameter selected, in different embodiments, from 3/23, 5/42 and even 4/29. All the embodiments disclosed above can be combined among them and with any other embodiment disclosed in this document that relates to “right temperature” in any combination, provided that they are not mutually exclusive.

All the embodiments disclosed above can be combined among them and with any other embodiment disclosed in this document in any combination, provided that they are not mutually exclusive, for example, in an embodiment, a method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; and shaping the treated powder or powder mixture using a metal additive manufacturing (MAM) method at a right temperature, wherein a right temperature is a temperature of 0.74*Tm or less, wherein Tm is the melting temperature in Kelvin of the powder or powder mixture.

As explained above, different metal additive manufacturing (MAM) methods can be used to form the component or at least part of the component. In an aspect of the present disclosure, the metal additive manufacturing (MAM) method comprises the use of a mold or capsule having the desired shape of the component to be manufactured (considering the shrinkage that occurs during the manufacturing process and the fact that the final geometry is often achieved with some kind of subtractive manufacturing like machining and/or with other additive manufacturing processes) which is filled with the treated powder or powder mixture and includes the application of a pressure and/or temperature to the filled mold. In an embodiment, according to this aspect of the disclosure, the method comprises the steps of: providing a powder or powder mixture; applying a treatment to the powder or powder mixture, wherein the treatment of the powder or powder mixture comprises applying energy into the powder or powder mixture through mechanical action; providing a mold; filling the mold with the treated powder or powder mixture; and applying a pressure and/or temperature treatment to the filled mold.

A wide variety of materials can be used to manufacture the mold or at least part of the mold. Some examples of materials that can be used to manufacture the mold, or at least part of the mold, include, but are not limited to, organic materials, polymers, polymeric materials, elastomers, thermosetting polymers, thermoplastic polymers, amorphous polymers, amorphous thermoplastic polymers, non-polar polymers, crystalline polymers, semi-crystalline polymers, semi-crystalline thermoplastic polymers and/or mixtures thereof. In an embodiment, the mold is at least partly made of an organic material. In another embodiment, the mold is at least partly made of a material comprising a polymer and/or a polymeric material. In another embodiment, the mold is made of a material consisting of a polymer and/or a polymeric material. In another embodiment, the mold is at least partly made of a material comprising a polymer. In another embodiment, the mold is made of a material consisting of a polymer. In another embodiment, the mold is at least partly made of a material comprising a polymeric material. In another embodiment, the mold is made of a material consisting of a polymeric material. Throughout this document, unless otherwise stated, the polymers encompass their copolymers. Some examples of polymers or polymeric materials that can be used to manufacture the mold, or at least part of the mold, include, but are not limited to, Viton, phenolic resin (PF), ureic resin (UF), melamine resin (MF), polyester resin (UP), epoxy resin (EP), polyethylene sulphide (PPS), ether ketone (EK), polyimide (PI), polystyrene (PS), high impact polystyrene (HIPS), polystyrene copolymer, copolymers comprising acrylonitrile, copolymers comprising styrene, acrylonitrile-butadiene-styrene (ABS), styrene-acrylonitrile (SAN), polycarbonate (PC), polyphenylene oxide (PPO), vinylic polymers (vinyl and related polymers), polyvinyl chloride (PVC), acrylic polymer, polymethylmethacrylate (PMMA), polycaprolactone (PCL), porous polycaprolactone (PCL), polyvinyl acetate (PVA), Kollidon VA64, Kollidon 12PF, polybutylene terephthalate (PBT), polyoxymethylene (POM), polyethylene terephthalate (PET), polyolefin polymer, polymer comprising ethylene monomers, polyethylene (PE), high density polyethylene (HDPE), low density polyethylene (LDPE), polymers comprising propylene monomers, polypropylene (PP), polymers comprising monomers linked by amide bonds, polyamide (PA), PA11, PA11 family materials, PA12, PA12 family materials, PA6, PA6 family materials, PA6-3-T, PA46, polyamide-Imide (PAI), polyethersulfone (PES), polyphenylsulfone (PPSU), polyetherimide (PEI), polysulfone (PSU), polyparaphenylene (PPP), polyether ether ketone (PEEK), polyetherketone (PEK), liquid crystal polymer (LCP), perfluoroalkoxy alkane (PFA), ethylene tetrafluoroethylene (ETFE), polychlorotrifluoroethylene (PCTFE), polyvinylidene fluoride (PVDF), polymethylpentene (PMP), polyphenylene Ether (PPE), nylon, biodegradable polymers, polar polymers, non-polar polymers, agro-polymers (e.g., biomass from agro-resources), biodegradable polymers from microorganisms (e.g., PHA, PHB, . . . ), biodegradable polymers from biotechnology (e.g., polylactic acid, polyactides, . . . ), biodegradable polymers from petrochemical products (e.g., polycaprolactones, PEA, aromatic polyesters, . . . ), and/or mixtures thereof. In an embodiment, the mold comprises an organic material. In another embodiment, the mold comprises a polymer. In another embodiment, the mold comprises a polymeric material. In another embodiment, the mold comprises at least two different polymers. In another embodiment, the mold comprises an elastomer. In another embodiment, the mold comprises a thermosetting polymer. In another embodiment, the mold comprises a thermoplastic polymer. Some applications may benefit from the superior dimensional accuracy of amorphous polymers (both thermosetting and thermoplastic). In another embodiment, the mold comprises an amorphous polymer. In this respect, for some applications the superior dimensional accuracy combined with re-shapability of amorphous thermoplastics may be advantageous. In an embodiment, the mold comprises an amorphous thermoplastic polymer. In another embodiment, the mold comprises a crystalline polymer. In another embodiment, the mold comprises a semi-crystalline polymer. In another embodiment, the mold comprises a semi-crystalline thermoplastic polymer. In another embodiment, the mold comprises PF. In another embodiment, the mold comprises UF. In another embodiment, the mold comprises MF. In another embodiment, the mold comprises UP. In another embodiment, the mold comprises EP. In another embodiment, the mold comprises Viton. In another embodiment, the mold comprises PPS. In another embodiment, the mold comprises EK. In another embodiment, the mold comprises PI. In another embodiment, the mold comprises PS. In another embodiment, the mold comprises high impact polystyrene (HIPS). In another embodiment, the mold comprises a copolymer of polystyrene. In another embodiment, the mold comprises PCL. In another embodiment, the mold comprises porous PCL. In another embodiment, the mold comprises PVA. In another embodiment, the mold comprises Kollidon VA64. In another embodiment, the mold comprises Kollidon 12PF. In another embodiment, the mold comprises a polymer comprising an aromatic group. In another embodiment, the mold comprises polymethyl methacrylate. In another embodiment, the mold comprises a copolymer comprising acrylonitrile. In another embodiment, the mold comprises a copolymer comprising styrene. In another embodiment, the mold comprises ABS. In another embodiment, the mold comprises SAN. In another embodiment, the mold comprises PC. In another embodiment, the mold comprises PPO. In another embodiment, the mold comprises a vinylic polymer (vinyl and related polymers). In another embodiment, the mold comprises PVC. In another embodiment, the mold comprises an acrylic polymer. In another embodiment, the mold comprises PMMA. In another embodiment, the mold comprises amorphous PP. In another embodiment, the mold comprises polybutylene PBT. In another embodiment, the mold comprises POM. In another embodiment, the mold comprises PET. In another embodiment, the mold comprises a thermoplastic polymer resin of the polyester family. In another embodiment, the mold comprises a polyolefin polymer. In another embodiment, the mold comprises a polymer comprising ethylene monomers. In another embodiment, the mold comprises PE. In another embodiment, the mold comprises HDPE. In another embodiment, the mold comprises LDPE. In another embodiment, the mold comprises a polymer comprising propylene monomers. In another embodiment, the mold comprises PP. In another embodiment, the mold comprises a polymer comprising monomers linked by amide bonds. In another embodiment, the mold comprises PA. In another embodiment, the mold comprises an aliphatic polyamide. In another embodiment, the mold comprises nylon. In another embodiment, the mold comprises a PA11 family material. In another embodiment, the mold comprises a PA12 family material. In another embodiment, the mold comprises PA12. In another embodiment, the mold comprises PA6. In another embodiment, the mold comprises a PA6 family material. In another embodiment, the mold comprises PA6-3-T. In another embodiment, the mold comprises PA46. In another embodiment, the mold comprises PAL. In another embodiment, the mold comprises PES. In another embodiment, the mold comprises PPSU. In another embodiment, the mold comprises PEI. In another embodiment, the mold comprises PSU. In another embodiment, the mold comprises PPP. In another embodiment, the mold comprises PEEK. In another embodiment, the mold comprises PEK. In another embodiment, the mold comprises LCP. In another embodiment, the mold comprises PFA. In another embodiment, the mold comprises ETFE. In another embodiment, the mold comprises PCTFE. In another embodiment, the mold comprises PVDF. In another embodiment, the mold comprises PMP. In another embodiment, the mold comprises PPE. In another embodiment, the mold comprises a biodegradable polymer. In another embodiment, the mold comprises a polar polymer. In another embodiment, the mold comprises a non-polar polymer. In another embodiment, the mold comprises an agro-polymer. In another embodiment, the mold comprises a biodegradable polymer from microorganisms. In another embodiment, the mold comprises a biodegradable polymer from biotechnology.

In another embodiment, the mold comprises a biodegradable polymer from petrochemical products In an embodiment, when it is said that the mold comprises a certain type of polymer, it is meant that a relevant amount of the polymeric material of the mold is made with the referred material. In another alternative, when it is said that the mold comprises a certain type of polymer, it is meant that a relevant amount of the polymeric material of the mold is made with the referred material or a related material. In different embodiments, a relevant amount of the polymeric material means 6% by volume or more, 26% by volume or more, 56% by volume or more, 76% by volume or more, 96% by volume or more and even 100% by volume. In an alternative embodiment, the percentages disclosed above are by weight (wt %). For certain applications, it may be advantageous to use materials having a relevant difference in the viscosity when measured at 20° C. and at 250° C. In an embodiment, the material used to manufacture the mold is a material with a relevant difference in the viscosity when measured at 20° C. and at 250° C. In another embodiment, the material used to manufacture the mold is a material having a different viscosity at 20° C. and at 250° C. In another embodiment, the material used to manufacture the mold is a material having a viscosity at 250° C. which is half or less times the viscosity at 20° C. In another embodiment, the viscosity is 10 times less. In another embodiment, the viscosity is 100 times less. As previously disclosed, for some applications, it may be advantageous to use semi-crystalline thermoplastic polymers to manufacture the mold or at least part of the mold. However, for some applications, besides the fact that the mold comprises a semi-crystalline thermoplastic polymer, it may be important that the semi-crystalline thermoplastic is chosen to have the right melting temperature. Obviously, as in the rest of the document, unless otherwise indicated, the same applies to the configurations where the mentioned type of material (in this case a semi-crystalline thermoplastic) is the main material of the mold or to the cases where the whole mold is built with such a material. In different embodiments, the right melting temperature is below 290° C., below 190° C., below 168° C., below 144° C., below 119° C. and even below 98° C. For some applications, semi-crystalline thermoplastic polymers with too low melting points may be not practicable without risk of distortion. In different embodiments, the right melting temperature is above 28° C., above 55° C., above 105° C., above 122° C. above 155° C. and even above 175° C. Throughout this document, unless otherwise stated, the melting temperature of any polymer is measured according to ISO 11357-1/-3:2016. In an embodiment, the melting temperature of the polymers is measured applying a heating rate of 20° C./min. For some applications, it may be important that the semi-crystalline thermoplastic polymer is chosen to have the right crystallinity level. In different embodiments, the right crystallinity level means a crystallinity above 12%, above 32%, above 52%, 76%, 82%, and even above 96%. In an embodiment, the values of crystallinity disclosed above are measured using an X-ray diffraction (XRD) technique. In an alternative embodiment, the values of crystallinity disclosed above are obtained using differential scanning calorimetry (DSC). In an embodiment, the crystallinity is measured applying a heating rate of 10° C./min. For some applications, besides the fact that the mold comprises a polymer, it may be important that the polymer is chosen to have the right molecular weight. In an embodiment, the material of the mold comprises polymeric material and a relevant part of it (as defined in this document) has a large enough molecular weight. The feature “relevant part” is defined throughout this document in the form of different alternatives, that are explained in detail below. In an embodiment, a relevant part is 16% by volume or more. In an alternative embodiment, a relevant part is 36% vol or more. In another alternative embodiment, a relevant part is 56% vol or more. In another alternative embodiment, a relevant part is 76% vol or more. In another alternative embodiment, a relevant part is 86% vol or more. In another alternative embodiment, a relevant part is 96% vol or more. In another alternative embodiment, a relevant part is 100% vol. In another alternative embodiment, the percentages disclosed above are by weight (wt %). All the embodiments disclosed above can be combined among them and with any other embodiment disclosed in this document that relates to “a relevant part” in any combination, provided that they are not mutually exclusive. In different embodiments, a large enough molecular weight is 8500 or more, 12000 or more, 45000 or more, 65000 or more, 85000 or more, 105000 or more and even 285000 or more. Some applications, contrary to what would result intuitively do not benefit from large molecular weights. In another embodiment, the molecular weight for the majority (as defined in this document) of the polymeric phase of the material of the mold is kept at low enough molecular weight. The feature “majority” is defined throughout this document in the form of different alternatives, that are explained in detail below. In an embodiment, the majority refers to 55% by volume or more. In an alternative embodiment, the majority refers to 66% by volume or more. In another alternative embodiment, the majority refers to 55% by volume or more. In another alternative embodiment, the majority refers to 78% by volume or more. In another alternative embodiment, the majority refers to 86% by volume or more. In another alternative embodiment, the majority refers to 96% by volume or more. In another alternative embodiment, the majority refers to 100% by volume. In another alternative embodiment, the percentages disclosed above are by weight (wt %). All the embodiments disclosed above can be combined among them and with any other embodiment disclosed in this document that relates to “the majority” in any combination, provided that they are not mutually exclusive. In different embodiments, a low enough molecular weight is 4900000 or less, 900000 or less, 190000 or less, 90000 or less, and even 74000 or less. For some applications, besides the fact that the mold comprises a polymer, it may be advantageous to ensure that the polymer is chosen to have the right heat deflection temperature (HDT). In an embodiment, the material of the mold comprises polymeric material and a relevant part of it (as defined in this document) has a low enough heat deflection temperature measured with a load of 1.82 MPa (also referred to as 1.82 MPa HDT”). In different embodiments, low enough means 380° C. or less, 280° C. or less, 190° C. or less, 148° C. or less. For some applications lower temperatures are preferred. In different embodiments, low enough means 118° C. or less, 98° C. or less, and even 58° C. or less. In another embodiment, the material of the mold comprises polymeric material and a relevant part of it (as defined in this document) has a low enough heat deflection temperature measured with a load of 0.455 MPa (also referred to as “0.455 MPa HDT”). In different embodiments, low enough means 440° C. or less, 340° C. or less, 240° C. or less, 190° C. or less, 159° C. or less, 119° C. or less, and even 98° C. or less. Excessively low heat deflection temperatures may be not appropriate for some applications. In another embodiment, the material of the mold comprises polymeric material and a relevant part of it (as defined in this document) has a high enough 1.82 MPa HDT. In different embodiments, high enough means 32° C. or more, 52° C. or more, 72° C. or more, 106° C. or more, 132° C. or more, 152° C. or more, 204° C. or more and even 250° C. or more. In another embodiment, the material of the mold comprises polymeric material and a relevant part of it (as defined in this document) has a high enough 0.455 MPa HDT. In different embodiments, high enough means 32° C. or more, 52° C. or more, 72° C. or more, 106° C. or more, 132° C. or more, 152° C. or more, 204° C. or more and even 250° C. or more. In an embodiment, the values of HDT are determined according to ASTM D648-07 standard test method. In an alternative embodiment, HDT is determined according to ISO 75-1:2013 standard. In an embodiment, the HDT is determined with a heating rate of 50° C./h. In another alternative embodiment, the HDT reported for the closest material in the UL IDES Prospector Plastic Database at 29/01/2018 is used. Like with all other aspects, and when not otherwise stated, some applications exist where the HDT of the material used to manufacture the mold does not matter. For some applications, besides the fact that the mold comprises a polymer, it may be important that the polymer is chosen to have the right Vicat softening point. In different embodiments, the right Vicat softening point is 314° C. or less, 248° C. or less, 166° C. or less, 123° C. or less, 106° C. or less, 74° C. or less, and even 56° C. or less. For some applications, a mold comprising a material having a certain Vicat softening point is preferred. In different embodiments, the right Vicat softening point is 36° C. or more, 56° C. or more, 76° C. or more, 86° C. or more, 106° C. or more, 126° C. or more, 156° C. or more and even 216° C. or more. In an embodiment, the Vicat softening point is determined according to ISO 306 standard. In an embodiment, the Vicat softening point is determined at a heating rate of 50° C./h. In an embodiment, the Vicat softening point is determined with a load of 50N. In an alternative embodiment, the Vicat softening point is determined according to ASTM D1525 standard. In another alternative embodiment, the Vicat softening point is determined by the B50 method. In another alternative embodiment, the Vicat softening point is determined by the A120 method and 18° C. is subtracted from the value measured. In another alternative embodiment, the Vicat softening point is determined according to ISO 10350-1 standard using the B50 method. In another alternative embodiment, the Vicat hardness reported for the closest material in the UL IDES prospector plastic database at 29/01/2018 is used. For some applications, besides the fact that the mold comprises a polymer, it may be advantageous to ensure that the polymer is chosen to have the right classification in the Ensinger manual for engineering plastics. In an embodiment, the latest version available 21 Jan. 2018 is used. In another embodiment, the version 10/12 E9911075A011 GB is used. In another embodiment, a polymer classified as a high-performance plastic is used. In another embodiment, a polymer classified as a Engineering plastic is used. In an embodiment, a polymer classified as a Standard plastic is used. For some applications, it may be particularly advantageous to use polymeric material with a particularly low softening point for at least certain portions of the mold. In different embodiments, a particularly low softening point means a melting temperature below 190° C., below 130° C., below 98° C., below 79° C., below 69° C. and even below 49° C. On the other hand, excessively low melting temperatures may be disadvantageous. In different embodiments, the melting temperature is above −20° C., above 28° C., above 42° C., above 52° C. and even above 62° C. For some applications, besides the fact that the mold comprises a polymer, it may be advantageous to ensure that the polymer is chosen to have the right glass transition temperature (Tg). The feature “right glass transition temperature” is defined throughout this document in the form of different alternatives that are explained in detail below. In different embodiments, the right glass transition temperature is above −260° C., above −230° C., above −190° C. and even above −90° C. Excessive values may be disadvantageous for some applications. In different embodiments, the right glass transition temperature is below 169° C., below 109° C., below 69° C., below 49° C., below 9° C., below −11° C., below −32° C. and even below −51° C. All the embodiments disclosed above can be combined among them and with any other embodiment disclosed in this document that relates to “the right glass transition temperature” in any combination, provided that they are not mutually exclusive. Throughout this document, unless otherwise stated, the glass transition temperature (Tg) of any polymer is measured by differential scanning calorimetry (DSC) according to ASTM D3418-12. All the values and ranges of the different embodiments disclosed above can be combined among them and with any other embodiment disclosed in this document in any combination, provided that they are not mutually exclusive. In certain embodiments, it may be advantageous to use the polymers and polymeric materials described in patent application number WO2021165545A1, the contents of which are incorporated herein by reference in their entirety. The inventor has found that the presence of other materials may also be advantageous to manufacture some molds. In some embodiments, the mold may further comprise other materials including, but not limited to, metallic particles, ceramic particles, reinforcement particles (as defined in this document), and/or combinations thereof. Also in some particular embodiments, the mold can be made of a material that does not include a polymer. For some applications, it may be advantageous to manufacture the mold of different materials. In an embodiment, the mold is made of at least two different materials. In another embodiment, the mold is made of at least three different materials. All the embodiments disclosed above can be combined among them and with any other embodiment disclosed in this document in any combination, provided that they are not mutually exclusive, for example, in an embodiment, the step of shaping the treated powder or powder mixture using a metal additive manufacturing (MAM) method comprises: providing a mold wherein the mold is made of a material comprising a polymeric material; filling the mold with the treated powder or powder mixture; and applying a pressure and/or temperature treatment to the filled mold.

A wide variety of technologies can be used to manufacture the mold, or at least part of the mold, including, but not limited to, additive manufacturing (AM), conventional polymer shaping technologies such as for example, blow molding, extrusion, injection molding, pultrusion, rotomolding, filament winding, thermoforming, compression molding, and/or combinations thereof. Often, the use of an additive manufacturing (AM) technology to manufacture the mold or at least part of the mold may be particularly advantageous due to, among others, the flexibility of design. In an embodiment, the mold, or at least part of the mold, is manufactured by means of an additive manufacturing (AM) technology. Some examples of additive manufacturing (AM) technologies that can be used to manufacture the mold, or at least part of the mold, include, but are not limited to, extrusion-based additive manufacturing technologies, such as for example, fused deposition modelling (FDM) or fused filament fabrication (FFF), additive manufacturing technologies based on vat-photo-polymerization, such as for example, stereolithography (SLA), digital light processing (DLP), continuous digital light processing (CDLP), digital light synthesis (DLS) or a technology based on continuous liquid interface production (CLIP), additive manufacturing technologies based on material jetting, such as for example, material jetting (MJ) or drop on demand (DOD), additive manufacturing technologies based on binder jetting, such as, but not limited to, multi jet fusion (MJF) or binder jetting (BJ), additive manufacturing technologies based on powder bed fusion such as for example, selective laser sintering (SLS) or selective heat sintering (SHS) and/or combinations thereof. In an embodiment, at least part of the mold is manufactured by means of an additive manufacturing technology selected from FDM, FFF, SLA, SHS, DLP, CDLP, DLS, a technology based on CLIP, MJ, DOD, MJF, BJ, SLS and/or combinations thereof. In another embodiment, at least part of the mold is manufactured by means of an additive manufacturing technology selected from FDM, SLA, MJ, MJF, BJ, SLS and/or combinations thereof. For some applications, the use of more than one technology to manufacture the mold is preferred. For some applications of the method, it may be advantageous to manufacture the mold in different parts that can be assembled together. In an embodiment, the mold comprises at least two parts assembled together. Alternatively or additionally, it may be advantageous to manufacture the mold using different manufacturing technologies. In an embodiment, the mold is manufactured using at least two different manufacturing technologies. All the embodiments disclosed above can be combined among them and with any other embodiment disclosed in this document in any combination, provided that they are not mutually exclusive, for example, in an embodiment, the step of shaping the treated powder or powder mixture using a metal additive manufacturing (MAM) method comprises: providing a mold at least partly manufactured using an additive manufacturing (AM) technology, wherein the mold is made of a material comprising a polymeric material; filling the mold with the treated powder or powder mixture; and applying a pressure and/or temperature treatment to the filled mold.

For some applications, it may be advantageous to use of molds that include elements that are not required to provide the shape to the powder or powder mixture such as support elements. In an embodiment, the mold comprises elements which are not required to provide the shape to the treated powder or powder mixture. In this respect, the inventor has found that for certain embodiments, it may be particularly advantageous to manufacture the mold and the support elements from different materials (e.g., materials with a different solubility in a solvent, . . . ).

The manufactured mold, can then be filled with the treated powder or powder mixture. In this respect, the inventor has found that for some applications of the method, the filling density of the mold may be important, for example to avoid internal defects, to have uniform density and dimensional accuracy, among others, particularly in applications of components with internal features. The inventor has found that for certain specific applications, it may be advantageous to use particularly low filling densities such as porous structures, among others. In different embodiments, the filling density of the mold is 12% or more, 21% or more, 31% or more and even 42% or more. For these applications, it may be important to ensure that the filling densities are not excessively high. In different embodiments, the filling density of the mold is 84% or less, 74% or less, 69% or less, 64% or less, and even 59% or less. All the values and ranges of the different embodiments disclosed above can be combined among them and with any other embodiment disclosed in this document in any combination, provided that they are not mutually exclusive, for example, in an embodiment, the filling density is between 12% and 84%; or for example, in another embodiment, between 21% and 84%; or for example, in another embodiment, between 21% and 74%. Often, higher filling densities may be desirable for some applications. In different embodiments, the filling density of the mold is 51% or more, 56% or more, 61% or more, 71% or more and even 81% or more. On the other hand, excessive filling densities may be particularly detrimental to certain components with complex geometries where for example warpage and distortion, or loss of dimensional control, part cracking must be controlled, among others. In different embodiments, the filling density of the mold is 96% or less, 93% or less, 88% or less, 84% or less, and even 78% or less. All the values and ranges of the different embodiments disclosed above can be combined among them and with any other embodiment disclosed in this document in any combination, provided that they are not mutually exclusive, for example, in an embodiment, the filling density is between 51% and 96%; or for example, in another embodiment, between 56% and 96%; or for example, in another embodiment, between 61% and 93%. For some applications, it may be important how the filling of the mold is accomplished. Various strategies can be advantageously employed to properly settle the powder or powders in the mold including, but not limited to, vibrating the mold. In an embodiment, the mold is vibrated during at least part of the filling with the treated powder or powder mixture. In certain embodiments, it may be advantageous to use the filling strategies described in patent application number WO2021165545A1, the contents of which are incorporated herein by reference in their entirety.

For certain applications, it may be important to seal the filled mold such that fluids cannot penetrate into the mold. In an embodiment, the filled mold is sealed. The mold may be sealed in a variety of ways such as for example, but not limited to, using a glue, an adhesive, a caulk, a sealant, a heat source, fusing the mold and its lid together, applying an additional polymeric material and/or sealing the mold around an extension (e.g., a tube that may be used in some embodiments to fill the mold and/or to vacuum the mold), and/or combinations thereof. In some embodiments, the sealing of the mold may be simplified and reduced to the closing of the mold. In some embodiments, the sealing of the mold can be extremely simplified and reduced to the closing of the mold. For some applications, it may be advantageous to use of a cover mold (e.g., pressure transmitting container, polymer film, bag, a vacuum bag, coating, conformal coating, etc.) that can be placed over the filled mold. In different embodiments, the cover mold is used as a vacuum container and a vacuum of 790 mbar or higher, 490 mbar or higher, 90 mbar or higher, 40 mbar or higher and even 9 mbar or higher is made. For some applications, it is advantageous to have a controlled high vacuum level in the mold. In an embodiment, a controlled high vacuum is applied to the filled mold using the cover mold as a vacuum tight container. In different embodiments, a controlled high vacuum level is 0.9 mbar or less, 0.09 mbar or less, 0.04 mbar or less, 0.009 mbar or less, 0.0009 mbar or less, and even 0.00009 mbar or less. For certain applications, an excessive vacuum may be detrimental. In different embodiments, a controlled high vacuum level is 10⁻¹⁰ mbar or more, 10⁻⁸ mbar or more, 10⁻⁶ mbar or more and even 10⁻⁴ mbar or more. In certain embodiments, it may be advantageous to use the strategies for sealing the mold described in patent application number WO2021165545A1, the contents of which are incorporated herein by reference in their entirety. All the values and ranges of the different embodiments disclosed above can be combined among them and with any other embodiment disclosed in this document in any combination, provided that they are not mutually exclusive.

As described above, the component can then be formed by applying a pressure and/or temperature treatment to the filled mold. For some applications, the atmosphere used in the pressure and/or temperature treatment may be important. In an embodiment, the pressure and/or temperature treatment comprises the use of a properly designed atmosphere (as defined in this document). For some applications, it may also be advantageous to change the atmosphere in the furnace or pressure vessel during the treatment. In an embodiment, the pressure and/or temperature treatment comprises the use of at least two different atmospheres. The pressure and/or temperature applied may, among others, have an impact on the properties and the dimensional accuracy of some components. These factors can impact various aspects such as density, particle bonding, diffusion and densification kinetics, and grain growth, among others. In certain embodiments, a good strategy can be based on the forming step as described in patent application number WO2021165545A1, the contents of which are incorporated herein by reference in their entirety. In some embodiments, it may be advantageous to perform the pressure and/or temperature treatment simultaneously (sequentially) with other method steps. For some applications, the inventor has found that it may be also advantageous to perform the pressure and/or temperature treatment as described below during the debinding treatment. In an embodiment, the method further comprises the step of applying a pressure and/or temperature treatment during the debinding treatment. Even in certain embodiments, it may be also advantageous to perform a pressure and/or temperature treatment as described below after applying a debinding treatment. In an embodiment, the method further comprises the step of applying a pressure and/or temperature treatment after the debinding treatment.

In some embodiments, the pressure and/or temperature treatment may comprise the application of pressure. In this respect, the inventor has found that the application of a certain pressure in the pressure and/or temperature treatment may be particularly advantageous for the manufacture of some components comprising, for example, powders or powder mixtures with low activation energies required for atomic diffusion, among others. In different embodiments, the pressure applied (as defined in this document) in the pressure and/or temperature treatment is 6 MPa or more, 60 MPa or more, 110 MPa or more, 220 MPa or more, 340 MPa or more, 560 MPa or more, 860 MPa or more and even 1060 MPa or more. On the other hand, excessive pressures seem to deteriorate some mechanical properties and the structural integrity, the dimensional accuracy, among others. In different embodiments, the pressure applied (as defined in this document) in the pressure and/or temperature treatment is 2100 MPa or less, 1600 MPa or less, 1200 MPa or less, 990 MPa or less, 790 MPa or less, 640 MPa or less, 590 MPa or less, and even 390 MPa or less. For some applications, the maximum pressure applied in the pressure and/or temperature treatment may be relevant. In different embodiments, the maximum pressure in the pressure and/or temperature treatment is 105 MPa or more, 210 MPa or more, 310 MPa or more, 405 MPa or more, 640 MPa or more, 1260 MPa or more and even 2600 MPa or more. In different embodiments, the maximum pressure applied in the pressure and/or temperature treatment is 2100 MPa or less, 1200 MPa or less, 990 MPa or less, 790 MPa or less, 640 MPa or less, than 590 MPa or less, 490 MPa or less, and even 390 MPa or less. All the values and ranges of the different embodiments disclosed above can be combined among them and with any other embodiment disclosed in this document in any combination, provided that they are not mutually exclusive, for example, in an embodiment, the pressure and/or temperature treatment comprises the application of a pressure between 6 and 2100 MPa, or for example, in another embodiment, between 6 and 1600 MPa, or for example, in another embodiment, between 60 and 1600 MPa; or for example, in another embodiment, the pressure and/or temperature treatment comprises the application of a maximum pressure between 105 and 2100 MPa. In an embodiment, the pressure is applied continuously. In another embodiment, the pressure is applied continuously for a relevant time (as defined in this document). In another embodiment, the pressure is applied in a stepwise manner (as defined in this document). In another embodiment, the pressure is increased and/or released more than once during the treatment. In an embodiment, the pressure is applied by a fluid. In an embodiment, the pressure is applied by a fluid comprising water. In an embodiment, the pressure is applied by a fluid comprising an organic material. In an embodiment, the pressure is applied by a fluid comprising oil. In an embodiment, the pressure is applied by a fluid comprising a vegetable oil. In an embodiment, the pressure is applied by a fluid comprising a mineral oil. In an embodiment, the pressure is applied by a liquid. In an embodiment, the pressure is applied by a gas. In an embodiment, the pressure is applied by a fluid comprising a liquid. In an embodiment, the pressure is applied by a fluid comprising a gas. In an embodiment, at least part of the pressure of the fluid is applied directly over the component. In another embodiment, the pressure of the fluid is applied directly over the component. In another embodiment, when the component comprises internal features, at least part of the pressure of the fluid is applied directly over the internal features. In another embodiment, when the component comprises internal features, the pressure of the fluid is applied directly over the internal features. In an alternative embodiment, the pressure is applied by a particle fluidized bed. In an embodiment, when the component comprises internal features, at least part of the pressure of the particle fluidized bed is applied directly over the internal features. In another embodiment, when the component comprises internal features, the pressure of the particle fluidized bed is applied directly over the internal features. However, the manner in which the pressure can be applied is not limited to the examples described above. In certain embodiments, the distribution of the applied pressure may be improved using for example, the strategies developed for applying pressure in a homogeneous way as described in patent application number WO2021165545A1, the contents of which are incorporated herein by reference in their entirety. In some embodiments, the manner in which the pressure may be applied described above can also be used in other steps of the method involving pressure.

Additionally or alternatively, in some embodiments, the pressure and/or temperature treatment may comprise the application of temperature. In this respect, the inventor has found that the application of a certain temperature in the pressure and/or temperature treatment may be particularly advantageous for the manufacture of some components for example, in cases where it is desirable to increase the densification rates. among others. In different embodiments, the temperature applied (as defined in this document) in the pressure and/or temperature treatment is above 0.16*Tm, above 0.19*Tm, above 0.26*Tm, above 0.3*Tm, above 0.45*Tm, above 0.61*Tm, above 0.69*Tm, above 0.74*Tm and even above 0.86*Tm, wherein Tm is the melting temperature in Kelvin of the powder or powder mixture (as defined in this document) provided. On the other hand, excessive temperatures may be disadvantageous for some treatments where for example deterioration of mechanical properties such as mechanical strength, and surface defects appearance should be avoided, among others. In different embodiments, the temperature applied (as defined in this document) in the pressure and/or temperature treatment is less than 0.94*Tm, less than 0.84*Tm, less than 0.74*Tm, less than 0.64*Tm, less than 0.44*Tm, less than 0.34*Tm, less than 0.29*Tm and even less than 0.24*Tm, wherein Tm is the melting temperature in Kelvin of the powder or powder mixture (as defined in this document) provided. For some applications, it may be better to define the temperature applied (as defined in this document) in absolute terms. In different embodiments, the temperature applied (as defined in this document) in the pressure and/or temperature treatment is above −14° C., above 9° C., above 31° C., above 46° C., above 86° C., above 110° C., above 156° C., above 210° C. above 270° C. and even above 310° C. On the other hand, excessive temperatures may be disadvantageous for some treatments. In different embodiments, the temperature applied (as defined in this document) in the pressure and/or temperature treatment is less than 649° C., less than 440° C., less than 298° C., less than 249° C., less than 149° C., less than 90° C., less than 49° C. and even less than 29° C. For some applications, the maximum temperature applied in the pressure and/or temperature treatment may be relevant to the mechanical properties of the manufactured component. In different embodiments, the maximum temperature applied in the pressure and/or temperature treatment is less than 995° C., less than 495° C., less than 245° C., less than 145° C. and even less than 85° C. For some applications, the maximum temperature applied should be above a certain value. In different embodiments, the maximum temperature applied in the pressure and/or temperature treatment is at least 26° C., at least 46° C., at least 76° C., at least 106° C., at least 260° C., at least 460° C., at least 600° C. and even at least 860° C. In an embodiment, the maximum temperature is maintained for a “relevant time” (as defined in this document). In an embodiment, any temperature which is maintained for less than a “critical time” (as defined in this document) is not considered a maximum temperature. For some applications, the minimum temperature applied may be relevant. In different embodiments, the minimum temperature applied in the pressure and/or temperature treatment is-29° C., −2° C., 9° C., 16° C., 26° C. and even 76° C. For some applications, the minimum temperature applied should be below a certain value. In different embodiments, the minimum temperature applied in the pressure and/or temperature treatment is less than 99° C., less than 49° C., less than 19° C., less than 1° C., less than −6° C. and even less than −26° C. For some applications, the minimum temperature applied should be above a certain value. In different embodiments, the minimum temperature in the pressure and/or temperature treatment is at least −51° C., at least −16° C., at least 0.1° C., at least 11° C., at least 26° C., at least 51° C. and even at least 91° C. All the values and ranges of the different embodiments disclosed above can be combined among them and with any other embodiment disclosed in this document in any combination, provided that they are not mutually exclusive, for example, in an embodiment, the pressure and/or temperature treatment comprises the application of a temperature between 0.16*Tm and 0.94*Tm, Tm being the melting temperature in Kelvin of the powder or powder mixture provided; or for example, in another embodiment, between 0.16*Tm and 0.84*Tm, Tm being the melting temperature in Kelvin of the powder or powder mixture, or for example, in another embodiment, between 0.16*Tm and 0.74*Tm, Tm being the melting temperature in Kelvin of the powder or powder mixture provided; or for example, in another embodiment, the pressure and/or temperature treatment comprises the application of a temperature between 0.16*Tm and 0.94*Tm, being Tm the melting temperature in Kelvin of the metallic powder with the lowest melting point in the powder of powder mixture provided, wherein the melting temperature of such metallic powder is the temperature at which the first metal liquid forms under equilibrium conditions; or for example, in another embodiment, the pressure and/or temperature treatment comprises the application of a temperature between 0.16*Tm and 0.94*Tm, being Tm the melting temperature in Kelvin of the metallic powder, which is at least 2.6% by weight of all the metallic powders in the powder or powder mixture provided, with the lowest melting point, wherein the melting temperature of such metallic powder is the temperature at which the first metal liquid forms under equilibrium conditions; or for example, in another embodiment, the pressure and/or temperature treatment comprises the application of a temperature between −14° C. and 649° C.; or for example, in another embodiment, between 9° C. and 440° C.; or for example, in another embodiment, between 31° C. and 440° C. In an embodiment, the minimum temperature is maintained for a “relevant time” (as defined in this document). In an embodiment, any temperature which is maintained less than a “critical time” (as defined in this document) is not considered a minimum temperature. In an embodiment, the temperature in the pressure and/or temperature treatment refers to the temperature of the pressurized fluid used to apply the pressure in the pressure and/or temperature treatment. In an embodiment, the temperature is applied continuously. In another embodiment, the temperature is applied continuously for a relevant time (as defined in this document). In another embodiment, the temperature is applied in a stepwise manner. In another embodiment, the temperature is increased and/or released more than once during the treatment. The inventor has found that the manner in which the temperature is applied, may have a strong influence on both the achievable accuracy and the absence of defects in some geometries. Heat transfer may involve various mechanisms such as for example, thermal conduction, thermal convection, thermal radiation phase changes and/or combinations thereof. In certain embodiments, at least part of the heating can be performed using microwaves, as described in patent application number WO2021165545A1, the contents of which are incorporated herein by reference in their entirety. However, the manner in which the heating can be performed is not limited to the examples described above. In some instances, it may also be advantageous to use microwaves to perform at least part of the heating in other treatments, such as for example, the consolidation and/or densification treatments. In some embodiments, the temperature can be raised, for example, by heating up the fluid that exerts the pressure (pressurized fluid). The inventor has found that for some applications, significant variations in the temperature of the pressurized fluid during the pressure and/or temperature treatment may be advantageous, for example, in those comprising the processing of enhanced mechanical properties materials, such as gradient hardness or thermal conductivity, among others. In different embodiments, the maximum temperature gradient of the pressurized fluid is greater than 6° C., greater than 11° C., greater than 16° C., greater than 21° C., greater than 55° C., greater than 105° C. and even greater than 145° C. On the other hand, excessive temperature gradients may be detrimental to the manufacture of some components. In different embodiments, the maximum temperature gradient of the pressurized fluid is less than 380° C., less than 290° C., less than 245° C., less than 149° C., less than 94° C., less than 49° C., less than 24.4° C., less than 23° C. and even less than 19° C. In an embodiment, the maximum temperature gradient is maintained for a relevant time (as defined in this document). In some embodiments, the manner in which the temperature may be applied described above can also be used in other steps of the method involving the application of temperature. In an embodiment, the maximum pressure and temperature are reached simultaneously in the pressure and/or temperature treatment. All the embodiments disclosed above can be combined among them and with any other embodiment disclosed in this document in any combination, provided that they are not mutually exclusive, for example, in an embodiment, the pressure and/or temperature treatment comprises the application of a temperature between 0.16*Tm and 0.94*Tm, being Tm the melting temperature in Kelvin of the powder or powder mixture provided, and a pressure between 6 and 2100 MPa.

The processing time may be important for the manufacture of some components especially, for example, for those were high mechanical properties, among others. In different embodiments, the processing time of the pressure and/or temperature treatment is at least 1 minute, at least 6 minutes, at least 25 minutes, at least 246 minutes, at least 410 minutes and even at least 1200 minutes. On the other hand, excessive processing times may lead to a disproportionate increase in cost mainly associated with energy consumption, among others. In different embodiments, the processing time of the pressure and/or temperature treatment is less than 119 hours, less than 47 hours, less than 23.9 hours, less than 12 hours, less than 2 hours, less than 54 minutes, less than 34 minutes, less than 14 minutes and even less than 8 minutes. All the values and ranges of the different embodiments disclosed above can be combined among them and with any other embodiment disclosed in this document in any combination, provided that they are not mutually exclusive, for example, in an embodiment, the processing time of the pressure and/or temperature treatment is between 1 minute and 119 hours; or foe example, in another embodiment, between 6 minutes and 47 hours; or for example, in another embodiment, between 25 minutes and 23.9 hours.

For some applications of the method, the use of a pressure and/or temperature treatment comprising the steps disclosed below may be advantageous. In an embodiment, the pressure and/or temperature treatment comprises the following steps:
step i) subjecting the mold to high pressure;
step ii) while keeping a high pressure level, raising the temperature of the mold;
step iii) while keeping a high enough temperature, releasing at least some of the to the mold applied pressure.

In some embodiments, steps ii), and iii) may be optional and thus can be avoided. In an embodiment, step ii) is skipped. In an embodiment, step iii) is skipped.

For some applications, step i) may be very critical. In some embodiments, it may be important which means are used to apply the pressure, some being sensitive to the rate of pressure application and some to the maximum pressure level attained. On the other hand, some embodiments are rather insensitive as how pressure is applied and even to the pressure level achieved. In an embodiment, the pressure is applied by a particle fluidized bed. In another embodiment, the pressure is applied by a fluid. In another embodiment, the pressure is applied by a fluid comprising water. In another embodiment, the pressure is applied by a fluid comprising an organic material. In another embodiment, the pressure is applied by a fluid comprising oil. In another embodiment, the pressure is applied by a fluid comprising a vegetable oil. In another embodiment, the pressure is applied by a fluid comprising a mineral oil. In another embodiment, the pressure is applied by a liquid. In an embodiment, the pressure is applied by a gas. In an embodiment, the pressure is applied by a fluid comprising a liquid. In another embodiment, the pressure is applied by a fluid comprising a gas. In an embodiment, subjecting the mold to high pressure in step i) means subjecting the filled mold to the right amount of maximum pressure. In an embodiment, the right amount of maximum pressure is applied for a relevant time (as defined in this document). In different embodiments, the right amount of maximum pressure is 12 MPa or more, 105 MPa or more, 155 MPa or more, 170 MPa or more, 185 MPa or more, 205 MPa or more, 260 MPa or more and even 302 MPa or more. As explained above, steps ii), and/or iii) can be skipped in certain embodiments. Higher pressures are normally required when skipping steps ii), and iii), but also in some embodiments when not skipping them. Even in some embodiments, the use of higher pressures to attain high apparent densities may be particularly advantageous. In different embodiments, the right amount of maximum pressure is 410 MPa or more, 510 MPa or more, 601 MPa or more, 655 MPa or more and even 820 MPa or more. On the other hand, excessive pressures in step i) may lead to internal defects, even more so for complex and large geometries. In different embodiments, the right amount of maximum pressure is 1900 MPa or less, 900 MPa or less, 690 MPa or less, 490 MPa or less, 390 MPa or less, and even 290 MPa or less. Such low levels of pressure may lead to sound final components for some of the powder mixtures described in this document. All the values and ranges of the different embodiments disclosed above can be combined among them and with any other embodiment disclosed in this document in any combination, provided that they are not mutually exclusive, for example, in an embodiment, the maximum pressure applied in step i) is between 12 and 1900 MPa; or for example, in another embodiment, the maximum pressure applied in step i) is between 105 and 1900 MPa, or for example, in another embodiment, the mean pressure applied in step i) is between 12 and 1900 MPa, or for example, in another embodiment, the minimum pressure applied in step i) is between 12 and 1900 MPa. The manner in which the pressure is applied may have incidence in the soundness of certain components. In an embodiment, the pressure is applied in a stepwise manner. The feature “application of pressure in a stepwise manner” is defined throughout this document in the form of different alternatives that are explained in detail below. In an embodiment, the application of pressure in a stepwise manner comprises applying at least two steps. In another embodiment, the application of pressure in a stepwise manner comprises applying at least three steps. In different embodiments, the first step is performed within the first 20%, the first 15%, the first 10%, and even the first 5% of the right amount of maximum pressure. In different embodiments, holding time of the first step is at least 2 seconds, at least 5 seconds, at least 15 seconds, at least 55 seconds and even at least 5 minutes. In different embodiments, during the first step holding time there is a variation on the applied pressure of ±5% or less, ±15% or less, ±55% or less, and even ±75% or less. All the embodiments disclosed above can be combined among them and with any other embodiment disclosed in this document that relates to “the application of pressure in a stepwise manner” in any combination, provided that they are not mutually exclusive. Some applications suffer when the pressure is applied too rapidly. In an embodiment, step i) comprises applying the pressure at a low enough rate. The feature “low enough rate” is defined throughout this document in the form of different alternatives that are explained in detail below. In an embodiment, the pressure is applied at a low enough rate at least within the initial stretch. In different embodiments, a low enough rate is 980 MPa/s or less, 98 MPa/s or less, 9.8 MPa/s or less, 0.98 MPa/s or less, 0.098 MPa/s or less, and even 0.009 MPa/s or less. Some applications requiring a low rate cannot accept an excessively low rate. In different embodiments, a low enough rate is higher than 0.9 MPa/h, higher than 9 MPa/h, higher than 90 MPa/h, higher than 900 MPa/h and even higher than 9000 MPa/h. In different embodiments, the initial stretch is the first 5%, the first 10%, the first 25%, the first 55%, and even the first 100% of the right amount of maximum pressure. In different embodiments, the initial stretch means the first 5 MPa, the first 10 MPa, the first 15 MPa, the first 25 MPa and even the first 55 MPa applied. All the embodiments disclosed above can be combined among them and with any other embodiment disclosed in this document that relates to “a low enough rate” in any combination, provided that they are not mutually exclusive. Some treatments may benefit from a fast pressure rate application, particularly in the first stretch. In an embodiment, the pressure is applied at a high enough rate (in the same sense as described above) at least within the initial stretch. In different embodiments, a high enough rate is 0.09 MPa/s or more, 0.9 MPa/s or more, 9 MPa/s or more and even 90 MPa/s or more. For some treatments, it might be interesting to introduce the filled mold into the pressure application device, when the fluid used to apply the pressure is hot. In an embodiment, the filled mold is introduced into the pressure application device, when the fluid used to apply the pressure is hot. In another embodiment, the filled mold is introduced into the pressure application device, when the fluid used to apply the pressure is hot, but making sure at least part of the pressure is applied before the powder in the mold becomes hot. In another embodiment, the filled mold is introduced into the pressure application device, when the fluid used to apply the pressure is hot but making sure the pressure is applied in step i) before the powder in the mold becomes hot. In an embodiment, the pressure application device is any device capable of raising the applied pressure to the right amount of maximum pressure at the appropriate rate and capable of attaining the desired temperature in step ii). In an embodiment, the pressure application device is any device capable to raising the applied pressure to the right amount of maximum pressure. In different embodiments, the fluid being hot having a temperature of 35° C. or more, of 45° C. or more, of 55° C. or more, of 75° C. or more, of 105° C. or more and even of 155° C. or more. In different embodiments, the powder becoming hot means having a mean temperature of more than 35° C., of more than 45° C., of more than 95° C. and even of more than 145° C. In different embodiments, the powder not becoming hot means it has a mean temperature of 145° C. or less, of 95° C. or less, of 45° C. or less, and even of 35° C. or less. All the embodiments disclosed above can be combined among them and with any other embodiment disclosed in this document in any combination, provided that they are not mutually exclusive.

For some applications, the apparent filling density has to be well-adjusted with the maximum pressure applied to the mold in step i), and the mean temperature of the powder. In an embodiment, the following rule applies at some point within step i): when MPID<LLMPI then: MAD+RFT1*MTI<LADT1 or MAD-RFP1*MPID<LPT1; when LLMPI≤MPID<HLMPI then: MAD+RFT2*MTI<LADT2 or MAD-RFP2*MPID<LPT2; when HLMPI≤MPID then: MAD+RFT3*MTI<LADT3 or MAD+RFP3*MPID<LPT3; where: LLMPI, HLMPI, RFT1, LADT1, RFP1, LPT1, RFT2, LADT2, RFP2, LPT2, RFT3, LADT3, RFP3 and LPT3 are parameters; MPID=∛MaxPresD−5.84803548, and MaxPresD is the maximum pressure applied in step i); MAD=1/(AD)³ where AD is the mean apparent filling density of the powder in the mold; MTI=∛/TP−6.83990379 and TP is the mean absolute temperature of the powder. In different embodiments, LLMPI is −1.367, −1.206, −0.916, −0.476 and even −0.308. In different embodiments, HLMPI is 0.366, 0.831, 1.458, 2.035, 2.539 and even 2.988. In different embodiments, RFT1 is 0.3, 0.8, 1.0, 2.3 and even 4.3. In different embodiments, LADT1 is 6.0, 3.5, 3.0, 2.8, 2.5, 2.0 and even 1.5. In different embodiments, RFP1 is 0.2, 0.9, 1.6, 2.2 and even 3.0. In different embodiments, LPT1 is 8.0, 5.0, 4.0, 3.0, 2.5 and even 2.0. In different embodiments, RFT2 is 0.3, 0.8, 1.0, 2.3, 3.3, 4.5 and even 6.3. In different embodiments, LADT2 is 5.5, 3.5, 3.25, 3.0, 2.8, 2.5, 2.0, 1.5 and even 1.0. In different embodiments, RFP2 is 0.2, 1.0, 1.6, 2.2, 3.0, 5.0 and even 7.0. In different embodiments, LPT2 is 7.4, 7.0, 5.0, 4.1, 3.5, 2.0, 1.0 and even 0.0. In different embodiments, RFT3 is 0.3, 0.8, 1.0, 2.3 and even 4.3. In different embodiments, LADT3 is 6.0, 3.5, 3.0, 2.8, 2.5, 2.0 and even 1.5. In different embodiments, RFP3 is 0.4, 1.1, 2.0, 3.2 and even 4.5. In different embodiments, LPT3 is 20.0, 16.5, 14.0, 10.0, 7.2, 6.0, 5.2 and even 3.0. In an alternative embodiment, AD is the apparent filling density of the powder in the mold. In an embodiment AD is determined by means ASTM B212-21. In another embodiment AD is determined by means ASTM B329-20. In another embodiment AD is determined by means ASTM B417-22. In another embodiment AD is determined by means ASTM B703-21. In another alternative embodiment, AD is the balanced apparent density. In an embodiment, TP is the mean temperature of the powder in step i). In another embodiment, TP is the maximum temperature of the powder in step i). In an embodiment, in the preceding rule the following values of MPID are not permitted: HLMPI≤MPID. In another embodiment, in the preceding rules the following values of MPID are not permitted: MPID<LLMPI. In another embodiment, in the preceding rules the following values of MPID are not permitted: HLMPI≤MPID<LLMPI.

As explained above, step i) may be particularly important for many applications. In fact, shifting steps ii), and i) may lead to components with internal defects due, among many other reasons, to the flow of the mold into the component itself, which can be on a first instance corrected by introducing a protective intermediate layer, at least for some simple geometries, but this only prevents a few of the internal defects and no sound components can be obtained. For some applications, and in particular for small components, this lack of soundness is sometimes not detrimental but of course for most of the applications pursued it may be unacceptably detrimental.

For some applications, step ii) may be very important and the values of the relevant parameters must be properly controlled. In an embodiment, the temperature of the mold is raised while keeping a high pressure level in step ii). In an embodiment, the temperature of the mold is raised by heating up the fluid that exerts the pressure. In an embodiment, the temperature is raised at least by radiation. In an embodiment, the temperature is raised at least by convection. In an embodiment, the temperature is raised at least by conduction. The feature “temperature of the mold” is defined throughout the pressure and/or temperature treatment in the form of different alternatives that are explained in detail below. In an embodiment, the temperature of the mold refers to the mean temperature of the mold provided. In an alternative embodiment, the temperature of the mold refers to the mean temperature of the powder contained in the mold. In another alternative embodiment, the temperature of the mold refers to the mean temperature of the fluid exerting pressure on the mold. In another alternative embodiment, the temperature of the mold refers to the mean temperature of the fluid exerting pressure on the mold and within 5 mm of the mold or mold sealing. In another alternative embodiment, the temperature of the mold refers to the mean temperature of the fluid exerting pressure on the mold and within 25 mm of the mold or mold sealing. In another alternative embodiment, the temperature of the mold refers to the temperature in the gravity centre of the filled mold. In another alternative embodiment, the temperature of the mold refers to the temperature in the geometrical centre of the filled mold. All the embodiments disclosed above can be combined with any other embodiment disclosed in this document that relates to “the temperature of the mold” in any combination, provided that they are not mutually exclusive. In different embodiments, the temperature of the mold is raised in step ii) to 320K or more, to 350K or more, to 380K or more, to 400K or more, to 430K or more and even to 480K or more. For some applications of the method, it may be advantageous to avoid excessively high temperatures. In different embodiments, the temperature of the mold in step ii) is kept below 790K, below 690K, below 660K, below 560K, below 510K, below 470K and even below 420K. All the values and ranges of the different embodiments disclosed above can be combined among them and with any other embodiment disclosed in this document in any combination, provided that they are not mutually exclusive, for example, in an embodiment, the temperature is raised in step ii) to a temperature between 320K and 790K, or for example, in another embodiment, between 320K and 690K, or for example, in another embodiment, between 320K and 660K. For some applications, it may be important to relate the temperature at which the mold is raised in step ii) to the material used in the manufacture of the mold. In different embodiments, the temperature of the mold is raised to 0.6*1.82 MPa HDT of the mold material, or more, to 1.2*1.82 MPa HDT of the mold material, or more and even to 1.6*1.82 MPa HDT of the mold material, or more, wherein 1.82 MPa HDT is the heat deflection temperature (HDT) measured with a load of 1.82 MPa. In different embodiments, the temperature of the mold is raised to 0.6*0.455 MPa HDT of the mold material, or more, to 1.4*0.455 MPa HDT of the mold material, or more and even to 2.2*0.455 MPa HDT of the mold material, or more, wherein 0.455 MPa HDT is the heat deflection temperature (HDT) measured with a load of 0.45 MPa. In an embodiment, the calculations with HDT are performed with temperatures expressed in degrees Celsius. In an alternative embodiment, the calculations with HDT are performed with temperatures expressed in Kelvin degrees. In an embodiment, for mold materials having more than one phase with different HDT, the lowest value of any relevant part (as defined in this document) is taken. In an alternative embodiment, for mold materials having more than one phase with different HDT, the highest value of any relevant part (as defined in this document) is taken. In another alternative embodiment, for mold materials having more than one phase with different HDT, the mean value of all relevant parts (as defined in this document) is taken. In another alternative embodiment, for mold materials having more than one phase with different HDT, the mean value of all the parts constituting the majority (as defined in this document) of the polymeric phase of the mold with the lowest HDT is taken. In another alternative embodiment, for mold materials having more than one phase with different HDT, the mean value of all the parts constituting the majority (as defined in this document) of the polymeric phase of the mold with the highest HDT is taken. In this context, the mean refers to the weighted arithmetic mean, where the weights are the volume fractions. In an embodiment, the values of HDT are determined according to the standard test method ASTM D648-07. In an alternative embodiment, the values of HDT are determined according to the ISO 75-1:2013 standard. In an embodiment, the HDT is determined with a heating rate of 50° C./h. In another alternative embodiment, the HDT reported for the closest material in the UL IDES Prospector Plastic Database at 29/01/2018 is used. As with all other aspects of this disclosure, and when not otherwise stated, some applications exist where the HDT of the material used to manufacture the mold does not matter. In alternative embodiments, the HDT is replaced with the melting temperature for crystalline or semi-crystalline polymers. Throughout this document, unless otherwise stated, the melting temperature of any polymer is measured according to ISO 11357-1/-3:2016. In an embodiment, the melting temperature of the polymers is measured applying a heating rate of 20° C./min. In different embodiments, the temperature of the mold in step ii) is kept below 0.73*Tm, below 0.48*Tm, below 0.38*Tm and even below 0.24*Tm, wherein Tm is the melting temperature in Kelvin of the metallic powder which is a relevant powder (as defined in this document) with the lowest melting point. In an alternative embodiment, Tm is the melting temperature in Kelvin of the material comprised in the mold. In another alternative embodiment, Tm is the melting temperature in Kelvin of the powder mixture (as defined in this document) provided. In another alternative embodiment, Tm is the melting temperature in Kelvin of a relevant part (as defined in this document) of the mold. In another alternative embodiment, Tm is the melting temperature in Kelvin of the mold. In different embodiments, the temperature of the mold in step ii) is kept below 0.68*Tm, below 0.48*Tm, below 0.42*Tm, below 0.34*Tm and even below 0.24*Tm, wherein Tm is the melting temperature in Kelvin of the metallic powder which is a relevant powder (as defined in this document) with the highest melting point. In an alternative embodiment, Tm is the melting temperature in Kelvin of the material comprised in the mold. In another alternative embodiment, Tm is the melting temperature in Kelvin of the powder mixture (as defined in this document) provided. In another alternative embodiment, Tm is the melting temperature in Kelvin of a relevant part (as defined in this document) of the mold. In an alternative embodiment, Tm is the melting temperature in Kelvin of the mold. For some applications, the maximum relevant temperature (as defined in this document) achieved in step ii) may be more relevant. In different embodiments, the maximum relevant temperature reached in step ii) is 190° C. or less, 140° C. or less, 120° C. or less, 90° C. or less, Tm+50° C. or less, Tm+30° C. or less, Tm+10° C. or less, Tm or less, and even Tm−20° C. or less, wherein Tm is the melting temperature in Kelvin of the powder or powder mixture (as defined in this document) provided. In an alternative embodiment, Tm is the melting temperature in Kelvin of the material comprised in the mold. In another alternative embodiment, Tm is the melting temperature in Kelvin of a relevant part (as defined in this document) of the mold. In another alternative embodiment, Tm is the melting temperature in Kelvin of the mold. All the embodiments disclosed above can be combined among them and with any other embodiment disclosed in this document in any combination, provided that they are not mutually exclusive.

As previously disclosed, the temperature of the mold is raised while keeping a high pressure level in step ii). In an embodiment, a high pressure level in step ii) means a right pressure level in step ii). The feature “right pressure level in step ii)” is defined throughout this document in the form of different alternatives that are explained in detail below. In an embodiment, the right pressure level refers to the minimum pressure applied to the mold in step ii). In an alternative embodiment, the right pressure level refers to the maximum pressure applied to the mold in step ii). In another alternative embodiment, the right pressure level refers to any pressure applied to the mold in step ii). In another alternative embodiment, the right pressure level refers to the mean pressure applied to the mold in step ii). In another alternative embodiment, the right pressure level refers to the weighted arithmetic mean pressure (time weighted) applied to the mold in step ii). In different embodiments, the right pressure level in step ii) is 0.5 MPa or more, 5.5 MPa or more, 10.5 MPa or more, 21 MPa or more, 105 MPa or more, 160 MPa or more and even 215 MPa or more. On the other hand, excessive pressures in step ii) may cause undesirable distortions in the manufacture of certain components. In different embodiments, the right pressure level in step ii) is 1300 MPa or less, 990 MPa or less, 860 MPa or less, 790 MPa or less, 490 MPa or less, 390 MPa or less, 290 MPa or less, 190 MPa or less, 90 MPa or less, and even 39 MPa or less. All the values and ranges of the different embodiments disclosed above can be combined among them and with any other embodiment disclosed in this document in any combination, provided that they are not mutually exclusive, for example, in an embodiment, a high pressure level in step ii) is a pressure between 0.5 and 1300 MPa, or for example, in another embodiment, between 5.5 and 1300 MPa, or for example, in another embodiment, between 10.5 and 1300 MPa. For some applications, it may be of interest to maintain a certain relationship between the maximum temperature of the mold and the right pressure level within step ii). In an embodiment, the right pressure level is kept between MSELP*[maximum temperature of the mold in step i) expressed in ° C.] and MSEHP*[maximum temperature of the mold in step i) expressed in ° C.]. In different embodiments, MSELP is 0.005, 0.02, 0.1, 0.25 and even 0.5. In different embodiments, MSEHP is 0.6, 1.0, 2.0, 4.0 and even 7.0. All the embodiments disclosed above can be combined among them and with any other embodiment disclosed in this document in any combination, provided that they are not mutually exclusive.

The method can be used to manufacture components with intricate geometries and even more so when they comprise internal features for the reasons already explained. Obviously, the process window is rather small and often geometry dependent. For complex geometries it may often be helpful for the obtaining of crack free components to apply a complex strategy when it comes to the achieving of the pressure and temperature levels indicated for steps i), and ii). The inventor has found that the manner in which the temperature is applied, may have a strong influence on both the achievable accuracy and the absence of defects in some geometries. One such strategy consists of applying the pressure and temperature on a staircase fashion, where the levels are related to some intrinsic properties of at least one of the polymeric materials used for the mold. In an embodiment, the following steps are used:
step A1: raising the pressure at a high enough level while keeping the temperature low enough;
step B1: raising the temperature to a certain level and keeping it in that level for a given time;
step C1: raising the pressure to a certain level and keeping it at that level for a given time;
step D1 (optional): repeat step B1, C1 or both one or more times at different levels of pressure and temperature;
step E1 (optional): ensuring that the pressure and temperature are at the level defined for general step i) before proceeding with general step ii).

In different embodiments, the high enough pressure level in step A1 is 55 bar or more, 105 bar or more, 155 bar or more, 455 bar or more and even 655 bar or more. On the other hand, excessive pressures in step A1 may be disadvantageous for some treatments. In different embodiments, the high enough pressure level in step A1 is 6400 bar or less, 2900 bar or less, 1900 bar or less, 1600 bar or less, 1200 bar or less, 990 bar or less, and even 840 bar or less. In an embodiment, the low enough temperature level in step A1 is the critical temperature (as defined in this document) of the polymer of the mold or less. In another embodiment, the low enough temperature level in step A1 is 84% of the critical temperature (as defined in this document) of the polymer of the mold or less. In another embodiment, the low enough temperature level in step A1 is 75% of the critical temperature (as defined in this document) of the polymer of the mold or less. The feature “critical temperature of the polymer” is defined throughout this document in the form of different alternatives that are explained in detail below. In an embodiment, the critical temperature of the polymer refers to the melting temperature of the polymer. In an alternative embodiment, the critical temperature of the polymer refers to the 1.82 MPa HDT (as defined in this document) of the polymer. In another alternative embodiment, the critical temperature of the polymer refers to the 0.455 MPa HDT (as defined in this document) of the polymer. In another alternative embodiment, the critical temperature of the polymer refers to the glass transition temperature (Tg) of the polymer. In another alternative embodiment, the critical temperature of the polymer refers to the Vicat temperature of the polymer. All the embodiments disclosed above can be combined among them and with any other embodiment disclosed in this document that relates to “the critical temperature of the polymer” in any combination, provided that they are not mutually exclusive. In an embodiment, the polymer of the mold refers to the polymer with a higher volume fraction. In an alternative embodiment, the polymer of the mold refers to the polymer with a higher weight fraction. In another alternative embodiment, the temperature is the weighted mean, using volume fraction as weight factors. In different embodiments, the upper level for the temperature in step B1 is 2.4 times, 1.4 times, 1 time and even 0.8 times the critical temperature (as defined in this document). In different embodiments, the lower level for the temperature in step B1 is 0.2 times, 0.4 times the critical temperature, 0.8 times the critical temperature and even the critical temperature (as defined in this document). In different embodiments, the time for which the temperature is kept at the desired level in step B1 is 3 minutes or more, 16 minutes or more, 32 minutes or more, 65 minutes or more and even 160 minutes or more. On the other hand, excessively long times may be disadvantageous. In different embodiments, the time for which the temperature is kept at the desired level in step B1 is less than 27 hours, less than 9 hours and even less than 6 hours. In different embodiments, the upper pressure level in step C1 is 6400 bar, 2900 bar, 2400 bar, 1900 bar and even 990 bar. In different embodiments, the lower pressure level in step C1 is 310 bar or more, 610 bar or more, 1100 bar or more, 1600 bar or more and even 2100 bar or more. In different embodiments, the time for which the pressure is kept at the desired level in step B1 is 3 minutes or more, 16 minutes or more, 32 minutes or more, 65 minutes or more and even 160 minutes or more. On the other hand, excessively long times may be disadvantageous. In different embodiments, the time for which the pressure is kept at the desired level in step B1 is 26 hours or less, 12 hours or less, 8 hours or less, 5 hours or less, and even 2 hours or less. For some applications, it may be more recommendable to work with temperature values to define the steps in the staircase and not relate them to the intrinsic properties of the polymers used for the construction of the mold. In different embodiments, the low enough temperature level in step A1 is 190° C. or less, 140° C. or less, 90° C. or less, and even 40° C. or less. In different embodiments, the upper level for the temperature in step B1 is 190° C., 159° C., 139° C. and even 119° C. In different embodiments, the lower level for the temperature in step B1 is 35° C., 45° C., 64° C., 84° C. and even 104° C. All the embodiments disclosed above can be combined among them and with any other embodiment disclosed in this document in any combination, provided that they are not mutually exclusive.

For some applications, step iii) may be very important to avoid internal defects in the manufactured components. In an embodiment, while keeping a high enough temperature, at least some of the to the mold applied pressure is released in step iii). In an embodiment, the temperature of the mold has the same meaning as in step ii). In different embodiments, a high enough temperature in step iii) means 320K or more, 350K or more, 380K or more, 400K or more, 500K or more. For some applications of the method, it may be advantageous to avoid excessively high temperatures. In different embodiments, the temperature of the mold in step iii) is kept below 690K, below 660K, below 560K, below 510K, below 470 K and even below 420K. All the embodiments disclosed above can be combined among them and with any other embodiment disclosed in this document in any combination, provided that they are not mutually exclusive, for example, in an embodiment, the high enough temperature in step iii) is a temperature between 320 and 790K; or for example, in another embodiment, between 320 and 690K; or for example, in another embodiment, between 350K and 690K. For some applications, it may be important to relate the temperature at which the mold is kept in step iii) to the material used for the manufacture of the mold. In an embodiment, the temperature of the mold is kept at 0.58*1.82 MPa HDT of the mold material or more, being 1.82 MPa HDT as defined in this document. In another embodiment, the temperature of the mold is kept at 1.15*1.82 MPa HDT of the mold material or more being 1.82 MPa HDT as defined in this document. In another embodiment, the temperature of the mold is kept at 1.55*1.82 MPa HDT of the mold material or more, being 1.82 MPa HDT as defined in this document. In an embodiment, the temperature of the mold is kept at 0.6*0.455 MPa HDT of the mold material or more, being 0.455 MPa HDT defined in this document. In another embodiment, the temperature of the mold is kept at 1.4*0.455 MPa HDT of the mold material, or more, being 0.455 MPa HDT as defined in this document. In another embodiment, the temperature of the mold is kept at 2.2*0.455 MPa HDT of the mold material or more, being 0.455 MPa HDT as defined in this document. In an embodiment, in the context of this paragraph, the calculations with HDT are done with temperatures expressed in Celsius degrees. In an alternative embodiment, in the context of this paragraph, the calculations with HDT are done with temperatures expressed in Kelvin degrees. In an embodiment, for mold materials having more than one phase with different HDT, the lowest value of any relevant part (defined in this document) is taken. In an embodiment, for mold materials having more than one phase with different HDT, the highest value of any relevant part (as defined in this document) is taken. In an embodiment, for mold materials having more than one phase with different HDT, the mean value of all relevant parts (as defined in this document) is taken. In the context of this paragraph, the mean value refers to the weighted arithmetic mean value, where the weights are the volume fractions. In an embodiment, for mold materials having more than one phase with different HDT, the mean value of all the parts that constitute the majority (as defined in this document) of the polymeric phase of the mold with the lowest HDT is taken. In an embodiment, for mold materials having more than one phase with different HDT, the mean value of all the parts constituting the majority (as defined in this document) of the polymeric phase of the mold with the highest HDT is taken. In an embodiment, the HDT is determined according to ISO 75-1:2013 standard. In an alternative embodiment, the values of HDT are determined according to the ASTM D648-07 standard test method. In an embodiment, the HDT is determined with a heating rate of 50° C./h. In another alternative embodiment, the HDT reported for the closest material in the UL IDES Prospector Plastic Database at 29/01/2018 is used. In an alternative embodiment, the HDT is replaced with the melting temperature for crystalline or semi-crystalline polymers. In different embodiments, the temperature of the mold is kept below 0.73*Tm, below 0.48*Tm, below 0.38*Tm, below 0.24*Tm, wherein Tm is the melting temperature in Kelvin of the metallic powder which is a relevant powder (as defined in this document) with the lowest melting point. In an alternative embodiment, Tm is the melting temperature in Kelvin of the powder mixture (as defined in this document) provided. In different embodiments, the temperature of the mold is kept below 0.68*Tm, below 0.48*Tm, below 0.42*Tm, below 0.34*Tm and even below 0.24*Tm, wherein Tm is the melting temperature in Kelvin of the metallic powder which is a relevant powder (as defined in this document) with the highest melting point. In an alternative embodiment, Tm is the melting temperature in Kelvin of the powder mixture (as defined in this document) provided. For some applications, the maximum relevant temperature reached in step iii) may be more important. In different embodiments, the maximum relevant temperature (as defined in this document) achieved in step iii) is 190° C. or less, 140° C. or less, 120° C. or less, 90° C. or less, Tm+50° C. or less, Tm+30° C. or less, Tm+10° C. or less, Tm or less, and even Tm−20° C. or less, wherein Tm is the melting temperature in Kelvin of the powder or powder mixture (as defined in this document) provided. In an alternative embodiment, Tm is the melting temperature of a relevant part (as defined in this document) of the mold. In an alternative embodiment, Tm is the melting temperature of the mold. In some particular embodiments the maximum relevant temperature applied in step iii) is the maximum temperature applied in step iii). The feature “releasing at least some of the to the mold applied pressure in step iii)” is defined throughout this document in the form of different alternatives, that are explained in detail below. In different embodiments, releasing at least some of the to the mold applied pressure in step iii) means the pressure is lowered at least 5%, at least 10%, at least 20%, at least 40%, at least 60%, and even at least 80% with respect to the highest value achieved in step i). In an embodiment, the percentage lowering of the pressure described in the previous lines refers not only to step i), but to any of steps i), ii) or iii), and thus the highest pressure reached in any of them. In different embodiments, the pressure is lowered at least 0.6 MPa, at least 2 MPa, at least 10 MPa and even at least 60 MPa with respect to the highest value achieved in step i). For some applications, the pressure level achieved in step iii) may be more important than the percentage reduction. In an embodiment, step iii) should read: while keeping a high enough temperature releasing at least some of the to mold applied pressure as to attain a pressure level below 390 MPa, below 90 MPa, below 19 MPa, below 9 MPa, below 4 MPa, below 0.4 MPa and even below 0.2 MPa. In an embodiment, all pressure is removed within step iii). Some applications are quite sensitive, particularly with respect to internal defects of components, to the rates used to release the pressure in step iii). In an embodiment, the pressure is released at a low enough rate (as defined in this document) at least within the final stretch. In different embodiments, the final stretch refers to the final 2%, the final 8%, the final 12%, the final 18%, and even the final 48% [taking as an initial point the highest pressure applied to the mold in any of steps i), ii) or iii), and as final point the minimum pressure applied to the mold in step iii)]. In different embodiments, the final stretch refers to the final 0.1 MPa, the final 0.4 MPa, the final 0.9 MPa, the final 1.9 MPa and even the final 9 MPa [before reaching the minimum pressure applied to the mold in step iii)]. All the embodiments disclosed above can be combined among them and with any other embodiment disclosed in this document in any combination, provided that they are not mutually exclusive.

In an embodiment, after step iii) the pressure applied to the mold is completely released if it was not already released in step iii). In another embodiment, after step iii), the pressure applied to the mold is completely released with the same caution regarding pressure release rates as described above for step iii). In another embodiment, after step iii) the pressure applied to the mold is completely released with the same fashion regarding pressure release steps as described above for step iii). In another embodiment, after step iii) the temperature of the mold is let drop to close to ambient values if it was not already done do in step iii). In another embodiment, after step iii) the mold is let drop to below 98° C. if it was not already done do in step iii). In another embodiment, after step iii) the temperature of the mold is let drop to below 48° C. if it was not already done do in step iii). In another embodiment, after step iii) the temperature of the mold is let drop to below 38° C. if it was not already done do in step iii). In another embodiment, after step iii), if not already done in step iii), the temperature of the mold is let drop to a value convenient for carrying out the following method step.

The duration of the process required for steps i) to iii) may be much higher than that involved in other high-pressure moderate temperature (below 0.5*Tm and very often below 0.3*Tm) existing processes. In different embodiments, the total time of steps i) to iii) is greater than 22 minutes, greater than 190 minutes, greater than 410 minutes. For some applications, not very long times are preferred. In different embodiments, the total time of steps i) to iii) is lower than 47 hours, lower than 12 hours and even lower than 7 hours. Another singular overall characteristic of the process used in steps i) to iii) is the large variations in temperature of the pressurized fluid taking place within the process. In different embodiments, the pressurized fluid maximum temperature gradient in steps i) to iii) is 25° C. or more, 55° C. or more, 105° C. or more. On the other hand, excessive temperature gradients may result in undesirable distortions. In different embodiments, the maximum pressurized fluid temperature gradient in steps i) to iii) is 245° C. or less, 195° C. or less, and even 145° C. or less. All the values and ranges of the different embodiments disclosed above can be combined among them and with any other embodiment disclosed in this document in any combination, provided that they are not mutually exclusive, for example, in an embodiment, the total time of steps i) to iii) is between 22 minutes and 47 hours; or for example, in another embodiment, the maximum pressurized fluid temperature gradient in steps i) to iii) is between 25° C. and 245° C.

In some instances, method steps ii), and iii) can be avoided, provided that a very precise selection is made of the powder mixture used to fill the mold and the material used to manufacture the mold. In some instances, also special care has to be taken how the pressure is released, especially for the pressure releasing rate, after method step i) when method steps ii), and iii) are skipped. In some instances, also special care has to be taken to make sure void internal features from the mold receive the pressure applied to the mold in step i) when steps ii), and iii) are skipped. In an embodiment, steps ii), and iii) are not present. In an embodiment, steps ii), and iii) are limited to release at least some of the pressure applied to the mold in step i). In an embodiment, steps ii), and iii) are not present as described provided at least some of the conditions described in this paragraph are met. Several efforts have been used in the past years to improve the properties of the materials obtained through AM. In this aspect of the disclosure, it may be convenient to deliberately choose very poor performing materials or deliberately aim at poor mechanical properties and even voids and constructive defects when manufacturing the mold. In fact, when a high performant material is used for the mold, according to this aspect of the disclosure, then even more care has to be taken to ensure that void internal features from the mold receive the pressure applied to the mold in step i), special care has to be taken how the pressure is released, proper filling rates have to be used and/or special powder mixtures used. In an embodiment, when steps ii), and iii) are skipped, at least one of the following has to take place:
I. the mold has a low tensile strength;
II. the mold has a high elastic modulus;
III. the mold has a significant drop in tensile strength when the strain rate is lowered;
IV. the filling of the mold is made with a high filling density;
V. the void internal features of the mold are allowed to have the applied pressure to the mold;
VI. pressure is released as described for step iii).

In different embodiments, a low tensile strength is 99 MPa or less, 49 MPa or less, 34 MPa or less, 29 MPa or less, 19 MPa or less, 14 MPa or less, and even 9 MPa or less. In different embodiments, a high elastic modulus is more than 1.06 GPa, more than 1.12 GPa, more than 1.28 GPa, more than 1.46 GPa, more than 1.77 GPa and even more than 2.08 GPa. For some applications, the elastic modulus should be limited. In different embodiments, a high elastic modulus is less than 6 GPa, less than 4 GPa, less than 3.2 GPa, less than 2.9 GPa and even less than 1.9 GPa. In an embodiment, the values of low tensile strength are measured with the proper strain rate. In different embodiments, the proper strain rate is a strain rate of 2500 s⁻¹, 500 s⁻¹, 50 s⁻¹, 1.0 s⁻¹, 1.10⁻² s⁻¹ and even 1-10⁻³ s⁻¹. In an embodiment, the tensile strength values disclosed above are at room temperature. In an embodiment, Point (II) is replaced by: the mold has a low elastic modulus. In different embodiments, a low elastic modulus is an elastic modulus of 0.96 GPa or less, 0.79 GPa or less, 0.74 GPa or less, 0.68 GPa or less, 0.48 GPa or less, and even 0.24 GPa or less. In an embodiment, the values of elastic modulus disclosed above are at room temperature. In different embodiments, a significant drop in the tensile strength is a drop of 6% or more, 12% or more, 16% or more, 22% or more and even 42% or more. In different embodiments, the significant drop in tensile strength is produced when the strain rate is lowered at least 0.1%, at least 1.1%, at least 3.2%, at least 18%, at least 26%, and even at least 41%. In different embodiments, the strain rate that is lowered is 2500 s⁻¹, 500 s⁻¹, 50 s⁻¹, 1.0 s⁻¹, 1-10⁻² s⁻¹ and even 1-10⁻³ s⁻¹. In an embodiment, only I, II, III, V and VI are taken into account. In another embodiment, only I, III, IV and V are taken into account. In an embodiment, V is not taken into account. In an embodiment, VI is not taken into account. In an embodiment, IV is not taken into account. In an embodiment, III is not taken into account. In an embodiment, II is not taken into account. In an embodiment, I is not taken into account. In an embodiment, VI is not taken into account. In an embodiment, at least two of the points have to take place. In another embodiment, at least three of the points have to take place. In another embodiment, at least four of the points have to take place.

In some embodiments, the pressure and/or temperature treatment, as described above, can be also advantageously applied to the component obtained when the treated powder or powder mixture is shaped using an additive manufacturing (AM) technology, as disclosed later in this document. In such cases the terms “pressure applied to the mold or “pressure applied to the filled mold” and “temperature applied to the mold” or “temperature applied to the filled mold” as used above can be replaced by “pressure applied to the component” and “temperature applied to the component” respectively (the term component may refer for example to the metal comprising component obtained after shaping the treated powder or powder mixture using an additive manufacturing (AM) technology, and/or to the metal comprising component obtained at any later stage, after applying other method steps, such as for example, the metal comprising component which is being subjected to a debinding treatment or the metal comprising component obtained after applying a debinding treatment). In this regard, the inventor has found, that in some embodiments, this pressure and/or temperature treatment may be advantageously applied to the component obtained after shaping the treated powder or powder mixture using an additive manufacturing (AM) technology before, during and/or after the debinding treatment, but often, the application of this pressure and/or temperature treatment may be particularly advantageous when performed before and/or during the debinding treatment. In some embodiments, the pressure and/or temperature treatment, as described above, can be also advantageously applied to the component obtained when the treated powder or powder mixture is shaped using a mold, as disclosed later in this document.

For some applications, it may be advantageous to use of several cycles. In an embodiment, at least two cycles of the pressure and/or temperature treatment are applied. In another embodiment, at least three cycles of the pressure and/or temperature treatment are applied. In some embodiments, it may be advantageous to perform the pressure and/or temperature treatment simultaneously (sequentially) with other method steps.

As described above, different metal additive manufacturing (MAM) methods can be used to form the treated powder or powder mixture into a component, or into a part of a component, also including the possibility of forming the component, or at least part of the component, in a layer-by-layer fashion. In another aspect of the present disclosure, the metal additive manufacturing (MAM) method comprises using an additive manufacturing (AM) technology to form the component or at least a part of the component. In this respect, the inventor has found that for certain applications, components with high mechanical properties, such as for example, but not limited to, mechanical strength, elongation and/or toughness can be manufactured with a surprisingly high design flexibility at a low cost and with low environmental impact when the metal additive manufacturing (MAM) method used is an additive manufacturing (AM) technology. In some embodiments, the AM technology used to form the component, or at least part of the component, may further comprise the use of an organic material (e.g., a polymer or polymeric material, binder and/or resin). In an embodiment, according to this aspect of the disclosure, the method comprises the steps of: providing a powder or powder mixture comprising at least a metal or a metal-based alloy; applying a treatment to the powder or powder mixture; and forming the component from the treated powder or powder mixture using an additive manufacturing (AM) technology.

Some examples of AM technologies that can be advantageously employed, include, but are not limited to, fused deposition (FDM), fused filament fabrication (FFF), stereolithography (SLA), digital light processing (DLP), continuous digital light processing (CDLP), digital light synthesis (DLS), a technology based on continuous liquid interface production (CLIP), material jetting (MJ), drop on demand (DOD), multi jet fusion (MJF), binder jetting (BJ), laser sintering (SLS), Joule Printing and/or combinations thereof. In an embodiment, the AM technology comprises the use of a filament or wire comprising a mixture of an organic material and the treated powder or powder mixture. In an embodiment, the AM technology comprises fusing at least part of the organic material into the filament or wire. In an embodiment, the AM technology comprises fusing at least part of the treated powder or powder mixture into the filament or wire. In an embodiment, the organic material acts as an adhesive to bind the particles of the treated powder or powder mixture. In another embodiment, the AM technology is a BJ technology, in which a binder is applied to each layer. In another embodiment, the AM technology is a FDM technology, in which an organic material comprising the treated powder or powder mixture is extruded through a nozzle to deposit the layers on a platform. In another embodiment, the AM technology is a FDM technology wherein the filament or wire used comprises a mixture of an organic material and the treated powder or powder mixture. In another embodiment, the AM technology is a FFF technology wherein the filament or wire used comprises a mixture of an organic material and the treated powder or powder mixture. In an embodiment, the AM technology is selected from FDM, FFF, SLA, DLP, CDLP, DLS, a technology based on CLIP, MJ, DOD, MJF, BJ, SLS, and/or combinations thereof. In another embodiment, the AM technology is selected from FDM, SLA, MJ, MJF, BJ, SLS and/or combinations thereof. For some applications, the use of more than one AM technology is preferred. In some particular embodiments, the metal additive manufacturing (MAM) method comprises the use of at least two different AM technologies.

All the embodiments disclosed above can be combined among them and with any other embodiment disclosed in this document in any combination, provided that they are not mutually exclusive, for example, in an embodiment, a method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; and shaping the treated powder or powder mixture using an additive manufacturing (AM) technology; or for example, in another embodiment, a method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action, and shaping the treated powder or powder mixture using an additive manufacturing (AM) technology at a right temperature, wherein a right temperature is a temperature of 0.74*Tm or less, wherein Tm is the melting temperature in Kelvin of the powder or powder mixture.

In some embodiments, the component obtained after the application of the metal additive manufacturing (MAM) method step disclosed above may be a final component, intended for the end use. However, often the component obtained in other embodiments may not be the final component (also referred to as the “green component” or “preform”), and the application of additional steps to obtain the final component, as disclosed below, may be advantageous.

Optionally, the method may further comprise a step wherein a debinding treatment is applied to eliminate the organic material or at least part of the organic material (also referred to as the “debinding step”) from the component obtained after applying the metal additive manufacturing (MAM) method. In an embodiment, the method further comprises the step of: applying a debinding treatment. In some embodiments, the component formed from the treated powder or powder mixture using the metal additive manufacturing (MAM) method as described above may comprise an organic material, such as for example, but not limited to, the mold or part of the mold used to provide the shape to the treated powder or powder mixture in some embodiments or the binder, resin, polymer or polymeric material, that may be part of the component obtained after shaping the treated powder or powder mixture using an additive manufacturing (AM) technology (as previously described, in some embodiments, the additive manufacturing technology employed may also comprise the use of an organic material such as for example, but not limited to, a polymer or polymeric material, a binder, a resin . . . ) that in some cases may be desirable to eliminate. On the other hand, there are also some particular applications in which the debinding step may not be necessary, for example, in certain embodiments where a particularly suitable selection of the organic material has been made.

In an embodiment, the debinding step comprises the elimination of at least part of the organic material. In another embodiment, the debinding step comprises the complete elimination of the organic material. Some examples of debinding treatments that can be applied include, but are not limited to, thermal debinding, non-thermal debinding (catalytic, wicking, drying, supercritical extraction, solvent extraction, organic solvent extraction, water-based solvent extraction, freeze drying . . . ), chemical debinding and/or combinations thereof.

For some applications, the use of a thermal debinding may be advantageous. In an embodiment, the debinding treatment comprises the application of a thermal debinding. On the other hand, the use of a non-thermal debinding may be advantageous for some components, particularly for certain components comprising metals or alloys that may be adversely affected by any of the thermal decomposition products of the organic material. In an embodiment, the debinding treatment comprises the application of a non-thermal debinding. The inventor has found that for some applications, it may be advantageous to eliminate at least part of the organic material by chemical attack to avoid undesirable chemical reactions during the debinding treatment. In an embodiment, the debinding treatment comprises the elimination of at least part of the organic material with solvents. The solvent extraction can be performed, for example, by immersion in a liquid solvent and/or or by contact with saturated vapour of a liquid solvent. In an embodiment, the debinding treatment comprises eliminating at least part of the organic material by immersion in a solvent.

In another embodiment, the debinding treatment comprises eliminating at least part of the organic material by contact with a solvent in vapour form. Some examples of solvents that can be used in the debinding step include, but are not limited to, polar solvents such as water, water-based solvents, oxalic acid, ammonium hydroxide, ethyl alcohol, methanol, isopropanol, dimethyl carbonate, acetonitrile, non-polar solvents such as limonene, heptane, pentane, hexane, cyclohexane or toluene, xylene, benzene, polyethylene glycol, methyl methacrylate, butyl acetate, ethyl acetate, sec-butyl alcohol, and/or mixtures thereof. In an embodiment, at least part of the organic material is eliminated using a polar solvent. In another embodiment, at least part of the organic material is eliminated using water and/or a water-based solvent. In another embodiment, at least part of the organic material is eliminated using a non-polar solvent. In this respect, the application of a treatment comprising the use of a solvent may be particularly advantageous for eliminating certain parts of the organic material (e.g., mold supports or other elements not required to provide the shape to the powder or powder mixture, for example, in certain embodiments where the mold is manufactured using at least two materials with different solubilities in a solvent). In an embodiment, the debinding treatment comprises the elimination of at least part of the elements of the mold that are not required to provide the shape to the powder or powder mixture using a solvent. In another embodiment, the debinding treatment comprises the elimination of at least part of the mold supports using a solvent that does not degrade the material of the mold. In some particular embodiments, at least part of the elements of the mold not required to provide the shape to the powder or powder mixture (e.g., mold supports) may be eliminated prior to applying the pressure and/or temperature treatment. In some embodiments, it may be advantageous to perform the debinding step simultaneously (sequentially) with other method steps.

For some applications, it may be advantageous to use of several cycles. In an embodiment, at least two cycles of the debinding treatment are applied. In another embodiment, at least three cycles of the debinding treatment are applied. On the other hand, in some particular embodiments, the debinding step may not be necessary and can therefore be skipped, for example, in certain embodiments where a suitable selection of the organic material used (e.g. to manufacture the mold . . . ) has been made.

All the embodiments disclosed above can be combined among them and with any other embodiment disclosed in this document in any combination, provided that they are not mutually exclusive, for example, in an embodiment, a method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; shaping the treated powder or powder mixture using an additive manufacturing (AM) technology; and applying a debinding treatment; or for example, in another embodiment, a method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; shaping the treated powder or powder mixture using an additive manufacturing (AM) technology at the right temperature; and applying a debinding treatment; or for example, in another embodiment, a method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action such that welding occurs; shaping the treated powder or powder mixture using an additive manufacturing (AM) technology at a temperature of 0.74*Tm or less, wherein Tm is the melting temperature in Kelvin of the powder or powder mixture; and applying a debinding treatment.

Optionally, the method may further comprise a step wherein the component is subjected to a pressure and/or temperature treatment (the pressure and/or temperature treatment as previously described in this document). In an embodiment, the method further comprises the step of: applying a pressure and/or temperature treatment. This pressure and/or temperature treatment may be advantageously applied to the component before, during and/or after the debinding step (in certain embodiments, the pressure and/or temperature treatment may also be applied to the component obtained after applying the metal additive manufacturing (MAM) method). In an embodiment, the method further comprises the step of: applying a pressure and/or temperature treatment before the debinding treatment. The inventor has found that the application of this pressure and/or temperature treatment may be particularly advantageous, among others, for setting the density of certain components to the desired value. In some embodiments, the components obtained after shaping the treated powder or powder mixture (e.g. the components obtained after shaping the treated powder or powder mixture using a mold and/or the component shaped using an additive manufacturing (AM) technology) may benefit from the application of a pressure and/or temperature treatment during and/or after applying a debinding treatment. In an embodiment, the method further comprises the step of: applying a pressure and/or temperature treatment during and/or after applying the debinding treatment. As explained before, the components obtained after shaping the treated powder or powder mixture using an additive manufacturing (AM) technology may also benefit from the application of a pressure and/or temperature treatment in some embodiments. In such cases, this pressure and/or temperature treatment may be advantageously applied before, during and/or after the application of a debinding treatment, but for some embodiments, the application of this pressure and/or temperature treatment may be particularly advantageous when performed before and/or during the debinding treatment. In an embodiment, the method further comprises the step of: applying a pressure and/or temperature treatment before, during and/or after applying the debinding treatment. In some embodiments, it may be advantageous to perform the pressure and/or temperature treatment simultaneously (sequentially) with other method steps. All the embodiments disclosed above can be combined among them and with any other embodiment disclosed in this document in any combination, provided that they are not mutually exclusive, for example, in an embodiment, the step of shaping the treated powder or powder mixture using a metal additive manufacturing (MAM) method comprises the use of an additive manufacturing (AM) technology to form the component or at least a part of the component, wherein the additive manufacturing (AM) technology further comprises the use of an organic material, and wherein the method further comprises the step of applying a pressure and/or temperature treatment, said treatment comprising the application of a pressure between 6 and 2100 MPa, and wherein the pressure and/or temperature treatment is applied before and/or during the application of a debinding treatment.

Optionally, the method may further comprise a step wherein a certain level of % C, % O, % N, % H and/or % B is set in the metallic part of the component (also referred to as the “fixing step”). In an embodiment, the method further comprises the step of: applying a fixing step for setting the % C, % O, % N, % H and/or % B levels in the metallic part of the component. In this regard, the inventor has found that a right selection of the levels of certain elements comprised in the metallic part of the component, to be set in the fixing step, may have a surprising effect on the properties that can be achieved in some manufactured components. In any event, the skilled person will know how to set the right values of the content of % C, % O, % N, % H and/or % B elements as given below. It may often be advantageous to perform the fixing step simultaneously (sequentially) with other method steps, for example, in certain embodiments where the equipment (e.g., furnace or pressure vessel) used to perform the treatment allows to change the atmosphere. In an embodiment, the fixing step is performed simultaneously (sequentially) with other method steps. All the embodiments disclosed above can be combined among them and with any other embodiment disclosed in this document in any combination, provided that they are not mutually exclusive, for example, in an embodiment, the component comprises at least the elements C, O, N, H and/or B in its metallic part, and the method further comprises the step of: applying a fixing step for setting the % C, % O, % N, % H and/or % B levels in the metallic part of the component.

In an embodiment, the fixing step comprises the use of a properly designed atmosphere (as defined in this document). The atmosphere used in the fixing step may have a significant effect on the performance of some manufactured components. The feature “properly designed atmosphere” is defined throughout this document in the form of different embodiments that are explained in detail below. In an embodiment, a properly designed atmosphere means a vacuum atmosphere. In different embodiments, a vacuum atmosphere means a vacuum level of 590 mbar or better, of 99 mbar or better, of 9 mbar or better, of 0.9 mbar or better, of 0.9*10⁻² mbar or better, of 0.9*10⁻³ mbar or better, of 0.9*10⁻⁴ mbar or better and even of 0.9*10⁻⁵ mbar or better. For some applications, too low vacuum levels may be disadvantageous. In different embodiments, a vacuum atmosphere means a vacuum level of 1.2*10⁻¹⁰ mbar or worse, of 1.2*10⁻⁸ mbar or worse, of 1.2*10⁻⁶ mbar or worse and even of 1.2*10⁻⁴ mbar or worse. In another embodiment, a properly designed atmosphere means an atmosphere comprising a noble gas. In another embodiment, a properly designed atmosphere means an atmosphere comprising mostly noble gases. In another embodiment, a properly designed atmosphere means an atmosphere comprising % Ar. In another embodiment, a properly designed atmosphere means an atmosphere comprising mostly % Ar. In another embodiment, a properly designed atmosphere means an atmosphere comprising % He. In another embodiment, a properly designed atmosphere means an atmosphere comprising mostly % He. In another embodiment, a properly designed atmosphere means an atmosphere comprising % N₂. In another embodiment, a properly designed atmosphere means an atmosphere comprising mostly % N₂. In another embodiment, a properly designed atmosphere means an atmosphere comprising % H₂. In another embodiment, a properly designed atmosphere means an atmosphere comprising mostly % H₂. In another embodiment, a properly designed atmosphere means an atmosphere comprising an organic gas. In another embodiment, a properly designed atmosphere means an atmosphere comprising mostly an organic gas. In different embodiments, comprising mostly means 55 wt % or more, 75 wt % or more, 85 wt % or more, 95.5 wt % or more, 99.1 wt % or more and even 99.92 wt % or more. In another embodiment, comprising mostly means that only unavoidable impurities are present. In another embodiment, a properly designed atmosphere means an atmosphere comprising at least two of the above gases. In an embodiment, a properly designed atmosphere means an atmosphere comprising at least two of the above gases where one of them is % H₂. In another embodiment, a properly designed atmosphere means an atmosphere comprising at least two of the above gases where one of them is % Ar. In another embodiment, a properly designed atmosphere means an atmosphere comprising at least two of the above gases where one of them is an organic gas. In another embodiment, a properly designed atmosphere means an atmosphere comprising at least two of the above gases where one of them is % N₂. In another embodiment, a properly designed atmosphere means an atmosphere comprising a right carbon potential. In different embodiments, a right carbon potential is carbon potential above 0.0001%, above 0.006%, above 0.11%, above 0.22%, above 0.31%, above 0.46%, above 0.81%, and even above 1.1%. For certain applications, the carbon potential should be kept below a certain value. In different embodiments, a right carbon potential is a carbon potential below 5.9%, below 2.9%, below 1.9%, below 1.58%, below 0.98%, below 0.69%, below 0.49%, below 0.19%, below 0.09%. In another embodiment, the right carbon potential is the result of measuring the carbon potential in the atmosphere of the furnace or pressure vessel. In another alternative embodiment, the right carbon potential is the result of measuring the carbon potential in the atmosphere of the furnace or pressure vessel using oxygen and carbon probes and calculating the carbon potential. In another alternative embodiment, the right carbon potential is the result of measuring the carbon potential in the atmosphere of the furnace or pressure vessel by means of NDIR (Non-Dispersive Infrared analyser). In another alternative embodiment, the right carbon potential is determined by simulation using ThermoCalc (version 2020b). In another embodiment, a properly designed atmosphere means an atmosphere comprising a right atomic nitrogen content. In different embodiments, the right atomic nitrogen content is an atomic nitrogen content of 0.078 mol % or more, 0.78 mol % or more, 1.17 mol % or more, 1.56 mol % or more, 2.34 mol % or more, 3.55 mol % or more and even 4.68 mol % or more. For certain applications, an excessive content may be detrimental. In different embodiments, the right atomic nitrogen content is an atomic nitrogen content of 46.8 mol % or less, 15.21 mol % or less, 11.31 mol % or less, 7.91 mol % or less, 5.46 mol % or less, and even 3.47 mol % or less. For certain applications, the use of atmospheres comprising higher atomic nitrogen contents is preferred. In different embodiments, the right atomic nitrogen content is an atomic nitrogen content of 2.14 mol % or more, 4.29 mol % or more, 6.24 mol % or more, 8.19 mol % or more, 10.14 mol % or more, 21.45 mol % or more and even 39.78 mol % or more. For certain applications, an excessive content may be detrimental. In different embodiments, the right atomic nitrogen content is an atomic nitrogen content of 89 mol % or less, 69 mol % or less, 49 mol % or less, 29 mol % or less, 19 mol % or less, 14 mol % or less, and even 9 mol % or less. For some applications, the atomic nitrogen content can be replaced by any alternative atmosphere that provides the same percentage of atomic nitrogen. For some applications, atomic nitrogen is introduced by the use of ammonia (NH₃). In another embodiment, a properly designed atmosphere means an atmosphere comprising a right nitrogen content. In different embodiments, an atmosphere having the right nitrogen content is an atmosphere having a nitrogen content of 0.02 wt % or more, of 0.2 wt % or more, of 0.3 wt % or more, of 0.4 wt % or more, of 0.6 wt % or more, of 0.91 wt % or more and even of 1.2 wt % or more. On the other hand, excessive content of nitrogen may be detrimental. In different embodiments, an atmosphere having the right nitrogen content is an atmosphere having a nitrogen content of 3.9 wt % or less, of 2.9 wt % or less, of 1.9 wt % or less, of 1.4 wt % or less, and even of 0.89 wt % or less. In another embodiment, a properly designed atmosphere means an atmosphere comprising ammonia. In different embodiments, the ammonia content is more than 0.1% by volume, more than 0.11% by volume, more than 2.2% by volume, more than 5.2% by volume and even more than 10.2% by volume. On the other hand, excessive content of ammonia may be detrimental. In different embodiments, the ammonia content is less than 89% by volume, less than 49%, less than 19% by volume less than 14% by volume, less than 9% by volume and even less than 4% by volume. For some applications, it may be better to control the pO₂ (oxygen partial pressure). In different embodiments, a properly designed atmosphere means an atmosphere where pO₂ is 4*10⁻¹ atm or lower, 4*10⁻³ atm or lower, 4*10⁻⁴ atm or lower, 4*10⁻¹⁰ atm or lower, 4*10⁻¹⁴ atm or lower, 4*10⁻¹⁸ atm or lower and even 4*10⁻²⁴ atm or lower. On the other hand, excessively low pO₂ may be disadvantageous. In different embodiments, a properly designed atmosphere means an atmosphere where pO₂ is 4*10⁻³⁸ atm or higher, 4*10⁻³² atm or higher, 4*10⁻²⁸ atm or higher, 4*10⁻²⁴ atm or higher and even 4*10⁻¹⁹ atm or higher. For some applications, it may be more efficient to control pCO/pCO₂. In different embodiments, a properly designed atmosphere means an atmosphere where pCO/pCO₂ is 2*10⁻¹² or higher, 2*10⁻⁴ or higher, 2*10⁻¹ or higher, 2*10¹ or higher, 2*10³ or higher, 2*10⁵ or higher, 2*10⁷ or higher and even 2*10¹² or higher. On the other hand, an excessively high level of pCO/pCO₂ may be detrimental. In different embodiments, a properly designed atmosphere means an atmosphere where pCO/pCO₂ is 2*10¹⁴ or lower, 2*10¹² or lower, 2*109 or lower and even 2*10⁶ or lower. For some applications, it may be more efficient to control pH2/pH2O. In different embodiments, a properly designed atmosphere means an atmosphere where pH2/pH2O is 2*10⁻⁸ or higher, 2*10⁻⁵ or higher, 2*10⁻² or higher, 2*10¹ or higher, 2*10² or higher, 2*104 or higher, 2*10⁶ or higher and even 2*10¹¹ or higher. In some instances, an excessively high level of pH2/pH2O may be detrimental. In different embodiments, a properly designed atmosphere means an atmosphere where pH2/pH2O is 2*10¹³ or lower, 2*10¹¹ or lower, 2*10⁸ or lower and even 2*105 or lower. For some applications, mixtures of the above atmospheres may be particularly desirable. For some applications, it may also be advantageous to change the atmosphere in the furnace or pressure vessel during the fixing step. In an embodiment, the fixing step comprises the use of at least two different atmospheres. All the embodiments disclosed above can be combined among them and with any other embodiment disclosed in this document that relates to a “properly designed atmosphere” in any combination, provided that they are not mutually exclusive. In some embodiments, a properly designed atmosphere as disclosed in this paragraph can also be used in other method steps (e.g., consolidation treatment, densification treatment, . . . ). For some applications, the use of an % O₂ comprising atmosphere in the fixing step may be advantageous. In an embodiment, the fixing step comprises the use of an % O₂ comprising atmosphere at the right temperature for the right time (as defined in this document). Unless otherwise stated, the feature “% O₂ comprising atmosphere at the right temperature for the right time” is defined throughout the present document in the form of different alternatives, that are explained in detail below. For certain applications, the O₂ content in the % O₂ comprising atmosphere is relevant. In different embodiments, % O₂ is 0.002 vol % or more, 0.02 vol % or more, 0.11 vol % or more, 0.22 vol % or more, 1.2 vol % or more, 6 vol % or more, 12 vol % or more and even 42 vol % or more. In some particular embodiments, the use of pure O₂ may be advantageous. On the contrary, for some applications, the % O₂ should be maintained below a certain level. In different embodiments, the % O₂ is 89 vol % or less, 49 vol % or less, 19 vol % or less, 4 vol % or less and even 0.9 vol % or less. The inventor has also found that for some applications, the presence of Ar, N₂ or other inert gases is advantageous. In an embodiment, the % O₂ comprising atmosphere further comprises a gas which is mainly Ar. In an embodiment, the % O₂ comprising atmosphere further comprises a gas which is mainly an inert gas. In another embodiment, the % O₂ comprising atmosphere further comprises a gas which is mainly N₂. In another embodiment, the % O₂ comprising atmosphere further comprises a gas which is mainly a mixture of inert gases. In different embodiments, the right temperature is a temperature higher than 55° C., higher than 105° C., higher than 155, higher than 176° C., higher than 210° C. and even higher than 260° C. For some applications, excessive temperature may be detrimental. In different embodiments, the right temperature is a temperature lower than 890° C., lower than 590° C., lower than 490° C., lower than 390° C., lower than 345° C., lower than 290° C. and even lower than 240° C. In different embodiments, the right time is more than 1 h, more than 2.5 h, more than 6 h, more than 8 h and even more than 11 h. For some applications, excessively long times are disadvantageous. In different embodiments, the right time is less than 90 h, less than 49 h, less than 29 h, less than 19 h, less than 14 h and even less than 9 h. In some embodiments, % O₂ comprising atmosphere at the right temperature for the right time (as defined in this document) as disclosed in this paragraph can also be used in other method steps (e.g., debinding treatment, consolidation treatment, densification treatment, . . . ).

For some applications, the carbon content in the metallic part of the component after the fixing step may be relevant, among others, to the properties of some components. In an embodiment, the metallic part of the component comprises a right % C content after the fixing step. The feature “right % C content” is defined throughout this document in in the form of different alternatives that are explained in detail below. In different embodiments, the content of carbon (% C) after the fixing step is a carbon content of 0.01 ppm or more, 0.6 ppm or more, 0.06 wt % or more, 0.1 wt % or more, 0.21 wt % or more, 0.81 wt % or more, 1.1 wt % or more and even 2.1 wt % or more. On the other hand, an excessive content of % C may be detrimental for some applications. In different embodiments, the content of carbon (% C) after the fixing step is a carbon content of 3.9 wt % or less, 2.09 wt % or less, 1.19 wt % or less, 0.98 wt % or less, 0.69 wt % or less, and even 0.34 wt % or less. All the values and ranges of the different embodiments disclosed above can be combined among them and with any other embodiment disclosed in this document in any combination, provided that they are not mutually exclusive, for example, in an embodiment, the carbon content in the metallic part of the component after the fixing step is a right % C content, wherein a right % C content is a carbon content between 0.01 ppm and 3.9 wt %; or for example, in another embodiment, between 0.6 ppm and 2.09 wt %; or for example, in another embodiment, between 0.06 wt % and 2.09 wt %. Alternatively or additionally, the oxygen content in the metallic part of the component after the fixing step may be relevant for some applications. In an embodiment, the metallic part of the component comprises a right % O content after the fixing step. The feature “right % O content” is defined throughout this document in in the form of different alternatives that are explained in detail below. In different embodiments, the right content of oxygen (% O) after the fixing step is an oxygen content of 0.01 ppm, 0.6 ppm or more, 16 ppm or more, 61 ppm or more, 310 ppm or more, 1100 ppm or more, 2600 ppm or more and even 5100 ppm or more. On the other hand, an excessive content of % O may be detrimental for some applications. In different embodiments, the right content of oxygen (% O) after the fixing step is an oxygen content of 19000 ppm or less, 8900 ppm or less, 3400 ppm or less, 890 ppm or less, 490 ppm or less, 340 ppm or less, and even 190 ppm or less. All the values and ranges of the different embodiments disclosed above can be combined among them and with any other embodiment disclosed in this document in any combination, provided that they are not mutually exclusive, for example, in an embodiment, the oxygen content in the metallic part of the component after the fixing step is a right % O content, wherein a right % O content is an oxygen content between 0.01 and 19000 ppm or for example, in another embodiment, between 0.6 and 19000 ppm; or for example, in another embodiment, between 16 and 8900 ppm. Alternatively or additionally, the nitrogen content in the metallic part of the component after the fixing step may be relevant for some applications. In an embodiment, the metallic part of the component comprises a right % N content after the fixing step. The feature “right % N content” is defined throughout this document in in the form of different alternatives that are explained in detail below. In different embodiments, the right content of nitrogen (% N) after the fixing step is a nitrogen content of 0.01 ppm or more, 0.6 ppm or more, 1 ppm or more, 16 ppm or more, 51 ppm or more, 110 ppm or more, 310 ppm or more, 1100 ppm or more and even 2600 ppm or more. On the other hand, an excessive content of % N may be detrimental for some applications. In different embodiments, the right content of nitrogen (% N) after the fixing step is a nitrogen content of 2.9 wt % or less, 0.9 wt % or less, 0.19 wt % or less, 0.09 wt % or less, 9000 ppm or less, 2900 ppm or less, 900 ppm or less, 440 ppm or less, 290 ppm or less, 90 ppm or less, 19 or less and even 9 or less. All the values and ranges of the different embodiments disclosed above can be combined among them and with any other embodiment disclosed in this document in any combination, provided that they are not mutually exclusive, for example, in an embodiment, the nitrogen content in the metallic part of the component after the fixing step is a right % N content, wherein a right % N content is a nitrogen content between 0.01 ppm and 2.9 wt % or for example, in another embodiment, between 0.6 and 0.9 wt %; or for example, in another embodiment, between 16 and 9000 ppm. Alternatively or additionally, the hydrogen content in the metallic part of the component after the fixing step may be relevant for some applications. In an embodiment, the metallic part of the component comprises a right % H content after the fixing step. The feature “right % H content” is defined throughout this document in in the form of different alternatives that are explained in detail below. In different embodiments, the content of % H after the fixing step is 0.01 ppm or more, 0.6 ppm or more, 6 ppm or more, 21 ppm or more, 56 ppm or more and even 510 ppm or more. On the other hand, an excessive content of % H may be detrimental for some applications. In different embodiments, the content of % H after the fixing step is 5400 ppm or less, 1400 ppm or less, 490 ppm or less, 90 ppm less, and even 74 ppm or less. All the values and ranges of the different embodiments disclosed above can be combined among them and with any other embodiment disclosed in this document in any combination, provided that they are not mutually exclusive, for example, in an embodiment, the nitrogen content in the metallic part of the component after the fixing step is a right % H content, wherein a right % H content is a hydrogen content between 0.01 and 5400 ppm or for example, in another embodiment, between 0.6 and 1400 ppm; or for example, in another embodiment, between 6 and 1400 ppm. Alternatively or additionally, the boron content in the metallic part of the component after the fixing step may be relevant for some applications. In an embodiment, the metallic part of the component comprises a right % B content after the fixing step. The feature “right % B content” is defined throughout this document in in the form of different alternatives that are explained in detail below. In different embodiments, the content of % B after the fixing step is 0.01 ppm or more, 0.6 ppm or more, 0.7 ppm or more, 16 ppm or more, 76 ppm or more, 260 ppm or more, 710 ppm or more and even 3600 ppm or more. On the other hand, an excessive content of % B may be detrimental for some applications. In different embodiments, the content of % B after the fixing step is 0.24 wt % or less, 0.09 wt % or less, 24000 ppm or less, 9000 ppm or less, 2900 ppm or less, 890 ppm or less, 490 ppm or less, 140 ppm or less, and even 54 ppm or less. All the values and ranges of the different embodiments disclosed above can be combined among them and with any other embodiment disclosed in this document in any combination, provided that they are not mutually exclusive, for example, in an embodiment, the boron content in the metallic part of the component after the fixing step is a right % B content, wherein a right % B content is a boron content between 0.01 ppm and 0.24 wt % or for example, in another embodiment, between 0.6 and 24000 ppm; or for example, in another embodiment, between 16 and 9000 ppm.

All the embodiments disclosed above can be combined among them and with any other embodiment disclosed in this document, provided that they are not mutually exclusive, for example, in an embodiment, a method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; providing a mold at least partly manufactured by additive manufacturing (AM); filling the mold with the treated powder or powder mixture; applying a pressure and/or temperature treatment; wherein the pressure and/or temperature treatment comprises the following steps: step i) subjecting the component to high pressure, wherein the maximum pressure applied is between 12 MPa and 790 MPa; step ii) while keeping a high pressure level, raising the temperature of the component; step iii) while keeping a high enough temperature between 320K and 790K, releasing at least some of the to the component applied pressure; and applying a debinding treatment; optionally, applying a pressure and/or temperature treatment; and applying a fixing step for setting the % C, % O, % N, % H and/or % B levels in the component; or for example, in another embodiment, a method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; shaping the treated powder or powder mixture using an additive manufacturing (AM) technology at a right temperature, wherein a right temperature is a temperature between 0.08*Tm and 0.74*Tm, being Tm the melting temperature in Kelvin of the powder or powder mixture provided, wherein the additive manufacturing (AM) technology employed further comprises the use of an organic material; applying a pressure and/or temperature treatment, wherein the pressure and/or temperature treatment comprises the following steps: step i) subjecting the component to high pressure, wherein the maximum pressure applied is between 12 MPa and 790 MPa; step ii) while keeping a high pressure level, raising the temperature of the component; step iii) while keeping a high enough temperature between 320K and 790K, releasing at least some of the to the component applied pressure; and applying a debinding treatment to eliminate at least part of the organic material; and applying a fixing step for setting the % C, % O, % N, % H and/or % B levels in the component, wherein the pressure and/or temperature treatment is applied before and/or during the application of the debinding treatment.

Optionally, the method may further comprise a step wherein the component is subjected to a consolidation treatment (also referred to as the “consolidation step”). The consolidation step may significantly influence the macrostructure, microstructure and tensile properties of some components, high-cycle fatigue life, and so on. In an embodiment, the method further comprises the step of: applying a consolidation treatment. The consolidation treatment may, among others, help to reduce or even eliminate the internal porosity of some components, further having a strong contribution on some properties, in particular mechanical and thermo-electrical properties. The consolidation treatment may also be relevant for certain applications requiring seamless, and very high performant large components resulting from the joining of smaller components, at least some of which are manufactured with the metal comprising manufacturing method disclosed in this document and joined together (as described in this document). Different consolidation treatments can be applied such as for example, but not limited to, a sintering treatment, including, but not limited to, spark plasma sintering. In an embodiment, the consolidation treatment comprises applying a sintering. For some applications, the atmosphere used in the consolidation treatment may be important. In an embodiment, the consolidation treatment comprises the use of a properly designed atmosphere (as defined in this document). For some applications, it may also be advantageous to change the atmosphere in the furnace or pressure vessel during the treatment. In an embodiment, the consolidation treatment comprises the use of at least two different atmospheres. Often, some of the treatments may be performed sequentially (e.g., the debinding treatment and the consolidation treatment, . . . ), for example, in certain embodiments where the equipment (e.g., furnace or pressure vessel) used to perform the treatment allows to change the atmosphere. In some embodiments, it may be advantageous to perform the consolidation treatment simultaneously (sequentially) with other method steps.

In some embodiments, the consolidation treatment may comprise the application of temperature. For some applications, it may be particularly important to properly select the temperature in the consolidation treatment. In this respect, the inventor has surprisingly found that components with a particularly high dimensional accuracy and absence of defects can be obtained for some geometries even when particularly low temperatures are applied in the consolidation treatment. In different embodiments, the temperature applied (as defined in this document) in the consolidation treatment is 0.36*Tm or more, 0.46*Tm or more, 0.54*Tm or more, 0.66*Tm or more, wherein Tm is the melting temperature in Kelvin of the powder or powder mixture (as defined in this document) provided. For some particular applications, higher temperatures may be preferred. In different embodiments, the temperature applied (as defined in this document) in the consolidation treatment is 0.72*Tm or more, 0.76*Tm or more, 0.85*Tm or more and even 0.89*Tm or more, being Tm the melting temperature in Kelvin of the powder or powder mixture (as defined in this document) provided. As described above, for some applications, it may be particularly advantageous to keep the temperature in the consolidation treatment rather low. In different embodiments, the temperature applied (as defined in this document) in the consolidation treatment is 0.96*Tm or less, 0.88*Tm or less, 0.78*Tm or less, 0.68*Tm or less, and even 0.63*Tm or less, wherein Tm is the melting temperature in Kelvin of the powder or powder mixture (as defined in this document) provided. All the values and ranges of the different embodiments disclosed above can be combined among them and with any other embodiment disclosed in this document in any combination, provided that they are not mutually exclusive, for example, in an embodiment, the consolidation treatment comprises the application of a temperature between 0.36*Tm and 0.96*Tm, being Tm the melting temperature in Kelvin of the powder or powder mixture provided; or for example, in another embodiment, between 0.36*Tm and 0.88*Tm, being Tm the melting temperature in Kelvin of the powder or powder mixture provided; or for example, in another embodiment, between 0.46*Tm and 0.78*Tm, being Tm the melting temperature in Kelvin of the powder or powder mixture provided; or for example, in another embodiment, between 0.36*Tm and 0.96*Tm, being Tm the melting temperature in Kelvin of the metallic powder with the lowest melting point in the powder of powder mixture provided, wherein the melting temperature of such metallic powder is the temperature at which the first metal liquid forms under equilibrium conditions; or for example, in another embodiment, between 0.36*Tm and 0.96*Tm, being Tm the melting temperature in Kelvin of the metallic powder, which is at least 2.6% by weight of all the metallic powders in the powder or powder mixture provided, with the lowest melting point, wherein the melting temperature of such metallic powder is the temperature at which the first metal liquid forms under equilibrium conditions.

For some applications, the presence of certain liquid phase during the consolidation treatment may be acceptable, and even advantageous. In different embodiments, the temperature applied (as defined in this document) in the consolidation treatment is 0.96*Tm or more, Tm or more, 1.02*Tm or more, 1.06*Tm or more, 1.12*Tm or more, 1.25*Tm or more and even 1.3*Tm or more, wherein Tm is the melting temperature in Kelvin of the powder or powder mixture (as defined in this document). For some applications, it may be better to define the temperature in the consolidation treatment in terms of overheating. In different embodiments, the temperature applied (as defined in this document) in the consolidation treatment is Tm+1 or more, Tm+11 or more, Tm+22 or more, Tm+51 or more, Tm+105 or more, Tm+205 or more and even Tm+405 or more, wherein Tm is the melting temperature in Kelvin of the powder or powder mixture (as defined in this document). On the other hand, it may be advantageous to keep the temperature below a certain value. In different embodiments, the temperature applied (as defined in this document) in the consolidation treatment is 1.9*Tm or less, 1.49*Tm or less, 1.29*Tm or less, and even 1.19*Tm or less, wherein Tm is the melting temperature in Kelvin of the powder or powder mixture (as defined in this document). In different embodiments, the temperature in the consolidation treatment is Tm+890 or less, Tm+450 or less, Tm+290 or less, Tm+190 or less, and even Tm+90 or less, wherein Tm is the melting temperature in Kelvin of the powder or powder mixture (as defined in this document). In the context of this paragraph, the temperatures are expressed in Kelvin. For some of these applications, the percentage of liquid phase may be more relevant. In different embodiments, the maximum liquid phase during the consolidation treatment is above 0.2% by volume, above 1.2% by volume, above 3.6% by volume, above 6% by volume, above 11% by volume and even above 21% by volume. On the other hand, excessive liquid phase should be avoided. In different embodiments, the liquid phase is maintained below 39% by volume, below 29% by volume, below 19% by volume, below 9% by volume and even below 4% by volume at any time during the consolidation treatment. All the values and ranges of the different embodiments disclosed above can be combined among them and with any other embodiment disclosed in this document in any combination, provided that they are not mutually exclusive, for example, in an embodiment, the consolidation treatment comprises the application of a temperature between 0.96*Tm and 1.9*Tm, being Tm the melting temperature in Kelvin of the powder or powder mixture provided; or for example, in another embodiment, between 0.96*Tm and 1.9*Tm, being Tm the melting temperature in Kelvin of the metallic powder with the lowest melting point in the powder of powder mixture provided, wherein the melting temperature of such metallic powder is the temperature at which the first metal liquid forms under equilibrium conditions; or for example, in another embodiment, between 0.96*Tm and 1.9*Tm, being Tm the melting temperature in Kelvin of the metallic powder, which is at least 2.6% by weight of all the metallic powders in the powder or powder mixture provided, with the lowest melting point, wherein the melting temperature of such metallic powder is the temperature at which the first metal liquid forms under equilibrium conditions.

Additionally or alternatively, in some embodiments, the consolidation treatment may comprise the application of pressure. For some applications, it may be advantageous to perform the consolidation treatment under a certain pressure. In an embodiment, the consolidation treatment further comprises the application of pressure. In this respect, the inventor has found that the pressure applied (as defined in this document) in the consolidation step may help to achieve very high densities and even full density (the maximum theoretical density) in some components. In different embodiments, the pressure applied (as defined in this document) in the consolidation treatment is at least 1 mbar, at least 10 mbar, at least 0.1 bar, at least 1.6 bar, at least 10.1 bar, at least 21 bar and even at least 61 bar. On the other hand, excessive pressures may be detrimental for some treatments. In different embodiments, the pressure applied (as defined in this document) in the consolidation treatment is less than 4900 bar, less than 790 bar, less than 89 bar, less than 8 bar, less than 1.4 bar and even less than 800 mbar. Even in certain embodiments, a consolidation treatment under vacuum may be advantageous. All the values and ranges of the different embodiments disclosed above can be combined among them and with any other embodiment disclosed in this document in any combination, provided that they are not mutually exclusive, for example, in an embodiment, the consolidation treatment comprises the application of a pressure between 1 mbar and 4900 mbar; or for example, in another embodiment, between 10 mbar and 790 bar; or for example, in another embodiment, between 0.1 and 790 bar. All the embodiments disclosed above can be combined among them and with any other embodiment disclosed in this document in any combination, provided that they are not mutually exclusive, for example, in an embodiment, the method further comprises the step of: applying a consolidation treatment, wherein the consolidation treatment comprises the application of a pressure between 1 mbar and 4900 bar and a temperature between 0.36*Tm and 0.88*Tm, being Tm the melting temperature in Kelvin of the powder or powder mixture provided.

In certain embodiments, a good strategy for avoiding density loss during the consolidation step can be based on the consolidation strategy as described in patent application number WO2021165545A1, the contents of which are incorporated herein by reference in their entirety. As explained in that patent application, for some applications, the negative effect can be significantly reduced if at least a part of the consolidation step is performed under pressure. In some applications, consolidation under pressure can help to achieve very high densities even the maximum theoretical density. As explained in WO2021165545A1, for some applications, when pressure is applied, the temperature process window for achieving very high densities is rather small and involving relatively low temperatures. In an embodiment, the consolidation to high densities can be achieved by a process comprising the following steps:

Step 1i: Raising the temperature while keeping a low pressure.

Step 2i: Keeping the temperature at a high level while keeping the pressure at a low level for a long enough time period.

Step 3i: Raising the pressure to a high level.

Step 4i: Keeping a high pressure and high temperature for a long enough time period.

In an embodiment, all steps are performed in the same furnace/pressure vessel. In an embodiment, all steps are performed in a HIP (Hot Isostatic Pressure) equipment. In an embodiment, at least two pieces of equipment are used to execute all steps 1 i-4i. In an embodiment, at least two furnace/pressure vessels are involved to execute steps 1 i-4i. In different embodiments, the pressure in step 1i is 900 bar or less, 90 bar or less, 9 bar or less, 1.9 bar or less, 0.9 bar or less, and even 900 mbar or less. For some applications, the pressure in step 1i should be maintained above a certain value. In different embodiments, the pressure in step 1i is 0. 9 mbar or more, 9 mbar or more, 90 mbar or more and even 0.09 bar or more. In different embodiments, the temperature in step 1i is raised to 0.36*Tm or more, to 0.46*Tm or more, to 0.54*Tm or more, to 0.66*Tm or more, to 0.72*Tm or more and even to 0.76*Tm or more, wherein Tm is the melting temperature in Kelvin of the powder mixture (as defined in this document) provided. As explained above, for some applications it may be advantageous to keep temperature in step 1i rather low. In different embodiments, the temperature in step 1i is raised to 0.89*Tm or less, to 0.79*Tm or less, to 0.74*Tm or less, to 0.69*Tm or less, and even to 0.64*Tm or less, wherein Tm is the melting temperature in Kelvin of the powder mixture (as defined in this document) provided. In an embodiment, the pressure levels in step 2i are the same as those in step 1i. In an embodiment, the same pressure limits described above for step 1i apply for step 2i although the actual pressure value might be different in steps 1i and 2i. In an embodiment, the temperature levels in step 2i are the same as those in step 1i. In an embodiment, the same temperature limits described above for step 1i apply for step 2i although the actual temperature value might be different in steps 1i and 2i. In different embodiments, a long enough time period in step 2i is 6 minutes or more, 12 minutes or more, 32 minutes or more, 62 minutes or more, 122 minutes or more and even 240 minutes or more. For some applications a too long time in step 2i leads to lower density. In different embodiments, the long enough period of time in step 2i is less than 590 minutes, less than 390 minutes, less than 290 minutes, less than 240 minutes, less than 110 minutes and even less than 40 minutes. In different embodiments, the high level of pressure in step 3i is 210 bar or more, 510 bar or more, 810 bar or more, 1010 bar or more, 1520 bar or more and even 2220 bar or more. On the other hand, excessive pressures may be disadvantageous for some treatments. In different embodiments, the high level of pressure in step 3i is 6400 bar or less, 2900 bar or less, and even 1900 bar or less. In another embodiment, the pressure levels in step 4i are the same as those in step 3i. In another embodiment, the same pressure limits described above for step 3i apply for step 4i although the actual pressure value might be different in steps 3i and 4i. In different embodiments, the temperature in step 4i is raised to 0.76*Tm or more, to 0.82*Tm or more, to 0.86*Tm or more, to 0.91*Tm or more, to 0.96*Tm or more and even to 1.05*Tm or more, wherein Tm is the melting temperature in Kelvin of the powder mixture (as defined in this document) provided. In different embodiments, the long enough period of time in step 4i is 16 minutes or more, 66 minutes or more, 125 minutes or more, 178 minutes or more, 250 minutes or more and even 510 minutes or more. On the other hand, excessively long times are disadvantageous. In different embodiments, the long enough period of time in step 4i is less than 590 minutes, less than 390 minutes, less than 290 minutes, less than 240 minutes, less than 110 minutes and even less than 40 minutes. In an embodiment, additionally to steps 1i-4i also a debinding step is incorporated. Some applications may benefit from the present strategy when a carbonyl powder is used in a right amount. In an embodiment, the powder mixture used comprises a carbonyl powder. In an embodiment, the powder mixture used comprises a carbonyl iron powder. In an embodiment, the powder mixture used comprises a carbonyl nickel powder. In an embodiment, the powder mixture used comprises a carbonyl titanium powder. In an embodiment, the powder mixture used comprises a carbonyl cobalt powder. In an embodiment, the carbonyl powder is a high purity powder of the mentioned metal element resulting from the decomposition of the carbonyl. In an embodiment, the carbonyl powder is a high purity powder of the mentioned metal element resulting from the decomposition of the purified carbonyl (for example: high purity carbonyl iron resulting from the chemical decomposition of purified iron pentacarbonyl). In different embodiments, the carbonyl powder is present in an amount exceeding 6 wt %, exceeding 16 wt %, exceeding 21 wt %, exceeding 36 wt %, exceeding 52 wt %, and even exceeding 66 wt % of all metal or metal alloy powders. On the other hand, excessive carbonyl content may de undesirable. In different embodiments, the carbonyl powder is present in an amount of 79 wt % or less, of 69 wt % or less, of 49 wt % or less, of 39 wt % or less, and even of 29 wt % or less. In an embodiment, the treatments described in this paragraph are applied to a component manufactured by a method comprising an AM step. In an embodiment, the treatment described in this paragraph is applied to a component whose manufacture comprises a low temperature AM step where the temperatures involved in the binding of the powder to manufacture the component during the AM step are below 0.49*Tm, wherein Tm is the melting temperature in Kelvin of the powder mixture (as defined in this document) provided. In an embodiment, the treatment further comprises adding a carbonyl metal powder. In an embodiment, the following method can be used to attain very high densities and performance in an economic way for a low temperature metal AM method:
Step 1ii: Providing a powder comprising a carbonyl metal powder;
Step 2ii: Manufacturing an object through the additive manufacturing of metal powder with a method where temperatures below 0.49*Tm, wherein Tm is the melting temperature in Kelvin of the powder provided (as defined in this document);
Step 3ii: proceeding with at least the 4 steps of the method described above in this paragraph.

The step 2ii of the method described above involves the use of additive manufacturing of metal powders using temperatures below 0.49*Tm, wherein Tm is the melting temperature in Kelvin of the powder mixture (as defined in this document) provided. For some applications, during the additive manufacturing process the binding can be made using processes that are not related to temperature, such as for example, but not limited to, the use of a glue, or radiation, among others. The use of powder mixtures wherein at least one of the powders comprises % Y, % Sc, and/or % REE (as defined in this document) may be interesting to apply with the method described above. In an embodiment, at least one of the powders of the mixture comprises % Y. In another embodiment, at least one of the powders of the mixture comprises % Sc. In another embodiment, at least one of the powders of the mixture comprises % REE. In another embodiment, at least one powder comprises % Y, % Sc and/or % REE, being the % Fe with a content greater than 90 wt %.

For some applications, it may be advantageous to use of several cycles. In an embodiment, at least two cycles of the consolidation treatment are applied. In another embodiment, at least three cycles of the consolidation treatment are applied. On the other hand, in some embodiments, the consolidation treatment may be optional, and can therefore be skipped.

All the embodiments, disclosed above can be combined among them and with any other embodiment disclosed in this document, provided that they are not mutually exclusive, for example in an embodiment, a method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; providing a mold at least partly manufactured by additive manufacturing (AM); filling the mold with the treated powder or powder mixture; applying a pressure and/or temperature treatment; optionally, applying a debinding treatment; optionally, applying a pressure and/or temperature treatment; optionally, applying a fixing step for setting the % C, % O, % N, % H and/or % B levels in the component; and applying a consolidation treatment; or for example in another embodiment, a method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; providing a mold at least partly manufactured by additive manufacturing (AM); filling the mold with the treated powder or powder mixture; applying a pressure and/or temperature treatment; applying a debinding treatment; optionally, applying a pressure and/or temperature treatment; optionally, applying a fixing step for setting the % C, % O, % N, % H and/or % B levels in the component; and applying a consolidation treatment; or for example, in another embodiment, a method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; shaping the treated powder or powder mixture using an additive manufacturing (AM) technology; optionally, applying a pressure and/or temperature treatment; optionally, applying a debinding treatment; optionally, applying a pressure and/or temperature treatment; optionally, applying a fixing step for setting the % C, % O, % N, % H and/or % B levels in the component; and applying a consolidation treatment; or for example, in another embodiment, a method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; shaping the treated powder or powder mixture using an additive manufacturing (AM) technology at the right temperature; optionally, applying a pressure and/or temperature treatment; optionally, applying a debinding treatment; optionally, applying a pressure and/or temperature treatment; optionally, applying a fixing step for setting the % C, % O, % N, % H and/or % B levels in the component; and applying a consolidation treatment.

Optionally, the method may further comprise a step wherein a carburizing treatment, a boriding treatment, a nitriding treatment and/or combinations thereof are applied at any time between the debinding step and the consolidation step. In an embodiment, the method further comprises the step of: applying a treatment selected from carburizing, boriding, nitriding and/or combinations thereof.

All the embodiments, disclosed above can be combined among them and with any other embodiment disclosed in this document, provided that they are not mutually exclusive, for example, in an embodiment, a method of manufacturing metal comprising components, which method comprises the steps of providing a powder or powder mixture comprising at least a metal or a metal-based alloy; applying a treatment to the powder or powder mixture, wherein the treatment of the powder or powder mixture comprises applying energy into the powder or powder mixture through mechanical action; providing a mold at least partly manufactured by additive manufacturing (AM); filling the mold with the treated powder or powder mixture; applying a pressure and/or temperature treatment; optionally, applying a debinding treatment; optionally, applying a pressure and/or temperature treatment; and optionally, applying a treatment selected from carburizing, boriding, nitriding and/or combinations thereof; or for example, in another embodiment, a method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; shaping the treated powder or powder mixture using an additive manufacturing (AM) technology; optionally, applying a pressure and/or temperature treatment; optionally, applying a debinding treatment; optionally, applying a pressure and/or temperature treatment; and optionally, applying a treatment selected from carburizing, boriding, nitriding and/or combinations thereof; or for example, in another embodiment, a method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; shaping the treated powder or powder mixture using an additive manufacturing (AM) technology at the right temperature; optionally, applying a pressure and/or temperature treatment; optionally, applying a debinding treatment; optionally, applying a pressure and/or temperature treatment; and optionally, applying a treatment selected from carburizing, boriding, nitriding and/or combinations thereof.

Optionally, the method may further comprise a step wherein at least two parts are joined (also referred to as the “joining step”). In an embodiment, the method further comprises the step of: joining different parts to make a bigger component. For some applications, it may be advantageous to apply an additional step to joint different parts, preferably after applying the consolidation step, although in some embodiments, the joining step can also be applied before the consolidation treatment. In certain embodiments, the step of joining of different parts to make a bigger component can be made as described in patent application number WO2021165545A1, the contents of which are incorporated herein by reference in their entirety.

Optionally, the method may further comprise a step wherein the component is subjected to a densification treatment (also referred to as the “densification step”). In an embodiment, the method further comprises the step of: applying a densification treatment. The densification treatment may, among others, help to increase the density, further having a strong contribution on the thermo-mechanical properties which can be achieved for some components. In an embodiment, the densification treatment comprises applying a hot isostatic pressing (HIP). For some applications, the atmosphere used in the densification treatment may be important. In an embodiment, the densification treatment comprises the use of a properly designed atmosphere (as defined in this document). For some applications, it may also be advantageous to change the atmosphere in the furnace or pressure vessel during the treatment. In an embodiment, the densification treatment comprises the use of at least two different atmospheres. In some embodiments, it may be advantageous to perform the densification treatment simultaneously (sequentially) with other method steps.

In some embodiments, the densification treatment may comprise the application of pressure. For some applications, it may be particularly important to properly select the pressure applied (as defined in this document) in the densification treatment. In different embodiments, the pressure applied (as defined in this document) in the densification treatment is 160 bar or more, 320 bar or more, 560 bar or more, 1050 bar or more and even 1550 bar or more. On the other hand, excessive pressures may lead to undesirable distortions in the manufacture of certain components. In different embodiments, the pressure applied (as defined in this document) in the densification treatment is less than 4900 bar, less than 2800 bar, less than 2200 bar, less than 1800 bar, less than 1400 bar, less than 900 bar and even less than 490 bar. All the values and ranges of the different embodiments disclosed above can be combined among them and with any other embodiment disclosed in this document in any combination, provided that they are not mutually exclusive, for example, in an embodiment, the densification treatment comprises the application of a pressure between 160 and 4900 bar; or for example, in another embodiment, between 160 and 2800 bar; or foe example, in another embodiment, between 320 and 2800 bar.

Additionally or alternatively, in some embodiments, the densification treatment may comprise the application of temperature. For some applications, it may be particularly important to properly select the temperature applied (as defined in this document) in the densification treatment. In different embodiments, the temperature applied (as defined in this document) in the densification treatment is 0.45*Tm or more, 0.55*Tm or more, 0.65*Tm or more, 0.70*Tm or more, 0.75*Tm or more, 0.8*Tm or more and even 0.86*Tm or more, wherein Tm is the melting temperature in Kelvin of the powder or powder mixture (as defined in this document) provided. On the other hand, it may be advantageous to keep the temperature rather low. In different embodiments, the temperature applied (as defined in this document) in the densification treatment is 0.92*Tm or less, 0.88*Tm or less, 0.78*Tm or less, 0.75*Tm or less, and even 0.68*Tm or less, wherein Tm is the melting temperature in Kelvin of the powder or powder mixture (as defined in this document) provided. All the values and ranges of the different embodiments disclosed above can be combined among them and with any other embodiment disclosed in this document in any combination, provided that they are not mutually exclusive, for example, in an embodiment, the densification treatment comprises the application of a temperature between 0.45*Tm and 0.92*Tm, being Tm the melting temperature in Kelvin of the powder or powder mixture provided; or for example, in another embodiment, the densification treatment comprises the application of a temperature between 0.45*Tm and 0.92*Tm, being Tm the melting temperature in Kelvin of the metallic powder with the lowest melting point in the powder of powder mixture provided, wherein the melting temperature of such metallic powder is the temperature at which the first metal liquid forms under equilibrium conditions; or for example, in another embodiment, the densification treatment comprises the application of a temperature between 0.45*Tm and 0.92*Tm, being Tm the melting temperature in Kelvin of the metallic powder, which is at least 2.6% by weight of all the metallic powders in the powder or powder mixture provided, with the lowest melting point, wherein the melting temperature of such metallic powder is the temperature at which the first metal liquid forms under equilibrium conditions. All the embodiments disclosed above can be combined among them and with any other embodiment disclosed in this document in any combination, provided that they are not mutually exclusive, for example, in an embodiment, the method further comprises the step of: applying a densification treatment, wherein the densification treatment comprises the application of a pressure between 160 and 4900 bar and a temperature between 0.45*Tm and 0.92*Tm, being Tm the melting temperature in Kelvin of the powder or powder mixture provided.

For some applications, it may be advantageous to use of several cycles. In an embodiment, at least two cycles of the densification treatment are applied. In another embodiment, at least three cycles of the densification treatment are applied. On the other hand, in some embodiments, the densification treatment may be optional, and can therefore be skipped.

All the embodiments, disclosed above can be combined among them and with any other embodiment disclosed in this document, provided that they are not mutually exclusive, for example, in an embodiment, the method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; providing a mold at least partly manufactured by additive manufacturing (AM); filling the mold with the treated powder or powder mixture; applying a pressure and/or temperature treatment; optionally, applying a debinding treatment; optionally, applying a pressure and/or temperature treatment; optionally, applying a fixing step for setting the % C, % O, % N, % H and/or % B levels in the component; optionally, applying a consolidation treatment; and applying a densification treatment; or for example, in another embodiment, a method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; providing a mold at least partly manufactured by additive manufacturing (AM); filling the mold with the treated powder or powder mixture; applying a pressure and/or temperature treatment; applying a debinding treatment; optionally, applying a pressure and/or temperature treatment; optionally, applying a fixing step for setting the % C, % O, % N, % H and/or % B levels in the component; applying a consolidation treatment; and applying a densification treatment; or for example, in another embodiment, a method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; shaping the treated powder or powder mixture using an additive manufacturing (AM) technology; optionally, applying a pressure and/or temperature treatment; optionally, applying a debinding treatment; optionally, applying a pressure and/or temperature treatment; optionally, applying a fixing step for setting the % C, % O, % N, % H and/or % B levels in the component; optionally, applying a consolidation treatment; and applying a densification treatment; or for example, in another embodiment, a method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; shaping the treated powder or powder mixture using an additive manufacturing (AM) technology at the right temperature; optionally, applying a pressure and/or temperature treatment; optionally, applying a debinding treatment; optionally, applying a pressure and/or temperature treatment; optionally, applying a fixing step for setting the % C, % O, % N, % H and/or % B levels in the component; optionally, applying a consolidation treatment; and applying a densification treatment.

Optionally, the method may further comprise a step wherein the component, or at least part of the component, is infiltrated (also referred to as the “infiltration step”). In an embodiment, the method further comprises the step of: infiltrating at least part of the component with an infiltrate material.

Some examples of infiltrate materials which can be used include, but are not limited to, metallic materials, organic materials such as for example, polymers, polymeric materials, resins and/or mixtures thereof. In an embodiment, the infiltrant comprises a metallic material. In another embodiment, the infiltrant comprises a resin.

For certain applications, it may be advantageous to limit the infiltration area to certain geometric features of the component in order to preserve certain desired geometric features including, but not limited to, external features, internal features, holes, voids, channels (e.g., cooling and/or heating channels), sharp angles and/or combinations thereof. In an embodiment, only part of the component is infiltrated. In an embodiment, the component comprises at least one infiltration barrier to prevent infiltration in some geometric features of the component. In some embodiments, this infiltration barrier can be manufactured with the component or formed at a later stage, for example, by dipping, spraying and/or deposition, among others. However, the formation of the infiltration barrier is not limited to the technologies described above.

Optionally, the method may further comprise a step wherein the component is subjected to a densification treatment (as described above) after the infiltration step. In an embodiment, the method further comprises the step of: applying a densification treatment to the at least partially infiltrated component.

All the embodiments disclosed above can be combined among them and with any other embodiment disclosed in this document in any combination, provided that they are not mutually exclusive, for example, in an embodiment, a method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; providing a mold at least partly manufactured by additive manufacturing (AM); filling the mold with the treated powder or powder mixture; applying a pressure and/or temperature treatment; optionally, applying a debinding treatment; optionally, applying a pressure and/or temperature treatment; optionally, applying a fixing step for setting the % C, % O, % N, % H and/or % B levels in the component; optionally, applying a consolidation treatment; optionally, applying a densification treatment; and infiltrating at least part of the component with an infiltrate material; or for example, in another embodiment, a method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical actionaction; shaping the treated powder or powder mixture using an additive manufacturing (AM) technology; optionally, applying a pressure and/or temperature treatment; optionally, applying a debinding treatment; optionally, applying a pressure and/or temperature treatment; optionally, applying a fixing step for setting the % C, % O, % N, % H and/or % B levels in the component; optionally, applying a consolidation treatment; optionally, applying a densification treatment; and infiltrating at least part of the component with an infiltrate material.

In some embodiments, the application of certain post-processing treatments, including, but not limited to, thermo-mechanical treatments, surface conditioning, machining and/or combinations thereof may help to improve some properties of the manufactured components. In an embodiment, the method further comprises the step of: applying a thermo-mechanical treatment, a surface conditioning, a machining and/or combinations thereof.

Optionally, the method may further comprise a step wherein the component is subjected to a thermo-mechanical treatment. In an embodiment, the method further comprises the step of: applying a thermo-mechanical treatment. In certain embodiments, the step of applying a thermo-mechanical treatment can be made as described in patent application number WO2021165545A1, the contents of which are incorporated herein by reference in their entirety.

Optionally, the method may further comprise other additional steps such as applying a machining step and/or a surface conditioning. In an embodiment, the method further comprises the step of: applying a machining. In some embodiments, the application of a machining step may also be advantageous before and/or after performing any of the above disclosed method steps (e.g., the pressure and/or temperature treatment, the fixing step, the consolidation treatment, the densification treatment, . . . ). For some applications, it may be particularly advantageous to perform a surface conditioning. In an embodiment, the method further comprises the step of: applying a surface conditioning. This surface conditioning may, among others, comprise a physical and/or chemical modification of at least part of the surface of the component. In certain embodiments, the surface conditioning can be made as described in patent application number WO2021165545A1, the contents of which are incorporated herein by reference in their entirety.

As previously disclosed, in some embodiments, components comprising materials having particularly low grain sizes can be manufactured using the method described above. In different embodiments, the component comprises at least a material with a grain size of 19.5 microns or less, of 13.8 microns or less, of 9.77 microns or less, of 4.88 microns or less, of 2.44 microns or less, of 1 micron or less, of 0.6 microns or less, and even of 0.4 microns or less.

Some of the components manufactured with the method described above may benefit from a right level of % C, % O, % N, % H and/or % B in their composition (the right levels of % C, % O, % N, % H and/or % B as defined in this document). For some applications, components having a right % C content (as defined in this document) maybe advantageous. In an embodiment, at least one material of the component comprises a right % C content. Alternatively or additionally, for some applications, components having a right % O content (as defined in this document) maybe advantageous. In an embodiment, at least one material of the component comprises a right % O content. Alternatively or additionally, for some applications, components having a right % N content (as defined in this document) maybe advantageous. In an embodiment, at least one material of the component comprises a right % N content. Alternatively or additionally, components having a right % H content (as defined in this document) maybe advantageous. In an embodiment, at least one material of the component comprises right % H content. Alternatively or additionally, for some applications, components having a right % B content (as defined in this document) maybe advantageous. In an embodiment, at least one material of the component comprises a right % B content. In alternative embodiments, the above disclosed about the content in at least one material of the component can be extended to the entire component.

Some of the components manufactured by the method described above may comprise particularly interesting materials with magnetic properties such as for example, but not limited to, a certain remanent induction. In this respect, the inventor has found that in some embodiments, this method may be particularly suitable for the manufacture of components comprising materials with remanent induction (Br). These components can be advantageously manufactured, following the method steps disclosed in the preceding paragraphs, for example, with a method that comprises using an additive manufacturing (AM) technology at the right temperature (as defined in this document), more advantageously when the method further comprises applying a pressure and/or temperature treatment, or for example, with a method that comprises using a mold to form the component. In an embodiment, the component is made of a material having a proper Br. In another embodiment, the component comprises a material having a proper Br. The feature “proper Br” is defined throughout this document in the form of different alternatives that are explained in detail below. In different embodiments, a proper Br is a remanent induction (Br) of 0.2 T or more, 0.52 T or more, 0.76 T or more, 1.05 T or more, 1.26 T or more and even 1.51 T or more. On the other hand, for some applications Br should not be excessive. In different embodiments, a proper Br is a remanent induction (Br) of 2.9 T or less, 1.9 T or less, and even 1.69 T or less. All the embodiments disclosed above can be combined among them and with any other embodiment disclosed in this document that relates to “proper Br” in any combination, provided that they are not mutually exclusive. Some examples of materials having a proper Br (as defined in this document) that may be particularly interesting for certain applications include, but are not limited to, AlNiCo, α″Fe₁₆N₂ and/or mixtures thereof. In an embodiment, the component comprises an AlNiCo material having a proper Br (as defined in this document). In another embodiment, the component is made of an AlNiCo material having a proper Br. In another embodiment, the component comprises an α″Fe₁₆N₂ material having a proper Br (as defined in this document). In another embodiment, the component is made of an α″Fe₁₆N₂ material having a proper Br (as defined in this document). In another embodiment, the component comprises an AlNiCo material and an α″Fe₁₆N₂ material having a proper Br (as defined in this document). In another embodiment, the component comprises a material comprising both an AlNiCo material and α″Fe₁₆N₂ material having a proper Br (as defined in this document). In another embodiment, the component is made of a material comprising both an AlNiCo material and an α″Fe₁₆N₂ material having a proper Br (as defined in this document). For some applications, components comprising other materials, such as for example, but not limited to low melting point alloys may be of interest. In an embodiment, the component comprises a material comprising α″Fe₁₆N₂ material and a low melting point alloy (as defined in this document). In another embodiment, the component is made of a material comprising α″Fe₁₆N₂ material and a low melting point alloy (as defined in this document). The feature “low melting point alloy” is defined throughout this document in the form of different alternatives that are explained in detail below. In an embodiment, a low melting point alloy refers to an alloy with a melting point below 1090° C. In an alternative embodiment, a low melting point alloy refers to an alloy with a melting point below 990° C. In another alternative embodiment, a low melting point alloy refers to an alloy with a melting point below 890° C. In another alternative embodiment, a low melting point alloy refers to an alloy with a melting point below 690° C. In an embodiment, the components comprising or made of the materials disclosed in this paragraph are manufactured by a method comprising the use of an additive manufacturing (AM) technology at the right temperature, more advantageously when the method further comprises the application of a pressure and/or temperature treatment, or by a method that comprises using a mold to form the component.

The inventor has found that it may be advantageous to use the method described above, particularly when the method comprises treating the powder or powder mixture with the application of energy through mechanical action, to manufacture components comprising or made from certain materials having high mechanical strength and/or yield strength and a predominantly austenitic microstructure (as defined in this document). In an embodiment, the component comprises a predominantly austenitic material having a high mechanical strength and/or yield strength. In another embodiment, the component comprises a predominantly austenitic material having a high mechanical strength. In another embodiment, the component comprises a predominantly austenitic material having a high yield strength. In another embodiment, the component comprises a predominantly austenitic material having a high mechanical strength and a high yield strength. In another embodiment, the component is made of a predominantly austenitic material having a high mechanical strength and/or yield strength. In another embodiment, the component is made of a predominantly austenitic material having a high mechanical strength. In another embodiment, the component is made of a predominantly austenitic material having a high yield strength. In another embodiment, the component is made of a predominantly austenitic material having a high mechanical strength and a high yield strength. The feature “predominantly austenitic material” is defined throughout this document in the form of different alternatives that are explained in detail below. In an embodiment, a predominantly austenitic material means a material with a microstructure comprising at least 22% by volume of austenite. In an alternative embodiment, a predominantly austenitic material means a material with a microstructure comprising at least 42% by volume of austenite. In another alternative embodiment, a predominantly austenitic material means a material with a microstructure comprising at least 52% by volume of austenite. In another alternative embodiment, a predominantly austenitic material means a material with a microstructure comprising at least 62% by volume of austenite. In another alternative embodiment, a predominantly austenitic material means a material with a microstructure comprising at least 82% by volume of austenite. In another alternative embodiment, a predominantly austenitic material means a material with a microstructure comprising at least 92% by volume of austenite. In another alternative embodiment, a predominantly austenitic material means a material with a microstructure comprising 100% by volume of austenite. All the embodiments disclosed above can be combined with any other embodiment disclosed in this document that relates to “a predominantly austenitic material” in any combination, provided that they are not mutually exclusive. The feature “high mechanical strength” is defined throughout this document in the form of different alternatives that are explained in detail below. In an embodiment, high mechanical strength means 610 MPa or more. In an alternative embodiment, high mechanical strength means 1210 MPa or more. In another alternative embodiment, high mechanical strength means 1615 MPa or more. In another alternative embodiment, high mechanical strength means 2115 MPa or more. In another alternative embodiment, high mechanical strength means 2610 MPa or more. In another alternative embodiment, high mechanical strength means 3025 MPa or more. In an embodiment, mechanical strength is measured according to international standard ASTM E8/E8M-22. All the embodiments disclosed above can be combined among them and with any other embodiment disclosed in this document that relates to “high mechanical strength” in any combination, provided that they are not mutually exclusive. The feature “high yield strength” is defined throughout this document in the form of different alternatives that are explained in detail below. In an embodiment, high yield strength means 600 MPa or more. In an alternative embodiment, high yield strength means 1200 MPa or more. In another alternative embodiment, high yield strength means 1600 MPa or more. In another alternative embodiment, high yield strength means 2100 MPa or more. In another alternative embodiment, high yield strength means 2600 MPa or more. In another alternative embodiment, high yield strength means 3010 MPa or more. All the embodiments disclosed above can be combined among them and with any other embodiment disclosed in this document that relates to “a high yield strength” in any combination, provided that they are not mutually exclusive. In an embodiment, yield strength is measured according to international standard ASTM E8/E8M-22. Some examples of predominantly austenitic materials (as defined in this document) that may be particularly interesting for some applications include, but are not limited to, the austenitic steels disclosed in patent application number WO2021165545A1, the contents of which are incorporated herein by reference in their entirety, predominantly austenitic Fe-based alloys, predominantly austenitic Ni-based alloys, predominantly austenitic steels comprising low % Cr and high % N contents and/or mixtures thereof. Another aspect of the disclosure, refers to a predominantly austenitic steel with low % Cr and high % N contents (as described below). In different embodiments, a low chromium content is a chromium content of 11.5 wt % or less, 9.9 wt % or less, 4.8 wt % or less, 2.8 wt % or less, 0.9 wt % or less, and even 0.3 wt % or less. In different embodiments, a high nitrogen content is a nitrogen content of 0.003 wt % or more, 0.012 wt % or more 0.12 wt % or more, 0.36 wt % or more, 0.56 wt % or more, 0.82 wt % or more and even 1.02 wt % or more. Some applications, may require some % Cr. In different embodiments, a low chromium content is a chromium content of 0.001 wt % or more, 0.006 wt % or more, 0.011 wt % or more, 0.06 wt % or more and even 0.12 wt % or more. Some applications, do not require an excessive % N content. In different embodiments, a high nitrogen content is a nitrogen content of 4.9 wt % or less, 2.9 wt % or less 1.9 wt % or less, 1.4 wt % or less, and even 0.96 wt % or less. The predominantly austenitic steels with low % Cr and high % N contents disclosed above are new, inventive and of great interest for other applications, manufacturing methods and/or components and thus can constitute and invention in its own. The inventor has found that for some applications, it may be very interesting to apply a high temperature surface treatment and/or coating to the components comprising or made of a predominantly austenitic material described in this paragraph. The feature “high temperature” is defined throughout the present paragraph in the form of different alternatives that are explained in detail below. In different embodiments, high temperature, means a maximum applied temperature of 610° C. or more, of 660° C. or more, of 710° C. or more, of 810° C. or more, of 860° C. or more and even of 910° C. or more. In some cases, the temperature should be limited. In different embodiments, high temperature, means a maximum applied temperature of 1290° C. or less, of 1190° C. or less, of 1080° C. or less, and even of 990° C. or less. Other interesting surface treatments and/or coatings that can be applied to the components comprising or made of a predominantly austenitic material described in this paragraph include, but are not limited to boriding, boronizing, Toyota diffusion (or other VC comprising surface treatments and/or coatings), CVD and/or combinations thereof. The application of a boriding surface treatment and/or coating may be of particular interest for materials containing or to which it is added % Ti, % Ni, % Cr, % Mo, % W, % Nb, % Ta and/or % V, such that % Ti+% Ni+% Cr+% Mo+% W+% Nb+% Ta+% V is from 0.06 to 10 wt %. The application of a Toyota superficial treatment and/or coating (or other VC comprising surface treatment and/or coating) may be of particular interest for materials comprising or to which it is added % V, % Cr and or % Nb, such that % V+% Cr+% Nb is from 0.1 to 6 wt %. Other surface treatments and/or coatings that can be applied to the components comprising or made of a predominantly austenitic material described in this paragraph include, but are not limited to CVD, PVD, nitriding, carburization, oxidation, sulfonization and/or combinations thereof. The surface treatments and/or coatings that can be applied are not limited to the examples described above. In an embodiment, the components comprising or made of the materials disclosed in this paragraph are manufactured with a method comprising the use of an additive manufacturing (AM) technology at the right temperature (as defined in this document), more advantageously when the method further comprises the application of a pressure and/or temperature treatment, or by a method that comprises using a mold to form the component. In an alternative embodiment, the components comprising or made of the materials disclosed in this paragraph are manufactured using any available technology.

Other examples of the compositions of the components that can be advantageously manufactured with the method of manufacturing metal comprising components disclosed in this document, for example, with a method comprising the use of an additive manufacturing (AM) technology at the right temperature (as defined in this document), more advantageously when the method further comprises the application of a pressure and/or temperature treatment, or for example, with a method comprising the use of a mold to form the component, include, but are not limited to components comprising or made of tool steels, hot work tool steels, reduced activation ferritic martensitic (RAFM) steels, oxide dispersion strengthened (ODS) RAFM steels and/or combinations thereof. In an embodiment, the manufactured component comprises or is made of a RAFM and/or an ODS-RAFM steel. In another embodiment, the manufactured component comprises or is made of a RAFM steel. In another embodiment, the manufactured component comprises or is made of an ODS-RAFM steel. For some applications, it may be particularly advantageous to manufacture a component comprising or made of a RAFM and/or an ODS-RAFM material using the method of the present aspect of the disclosure that involves applying energy into the powder or powder mixture through mechanical action. Different compositions of RAFM steels may be advantageously used in the manufacture of various components. As a non-limiting example, the RAFM material may have the following composition, all percentages being indicated in weight percent: % C: 0.01-0.29 (preferably from 0.089 to 0.015, more preferably around 0.11); % Cr: 6.6-10.9 (preferably from 8.5 to 9.5); % V: 0.01 to 0.49 (preferably from 0.15 to 0.25); % Ta: 0.001 to 0.8 (preferably from 0.05 to 0.09); % W: 0.1-4.9 (preferably from 1 to 2); % Ti: 0.0001-0.9 (preferably from 0.0001 to 0.09); % Mn: 0.06-1.3 (preferably from 0.3 to 0.6); % P and/or % S: 0.0001 to 0.05 (preferably from 0.0005 to 0.007); % Ni, % Mo, % Cu % Nb, % Al % B, % Co<0.09 (preferably <0.009; more preferably <0.004 and even more preferably <0.0009); % Si: 0.0001-0.29 (preferably from 0.001 to 0.08); % As+% Sn+% Sb+% Zr: 0.0001-0.09 (preferably from 0.005 to 0.05); % N: 0.001-0.12 (preferably from 0.015 to 0.045); % O: 0.0001-1.2 (preferably from 0.0005 to 0.01); % REE+% Sc+% Y: 0-2.9 (preferably from 0 to 0.2); the rest consisting of iron and trace elements (as defined in this document). However, the composition of the RAFM material is not limited to the composition in the example described above. With respect to the ODS-RAFM materials, different compositions may be advantageously used in the manufacture of various components. As a non-limiting example, the ODS-RAFM material may have the following composition, all percentages being indicated in weight percent: % C: 0.01-0.29 (preferably from 0.089 to 0.015, more preferably around 0.11); % Cr: 6.6-10.9 (preferably from 8.5 to 9.5); % V: 0.01 to 0.49 (preferably from 0.15 to 0.25); % Ta: 0.001 to 0.8 (preferably from 0.05 to 0.09); % W: 0.1-4.9 (preferably from 1 to 2); % Ti: 0.0001-0.9 (preferably from 0.01 to 0.4); % Mn: 0.06-1.3 (preferably from 0.3 to 0.6); % P and/or % S: 0.0001 to 0.05 (preferably from 0.0005 to 0.007); % Ni, % Mo, % Cu % Nb, % Al % B, % Co<0.09 (preferably <0.009; more preferably <0.004 and even more preferably <0.0009); % Si: 0.0001-0.29 (preferably from 0.001 to 0.08); % As+% Sn+% Sb+% Zr: 0.0001-0.09 (preferably from 0.005 to 0.05); % N: 0.001-0.12 (preferably from 0.015 to 0.045); % O: 0.0001-1.2 (preferably from 0.03 to 0.4); % REE+% Sc+% Y: 0-2.9 (preferably from 0.12 to 1.4); the rest consisting of iron and trace elements (as defined in this document). However, the composition of the ODS-RAFM material is not limited to the composition in the example described above. The inventor has surprisingly found that for some applications, components comprising or made of any of the materials disclosed above in this paragraph can be advantageously manufactured using a method comprising the use of an additive manufacturing (AM) technology at the right temperature (as defined in this document), more advantageously when the method further comprises the application of a pressure and/or temperature treatment and/or the use of a mold to form the component as described in this document. Additionally or alternatively, in an embodiment, the components comprising or made of the materials disclosed above in this paragraph can be manufactured using a method that comprises applying energy through mechanical action into the powder or powder mixture.

Another aspect of the disclosure provides a method of manufacturing ceramic or ceramic comprising components including, but not limited to, parts, pieces, components, molds, and/or tools for various industries such as for example, but not limited to, the automotive industry, the food processing industry, the aerospace industry, the transportation industry (e.g., marine, rail . . . ), the packaging industry, the pharmaceutical industry, the electronics industry, the appliance industry, the material transformation industry and/or the power generation/transformation industry, among others, which method comprises the steps of:
providing a material; and
shaping the material using a ceramic additive manufacturing (CAM) method.

In some embodiments, the method may further comprise other additional steps, some of which are further discussed later in this document.

The method of manufacturing ceramic comprising components disclosed in this document can be used to manufacture the entire component or at least part of the component. In this respect, for some applications of the method, it may be advantageous to manufacture the ceramic comprising component in different parts which can be assembled together. In an embodiment, the method is used to manufacture at least part of the ceramic comprising component. In another embodiment, the method is used to manufacture the entire ceramic comprising component. The inventor has also found that for some applications, it may be advantageous to manufacture the component from different materials. In an embodiment, the manufactured component comprises at least two different materials. In another embodiment, the manufactured component comprises at least three different materials.

Another aspect refers to the ceramic or ceramic comprising components manufactured using the method disclosed in the present aspect of the disclosure.

The method disclosed in the present aspect of the disclosure may be particularly suitable for manufacturing components from starting materials comprising ceramic materials in particulate form (e.g. powders or powder mixtures). In an embodiment, the material provided comprises a ceramic material. In another embodiment, the material provided consist of a ceramic material. A wide variety of ceramic materials can be used to manufacture different types of ceramic comprising components. In an embodiment, the material provided comprises a powder or powder mixture comprising at least a ceramic material. Some examples of ceramic materials that may be particularly suitable include, but are not limited to, boron, crystalline boron, borides (e.g., chromium boride (CrB), chromium diboride (CrB₂), titanium diboride (TiB₂), zirconium diboride (ZrB₂), magnesium diboride (MgB₂), niobium diboride (NbB₂), hafnium diboride (HfB₂), tantalum diboride (TaB₂) . . . ), carbides (e.g., boron carbide (B₄C), chromium carbide (Cr₃C₂), molybdenum carbide (Mo₂C), silicon carbide (SiC), titanium carbide (TiC), tungsten titanium carbide (WTiC), vanadium carbide (VC), zirconium carbide (ZrC), hafnium carbide (HfC), tantalum carbide (TaC), niobium carbide (NbC) . . . ), nitrides (e.g., aluminium nitride (AlN), boron nitride (BN), silicon nitride (Si₃N₄), titanium carbonitride (Ti (C,N)), titanium nitride (TiN), zirconium nitride (ZrN), hafnium nitride (HfN), vanadium nitride (VN), tantalum nitride (TaN), niobium nitride (NbN) . . . ), oxides (e.g., yttrium oxide (Y₂O₃), boron oxide (B₂O₃), zin oxide (ZnO), zirconium oxide (ZrO₂) . . . ), silicon, silicides (e.g., molybdenum disilicide (MoSi₂), . . . ), titanates (e.g., barium titanate (BaTiO₃), strontium titanate (SrTiO₃), lead zirconate, titanate (PZT), . . . ) silicates (e.g., steatite, . . . ), sialon, bioceramics, alumina, ferrite, porcelain and/or mixtures thereof. In an embodiment, the powder or powder mixture comprises at least a ceramic material selected from boron, crystalline boron, borides, carbides, nitrides, oxides, silicon, silicides, titanates, silicates, sialon, bio-ceramics, alumina, ferrite, porcelain and/or mixtures thereof. In an embodiment, the ceramic material is in powder form. In this regard, the use of a single powder may be advantageous for the manufacture of some components, while the use of powder mixtures may be preferred for the manufacture of other components. In some embodiments, the starting material may further comprise other components including, but not limited to, organic materials, polymers, polymeric materials, fluxes, lubricants, additives, binders, resins, metallic particles, reinforcement particles (as defined in this document), whiskers, graphene, nanotubes, carbon nanotubes and/or combinations thereof. In an embodiment, the material provided further comprises at least one material selected from an organic material, a metallic material and/or reinforcement particles (as defined in this document).

All the embodiments disclosed above can be combined among them and with any other embodiment disclosed in this document in any combination, provided that they are not mutually exclusive, for example, in an embodiment, a method of manufacturing ceramic or ceramic comprising components, which method comprises the steps of: providing a powder or powder mixture comprising at least a ceramic material; and shaping the powder or powder mixture using a ceramic additive manufacturing (CAM) method.

Certain characteristics of the material provided may be important, among others, to the dimensional accuracy that can be achieved in some components, particularly in certain components with extremely complex geometries. For some applications, the size (as defined in this document) of the material provided may be important to the dimensional accuracy. In an embodiment, the ceramic material is a powder with a right size (as defined in this document). In an alternative embodiment, the ceramic material comprises at least one powder with a right size (as defined in this document). In another alternative embodiment, the material provided has a right size (as defined in this document). In different embodiments, a right size is a size of 0.3 microns or more, 6 microns or more, 21 microns or more, 61 microns or more, 210 microns or more, 310 microns or more and even 510 microns or more. On the other hand, particle sizes that are too large may be disadvantageous for some applications. In different embodiments, a right size is a size of 990 microns or less, 590 microns or less, 290 microns or less, 140 microns or less, and even 98 microns or less. With respect to sphericity, for some applications, the use of powders or powder mixtures comprising at least one irregular powder (as defined in this document) may be preferred. In an embodiment, the powder or powder mixture provided is an irregular powder or powder mixture. In another embodiment, the powder or powder mixture comprises at least one irregular powder. For other applications, the use of spherical powders (as defined in this document) may be advantageous, in particular for the manufacture of components with complex geometries. In an embodiment, the powder or powder mixture provided is a spherical powder or powder mixture. In another embodiment, the powder or powder mixture comprises at least one spherical powder. For some applications, it may be more important to ensure the presence of a certain percentage of spherical particles in the powder or powder mixture provided. In different embodiments, the percentage of spherical particles is 21% or more, 36% or more, 51% or more, 81% or more, 91% or more and even 98% or more. On the other hand, for certain applications an excessive percentage of spherical particles may be disadvantageous. In different embodiments, the percentage of spherical particles is 89% or less, 74% or less, 59% or less, and even 44% or less. Some examples of technologies that can be used to obtain the powders include, but are not limited to, mechanical action, comminution, crushing, grinding, attrition, milling (e.g., ball milling, . . . ), mechanochemical synthesis, chemical, solid state reaction (e.g., decomposition, reaction between solids, . . . ), liquid solutions, precipitation, co-precipitation, solvent vaporization (e.g., spray drying, spray pyrolysis, freeze drying, . . . ), gel routes (e.g., sol-gel synthesis, Pechini method, citrate gel, glycine nitrate, . . . ), non-aqueous liquid reaction, vapor phase reaction, gas-solid reaction, gas-liquid reaction, reaction between gases, gas phase pyrolysis and/or combinations thereof. All the embodiments disclosed above can be combined among them and with any other embodiment disclosed in this document in any combination, provided that they are not mutually exclusive.

As described above, the component, or at least part of the component, can then be formed from the starting material provided using a ceramic additive manufacturing (CAM) method (this step is also referred to as the “CAM forming step”). In this document, the definition of ceramic additive manufacturing (CAM) includes any near net shape manufacturing method described throughout this document. In particular, the definition of ceramic additive manufacturing (CAM) includes those methods in which the component, or at least part of the component, is manufactured using a mold or capsule, or part of the mold or capsule, that is subsequently filled and subjected to pressure and/or temperature and also includes those methods in which the component is manufactured by means of an additive manufacturing (AM) technology. In an embodiment, the material provided is formed into a component, or into a part of a component, using a ceramic additive manufacturing (CAM) method.

The temperature used in the ceramic additive manufacturing (CAM) method may be important in the manufacture of some components. In this regard, the inventor has found that in some applications of the method, the use of ceramic additive manufacturing (CAM) methods at the proper temperature may lead to a very surprising flexibility of design with a low environmental impact. In an embodiment, according to this aspect of the disclosure, the method comprises the step of: shaping the powder or powder mixture using a ceramic additive manufacturing (CAM) method at the proper temperature (as defined in this document). The feature “proper temperature” is defined throughout this document in the form of different alternatives that are explained in detail below. In different embodiments, the proper temperature is a temperature of 340° C. or less, 298° C. or less, 240° C. or less, 199° C. or less, 149° C. or less, 124° C. or less, 99° C. and even 49° C. or less. For some particular applications, the temperature should not be too low. In different embodiments, the proper temperature is a temperature of 26° C. or more, 41° C. or more, 61° C. or more and even 81° C. or more. All the embodiments disclosed above can be combined among them and with any other embodiment disclosed in this document that relates to “the proper temperature” in any combination, provided that they are not mutually exclusive. All the values and ranges of the different embodiments disclosed above can be combined among them and with any other embodiment disclosed in this document in any combination, provided that they are not mutually exclusive, for example, in an embodiment, the ceramic additive manufacturing (CAM) method at the proper temperature is performed at a proper temperature, wherein a proper temperature is a temperature between 26° C. and 340° C.; or for example in another embodiment, between 26° C. and 298° C.; or for example, in another embodiment, between 41° C. and 298° C.

All the embodiments disclosed above can be combined among them and with any other embodiment disclosed in this document in any combination, provided that they are not mutually exclusive, for example, in an embodiment, a method of manufacturing ceramic or ceramic comprising components, which method comprises the steps of: providing a powder or powder mixture comprising at least a ceramic material; and shaping the powder or powder mixture using a ceramic additive manufacturing (CAM) method at the proper temperature; or for example, in another embodiment, a method of manufacturing ceramic or ceramic comprising components, which method comprises the steps of: providing a powder or powder mixture comprising at least a ceramic material; and shaping the powder or powder mixture at a temperature of 340° C. or less; or for example, in another embodiment, a method of manufacturing ceramic or ceramic comprising components, which method comprises the steps of: providing a powder or powder mixture comprising at least a ceramic material; and shaping the powder or powder mixture at a proper temperature, wherein a proper temperature is a temperature between 26° C. and 340° C.

As explained above, different ceramic additive manufacturing (CAM) methods can be used to form the component or at least part of the component. In an aspect of the present disclosure, the ceramic additive manufacturing (CAM) method comprises the use of a mold or capsule having the desired shape of the component to be manufactured (considering the shrinkage that occurs during the manufacturing process and the fact that the final geometry is often achieved with some kind of subtractive manufacturing like machining and/or with other additive manufacturing processes), which is filled with the powder or powder mixture and the application of a pressure and/or temperature treatment. In this respect, the inventor has found that for some applications, the use of a mold to provide the shape of the component may lead to a surprising improvement in dimensional accuracy for certain geometries.

All the embodiments disclosed above can be combined among them and with any other embodiment disclosed in this document in any combination, provided that they are not mutually exclusive, for example, in an embodiment, a method of manufacturing ceramic or ceramic comprising components, which method comprises the steps of: providing a powder or powder mixture comprising at least a ceramic material; shaping the powder or powder mixture using a ceramic additive manufacturing (CAM) method, wherein the CAM method comprises: providing a mold at least partly manufactured by additive manufacturing (AM); filling the mold with the powder or powder mixture; and applying a pressure and/or temperature treatment; or for example, in another embodiment, a method of manufacturing ceramic or ceramic comprising components, which method comprises the steps of: providing a powder or powder mixture comprising at least a ceramic material; shaping the powder or powder mixture using a method at the proper temperature, wherein the shaping method comprises: providing a mold at least partly manufactured by additive manufacturing (AM); filling the mold with the powder or powder mixture; and applying a pressure and/or temperature treatment.

Some examples of materials that can be used to manufacture the mold, or at least part of the mold, include, but are not limited to, organic materials, polymers, polymeric materials, elastomers, thermosetting polymers, thermoplastic polymers, amorphous polymers, amorphous thermoplastic polymers, crystalline polymers, semi-crystalline polymers, semi-crystalline thermoplastic polymers and/or combinations thereof. In some embodiments, the organic materials disclosed throughout this document for the manufacture of a mold can also be used to manufacture the mold, or at least part of the mold, in the present aspect of the disclosure. In certain embodiments, it may be advantageous to use the polymers and polymeric materials described in patent application number WO2021165545A1, the contents of which are incorporated herein by reference in their entirety.

A wide variety of technologies can be used to manufacture the mold, or at least part of the mold, in the present aspect of the disclosure including, but not limited to, conventional polymer shaping technologies such as for example, blow molding, extrusion, injection molding, pultrusion, rotomolding, filament winding, thermoforming or compression molding, additive manufacturing (AM) technologies such as for example, fused deposition modelling (FDM) or fused filament fabrication (FFF), additive manufacturing technologies based on vat-photo-polymerization, such as for example, stereolithography (SLA), digital light processing (DLP), continuous digital light processing (CDLP), digital light synthesis (DLS) or a technology based on continuous liquid interface production (CLIP), additive manufacturing technologies based on material jetting, such as for example, material jetting (MJ) or drop on demand (DOD), additive manufacturing technologies based on binder jetting, such as for example, multi jet fusion (MJF) or binder jetting (BJ), additive manufacturing technologies based on powder bed fusion, such as for example, selective laser sintering (SLS) or selective heat sintering (SHS), and/or combinations thereof. For some applications, the use of more than one technology to manufacture the mold is preferred.

The manufactured mold can then be filled with the material provided. In an embodiment, the ceramic additive manufacturing (CAM) method comprises filling the mold with the material provided. For some applications, it may be important how the filling of the mold is effectuated. Different strategies can be advantageously applied to settle the powder or powders correctly in the mold including, but not limited to, vibrating the mold. In an embodiment, the mold is vibrated during at least part of the filling with the powder or powder mixture. In certain embodiments, it may be advantageous to use the filling strategies described in patent application number WO2021165545A1, the contents of which are incorporated herein by reference in their entirety.

In some embodiments, the filled mold may be sealed to, among others, avoid that the powder or powder mixture enters into contact with any fluid outside the mold. In certain embodiments, it may be advantageous to use the strategies for sealing the mold described in patent application number WO2021165545A1, the contents of which are incorporated herein by reference in their entirety. In some cases, the sealing of the mold can be extremely simplified and reduced to the closing of the mold. Alternatively or additionally, the use of a cover mold may be particularly advantageous for certain applications.

All the embodiments disclosed above can be combined among them and with any other embodiment disclosed in this document in any combination, provided that they are not mutually exclusive, for example, in an embodiment, a method of manufacturing ceramic or ceramic comprising components, which method comprises the steps of: providing a powder or powder mixture comprising at least a ceramic material; providing a mold at least partly manufactured by additive manufacturing (AM); filling the mold with the material provided; and applying a pressure and/or temperature treatment.

As previously disclosed, the component can then be formed by applying pressure and/or temperature to the filled mold. In an embodiment, the ceramic additive manufacturing (CAM) method comprises applying a pressure and/or temperature treatment. The pressure and/or temperature applied (as defined in this document) may have an impact, among others, on the properties and the dimensional accuracy of some components. For some applications, the atmosphere used in the pressure and/or temperature treatment may be important. In an embodiment, the pressure and/or temperature treatment comprises the use of a properly designed atmosphere (as defined in this document). For some applications, it may also be advantageous to change the atmosphere in the furnace or pressure vessel during the treatment. In an embodiment, the pressure and/or temperature treatment comprises the use of at least two different atmospheres. In some embodiments, it may be advantageous to perform the pressure and/or temperature treatment simultaneously (sequentially) with other method steps.

In some embodiments, the pressure and/or temperature treatment may comprise the application of pressure. The inventor has found that the application of a certain pressure in the pressure and/or temperature treatment may be particularly advantageous for some components. In different embodiments, the pressure applied (as defined in this document) in the pressure and/or temperature treatment is 1.1 MPa or more, 41 MPa or more, 91 MPa or more, 101 MPa or more, 160 MPa or more, 306 MPa or more and even 560 MPa or more. On the other hand, excessive pressures seem to be disadvantageous for some treatments. In different embodiments, the pressure applied (as defined in this document) in the pressure and/or temperature treatment is 640 MPa or less, 320 MPa or less, 240 MPa or less, 140 MPa or less, 90 MPa or less, 49 MPa or less, and even 24 MPa or less. All the values and ranges of the different embodiments disclosed above can be combined among them and with any other embodiment disclosed in this document in any combination, provided that they are not mutually exclusive, for example, in an embodiment, the pressure and/or temperature treatment comprises the application of a pressure between 1.1 and 640 MPa; or for example, in another embodiment, between 1.1 and 320 MPa; or for example, in another embodiment, between 41 and 320 MPa. In an embodiment, the pressure is applied continuously. In another embodiment, the pressure is applied continuously for a relevant time (as defined in this document). In another embodiment, the pressure is applied in a stepwise manner (as defined in this document). In another embodiment, the pressure is increased and/or released more than once during the treatment. In an embodiment, the pressure is applied by a fluid. In an embodiment, the pressure is applied by a fluid comprising water. In an embodiment, the pressure is applied by a fluid comprising an organic material. In an embodiment, the pressure is applied by a fluid comprising oil. In an embodiment, the pressure is applied by a fluid comprising a vegetable oil. In an embodiment, the pressure is applied by a fluid comprising a mineral oil. In an embodiment, the pressure is applied by a liquid. In an embodiment, the pressure is applied by a gas. In an embodiment, the pressure is applied by a fluid comprising a liquid. In an embodiment, the pressure is applied by a fluid comprising a gas. In an embodiment, at least part of the pressure of the fluid is applied directly over the component. In another embodiment, the pressure of the fluid is applied directly over the component. In another embodiment, when the component comprises internal features, at least part of the pressure of the fluid is applied directly over the internal features. In another embodiment, when the component comprises internal features, the pressure of the fluid is applied directly over the internal features. In an alternative embodiment, the pressure is applied by a particle fluidized bed. In an embodiment, when the component comprises internal features, at least part of the pressure of the particle fluidized bed is applied directly over the internal features. In another embodiment, when the component comprises internal features, the pressure of the particle fluidized bed is applied directly over the internal features. However, the manner in which the pressure can be applied is not limited to the examples described above. In certain embodiments, the distribution of the applied pressure may be improved using the strategies developed for applying pressure in a homogeneous way as described in patent application number WO2021165545A1, the contents of which are incorporated herein by reference in their entirety. In some embodiments, the manner in which the pressure may be applied described above can also be used in other steps of the method involving pressure.

Additionally or alternatively, in some embodiments, the pressure and/or temperature treatment may comprise the application of temperature. The inventor has found that the application of a certain temperature in the pressure and/or temperature treatment may be particularly advantageous for the manufacture of some components. In different embodiments, the temperature applied (as defined in this document) in the pressure and/or temperature treatment is above 0.1° C., above 36° C., above 51° C., above 81° C., above 156° C., above 206° C., above 260° C. and even above 360° C. On the other hand, excessive temperatures may be disadvantageous for some treatments. In different embodiments, the temperature applied (as defined in this document) in the pressure and/or temperature treatment is below 480° C., below 390° C., below 240° C., below 120° C., below 90° C. and even below 49° C. All the values and ranges of the different embodiments disclosed above can be combined among them and with any other embodiment disclosed in this document in any combination, provided that they are not mutually exclusive, for example, in an embodiment, for example, in an embodiment, the pressure and/or temperature treatment comprises the application of a temperature between 0.1° C. and 480° C.; or for example in another embodiment, between 36° C. and 390° C., or for example, in another embodiment, between 51° C. and 390° C. In an embodiment, the temperature is applied continuously. In another embodiment, the temperature is applied continuously for a relevant time (as defined in this document). In another embodiment, the temperature is applied in a stepwise manner. In another embodiment, the temperature is increased and/or released more than once during the treatment. The inventor has found that the manner in which the temperature is applied, may have a strong influence on both the achievable accuracy and the absence of defects in some geometries. Heat transfer may involve different mechanisms such as for example, thermal conduction, thermal convection, thermal radiation and/or phase changes. In certain embodiments, at least part of the heating can be performed using microwaves, as described in patent application number WO2021165545A1, the contents of which are incorporated herein by reference in their entirety. However, the manner in which the heating can be performed is not limited to the examples described above. In some instances, it may also be advantageous to use microwaves to perform at least part of the heating in other treatments, such as for example, the consolidation and/or densification treatments. In some embodiments, the temperature can be raised, for example, by heating up the fluid that exerts the pressure (pressurized fluid). The inventor has found that for some applications, significant variations in the temperature of the pressurized fluid during the pressure and/or temperature treatment may be advantageous. In some embodiments, the manner in which the temperature may be applied described above can also be used in other steps of the method involving the application of temperature.

For some applications, the processing time may be important, among others, to the properties of some components. In different embodiments, the processing time of the pressure and/or temperature treatment is at least 1.2 minutes, at least 11 minutes, at least 31 minutes, at least 276 minutes, at least 460 minutes and even at least 1400 minutes. On the other hand, excessive processing times seem to be disadvantageous. In different embodiments, the processing time of the pressure and/or temperature treatment is less than 139 hours, less than 63 hours, less than 14 hours, less than 4 hours, less than 59 minutes and even less than 24 minutes. All the values and ranges of the different embodiments disclosed above can be combined among them and with any other embodiment disclosed in this document in any combination, provided that they are not mutually exclusive, for example, in an embodiment, the processing time of the pressure and/or temperature treatment is between 1.2 minutes and 139 hours; or for example, between 11 minutes and 63 hours; or for example, in another embodiment, between 31 minutes an 63 hours.

For some applications, the use of a pressure and/or temperature treatment comprising the steps disclosed below may be advantageous. In an embodiment, the pressure and/or temperature treatment comprises at least the following steps:
Step 1) raising the temperature of the mold while maintaining low pressure;
Step 2) raising the temperature and pressure of the mold; and
Step 3) raising the temperature and pressure of the mold;

In certain embodiments, steps 2), and 3) may be optional and thus can be avoided. In an embodiment, step 2) is skipped. In another embodiment, step 3) is skipped.

In some embodiments, the pressure and/or temperature applied (as defined in this document), in steps 1) to 3) may have an effect on the properties that can be achieved for some components. Additionally or alternatively, in some embodiments, the pressure and/or temperature applied (as defined in this document) may be important for dimensional accuracy, particularly in the manufacture of certain components with complex geometries and/or internal features.

Step 1) may be particularly relevant for some components. In different embodiments, step 1) comprises raising the temperature of the mold to 0.1° C. or more, to 31° C. or more, to 51° C. or more, to 81° C. or more, to 101° C. or more and even to 126° C. or more. On the other hand, excessive temperatures may be disadvantageous for some applications. In different embodiments, step 1) comprises raising the temperature of the mold to 189° C. or less, to 119° C. or less, to 99° C. or less, to 79° C. or less, to 49° C. or less, and even to 29° C. or less. For some applications, it may be advantageous to apply a certain pressure in step 1). In different embodiments, low pressure in step 1) means ambient pressure or more, 0.3 MPa or more, 1.6 MPa or more, 5.6 MPa or more, 16 MPa or more and even 31 MPa or more. On the other hand, excessive pressures in step 1) may lead to undesirable distortions in the manufacture of certain components. In different embodiments, low pressure in step 1) means 49 MPa or less, 29 MPa or less, 19 MPa or less, 9 MPa or less, 4 MPa or less, and even 1.9 MPa or less. The right selection of the pressure and temperature applied (as defined in this document) in step 2) may be particularly advantageous. In different embodiments, step 2) comprises raising the temperature of the mold to 51° C. or more, to 81° C. or more, to 106° C. or more, to 121° C. or more, to 136° C. or more and even to 156° C. or more. On the other hand, excessive temperature seems to be disadvantageous. In different embodiments, step 2) comprises raising the temperature of the mold to 249° C. or less, to 209° C. or less, to 189° C. or less, to 149° C. or less, to 109° C. or less, and even to 89° C. or less. As previously disclosed, step 2) further comprises raising the pressure. In different embodiments, step 2) comprises raising the pressure of the mold to 4.1 MPa or more, to 8.6 MPa or more, to 21 MPa or more, to 36 MPa or more, to 51 MPa or more, to 61 MPa or more, to 71 MPa or more and even to 81 MPa or more. On the other hand, excessive pressures may lead to undesirable distortions in the manufacture of certain components. In different embodiments, step 2) comprises raising the pressure of the mold to 114 MPa or less, to 94 MPa or less, to 74 MPa or less, to 49 MPa or less, to 24 MPa or less, to 12 MPa or less, and even to 6.4 MPa or less. The right selection of the pressure and temperature applied (as defined in this document) in step 3) may be particularly advantageous. In different embodiments, step 3) comprises raising the temperature of the mold to 78° C. or more, to 96° C. or more, to 106° C. or more, to 130° C. or more, to 190° C. or more and even to 240° C. or more. On the other hand, excessive temperatures seem to be disadvantageous for some treatments. In different embodiments, step 3) comprises raising the temperature of the mold to 299° C. or less, to 249° C. or less, to 199° C. or less, to 169° C. or less, and even to 149° C. or less. As previously disclosed, step 3) further comprises raising the pressure. In different embodiments, step 3) comprises raising the pressure of the mold to 110 MPa or more, to 151 MPa or more, to 201 MPa or more, to 251 MPa or more, to 301 MPa or more and even to 451 MPa or more. On the other hand, excessive pressures may lead to undesirable distortions in the manufacture of certain components. In different embodiments, step 3) comprises raising the pressure of the mold to 580 MPa or less, to 520 MPa or less, to 390 MPa or less, to 290 MPa or less, to 240 MPa or less, and even to 170 MPa or less.

For some applications, it may be advantageous to use of several cycles. In an embodiment, at least two cycles of the pressure and/or temperature treatment are applied. In another embodiment, at least three cycles of the pressure and/or temperature treatment are applied. In some embodiments, it may be advantageous to perform the pressure and/or temperature treatment simultaneously (sequentially) with other method steps.

All the embodiments disclosed above can be combined among them and with any other embodiment disclosed in this document in any combination, provided that they are not mutually exclusive, for example, in an embodiment, a method of manufacturing ceramic or ceramic comprising components, which method comprises the steps of: providing a powder or powder mixture comprising at least a ceramic material; providing a mold at least partly manufactured by additive manufacturing (AM); filling the mold with the powder or powder mixture; and applying a pressure and/or temperature treatment.

All the embodiments disclosed above can be combined among them and with any other embodiment disclosed in this document in any combination, provided that they are not mutually exclusive, for example, in an embodiment, a method of manufacturing ceramic or ceramic comprising components, which method comprises the steps of: providing a powder or powder mixture comprising at least a ceramic material; shaping the powder or powder mixture using a ceramic additive manufacturing (CAM) method, wherein the CAM method comprises: providing a mold; filling the mold with the powder or powder mixture; applying a pressure and/or temperature treatment; and applying a debinding treatment; or for example, in another embodiment, a method of manufacturing ceramic or ceramic comprising components, which method comprises the steps of: providing a powder or powder mixture comprising at least a ceramic material; providing a mold at least partly manufactured by additive manufacturing (AM); filling the mold with the powder or powder mixture; applying a pressure and/or temperature treatment; and applying a debinding treatment.

As previously disclosed, different CAM methods can be used to form the component, including the manufacture of the component in a layer-by layer fashion. In an embodiment, the ceramic additive manufacturing (CAM) method comprises the use of an additive manufacturing (AM) technology. In this respect, the inventor has surprisingly found that for certain applications, components with improved properties can be manufactured with a high design flexibility and at low cost. In an embodiment, the AM technology used further comprises the use of an organic material (e.g., a polymer or polymeric material, a binder and/or a resin). Some examples of AM technologies that can be used to manufacture the ceramic comprising components include, but are not limited to, fused deposition (FDM), fused filament fabrication (FFF), stereolithography (SLA), digital light processing (DLP), continuous digital light processing (CDLP), digital light synthesis (DLS), a technology based on continuous liquid interface production (CLIP), material jetting (MJ), drop on demand (DOD), multi jet fusion (MJF), binder jetting (BJ), laser sintering (SLS), and/or combinations thereof. In an embodiment, the AM technology comprises the use of a filament or wire comprising a mixture of an organic material and the powder or powder mixture. In an embodiment, the AM technology comprises fusing at least part of the organic material in the filament or wire. In an embodiment, the AM technology comprises fusing at least part of the powder or powder mixture in the filament or wire. In an embodiment, the organic material acts as an adhesive to bind the particles of the powder or powder mixture. In another embodiment, the AM technology is a BJ technology, in which a binder is applied to each layer. In another embodiment, the AM technology is a FDM technology, wherein an organic material comprising a powder or powder mixture is extruded through a nozzle to deposit the layers onto a platform. In another embodiment, the AM technology is a FDM technology wherein the filament or wire used comprises a mixture of an organic material and the powder or powder mixture. In another embodiment, the AM technology is a FFF technology wherein the filament or wire used comprises a mixture of an organic material and the powder or powder mixture. In an embodiment, the AM technology is selected from FDM, FFF, SLA, DLP, CDLP, DLS, a technology based on CLIP, MJ, DOD, MJF, BJ, SLS and/or combinations thereof. In another embodiment, the AM technology is selected from FDM, SLA, MJ, MJF, BJ, SLS and/or combinations thereof. For some applications, the use of more than one AM technology is preferred. In an embodiment, the CAM method comprises the use of at least two different AM technologies.

In some embodiments, the component obtained after the application of the ceramic additive manufacturing (CAM) method step disclosed above may be a final component, intended for the end use. However, often the component obtained in other embodiments may not be the final component (also referred to as the “green component” or “preform”), and the application of additional steps to obtain the final component, as disclosed below, may be advantageous.

All the embodiments disclosed above can be combined among them and with any other embodiment disclosed in this document in any combination, provided that they are not mutually exclusive, for example, in an embodiment, a method of manufacturing ceramic or ceramic comprising components, which method comprises the steps of: providing a powder or powder mixture comprising at least a ceramic material; and shaping the powder or powder mixture using an additive manufacturing (AM) technology; or for example, in another embodiment, a method of manufacturing ceramic or ceramic comprising components, which method comprises the steps of: providing a powder or powder mixture comprising at least a ceramic material; and shaping the powder or powder mixture using an additive manufacturing (AM) technology at the proper temperature.

Optionally, the method may further comprise a step wherein a debinding treatment is applied to eliminate the organic material or at least part of the organic material (also referred to as the “debinding step”). In an embodiment, the method further comprises the step of: applying a debinding treatment. In some embodiments, the component formed using a ceramic additive manufacturing (CAM) method as described above may comprise an organic material (e.g. the mold used to provide the shape of the component or the polymer or polymeric material, binder and/or resin that may be used in some embodiments together with the material provided to form the component by means of an additive manufacturing (AM) technology, as described above . . . ) that in some cases may be desirable to eliminate. On the other hand, in some particular embodiments, the debinding step may not be necessary, for example, in certain embodiments where a particularly suitable selection of the organic material has been made.

In an embodiment, the debinding step comprises the elimination of at least part of the organic material. In another embodiment, the debinding step comprises the complete elimination of the organic material. Some examples of debinding treatments that can be applied include, but are not limited to, thermal debinding, non-thermal debinding (catalytic, wicking, drying, supercritical extraction, solvent extraction, organic solvent extraction, water-based solvent extraction, freeze drying . . . ), chemical debinding and/or combinations thereof.

For some applications, it may be advantageous to use of several cycles. In an embodiment, at least two cycles of the debinding treatment are applied. In another embodiment, at least three cycles of the debinding treatment are applied. In some embodiments, it may be advantageous to perform the debinding treatment simultaneously (sequentially) with other method steps. On the other hand, in some particular embodiments, the debinding step may not be necessary and can therefore be skipped, for example, in certain embodiments where a suitable selection of the organic material used (e.g. to manufacture the mold . . . ) has been made.

All the embodiments disclosed above can be combined among them and with any other embodiment disclosed in this document in any combination, provided that they are not mutually exclusive, for example, in an embodiment, a method of manufacturing ceramic or ceramic comprising components, which method comprises the steps of: providing a powder or powder mixture comprising at least a ceramic material; shaping the powder or powder mixture using an additive manufacturing (AM) technology; and applying a debinding treatment; or for example, in another embodiment, a method of manufacturing ceramic or ceramic comprising components, which method comprises the steps of: providing a powder or powder mixture comprising at least a ceramic material; shaping the powder or powder mixture using an additive manufacturing (AM) technology at a proper temperature; and applying a debinding treatment.

Optionally, the method may further comprise a step wherein the component is subjected to a pressure and/or temperature treatment (as described above) before and/or after applying the debinding treatment. In an embodiment, the method further comprises the step of: applying a pressure and/or temperature treatment. For some applications, this treatment may, among others, lead to a surprising increase in the apparent density achieved for some components. In such cases, the pressure and/or temperature can be applied to the component, to the mold or to a cover mold (e.g., pressure transmitting container, polymer film, bag, vacuum bag, coating, conformal coating, etc. placed over the component). In some embodiments, it may be advantageous to perform the pressure and/or temperature treatment simultaneously (sequentially) with other method steps.

For some applications, it may be advantageous to use of several cycles. In an embodiment, at least two cycles of the pressure and/or temperature treatment are applied. In another embodiment, at least three cycles of the pressure and/or temperature treatment are applied.

All the embodiments disclosed above can be combined among them and with any other embodiment disclosed in this document in any combination, provided that they are not mutually exclusive, in an embodiment, the method of manufacturing ceramic or ceramic comprising components, which method comprises the steps of: providing a powder or powder mixture comprising at least a ceramic material; providing a mold at least partly manufactured by additive manufacturing (AM); filling the mold with the powder or powder mixture; applying a pressure and/or temperature treatment; applying a debinding treatment; and applying a pressure and/or temperature treatment; or for example, in another embodiment, a method of manufacturing ceramic or ceramic comprising components, which method comprises the steps of: providing a powder or powder mixture comprising at least a ceramic material; shaping the powder or powder mixture using an additive manufacturing (AM) technology at the proper temperature; applying a pressure and/or temperature treatment; optionally, applying a debinding treatment; and optionally, applying a pressure and/or temperature treatment.

Optionally, the method may further comprise a step wherein a carburizing treatment, a boriding treatment, a nitriding treatment, a siliciding treatment and/or combinations thereof is applied at any time between the debinding treatment and the consolidation treatment. In an embodiment, the method further comprises the step of: applying a treatment selected from carburizing, boriding, nitriding, siliciding and/or combinations thereof. In some embodiments, it may be advantageous to perform these treatments simultaneously (sequentially) with other method steps.

All the embodiments disclosed above can be combined among them and with any other embodiment disclosed in this document in any combination, provided that they are not mutually exclusive, for example, in an embodiment, a method of manufacturing ceramic or ceramic comprising components, which method comprises the steps of: providing a powder or powder mixture comprising at least a ceramic material; providing a mold at least partly manufactured by additive manufacturing (AM); filling the mold with the powder or powder mixture; applying a pressure and/or temperature treatment; applying a debinding treatment; and applying a treatment selected from carburizing, boriding, nitriding, siliciding and/or combinations thereof; or for example, in another embodiment, a method of manufacturing ceramic or ceramic comprising components, which method comprises the steps of: providing a powder or powder mixture comprising at least a ceramic material; shaping the powder or powder mixture using an additive manufacturing (AM) technology; optionally, applying a debinding treatment; and applying a treatment selected from carburizing, boriding, nitriding, siliciding and/or combinations thereof.

Optionally, the method may further comprise a step wherein the component is subjected to a consolidation treatment (also referred to as the “CAM consolidation step”). In an embodiment, the method further comprises the step of: applying a consolidation treatment. The consolidation treatment may, among others, help to increase the density, further having a strong contribution to the dimensional accuracy and the properties that can be achieved in some components. In an embodiment, the consolidation treatment comprises applying a sintering. For some applications, the atmosphere used in the consolidation treatment may be important. In an embodiment, the consolidation treatment comprises the use of a properly designed atmosphere (as defined in this document). For some applications, it may also be advantageous to change the atmosphere in the furnace or pressure vessel during the treatment. In an embodiment, the consolidation treatment comprises the use of at least two different atmospheres. Often, some of the treatments may be performed sequentially (e.g., the debinding treatment and the consolidation treatment, . . . ), for example, in certain embodiments where the equipment (e.g., furnace or pressure vessel) used to perform the treatment allows to change the atmosphere. In some embodiments, it may be advantageous to perform the consolidation treatment simultaneously (sequentially) with other method steps.

In some embodiments, the CAM consolidation treatment may comprise the application of temperature. For some applications, it may be particularly important to properly select the temperature applied (as defined in this document) in the consolidation treatment. In different embodiments, the temperature applied (as defined in this document) in the consolidation treatment is 1100° C. or more, 1600° C. or more, 2100° C. or more and even 2600° C. or more. On the other hand, an excessive temperature may be disadvantageous for some treatments. In different embodiments, the temperature applied (as defined in this document) in the consolidation treatment is 3800° C. or less, 3400° C. or less, 2900° C. or less, 2200° C. or less, and even 1400° C. or less. All the values and ranges of the different embodiments disclosed above can be combined among them and with any other embodiment disclosed in this document in any combination, provided that they are not mutually exclusive, for example, in an embodiment, the CAM consolidation treatment comprises the application of a temperature between 1100° C. and 3800° C.; or for example, in another embodiment, between 1100° C. and 3400° C.; or for example, in another embodiment, between 1600° C. and 3400° C.

Additionally or alternatively, in some embodiments, the CAM consolidation treatment may comprise the application of pressure. For some applications, it may be advantageous to perform the consolidation treatment under a certain pressure. In an embodiment, the consolidation treatment further comprises the application of pressure. In this respect, the inventor has found that the pressure applied (as defined in this document) may help to achieve very high densities and even full density (the maximum theoretical density) in some components. In different embodiments, the pressure applied (as defined in this document) in the consolidation treatment is at least 12 mbar, at least 1.1 bar, at least 2.6 bar, at least 31 bar, at least 71 bar, and even at least 121 bar. On the other hand, excessive pressures may lead to undesirable distortions in the manufacture of certain components. In different embodiments, the pressure applied (as defined in this document) in the consolidation treatment is less than 189 bar, less than 149 bar, less than 119 bar, less than 89 bar, less than 39 bar, less than 9 bar and even less than 940 mbar. Even in certain embodiments, a consolidation treatment under vacuum may be advantageous. All the values and ranges of the different embodiments disclosed above can be combined among them and with any other embodiment disclosed in this document in any combination, provided that they are not mutually exclusive, for example, in an embodiment, the CAM consolidation treatment comprises the application of a pressure between 12 mbar and 189 bar; or for example, in another embodiment, between 1.1 and 189 bar; or for example, in another embodiment, between 1.1 and 149 bar.

For some applications, it may be advantageous to use of several cycles. In an embodiment, at least two cycles of the consolidation treatment are applied. In another embodiment, at least three cycles of the consolidation treatment are applied. On the other hand, in some embodiments, the consolidation treatment may be optional, and can therefore be skipped.

All the embodiments disclosed above can be combined among them and with any other embodiment disclosed in this document in any combination, provided that they are not mutually exclusive, for example, in an embodiment, the method of manufacturing ceramic or ceramic comprising components, which method comprises the steps of: providing a powder or powder mixture comprising at least a ceramic material; providing a mold at least partly manufactured by additive manufacturing (AM); filling the mold with the powder or powder mixture; applying a pressure and/or temperature treatment; applying a debinding treatment; optionally, applying a pressure and/or temperature treatment; and applying a consolidation treatment; or for example, in another embodiment, a method of manufacturing ceramic or ceramic comprising components, which method comprises the steps of: providing a powder or powder mixture comprising at least a ceramic material; shaping the powder or powder mixture using an additive manufacturing (AM) technology; optionally, applying a pressure and/or temperature treatment; optionally, applying a debinding treatment; optionally, applying a pressure and/or temperature treatment; and applying a consolidation treatment.

Optionally, the method may further comprise a step wherein at least two parts are joined to make a bigger component (also referred to as the “joining step”). In an embodiment, the method further comprises the step of: joining different parts.

Optionally, the method may further comprise a step wherein the component is subjected to a densification treatment (also referred to as the “CAM densification step”). In an embodiment, the method further comprises the step of: applying a densification treatment. For some applications, this densification treatment may, among others, help to increase the density (even up to the theoretical density), further having a strong contribution on the properties of some components. In an embodiment, the densification treatment comprises applying a hot isostatic pressing (HIP). For some applications, the atmosphere used in the densification treatment may be important. In an embodiment, the densification treatment comprises the use of a properly designed atmosphere (as defined in this document). For some applications, it may also be advantageous to change the atmosphere in the furnace or pressure vessel during the treatment. In an embodiment, the densification treatment comprises the use of at least two different atmospheres. In some embodiments, it may be advantageous to perform the densification treatment simultaneously (sequentially) with other method steps.

In some embodiments, the CAM densification treatment may comprise the application of pressure. In this respect, the inventor has found that for some applications, it may be important to properly select the pressure applied (as defined in this document) in the densification treatment. In different embodiments, the pressure applied (as defined in this document) in the densification treatment is 166 bar or more, 360 bar or more, 610 bar or more, 1200 bar or more and even 1600 bar or more. On the other hand, excessive pressures may lead to undesirable distortions in the manufacture of certain components. In different embodiments, the pressure applied (as defined in this document) in the densification treatment is less than 5300 bar, less than 3400 bar, less than 2400 bar, less than 1900 bar, less than 1300 bar, less than 990 bar and even less than 490 bar. All the values and ranges of the different embodiments disclosed above can be combined among them and with any other embodiment disclosed in this document in any combination, provided that they are not mutually exclusive, for example, in an embodiment, the CAM densification treatment comprises the application of a pressure between 166 and 5300 bar; or for example, in another embodiment, between 360 and 3400 bar; or for example, in another embodiment, between 360 and 2400 bar.

Additionally or alternatively, in some embodiments, the CAM densification treatment may comprise the application of temperature. For some applications, it may be particularly important to properly select the temperature applied (as defined in this document) in the densification treatment. In different embodiments, the temperature applied (as defined in this document) in the densification treatment is 960° C. or more, 1410° C. or more, 1910° C. or more and even 2510° C. or more. On the other hand, excessive temperatures may be disadvantageous for some treatments. In different embodiments, the temperature applied (as defined in this document) in the densification treatment is 3640° C. or less, 3290° C. or less, 2740° C. or less, 2400° C. or less, 1900° C. or less, and even 1290° C. or less. All the values and ranges of the different embodiments disclosed above can be combined among them and with any other embodiment disclosed in this document in any combination, provided that they are not mutually exclusive, for example, in an embodiment, the CAM densification treatment comprises the application of a temperature between 960° C. and 3640° C.; or for example, in another embodiment, between 960° C. and 3290° C.; or for example, in another embodiment, between 1410° C. and 3290° C.

For some applications, it may be advantageous to use of several cycles. In an embodiment, at least two cycles of the densification treatment are applied. In another embodiment, at least three cycles of the densification treatment are applied. On the other hand, in some embodiments, the densification treatment may be optional, and can therefore be skipped.

All the embodiments disclosed above can be combined among them and with any other embodiment disclosed in this document in any combination, provided that they are not mutually exclusive, for example, in an embodiment, a method of manufacturing ceramic or ceramic comprising components, which method comprises the steps of: providing a powder or powder mixture comprising at least a ceramic material; providing a mold at least partly manufactured by additive manufacturing (AM); filling the mold with the powder or powder mixture; applying a pressure and/or temperature treatment; optionally, applying a debinding treatment; optionally, applying a pressure and/or temperature treatment; optionally, applying a consolidation treatment; optionally, infiltrating at least part of the component with an infiltrate material; and optionally, applying a densification treatment; or for example, in another embodiment, a method of manufacturing ceramic or ceramic comprising components, which method comprises the steps of: providing a powder or powder mixture comprising at least a ceramic material; shaping the powder or powder mixture using an additive manufacturing (AM) technology; optionally, applying a pressure and/or temperature treatment; optionally, applying a debinding treatment; optionally, applying a pressure and/or temperature treatment; optionally, applying a consolidation treatment; optionally, applying a densification treatment; optionally, infiltrating at least part of the component with an infiltrate material; and optionally, applying a densification treatment.

Optionally, the method may further comprise a step wherein the component, or at least part of the component, is infiltrated (also referred to as the “infiltration step”). In an embodiment, the method further comprises the step of: infiltrating at least part of the component with an infiltrate material.

Some examples of infiltrate materials which can be used include, but are not limited to, metallic materials, organic materials such as for example, polymers, polymeric materials, resins and/or mixtures thereof. In an embodiment, the infiltrant comprises a metallic material. In another embodiment, the infiltrant comprises a resin.

For certain applications, it may be advantageous to limit the infiltration area to certain geometric features of the component in order to preserve certain desired geometric features including, but not limited to, external features, internal features, holes, voids, channels (e.g., cooling and/or heating channels), sharp angles and/or combinations thereof. In an embodiment, only part of the component is infiltrated. In an embodiment, the component comprises at least one infiltration barrier to avoid the infiltration in some geometric features of the component. In some embodiments, this infiltration barrier can be manufactured with the component or formed at a later stage, for example, by dipping, spraying or deposition, among others. However, the formation of the infiltration barrier is not limited to the technologies described above.

Optionally, the method may further comprise a step wherein the component is subjected to a densification treatment (as described above) after the infiltration step. In an embodiment, the method further comprises the step of: applying a densification treatment to the at least partly infiltrated material.

All the embodiments disclosed above can be combined among them and with any other embodiment disclosed in this document in any combination, provided that they are not mutually exclusive, for example, in an embodiment, a method of manufacturing ceramic or ceramic comprising components, which method comprises the steps of: providing a powder or powder mixture comprising at least a ceramic material; providing a mold at least partly manufactured by additive manufacturing (AM); filling the mold with the powder or powder mixture; applying a pressure and/or temperature treatment; applying a debinding treatment; optionally, applying a pressure and/or temperature treatment; optionally, applying a consolidation treatment; optionally, applying a densification treatment; optionally, infiltrating at least part of the component with an infiltrate material; and optionally, applying a densification treatment; or for example, in another embodiment, a method of manufacturing ceramic or ceramic comprising components, which method comprises the steps of: providing a powder or powder mixture comprising at least a ceramic material; shaping the powder or powder mixture using an additive manufacturing (AM) technology; optionally, applying a pressure and/or temperature treatment; optionally, applying a debinding treatment; optionally, applying a pressure and/or temperature treatment; optionally, applying a consolidation treatment; optionally, applying a densification treatment; optionally, infiltrating at least part of the component with an infiltrate material; and optionally, applying a densification treatment.

Optionally, the method may further comprise other additional steps, including, but not limited to, post-processing treatments such as for example, a machining step and/or a surface conditioning. In an embodiment, the method further comprises the step of: applying a machining. In some embodiments, it may also be advantageous to apply a machining step before and/or after performing any of the above disclosed method steps (e.g., the pressure and/or temperature treatment, the consolidation treatment, the densification treatment, . . . ). For some applications, it may be particularly advantageous to perform a surface conditioning. In an embodiment, the method further comprises the step of: applying a surface conditioning.

Another aspect of the disclosure provides a method of manufacturing polymer comprising components including, but not limited to, pieces, components, molds, and/or tools for different industries such as for example, but not limited to, the automotive industry, the food processing industry, the aerospace industry, the transportation industry (e.g., marine, rail . . . ), the packaging industry, the pharmaceutical industry, the electronics industry, the appliance industry, the material transformation industry and/or the power generation/transformation industry, among others, which method comprises the steps of:
providing a material comprising at least an organic material; and
shaping the material using a polymer additive manufacturing (PAM) method.

In some embodiments, the method may further comprise other additional steps, some of which are further discussed later in this document.

The method of manufacturing polymer comprising components disclosed in this document can be used to manufacture the entire component or at least part of the component. In this respect, for some applications of the method, it may be advantageous to manufacture the component in different parts that can be assembled together. In an embodiment, the method is used to manufacture at least part of the component.

In another embodiment, the method is used to manufacture the entire component. The inventor has also found that for some applications, it may be advantageous to manufacture the component from different materials. In an embodiment, the manufactured component comprises at least two different materials. In another embodiment, the manufactured component comprises at least three different materials.

The method disclosed in the present aspect of the disclosure may be particularly suitable for manufacturing components from starting materials comprising organic materials in different forms, including, but not limited to, powders, powder mixtures, wires, filaments, resins, liquids and/or mixtures thereof. Different organic materials can be advantageously used such as for example, but not limited to, polymers, polymeric materials, or polymer-based composites. In certain embodiments, it may be advantageous to use the organic materials described in patent application number WO2021165545A1, the contents of which are incorporated herein by reference in their entirety. In an embodiment, the organic material is a polymer or a polymer-based composite. In this respect, the inventor has found that for some applications, polymer-based composites, such as for example, but not limited to, those containing metallic and/or ceramic phases may be advantageously used. In an embodiment, the polymer-based composite is a material comprising at least a polymer and a metallic phase. In another embodiment, the polymer-based composite is a material comprising at least a polymer and a ceramic phase. In another embodiment, the polymer-based composite is a material comprising at least a polymer and a metallic and/or ceramic phase.

Some examples of polymeric materials that may be particularly suitable include, but are not limited to, polyimide (PI), polycarbonate (PC), ether ketone (EK), polyethylene sulfide (PPS), polytetrafluorethylene (PTFE), polyethylene terephthalate (PET), polybutylene terephthalate (PBT), PA6, PA11, polyamide (PA), polyoxymethylene (POM), polymethylmethacrylate (PMMA), polystyrene (PS), acrylonitrile-butadiene-styrene (ABS), styrene-acrylonitrile (SAN), polypropylene (PP), polyethylene (PE), Polyamide-Imide (PAI), Polyethersulfone (PES), olyphenylsulfone (PPSU), polyetherimide (PEI), polysulfone (PSU), polyparaphenylene (PPP), polyether ether ketone (PEEK), polyetherketone (PEK), liquid crystal polymer (LCP), perfluoroalkoxy alkane (PFA), ethylene tetrafluoroethylene (ETFE), polychlorotrifluoroethylene (PCTFE), polyvinylidene fluoride (PVDF), PA6-3-T, PA46, polymethylpentene (PMP), polyphenylene ether (PPE), and/or mixtures thereof. Alternatively or additionally, in some embodiments, any other organic materials disclosed throughout this document can also be used in the present aspect of the disclosure.

The inventor has found that for some applications, among the metal comprising composites suitable for use in the method of the present aspect of the disclosure, those having a certain ratio between the melting temperature of the metallic phase and the critical temperature (as defined in this document) of the polymer may be particularly suitable. In different embodiments, the melting temperature of the metallic phase is 3.8 times or less, 2.9 times or less, 2.4 times or less, 2 times or less, 1.8 times or less, and even 1.2 times or less the critical temperature (as defined in this document) of the polymer. On the other hand, excessively low values may reduce the processability of the material. In different embodiments, the melting temperature of the metallic phase is 0.5 times or more, 0.62 times or more, 0.77 times or more, 0.86 times or more, 1.1 times or more and even 1.35 times or more the critical temperature (as defined in this document) of the polymer. In this context the melting temperatures and the critical temperatures are expressed in Kelvin. Throughout this document, unless otherwise stated, the melting temperature of a metallic phase refers to the temperature at which the first metallic liquid forms in such metallic phase under equilibrium conditions.

All the embodiments disclosed above can be combined among them and with any other embodiment disclosed in this document provided that they are not mutually exclusive, for example, in an embodiment, a method of manufacturing polymer comprising components, which method comprises the steps of: providing a material comprising at least a polymer or a polymer-based composite; and shaping the material using a polymer additive manufacturing (PAM) method; or for example, in another embodiment, a method of manufacturing polymer comprising components, which method comprises the steps of: providing a material comprising at least a polymer or a polymer-based composite in powder form; and shaping the material using a polymer additive manufacturing (PAM) method; or for example, in another embodiment, a method of manufacturing polymer comprising components, which method comprises the steps of: providing a material comprising at least a polymer or a polymer-based composite in liquid form; and shaping the material using a polymer additive manufacturing (PAM) method; or for example, in another embodiment, a method of manufacturing polymer comprising components, which method comprises the steps of: providing a material comprising at least a polymer or a polymer-based composite in wire or filament form; and shaping the material using a polymer additive manufacturing (PAM) method; or for example, in another embodiment, a method of manufacturing polymer comprising components, which method comprises the steps of: providing a material comprising at least a polymer and a metallic phase, wherein the melting temperature of the metallic phase is between 0.5 and 3.8 times the melting temperature of the polymer; and shaping the material using a polymer additive manufacturing (PAM) method.

As described above, the component, or at least part of the component, can then be formed from the starting material provided using a polymer additive manufacturing (PAM) method (this step is also referred to as the “PAM forming step”). In this document, the definition of polymer additive manufacturing (PAM) includes any near net shape manufacturing method described throughout this document. In particular, the definition of PAM includes those methods in which additive manufacturing (AM) is used to manufacture a mold or capsule, or part of the mold or capsule, that is subsequently filled and subjected to pressure and/or temperature and also includes those methods in which the component is manufactured by means of an additive manufacturing (AM) technology. In an embodiment, the powder or powder mixture is formed into a component, or into a part of a component, using a polymer additive manufacturing (PAM) method.

For some applications, the temperature applied (as defined in this document) in the PAM forming step may be important. In this regard, the inventor has found that the use of PAM methods at the proper temperature (as defined in this document) may lead to a surprising increase in the dimensional accuracies achievable for some components. In an embodiment, according to this aspect of the disclosure, the method comprises the step of: shaping the material comprising at least a polymer or a polymer-based composite using a polymer additive manufacturing (PAM) method at the proper temperature (as defined in this document).

All the embodiments disclosed above can be combined among them and with any other embodiment disclosed in this document provided that they are not mutually exclusive, for example, in an embodiment, a method of manufacturing polymer comprising components, which method comprises the steps of: providing a material comprising at least a polymer or a polymer-based composite; and shaping the material using a polymer additive manufacturing (PAM) method at the proper temperature; or for example, in another embodiment, a method of manufacturing polymer comprising components, which method comprises the steps of: providing a material comprising at least a polymer or a polymer-based composite; and shaping the material using a polymer additive manufacturing (PAM) method at a temperature of 340° C. or less.

As explained above, different PAM methods can be used to form the component or at least part of the component. In an aspect of the present disclosure, the PAM method comprises the use of a mold or capsule having the desired shape of the component to be manufactured (considering the shrinkage that occurs during the manufacturing process and the fact that the final geometry is often achieved with some kind of subtractive manufacturing like machining and/or with other additive manufacturing processes), which is filled with the material and the application of a pressure and/or temperature treatment. In this respect, the inventor has found, that for some applications, the use of a mold to form the component may lead to a surprising reduction or even absence of defects, particularly in the manufacture of certain components with complex geometries.

Some examples of materials that can be advantageously used to manufacture the mold, or at least part of the mold, include, but are not limited to, organic materials, polymers, polymeric materials, elastomers, thermosetting polymers, thermoplastic polymers, amorphous polymers, amorphous thermoplastic polymers, crystalline polymers, semi-crystalline polymers, semi-crystalline thermoplastic polymers and/or combinations thereof. In some embodiments, the organic materials disclosed throughout this document for the manufacture of a mold can also be used to manufacture the mold, or at least part of the mold, in the present aspect of the disclosure.

A wide variety of technologies can be used to manufacture the mold, or at least part of the mold, in the present aspect of the disclosure, including, but not limited to, conventional polymer shaping technologies such as for example, blow molding, extrusion, injection molding, pultrusion, rotomolding, filament winding, thermoforming or compression molding, additive manufacturing (AM) technologies such as for example, fused deposition modelling (FDM) or fused filament fabrication (FFF), additive manufacturing technologies based on vat-photo-polymerization, such as for example, stereolithography (SLA), digital light processing (DLP), continuous digital light processing (CDLP), digital light synthesis (DLS) or a technology based on continuous liquid interface production (CLIP), additive manufacturing technologies based on material jetting, such as for example, material jetting (MJ) or drop on demand (DOD), additive manufacturing technologies based on binder jetting, such as for example, multi jet fusion (MJF) or binder jetting (BJ), additive manufacturing technologies based on powder bed fusion, such as for example, selective laser sintering (SLS) or selective heat sintering (SHS), and/or combinations thereof. For some applications, the use of more than one technology to manufacture the mold is preferred.

The manufactured mold can then be filled with the material provided. In an embodiment, the polymer additive manufacturing (PAM) method comprises filling the mold with the material comprising at least an organic material (e.g., a polymer or a polymer-based composite) provided. For some applications, it may be advantageous to settle the material correctly in the mold. Different strategies can be advantageously applied to settle the powder or powders correctly in the mold including, but not limited to, vibrating the mold. In an embodiment, the mold is vibrated during at least part of the filling with the material. In certain embodiments, it may be advantageous to use the filling strategies described in patent application number WO2021165545A1, the contents of which are incorporated herein by reference in their entirety.

In some embodiments, the filled mold may be sealed to, among others, avoid that the material comprising at least a polymer or a polymer-based composite enters into contact with any fluid outside the mold. In certain embodiments, it may be advantageous to use the strategies for sealing the mold described in patent application number WO2021165545A1, the contents of which are incorporated herein by reference in their entirety. In some cases, the sealing of the mold can be extremely simplified and reduced to the closing of the mold. Alternatively or additionally, the use of a cover mold may be particularly advantageous for certain applications.

As previously disclosed, the component can then be formed by applying pressure and/or temperature to the filled mold. In an embodiment, the polymer additive manufacturing (PAM) method comprises applying a pressure and/or temperature treatment. The pressure and/or temperature applied (as defined in this document) may, among others, have an impact on the properties and the dimensional accuracy of some components. For some applications, the atmosphere used in the pressure and/or temperature treatment may be important. In an embodiment, the pressure and/or temperature treatment comprises the use of a properly designed atmosphere (as defined in this document). For some applications, it may also be advantageous to change the atmosphere in the furnace or pressure vessel during the treatment. In an embodiment, the pressure and/or temperature treatment comprises the use of at least two different atmospheres. In some embodiments, it may be advantageous to perform the pressure and/or temperature treatment simultaneously (sequentially) with other method steps.

In some embodiments, the pressure and/or temperature treatment may comprise the application of pressure. The inventor has found that the application of a certain pressure in the pressure and/or temperature treatment may be particularly advantageous for some components. In different embodiments, the pressure applied (as defined in this document) in the pressure and/or temperature treatment is 1.6 MPa or more, 61 MPa or more, 156 MPa or more, 206 MPa or more, 260 MPa or more, 356 MPa or more and even 560 MPa or more. On the other hand, excessive pressures may lead to undesirable distortions in the manufacture of certain components. In different embodiments, the pressure applied (as defined in this document) in the pressure and/or temperature treatment is 690 MPa or less, 490 MPa or less, 390 MPa or less, 190 MPa or less, 140 MPa or less, 90 MPa or less, and even 39 MPa or less. All the values and ranges of the different embodiments disclosed above can be combined among them and with any other embodiment disclosed in this document in any combination, provided that they are not mutually exclusive, for example, in an embodiment, the pressure and/or temperature treatment comprises the application of a pressure between 1.6 and 690 MPa; or for example, in another embodiment, between 1.6 and 490 MPa; or for example, in another embodiment, between 61 and 490 MPa. In an embodiment, the pressure is applied continuously. In another embodiment, the pressure is applied continuously for a relevant time (as defined in this document). In another embodiment, the pressure is applied in a stepwise manner (as defined in this document). In another embodiment, the pressure is increased and/or released more than once during the treatment. In an embodiment, the pressure is applied by a fluid. In an embodiment, the pressure is applied by a fluid comprising water. In an embodiment, the pressure is applied by a fluid comprising an organic material. In an embodiment, the pressure is applied by a fluid comprising oil. In an embodiment, the pressure is applied by a fluid comprising a vegetable oil. In an embodiment, the pressure is applied by a fluid comprising a mineral oil. In an embodiment, the pressure is applied by a liquid. In an embodiment, the pressure is applied by a gas. In an embodiment, the pressure is applied by a fluid comprising a liquid. In an embodiment, the pressure is applied by a fluid comprising a gas. In an embodiment, at least part of the pressure of the fluid is applied directly over the component. In another embodiment, the pressure of the fluid is applied directly over the component. In another embodiment, when the component comprises internal features, at least part of the pressure of the fluid is applied directly over the internal features. In another embodiment, when the component comprises internal features, the pressure of the fluid is applied directly over the internal features. In an alternative embodiment, the pressure is applied by a particle fluidized bed. In an embodiment, when the component comprises internal features, at least part of the pressure of the particle fluidized bed is applied directly over the internal features. In another embodiment, when the component comprises internal features, the pressure of the particle fluidized bed is applied directly over the internal features. However, the manner in which the pressure can be applied is not limited to the examples described above. In certain embodiments, the distribution of the applied pressure may be improved using for example, the strategies developed for applying pressure in a homogeneous way as described in patent application number WO2021165545A1, the contents of which are incorporated herein by reference in their entirety. In some embodiments, the manner in which the pressure may be applied described above can also be used in other steps of the method involving pressure.

Additionally or alternatively, in some embodiments, the pressure and/or temperature treatment may comprise the application of temperature. The inventor has found that the application of a certain temperature in the pressure and/or temperature treatment may be particularly advantageous for some components. In different embodiments, the temperature applied (as defined in this document) in the pressure and/or temperature treatment is above 0.12° C., above 31° C., above 61° C., above 91° C., above 126° C., above 176° C. and even above 206° C. On the other hand, excessive temperatures may be disadvantageous for some treatments. In different embodiments, the temperature applied (as defined in this document) in the pressure and/or temperature treatment is below 440° C., below 380° C., below 220° C., below 120° C., below 89° C., below 44° C. and even below 29° C. All the values and ranges of the different embodiments disclosed above can be combined among them and with any other embodiment disclosed in this document in any combination, provided that they are not mutually exclusive, for example, in an embodiment, the pressure and/or temperature treatment comprises the application of a temperature between 0.12° C. and 440° C.; or for example, in another embodiment, between 0.12° C. and 380° C.; or for example, in another embodiment, between 31° C. and 380° C. In an embodiment, the temperature is applied continuously. In another embodiment, the temperature is applied continuously for a relevant time (as defined in this document). In another embodiment, the temperature is applied in a stepwise manner. In another embodiment, the temperature is increased and/or released more than once during the treatment. For certain components, the manner in which the temperature is applied, may have a strong influence on both the achievable accuracy in the manufactured component and the absence of defects in some geometries. Heat transfer may involve different mechanisms such as for example, thermal conduction, thermal convection, thermal radiation and/or phase change. In certain embodiments, at least part of the heating can be performed using microwaves, as described in patent application number WO2021165545A1, the contents of which are incorporated herein by reference in their entirety. However, the manner in which the heating can be performed is not limited to the examples described above. In some instances, it may also be advantageous to use microwaves to perform at least part of the heating in other treatments, such as for example, the consolidation and/or densification treatments. In some embodiments, the temperature can be raised, for example, by heating up the fluid that exerts the pressure (pressurized fluid). The inventor has found that for some applications, significant variations in the temperature of the pressurized fluid during the pressure and/or temperature treatment may be advantageous. In some embodiments, the manner in which the temperature may be applied described above can also be used in other steps of the method involving the application of temperature.

For some applications, it may be advantageous to use of several cycles. In an embodiment, at least two cycles of the pressure and/or temperature treatment are applied. In another embodiment, at least three cycles of the pressure and/or temperature treatment are applied. In some embodiments, it may be advantageous to perform the pressure and/or temperature treatment simultaneously (sequentially) with other method steps.

Some applications may require a minimum processing time. In different embodiments, the processing time of the pressure and/or temperature treatment is at least 0.9 minutes, at least 4 minutes, at least 21 minutes, at least 156 minutes, at least 310 minutes and even at least 1090 minutes. On the other hand, an excessive processing time seems to be disadvantageous for some components. In different embodiments, the processing time of the pressure and/or temperature treatment is less than 119 hours, less than 44 hours, less than 9 hours, less than 3 hours, less than 29 minutes and even less than 14 minutes. All the values and ranges of the different embodiments disclosed above can be combined among them and with any other embodiment disclosed in this document in any combination, provided that they are not mutually exclusive, for example, in an embodiment, the processing time of the pressure and/or temperature treatment is between 0.9 minutes and 119 hours; or for example, in another embodiment, between 4 minutes and 44 hours; or for example, in another embodiment, between 21 minutes and 44 hours.

For some applications, the use of a pressure and/or temperature treatment comprising the steps disclosed below may be advantageous. In an embodiment, the pressure and/or temperature treatment comprises at least the following steps:
step 1) raising the temperature of the mold while maintaining low pressure;
step 2) raising the temperature and pressure of the mold; and
step 3) raising the temperature and pressure of the mold;

In certain embodiments, steps 2), and 3) may be optional and thus can be avoided. In an embodiment, step 2) is skipped. In another embodiment, step 3) is skipped.

The pressure and/or temperature applied (as defined in this document), in steps 1) to 3) may have an effect on the properties that can be achieved for some components. Additionally or alternatively, in some embodiments, the pressure and/or temperature applied (as defined in this document) may be important for dimensional accuracy, particularly in the manufacture of certain components with complex geometries and/or internal features.

Step 1) may be particularly important for some components. In different embodiments, step 1) comprises raising the temperature of the mold to 0.1° C. or more, to 26° C. or more, to 41° C. or more, to 76° C. or more, to 91° C. or more and even to 106° C. or more. On the other hand, excessive temperatures may be disadvantageous for some treatments. In different embodiments, step 1) comprises raising the temperature of the mold to 179° C. or less, to 149° C. or less, to 109° C. or less, to 79° C. or less, to 39° C. or less, and even to 24° C. or less. All the values and ranges of the different embodiments disclosed above can be combined among them and with any other embodiment disclosed in this document in any combination, provided that they are not mutually exclusive, for example, in an embodiment, the temperature in step 1) is raised to a temperature between 0.1° C. and 179° C.; or for example, in another embodiment, between 26° C. and 179° C.; of for example in another embodiment, between 41° C. and 149° C. For some applications, it may be advantageous to apply a certain pressure in step 1). In different embodiments, low pressure in step 1) means ambient pressure or more, 0.36 MPa or more, 1.8 MPa or more, 6.1 MPa or more, 21 MPa or more and even 32 MPa or more. On the other hand, excessive pressures in step 1) may lead to undesired distortions in the manufacture of certain components. In different embodiments, low pressure in step 1) means 54 MPa or less, 34 MPa or less, 24 MPa or less, 14 MPa or less, 9 MPa or less, and even 2.4 MPa or less. All the values and ranges of the different embodiments disclosed above can be combined among them and with any other embodiment disclosed in this document in any combination, provided that they are not mutually exclusive, for example, in an embodiment, the low pressure maintained in step 1) is a pressure between 0.36 and 54 MPa; or for example, in another embodiment, between 1.8 and 54 MPa, or for example in another embodiment, between 1.8 and 34 MPa. The right selection of the pressure and temperature applied (as defined in this document) in step 2) may be particularly advantageous. In different embodiments, step 2) comprises raising the temperature of the mold to 46° C. or more, to 61° C. or more, to 96° C. or more, to 111° C. or more, to 116° C. or more and even to 136° C. or more. For some components, the application of excessive temperatures in step 2) seem to be disadvantageous for some treatments. In different embodiments, step 2) comprises raising the temperature of the mold to 234° C. or less, to 194° C. or less, to 149° C. or less, to 119° C. or less, to 94° C. or less, and even to 79° C. or less. All the values and ranges of the different embodiments disclosed above can be combined among them and with any other embodiment disclosed in this document in any combination, provided that they are not mutually exclusive, for example, in an embodiment, the temperature is raised in step 2) to a temperature between 46° C. and 234° C., or for example, in another embodiment, between 46° C. and 194° C., or for example, in another embodiment, between 61° C. and 194° C. As previously disclosed, step 2) further comprises raising the pressure. In different embodiments, step 2) comprises raising the pressure of the mold to 4.6 MPa or more, to 12 MPa or more, to 31 MPa or more, to 41 MPa or more, to 56 MPa or more, to 61 MPa or more, to 66 MPa or more, to 76 MPa or more and even to 86 MPa or more. On the other hand, excessive pressures in step 2) may lead to undesirable distortions in the manufacture of certain components. In different embodiments, step 2) comprises raising the pressure of the mold to 119 MPa or less, to 99 MPa or less, to 84 MPa or less, to 59 MPa or less, to 29 MPa or less, to 14 MPa or less, and even to 9 MPa or less. All the values and ranges of the different embodiments disclosed above can be combined among them and with any other embodiment disclosed in this document in any combination, provided that they are not mutually exclusive, for example, in an embodiment, the pressure is raised in step 2) to a pressure between 4.6 and 119 MPa, or for example, in another embodiment, between 4.6 and 99 MPa, or for example, in another embodiment, between 12 and 99 MPa. The right selection of the pressure and temperature applied (as defined in this document) in step 3) may be particularly advantageous. In different embodiments, step 3) comprises raising the temperature of the mold to 76° C. or more, to 81° C. or more, to 126° C. or more, to 160° C. or more, to 210° C. or more and even to 260° C. or more. On the other hand, excessive temperatures in step 3) seem to be disadvantageous for some treatments. In different embodiments, step 3) comprises raising the temperature of the mold to 279° C. or less, to 269° C. or less, to 226° C. or less, to 190° C. or less, and even to 140° C. or less. All the values and ranges of the different embodiments disclosed above can be combined among them and with any other embodiment disclosed in this document in any combination, provided that they are not mutually exclusive, for example, in an embodiment, the temperature is raised in step 3) to a temperature between 76° C. and 279° C., or for example, in another embodiment, between 81° C. and 279° C., or for example, in another embodiment, between 81° C. and 269° C. As previously disclosed, step 3) further comprises raising the pressure. In different embodiments, step 3) comprises raising the pressure of the mold to 110 MPa or more, to 160 MPa or more, to 210 MPa or more, to 310 MPa or more and even to 440 MPa or more. On the other hand, excessive pressures in step 3) may lead to undesirable distortions in the manufacture of certain components. In different embodiments, step 3) comprises raising the pressure of the mold to 590 MPa or less, to 520 MPa or less, to 440 MPa or less, to 340 MPa or less, to 240 MPa or less, and even to 190 MPa or less. All the values and ranges of the different embodiments disclosed above can be combined among them and with any other embodiment disclosed in this document in any combination, provided that they are not mutually exclusive, for example, in an embodiment, the pressure is raised in step 3) to a pressure between 110 and 590 MPa, or for example, in another embodiment, between 110 and 520 MPa, or for example, in another embodiment, between 160 and 520 MPa

For some applications, it may be advantageous to use of several cycles. In an embodiment, at least two cycles of the pressure and/or temperature treatment are applied. In another embodiment, at least three cycles of the pressure and/or temperature treatment are applied. In some embodiments, it may be advantageous to perform the pressure and/or temperature treatment simultaneously (sequentially) with other method steps.

All the embodiments disclosed above can be combined among them and with any other embodiment disclosed in this document provided that they are not mutually exclusive, for example, in an embodiment, a method of manufacturing polymer comprising components, which method comprises the steps of: providing a material comprising at least a polymer or a polymer-based composite; and shaping the material using a polymer additive manufacturing (PAM) method, wherein the shaping method comprises: providing a mold at least partly manufactured by additive manufacturing (AM); filling the mold with the material provided; and applying a pressure and/or temperature treatment; or for example, in another embodiment, a method of manufacturing polymer comprising components, which method comprises the steps of: providing a material comprising at least a polymer or a polymer-based composite; and shaping the material using a polymer additive manufacturing (PAM) method at the proper temperature, wherein the shaping method comprises: providing a mold at least partly manufactured by additive manufacturing (AM); filling the mold with the material provided; and applying a pressure and/or temperature treatment; or for example, in another embodiment, a method of manufacturing polymer comprising components, which method comprises the steps of: providing a material comprising at least a polymer or a polymer-based composite; providing a mold at least partly manufactured by additive manufacturing (AM); filling the mold with the material provided; and applying a pressure and/or temperature treatment.

As previously disclosed, different PAM methods can be used to form the component, including the manufacture of the component in a layer-by layer fashion. In an embodiment, the polymer additive manufacturing (PAM) method comprises the use of an additive manufacturing (AM) technology. In this regard, the inventor has surprisingly found that for certain applications, components with improved properties can be manufactured with a high design flexibility and at low cost using additive manufacturing (AM) technologies. In an embodiment, the AM technology used further comprises the use of an organic material (e.g., a polymer or polymeric material, binder and/or resin).

Some examples of AM technologies that can be advantageously used to manufacture the polymer comprising components include, but are not limited to, fused deposition (FDM), fused filament fabrication (FFF), stereolithography (SLA), digital light processing (DLP), continuous digital light processing (CDLP), digital light synthesis (DLS), a technology based on continuous liquid interface production (CLIP), material jetting (MJ), drop on demand (DOD), multi jet fusion (MJF), binder jetting (BJ), laser sintering (SLS), and/or combinations thereof. In an embodiment, the AM technology is selected from FDM, FFF, SLA, DLP, CDLP, DLS, a technology based on CLIP, MJ, DOD, MJF, BJ, SLS and/or combinations thereof. In another embodiment, the AM technology is selected from FDM, SLA, MJ, MJF, BJ, SLS and/or combinations thereof. For some applications, the use of more than one AM technology is preferred. In an embodiment, the PAM method comprises the use of at least two different AM technologies.

All the embodiments disclosed above can be combined among them and with any other embodiment disclosed in this document in any combination, provided that they are not mutually exclusive, for example, in an embodiment, a method of manufacturing polymer comprising components, which method comprises the steps of: providing a material comprising at least a a polymer or a polymer-based composite; and shaping the material using a polymer additive manufacturing (PAM) method comprising the use of an additive manufacturing (AM) technology; or for example, in another embodiment, a method of manufacturing polymer comprising components, which method comprises the steps of: providing a material comprising at least a polymer or a polymer-based composite; and shaping the material using a polymer additive manufacturing (PAM) method comprising the use of an additive manufacturing (AM) technology at the proper temperature; or for example, in another embodiment, a method of manufacturing polymer comprising components, which method comprises the steps of: providing a material comprising at least a polymer or a polymer-based composite; and forming the component from the material using an additive manufacturing (AM) technology; or for example, in another embodiment, a method of manufacturing polymer comprising components, which method comprises the steps of: providing a material comprising at least a polymer or a polymer-based composite; and forming the component from the material using an additive manufacturing (AM) technology at the proper temperature.

In some embodiments, the component obtained after the application of the polymer additive manufacturing (PAM) method step disclosed above may be a final component, intended for the end use. However, often the component obtained in other embodiments may not be the final component (also referred to as the “green component” or “preform”), and the application of additional steps to obtain the final component, as disclosed below, may be advantageous.

Optionally, the method may further comprise a step wherein a debinding treatment is applied to eliminate part of the organic material (also referred to as the “debinding step”). In an embodiment, the method further comprises the step of: applying a debinding treatment. In some embodiments, the component formed using a polymer additive manufacturing (PAM) method as described above may comprise an organic material (e.g. the mold used to provide the shape of the component or the polymer or polymeric material, binder and/or resin that may be used in some embodiments together with the material provided to form the component by means of an additive manufacturing (AM) technology, . . . ) that in some cases may be desirable to eliminate. On the other hand, in some particular embodiments, the debinding step may not be necessary, for example, in certain embodiments where a particularly suitable selection of the organic material has been made.

In an embodiment, the debinding step comprises the elimination of part of the organic material. In another embodiment, the debinding step comprises the complete elimination of the organic material. Some examples of debinding treatments that can be applied include, but are not limited to, thermal debinding, non-thermal debinding (catalytic, wicking, drying, supercritical extraction, solvent extraction, organic solvent extraction, water-based solvent extraction, freeze drying . . . ), chemical debinding and/or combinations thereof.

For some applications, it may be advantageous to use of several cycles. In an embodiment, at least two cycles of the debinding treatment are applied. In another embodiment, at least three cycles of the debinding treatment are applied. In some embodiments, it may be advantageous to perform the debinding treatment simultaneously (sequentially) with other method steps. On the other hand, in some particular embodiments, the debinding step may not be necessary and can therefore be skipped, for example, in certain embodiments where a suitable selection of the organic material used (e.g. to manufacture the mold . . . ) has been made.

All the embodiments disclosed above can be combined among them and with any other embodiment disclosed in this document in any combination, provided that they are not mutually exclusive, for example, in an embodiment, a method of manufacturing polymer comprising components, which method comprises the steps of: providing a material comprising at least a polymer or a polymer-based composite; providing a mold at least partly manufactured by additive manufacturing (AM); filling the mold with the material provided; applying a pressure and/or temperature treatment; and applying a debinding treatment; or for example, in another embodiment, a method of manufacturing polymer comprising components, which method comprises the steps of: providing a material comprising at least a polymer or a polymer-based composite; forming the component from the material provided using an additive manufacturing (AM) technology; and applying a debinding treatment; or for example, in another embodiment, a method of manufacturing polymer comprising components, which method comprises the steps of: providing a material comprising at least a polymer or a polymer-based composite; forming the component from the material provided using an additive manufacturing (AM) technology at the proper temperature; and applying a debinding treatment.

Optionally, the method may further comprise a step wherein the component is subjected to a pressure and/or temperature treatment (as described above) before and/or after applying the debinding treatment. In an embodiment, the method further comprises the step of: applying a pressure and/or temperature treatment. This treatment may be important, among others, to the apparent density of some components. In such cases, the pressure and/or temperature can be applied to the component, to the mold or to a cover mold (e.g., pressure transmitting container, polymer film, bag, vacuum bag, coating, conformal coating, etc., placed over the component).

For some applications, it may be advantageous to use of several cycles. In an embodiment, at least two cycles of the pressure and/or temperature treatment are applied. In another embodiment, at least three cycles of the pressure and/or temperature treatment are applied. In some embodiments, it may be advantageous to perform the pressure and/or temperature treatment simultaneously (sequentially) with other method steps.

All the embodiments disclosed above can be combined among them and with any other embodiment disclosed in this document in any combination, provided that they are not mutually exclusive, for example, in an embodiment, a method of manufacturing polymer comprising components, which method comprises the steps of: providing a material comprising at least a polymer or a polymer-based composite; providing a mold at least partly manufactured by additive manufacturing (AM); filling mold with the material; applying a pressure and/or temperature treatment; applying a debinding treatment; and optionally, applying a pressure and/or temperature treatment; or for example, in another embodiment, a method of manufacturing polymer comprising components, which method comprises the steps of: providing a material comprising at least a polymer or a polymer-based composite; forming the component from the material using an additive manufacturing (AM) technology; optionally, applying a pressure and/or temperature treatment; optionally, applying a debinding treatment; and optionally, applying a pressure and/or temperature treatment; or for example, in another embodiment, a method of manufacturing polymer comprising components, which method comprises the steps of: providing a material comprising at least a polymer or a polymer-based composite; forming the component from the material using an additive manufacturing (AM) technology at the proper temperature; optionally, applying a pressure and/or temperature treatment; optionally, applying a debinding treatment; and optionally, applying a pressure and/or temperature treatment.

For some applications, it may be particularly advantageous to apply an undercooling treatment by holding the filled mold at low temperature. In an embodiment, the method further comprises the step of: applying an undercooling treatment. For some applications, this undercooling treatment can be applied during the treatment of the filled mold, and preferably before and/or during the pressure and/or temperature treatment.

In an embodiment, the undercooling treatment is applied before applying the pressure and/or temperature treatment. In another embodiment, the undercooling treatment is applied at any time during the pressure and/or temperature treatment. For some applications, the undercooling treatment may be particularly advantageous, for example, in certain embodiments where the mold comprises a material having a right glass transition temperature (as defined in this document). In an embodiment, the mold comprises a material having a right glass transition temperature (Tg). In different embodiments, the undercooling is made by holding the mold at a low temperature for more than 10 minutes, more than 30 minutes, more than 2 hours and even more than 10 hours. In different embodiments, a low temperature for the undercooling is 19° C. or less, 9° C. or less, −1° C. or less, −11° C. or less, and even −20° C. or less. For some applications, it may be more convenient to adjust the low temperature to the softening point of the material of the mold having a low softening point. In different embodiments, a low temperature for the undercooling is Tg+60° C. or less, Tg+50° C. or less, Tg+40° C. or less, Tg+20° C. or less, and even Tg+10° C. or less, Tg being the glass transition temperature of the material of the mold having a low softening point. For some applications, an excessive undercooling is also negative leading to different shortcomings in different applications (e.g., fine mold details breakage during the pressure and/or temperature treatment). In different embodiments, the undercooling should be limited to a maximum temperature of −273° C., −140° C., −90° C., −50° C., Tg −50° C., Tg −20° C., Tg −10° C., Tg and even Tg+20° C., wherein Tg is the glass transition temperature of the material of the mold with low softening point. All the values and ranges of the different embodiments disclosed above can be combined among them and with any other embodiment disclosed in this document in any combination, provided that they are not mutually exclusive, for example, in an embodiment, the undercooling is made by holding the mold more than 10 minutes at a temperature between −273° C. and 19° C.; or for example, in another embodiment, between −140° C. and 9° C.; or for example, in another embodiment, between −90° C. and −1° C. For some applications, the maximum relevant temperature applied in the pressure and/or temperature treatment should be somewhat lower when undercooling is used. In different embodiments, when undercooling is used, then the maximum relevant temperature in the pressure and/or temperature treatment should be reduced in 18° C., in 10° C. and even in 8° C. The feature “relevant temperature” is defined throughout this document in the form of different alternatives that are explained in detail below. In an embodiment, a relevant temperature refers to a temperature that is maintained for more than 1 second. In an alternative embodiment, a relevant temperature refers to a temperature that is maintained for more than 20 seconds. In another alternative embodiment, a relevant temperature refers to a temperature that is maintained for more than 2 minutes. In another alternative embodiment, a relevant temperature refers to a temperature that is maintained for more than 11 minutes. In another alternative embodiment, a relevant temperature refers to a temperature that is maintained for more than 1 hour and 10 minutes. In another alternative embodiment, the maximum relevant temperature is the maximum temperature applied. All the embodiments disclosed above can be combined among them and with any other embodiment disclosed in this document that relates to “a relevant temperature” in any combination, provided that they are not mutually exclusive.

Optionally, the method may further comprise a step wherein the component is subjected to a consolidation treatment (also referred to as the “PAM consolidation step”). In an embodiment, the method further comprises the step of: applying a consolidation treatment. The consolidation treatment may, among others, help to increase the density, further having, among others, a strong contribution on the dimensional accuracy and the properties which can be achieved in some components. In an embodiment, the consolidation treatment comprises applying a sintering. For some applications, the atmosphere used in the consolidation treatment may be important. In an embodiment, the consolidation treatment comprises the use of a properly designed atmosphere (as defined in this document). For some applications, it may also be advantageous to change the atmosphere in the furnace or pressure vessel during the treatment. In an embodiment, the consolidation treatment comprises the use of at least two different atmospheres. Often, some of the treatments may be performed sequentially (e.g., the debinding treatment and the consolidation treatment, . . . ), for example, in certain embodiments where the equipment (e.g., furnace or pressure vessel) used to perform the treatment allows to change the atmosphere. In some embodiments, it may be advantageous to perform the consolidation treatment simultaneously (sequentially) with other method steps.

In some embodiments, the PAM consolidation treatment may comprise the application of temperature. The inventor has found that a right selection of the temperature applied (as defined in this document) in the consolidation treatment may, among others, help to avoid defects in some components. In different embodiments, the temperature applied (as defined in this document) in the consolidation treatment is 76° C. or more, 96° C. or more, 116° C. or more, 156c or more, 226° C. or more, 260° C. or more and even 360° C. or more. On the other hand, excessive temperatures may be disadvantageous for some treatments. In different embodiments, the temperature applied (as defined in this document) in the consolidation treatment is 690° C. or less, 540° C. or less, 440° C. or less, 340° C. or less, and even 240° C. or less. All the values and ranges of the different embodiments disclosed above can be combined among them and with any other embodiment disclosed in this document in any combination, provided that they are not mutually exclusive, for example, in an embodiment, the PAM consolidation treatment comprises the application of a temperature between 76° C. and 690° C., or for example, in another embodiment, between 76° C. and 540° C., or for example, in another embodiment, between 96° C. and 540° C.

Additionally or alternatively, in some embodiments, the PAM consolidation treatment may comprise the application of pressure. For some applications, it may be advantageous to perform the consolidation treatment under a certain pressure. In an embodiment, the consolidation treatment further comprises the application of pressure. In this respect, the inventor has found that the pressure applied (as defined in this document) may help to achieve high apparent densities and even full density (the maximum theoretical density). In different embodiments, the pressure applied (as defined in this document) in the consolidation treatment is at least 1 mbar, at least 0.9 bar, at least 1.6 bar, at least 21 bar, at least 51 bar, and even at least 112 bar. On the other hand, excessive pressures may lead to undesirable distortions in the manufacture of certain components. In different embodiments, the pressure applied (as defined in this document) in the consolidation treatment is less than 189 bar, less than 124 bar, less than 104 bar, less than 84 bar, less than 34 bar, less than 1.9 bar and even less than 790 mbar. Even in certain embodiments, a consolidation treatment under vacuum may be advantageous. All the values and ranges of the different embodiments disclosed above can be combined among them and with any other embodiment disclosed in this document in any combination, provided that they are not mutually exclusive, for example, in an embodiment, the PAM consolidation treatment comprises the application of a pressure between 1 mbar and 189 bar, or for example, in another embodiment, between 0.9 and 189 bar, or for example, in another embodiment, between 1.6 and 189 bar.

For some applications, it may be advantageous to use of several cycles. In an embodiment, at least two cycles of the consolidation treatment are applied. In another embodiment, at least three cycles of the consolidation treatment are applied. On the other hand, in some embodiments, the consolidation treatment may be optional, and can therefore be skipped.

All the embodiments disclosed above can be combined among them and with any other embodiment disclosed in this document in any combination, provided that they are not mutually exclusive, for example, in an embodiment, a method of manufacturing polymer comprising components, which method comprises the steps of: providing a material comprising at least a polymer or a polymer-based composite; providing a mold at least partly manufactured by additive manufacturing (AM); filling the mold with the material provided; applying a pressure and/or temperature treatment; applying a debinding treatment; and applying a consolidation treatment; or for example, in another embodiment, a method of manufacturing polymer comprising components, which method comprises the steps of: providing a material comprising at least a polymer or a polymer-based composite; forming the component from the material using an additive manufacturing (AM) technology; optionally, applying a debinding treatment; and applying a consolidation treatment; or for example, in another embodiment, a method of manufacturing polymer comprising components, which method comprises the steps of: providing a material comprising at least a polymer or a polymer-based composite; forming the component from the material using an additive manufacturing (AM) technology at the proper temperature; optionally, applying a debinding treatment; and applying a consolidation treatment.

Optionally, the method may further comprise a step wherein at least two parts are joined to manufacture a bigger component (also referred to as the “joining step”). In an embodiment, the method further comprises the step of: joining different parts.

Optionally, in certain particular embodiments, the method may further comprise a step wherein the component is subjected to a densification treatment (also referred to as the “PAM densification step”). In an embodiment, the method further comprises the step of: applying a densification treatment.

For certain particular applications, the densification treatment may be important to the properties of some components. In an embodiment, the densification treatment comprises the application of a hot isostatic pressing (HIP). For some applications, the atmosphere used in the densification treatment may be important. In an embodiment, the densification treatment comprises using of a properly designed atmosphere (as defined in this document). For some applications, it may also be advantageous to change the atmosphere in the furnace or pressure vessel during the treatment. In an embodiment, the densification treatment comprises the use of at least two different atmospheres. In some embodiments, it may be advantageous to perform the densification treatment simultaneously (sequentially) with other method steps.

In some embodiments, the PAM densification treatment may comprise the application of pressure. For some applications, it may be important to properly select the pressure applied (as defined in this document) in the densification treatment. In different embodiments, the pressure applied (as defined in this document) in the densification treatment is 171 bar or more, 371 bar or more, 621 bar or more, 1260 bar or more and even 1660 bar or more. On the other hand, excessive pressures may lead to undesirable distortions in the manufacture of certain components. In different embodiments, the pressure applied (as defined in this document) in the densification treatment is less than 5390 bar, less than 3490 bar, less than 2490 bar, less than 1990 bar, less than 1390 bar, less than 940 bar and even less than 490 bar. All the values and ranges of the different embodiments disclosed above can be combined among them and with any other embodiment disclosed in this document in any combination, provided that they are not mutually exclusive, for example, in an embodiment, the PAM densification treatment comprises the application of a pressure between 171 and 5390 bar, or for example, in another embodiment, between 171 and 3490 bar, or for example, in another embodiment, between 371 and 1990 bar.

Additionally or alternatively, in some embodiments, the PAM densification treatment may comprise the application of temperature. For some applications, it may be important to properly select the temperature applied (as defined in this document) in the densification treatment. In different embodiments, the temperature applied (as defined in this document) in the densification treatment is 46° C. or more, 71° C. or more, 101° C. or more, 151° C. or more, 201° C. or more, 251° C. or more and even 310° C. or more. On the other hand, excessive temperatures may be disadvantageous for some treatments. In different embodiments, the temperature applied (as defined in this document) in the densification treatment is 490° C. or less, 340° C. or less, 240° C. or less, 140° C. or less, and even 90° C. or less. All the values and ranges of the different embodiments disclosed above can be combined among them and with any other embodiment disclosed in this document in any combination, provided that they are not mutually exclusive, for example, in an embodiment, the PAM densification treatment comprises the application of a temperature between 46° C. and 490° C., or for example, in another embodiment, between 46° C. and 340° C., or for example, in another embodiment, between 71° C. and 340° C.

For some applications, it may be advantageous to use of several cycles. In an embodiment, at least two cycles of the densification treatment are applied. In another embodiment, at least three cycles of the densification treatment are applied. On the other hand, in some embodiments, the densification treatment may be optional, and can therefore be skipped.

All the embodiments disclosed above can be combined among them and with any other embodiment disclosed in this document in any combination, provided that they are not mutually exclusive, for example, in an embodiment, a method of manufacturing polymer comprising components, which method comprises the steps of: providing a material comprising at least a polymer or a polymer-based composite; providing a mold at least partly manufactured by additive manufacturing (AM); filling the mold with the material provided; applying a pressure and/or temperature treatment; applying a debinding treatment; optionally, applying a consolidation treatment; and applying a densification treatment; or for example, in another embodiment, a method of manufacturing polymer comprising components, which method comprises the steps of: providing a material comprising at least a polymer or a polymer-based composite; forming the component from the material using an additive manufacturing (AM) technology; optionally, applying a debinding treatment; optionally, applying a consolidation treatment; and applying a densification treatment; or for example, in another embodiment, a method of manufacturing polymer comprising components, which method comprises the steps of: providing a material comprising at least a polymer or a polymer-based composite; forming the component from the material using an additive manufacturing (AM) technology at the proper temperature; optionally, applying a debinding treatment; optionally, applying a consolidation treatment; and applying a densification treatment.

Optionally, the method may further comprise a step wherein the component, or at least part of the component, is infiltrated (also referred to as the “infiltration step”). In an embodiment, the method further comprises the step of: infiltrating at least part of the component with an infiltrate material.

Some examples of infiltrate materials that can be used include, but are not limited to, metallic materials such as for example, metals or metal-based alloys, organic materials such as for example, polymers, polymeric materials or resins and/or mixtures thereof. In an embodiment, the infiltrate material comprises a metallic material. In another embodiment, the infiltrate material comprises a resin.

For certain applications, it may be advantageous to limit the infiltration area to certain geometric features of the component in order to preserve certain desired geometric features including, but not limited to, external features, internal features, holes, voids, channels (e.g., cooling and/or heating channels), sharp angles and/or combinations thereof. In an embodiment, only part of the component is infiltrated. In an embodiment, the component comprises at least one infiltration barrier to prevent infiltration in some geometric features of the component. In some embodiments, this infiltration barrier can be manufactured with the component or formed at a later stage, for example, by dipping, spraying or deposition, among others. However, the formation of the infiltration barrier is not limited to the technologies described above.

Optionally, the method may further comprise a step wherein the component is subjected to a densification treatment (as described above) after the infiltration step. In an embodiment, the method further comprises the step of: applying a densification treatment to the infiltrated material.

All the embodiments disclosed above can be combined among them and with any other embodiment disclosed in this document in any combination, provided that they are not mutually exclusive, for example, in an embodiment, a method of manufacturing polymer comprising components, which method comprises the steps of: providing a material comprising at least a polymer or a polymer-based composite; providing a mold at least partly manufactured by additive manufacturing (AM); filling the mold with the material; applying a pressure and/or temperature treatment; optionally, applying a debinding treatment; optionally, applying a pressure and/or temperature treatment; optionally, applying a consolidation treatment; optionally, infiltrating at least part of the component with an infiltrate material; and optionally, applying a densification treatment; or for example, in another embodiment, a method of manufacturing polymer comprising components, which method comprises the steps of: providing a material comprising at least a polymer or a polymer-based composite; shaping the material using an additive manufacturing (AM) technology; applying a debinding treatment; applying a pressure and/or temperature treatment; optionally, applying a consolidation treatment; optionally, infiltrating at least part of the component with an infiltrate material; and optionally, applying a densification treatment.

Optionally, the method may further comprise other additional steps including, but not limited to, post-processing treatments such as for example, a machining step and/or a surface conditioning. In an embodiment, the method further comprises the step of: applying a machining. In some embodiments, it may also be advantageous to apply a machining step before and/or after performing any of the above disclosed method steps (e.g., the pressure and/or temperature treatment, the consolidation treatment, the densification treatment, . . . ). For some applications, it may be particularly advantageous to perform a surface conditioning. In an embodiment, the method further comprises the step of: applying a surface conditioning.

Another aspect refers to the polymer comprising components manufactured using the method disclosed above in the present aspect of the disclosure.

Throughout this document, unless otherwise stated, measurements are made at room temperature (23° C.), and standard pressure (1 atm).

The HDT test conditions to determine deflection temperature measured according to ASTM D648-07 standard test method with a load of 0.455 MPa [66 psi] or 1.82 MPa [264 psi] are disclosed below.

Heat deflection temperature is measured in an automated apparatus, with silicon oil as liquid heat-transfer medium up to 250° C., for higher temperatures graphite powder is employed as heat-transfer medium (and a thermocouple calibrated according to ASTM E2846-14 instead a thermometer for temperature measurement) 3 specimens are used of 3 mm width according to ASTM D648-07 Method A, with loads of 0.455 MPa [0.66 psi] or 1.82 MPa [264 psi], the load used is indicated for each measure. Prior to the analysis test specimens and bath are equilibrated at 30° C., heating rate is 2° C./min. Test specimens are obtained according to molding methods A to C disclosed below. When a specimen can be obtained by more than one molding method (A to C), the specimen obtained by each method is tested and the highest value obtained is the value selected of heat deflection temperature.

Preparation of test specimens: the mold used to obtain the test specimen for heat deflection temperature is 127 mm in length, 13 mm when HDT is measured according to ISO 75-1:2013 Method B test with a load of 0.455 MPa or 1.82 MPa (the load used is indicated for each measure).

Glass transition temperature (Tg) is measured by differential scanning calorimetry (DSC) according to ASTM D3418-12. Weight of the sample 10 mg. In a ceramic container. Purge gas used argon (99.9%) at flow rate 25 ml/min. Heating/cooling rates 10° C./min. For liquid polymers or resins, after pulverization the sample is polymerized according to molding methods A to C disclosed below to obtain a test specimen, and then the sample is pulverized. When a specimen can be obtained by more than one molding method (A to C), the specimen obtained by each method is tested and the highest value obtained is the value selected of Tg.

### Molding Methods:

Molding method A. Photopolymerization is carried using a photo-initiator. Photo-initiator (type, percentage) is selected in accordance with the recommendations of the supplier. If not provided, the photo-initiator used is Benzoyl peroxide, 2 wt %. A mold with the required dimensions in function the specimen required is filled with a homogeneous mixture between the resin and the photo-initiator. The mixture is polymerized according to the cured conditions provided by the supplier (wavelength, and time of exposure), if not provided the material is cured under UV lamp (365 nm, 6 W) for 2 h. After this time the specimen is removed from the mold and the bottom part is also cured in the same conditions as upper part. The cure is carried out in a closed light insulating box, where only the radiation of the lamp incident in the specimen, which is 10 cm away from the light source.

Molding method B. Thermoforming is carried in a conventional thermoforming machine, the required amount of material to obtain 3 mm in thickness is clamped in the frame of the mold. Once the material sheet is secured in the heating area, it is heated to forming temperature, which is selected in accordance with the supplier recommendations, if not provided, temperature selected is 20° C. below the glass transition temperature (Tg). Once specimen is in the mold, is cooled to 25° C. The excess material to obtain the required specimen is removed.

Molding method C. Injection molding is carried in a conventional injection molding machine. Plastics pellets are selected as raw material when available, if not the different chemical components are injected into the barrel. The material is heated up the temperature and during the time recommended by the supplier, if not provided, the material is heated to a temperature 10° C. above their melting temperature and maintained for 5 minutes (when the degradation point of the material is more than 50° C. higher than the melting temperature) or 20° C. above the glass transition temperature (Tg) of the material (if the degradation point is less than 50° C. higher than the melting temperature).

Throughout this document, unless otherwise stated, the use of terms such as “below”, “above”, “or more”, “from”, “to”, “up to”, “at least”, “greater than”, “less than”, “more than” and the like, refers to ranges that can be subsequently broken down into sub-ranges and combined with other upper and/or lower limits disclosed in any combination, provided that they are not mutually exclusive.

All the embodiments disclosed above can be combined among them and with any other embodiment disclosed in this document in any combination, provided that they are not mutually exclusive, for example, but not limited to, [1]. A method of manufacturing metal comprising components, which method comprises the steps of: providing a powder or powder mixture; applying a treatment to the powder or powder mixture; and shaping the treated powder or powder mixture using a metal additive manufacturing (MAM) method. [2]. A method of manufacturing metal comprising components, which method comprises the steps of: providing a powder or powder mixture; applying a treatment to the powder or powder mixture, wherein the treatment of the powder or powder mixture comprises applying energy into the powder or powder mixture through mechanical action; and; shaping the treated powder or powder mixture using a metal additive manufacturing (MAM) method. [3]. A method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; and; shaping the treated powder or powder mixture using a metal additive manufacturing (MAM) method at a right temperature, wherein a right temperature is a temperature between 0.08*Tm and 0.74*Tm, being Tm the melting temperature in Kelvin of the powder or powder mixture.[4]. A method of manufacturing metal comprising components, which method comprises the steps of: providing a powder or powder mixture; applying a treatment to the powder or powder mixture, wherein the treatment of the powder or powder mixture comprises applying energy into the powder or powder mixture through mechanical action; providing a mold at least partly manufactured by additive manufacturing (AM); filing the mold with the treated powder or powder mixture; and applying a pressure and/or temperature treatment. [5]. A method of manufacturing metal comprising components, which method comprises the steps of: providing a powder or powder mixture; applying a treatment to the powder or powder mixture, wherein the treatment of the powder or powder mixture comprises applying energy into the powder or powder mixture through mechanical action; providing a mold at least partly manufactured by additive manufacturing (AM), wherein the mold is made of a material comprising a polymeric material; filing the mold with the treated powder or powder mixture; and applying a pressure and/or temperature treatment. [6]. A method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; providing a mold at least partly manufactured by additive manufacturing (AM), wherein the mold is made of a material comprising a polymeric material; filing the mold with the treated powder or powder mixture; and applying a pressure and/or temperature treatment. [7]. A method of manufacturing metal comprising components, which method comprises the steps of: providing a powder or powder mixture; applying a treatment to the powder or powder mixture, wherein the treatment of the powder or powder mixture comprises applying energy into the powder or powder mixture through mechanical action; and shaping the treated powder or powder mixture using an additive manufacturing (AM) technology. [8]. A method of manufacturing metal comprising components, which method comprises the steps of: providing a powder or powder mixture; applying a treatment to the powder or powder mixture, wherein the treatment of the powder or powder mixture comprises applying energy into the powder or powder mixture through mechanical action; and shaping the treated powder or powder mixture using an additive manufacturing (AM) technology, wherein the additive manufacturing (AM) technology further comprises the use of an organic material. [9]. A method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; and shaping the treated powder or powder mixture using an additive manufacturing (AM) technology, wherein the additive manufacturing (AM) technology further comprises the use of an organic material. [10]. A method of manufacturing metal comprising components, which method comprises the steps of: providing a powder or powder mixture comprising at least a metal or a metal-based alloy; having a proper % O content, wherein a proper % O content is an oxygen content between 410 and 49000 ppm; applying a treatment to the powder or powder mixture, wherein the treatment of the powder or powder mixture comprises applying energy into the powder or powder mixture through mechanical action; wherein the oxygen content of the powder or powder mixture during and/or after applying such treatment is an appropriate % O content, wherein an appropriate % O content is an oxygen content between 910 and 49000 ppm; shaping the treated powder or powder mixture using an additive manufacturing (AM) technology at a right temperature, wherein a right temperature is a temperature between 0.08*Tm and 0.74*Tm, being Tm the melting temperature in Kelvin of the powder or powder mixture provided, wherein the additive manufacturing (AM) technology employed further comprises the use of an organic material; applying a pressure and/or temperature treatment, said treatment comprising the application of a pressure between 6 and 2100 MPa; applying a debinding treatment to eliminate at least part of the organic material; and applying a fixing step for setting the for setting the % C, % O, % N, % H and/or % B levels in the metallic part of the component; wherein the pressure and/or temperature treatment is applied before and/or during the application of the debinding treatment, wherein the oxygen content in the metallic part of the component after the fixing step is a right % O content, wherein a right % O content is an oxygen content between 0.6 and 190 ppm, and wherein at least one material of the manufactured component has a proper % O content, wherein a proper % O content is an oxygen content between 16 and 190 ppm. [11]. A method of manufacturing metal comprising components, which method comprises the steps of: providing a powder or powder mixture comprising at least a metal or a metal-based alloy having a proper % O content, wherein a proper % O content is an oxygen content between 410 and 49000 ppm; applying a treatment to the powder or powder mixture, wherein the treatment of the powder or powder mixture comprises applying energy into the powder or powder mixture through mechanical action, wherein the oxygen content of the powder or powder mixture during and/or after applying such treatment is an appropriate % O content, wherein an appropriate % O content is an oxygen content between 910 and 49000 ppm; providing a mold at least partly manufactured using an additive manufacturing (AM) technology, wherein the mold is made of a material comprising a polymeric material; filling the mold with the treated powder or powder mixture; applying a pressure and/or temperature treatment to the filled mold; and applying a fixing step for setting the for setting the % C, % O, % N, % H and/or % B levels in the metallic part of the component, wherein the oxygen content in the metallic part of the component after the fixing step is a right % O content, wherein a right % O content is an oxygen content between 0.6 and 190 ppm, and wherein at least one material of the manufactured component has a proper % O content, wherein a proper % O content is an oxygen content between 16 and 190 ppm. [12]. A method of manufacturing metal comprising components, which method comprises the steps of: providing a powder or powder mixture comprising at least a metal or a metal-based alloy; having a proper % N content, wherein a proper % N content is a nitrogen content between 56 ppm and 940 ppm; applying a treatment to the powder or powder mixture, wherein the treatment of the powder or powder mixture comprises applying energy into the powder or powder mixture through mechanical action; wherein the nitrogen content of the powder or powder mixture during and/or after applying such treatment is an appropriate % N content, wherein an appropriate % N content is a nitrogen content between 16 and 19400 ppm; shaping the treated powder or powder mixture using an additive manufacturing (AM) technology at a right temperature, wherein a right temperature is a temperature between 0.08*Tm and 0.74*Tm, being Tm the melting temperature in Kelvin of the powder or powder mixture provided, wherein the additive manufacturing (AM) technology employed further comprises the use of an organic material; applying a pressure and/or temperature treatment, said treatment comprising the application of a pressure between 6 and 2100 MPa; applying a debinding treatment to eliminate at least part of the organic material; and applying a fixing step for setting the for setting the % C, % O, % N, % H and/or % B levels in the metallic part of the component; wherein the pressure and/or temperature treatment is applied before and/or during the application of the debinding treatment, wherein the nitrogen content in the metallic part of the component after the fixing step is a right % N content, wherein a right % N content is a nitrogen content between 0.01 and 90 ppm, and wherein at least one material of the manufactured component has a proper % N content, wherein a proper % N content is a nitrogen content between 0.6 and 90 ppm [13]. A method of manufacturing metal comprising components, which method comprises the steps of: providing a powder or powder mixture comprising at least a metal or a metal-based alloy having a proper % N content, wherein a proper % N content is a nitrogen content between 56 ppm and 940 ppm; applying a treatment to the powder or powder mixture, wherein the treatment of the powder or powder mixture comprises applying energy into the powder or powder mixture through mechanical action, wherein the nitrogen content of the powder or powder mixture during and/or after applying such treatment is an appropriate % N content, wherein an appropriate % N content is a nitrogen content between 16 and 19400 ppm; providing a mold at least partly manufactured using an additive manufacturing (AM) technology, wherein the mold is made of a material comprising a polymeric material; filling the mold with the treated powder or powder mixture; applying a pressure and/or temperature treatment to the filled mold; and applying a fixing step for setting the for setting the % C, % O, % N, % H and/or % B levels in the metallic part of the component, wherein the nitrogen content in the metallic part of the component after the fixing step is a right % N content, wherein a right % N content is a nitrogen content between 0.01 and 90 ppm, and wherein at least one material of the manufactured component has a proper % N content, wherein a proper % N content is a nitrogen content between 0.6 and 90 ppm. [14]. A method of manufacturing metal comprising components, which method comprises the steps of: providing a powder or powder mixture; applying a treatment to the powder or powder mixture, wherein the treatment of the powder or powder mixture comprises applying energy into the powder or powder mixture through mechanical action; shaping the treated powder or powder mixture using an additive manufacturing (AM) technology at a right temperature, wherein a right temperature is a temperature between 0.08*Tm and 0.74*Tm, being Tm the melting temperature in Kelvin of the powder or powder mixture provided, wherein the additive manufacturing (AM) technology employed further comprises the use of an organic material; applying a pressure and/or temperature treatment, said treatment comprising the application of a pressure between 6 and 2100 MPa; and applying a debinding treatment to eliminate at least part of the organic material; wherein the pressure and/or temperature treatment is applied before and/or during the application of the debinding treatment. [15]. A method of manufacturing metal comprising components, which method comprises the steps of: providing a powder or powder mixture; applying a treatment to the powder or powder mixture, wherein the treatment of the powder or powder mixture comprises applying energy into the powder or powder mixture through mechanical action; providing a mold at least partly manufactured using an additive manufacturing (AM) technology, wherein the mold is made of a material comprising a polymeric material; filling the mold with the treated powder or powder mixture; and applying a pressure and/or temperature treatment to the filled mold. [16]. A method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; shaping the treated powder or powder mixture using an additive manufacturing (AM) technology at a right temperature, wherein a right temperature is a temperature between 0.08*Tm and 0.74*Tm, being Tm the melting temperature in Kelvin of the powder or powder mixture provided, wherein the additive manufacturing (AM) technology employed further comprises the use of an organic material. [17]. applying a pressure and/or temperature treatment, said treatment comprising the application of a pressure between 6 and 2100 MPa; applying a debinding treatment to eliminate at least part of the organic material; and applying a fixing step for setting the % C, % O, % N, % H and/or % B levels in the metallic part of the component; wherein the pressure and/or temperature treatment is applied before and/or during the application of the debinding treatment. [18]. A method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; providing a mold at least partly manufactured using an additive manufacturing (AM) technology, wherein the mold is made of a material comprising a polymeric material; filling the mold with the treated powder or powder mixture; applying a pressure and/or temperature treatment to the filled mold; and applying a fixing step for setting the % C, % O, % N, % H and/or % B levels in the metallic part of the component. [19]. A method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; shaping the treated powder or powder mixture using an additive manufacturing (AM) technology at a right temperature, wherein a right temperature is a temperature between 0.08*Tm and 0.74*Tm, being Tm the melting temperature in Kelvin of the powder or powder mixture provided, wherein the additive manufacturing (AM) technology employed further comprises the use of an organic material; applying a pressure and/or temperature treatment, said treatment comprising the application of a pressure between 6 and 2100 MPa; applying a debinding treatment to eliminate at least part of the organic material; applying a fixing step for setting the % C, % O, % N, % H and/or % B levels in the metallic part of the component; and applying a consolidation treatment, wherein the consolidation treatment comprises the application of a pressure between 1 mbar and 4900 bar and a temperature between 0.36*Tm and 0.88*Tm, being Tm the melting temperature in Kelvin of the powder or powder mixture provided; wherein the pressure and/or temperature treatment is applied before and/or during the application of the debinding treatment. [20]. A method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; providing a mold at least partly manufactured using an additive manufacturing (AM) technology, wherein the mold is made of a material comprising a polymeric material; filling the mold with the treated powder or powder mixture; applying a pressure and/or temperature treatment to the filled mold; applying a fixing step for setting the % C, % O, % N, % H and/or % B levels in the metallic part of the component; and applying a consolidation treatment, wherein the consolidation treatment comprises the application of a pressure between 1 mbar and 4900 bar and a temperature between 0.36*Tm and 0.88*Tm, being Tm the melting temperature in Kelvin of the powder or powder mixture provided. [21]. A method of manufacturing metal comprising components, which method comprises the steps of: providing a powder or powder mixture; applying a treatment to the powder or powder mixture, wherein the treatment of the powder or powder mixture comprises applying energy into the powder or powder mixture through mechanical action; shaping the treated powder or powder mixture using an additive manufacturing (AM) technology at a right temperature, wherein a right temperature is a temperature between 0.08*Tm and 0.74*Tm, being Tm the melting temperature in Kelvin of the powder or powder mixture provided, wherein the additive manufacturing (AM) technology employed further comprises the use of an organic material; applying a pressure and/or temperature treatment, wherein the pressure and/or temperature treatment comprises the following steps: step i) subjecting the component to high pressure, wherein the maximum pressure applied is between 12 MPa and 790 MPa; step ii) while keeping a high pressure level, raising the temperature of the component; step iii) while keeping a high enough temperature between 320K and 790K, releasing at least some of the to the component applied pressure; and applying a debinding treatment to eliminate at least part of the organic material; wherein the pressure and/or temperature treatment is applied before and/or during the application of the debinding treatment. [22]. A method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; providing a mold at least partly manufactured using an additive manufacturing (AM) technology, wherein the mold is made of a material comprising a polymeric material; filling the mold with the treated powder or powder mixture; and applying a pressure and/or temperature treatment to the filled mold, wherein the pressure and/or temperature treatment comprises the following steps: step i) subjecting the mold to high pressure, wherein the maximum pressure applied is between 12 MPa and 790 MPa; step ii) while keeping a high pressure level, raising the temperature of the mold; and step iii) while keeping a high enough temperature between 320K and 690K, releasing at least some of the to the mold applied pressure. [23]. A method of manufacturing metal comprising components, which method comprises the steps of: providing a powder or powder mixture; applying a treatment to the powder or powder mixture, wherein the treatment of the powder or powder mixture comprises applying energy into the powder or powder mixture through mechanical action; and shaping the treated powder or powder mixture using a metal additive manufacturing (MAM) method; wherein the step of applying a treatment to the powder or powder mixture comprises a value of the parameter KA2 between 0.3 and 4900, being KA2=Coeff*1/(V_{powder}*ρ_{powder}+V_{processing material}−ρ_{processing material})·EEC, wherein EEC is the electrical energy consumed while processing the powder expressed in MJ; V_{powder} is the volume of powder in the container, expressed in dm³; ρ_{powder} is the mean density of the powder in the container, expressed in kg/dm³; V_{processing material} is the volume of the processing material in the container, expressed in dm³; ρ_{processing material} is the mean density of the processing material in the container, expressed in kg/dm³; and Coeff is 0.89. [24]. A method of manufacturing metal comprising components, which method comprises the steps of: providing a powder or powder mixture; applying a treatment to the powder or powder mixture, wherein the treatment of the powder or powder mixture comprises applying energy into the powder or powder mixture through mechanical action; shaping the treated powder or powder mixture using an additive manufacturing (AM) technology at a right temperature, wherein a right temperature is a temperature between 0.08*Tm and 0.74*Tm, being Tm the melting temperature in Kelvin of the powder or powder mixture provided, wherein the additive manufacturing (AM) technology employed further comprises the use of an organic material; applying a pressure and/or temperature treatment, said treatment comprising the application of a pressure between 6 and 2100 MPa; and applying a debinding treatment to eliminate at least part of the organic material; wherein the pressure and/or temperature treatment is applied before and/or during the application of the debinding treatment and wherein the step of applying a treatment to the powder or powder mixture comprises a value of the parameter KA2 between 0.3 and 4900, being KA2=Coeff*1/(V_{powder}*ρ_{powder}+V_{processing material}*ρ_{processing material})*EEC, wherein EEC is the electrical energy consumed while processing the powder expressed in MJ; V_{powder} is the volume of powder in the container, expressed in dm³; ρ_{powder} is the mean density of the powder in the container, expressed in kg/dm³; V_{processing material} is the volume of the processing material in the container, expressed in dm³; ρ_{processing material} is the mean density of the processing material in the container, expressed in kg/dm³, and Coeff is 0.89. [25]. A method of manufacturing metal comprising components, which method comprises the steps of: providing a powder or powder mixture; applying a treatment to the powder or powder mixture, wherein the treatment of the powder or powder mixture comprises applying energy into the powder or powder mixture through mechanical action; providing a mold at least partly manufactured using an additive manufacturing (AM) technology, wherein the mold is made of a material comprising a polymeric material; filling the mold with the treated powder or powder mixture; and applying a pressure and/or temperature treatment to the filled mold; wherein the step of applying a treatment to the powder or powder mixture comprises a value of the parameter KA2 between 0.3 and 4900, being KA2=Coeff*1/(V_{powder}*ρ_{powder}+V_{processing material}*ρ_{processing material})*EEC, wherein EEC is the electrical energy consumed while processing the powder expressed in MJ; V_{powder} is the volume of powder in the container, expressed in dm³; ρ_{powder} is the mean density of the powder in the container, expressed in kg/dm³; V_{processing material} is the volume of the processing material in the container, expressed in dm³; ρ_{processing material} is the mean density of the processing material in the container, expressed in kg/dm³; and Coeff is 0.89. [26]. A method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; shaping the treated powder or powder mixture using an additive manufacturing (AM) technology at a right temperature, wherein a right temperature is a temperature between 0.08*Tm and 0.74*Tm, being Tm the melting temperature in Kelvin of the powder or powder mixture provided, wherein the additive manufacturing (AM) technology employed further comprises the use of an organic material. [27]. applying a pressure and/or temperature treatment, said treatment comprising the application of a pressure between 6 and 2100 MPa; applying a debinding treatment to eliminate at least part of the organic material; and applying a fixing step for setting the % C, % O, % N, % H and/or % B levels in the metallic part of the component; wherein the pressure and/or temperature treatment is applied before and/or during the application of the debinding treatment and wherein the step of applying a treatment to the powder or powder mixture comprises a value of the parameter KA2 between 0.3 and 4900, being KA2=Coeff*1/(V_{powder}*ρ_{powder}+V_{processing material}*ρ_{processing material})*EEC, wherein EEC is the electrical energy consumed while processing the powder expressed in MJ; V_{powder} is the volume of powder in the container, expressed in dm³; ρ_{powder} is the mean density of the powder in the container, expressed in kg/dm³; V_{processing material} is the volume of the processing material in the container, expressed in dm³; ρ_{processing material} is the mean density of the processing material in the container, expressed in kg/dm³; and Coeff is 0.89. [28]. A method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; providing a mold at least partly manufactured using an additive manufacturing (AM) technology, wherein the mold is made of a material comprising a polymeric material; filling the mold with the treated powder or powder mixture; applying a pressure and/or temperature treatment to the filled mold; and applying a fixing step for setting the % C, % O, % N, % H and/or % B levels in the metallic part of the component; wherein the step of applying a treatment to the powder or powder mixture comprises a value of the parameter KA2 between 0.3 and 4900, being KA2=Coeff*1/(V_{powder}*ρ_{powder}+V_{processing material}*ρ_{processing material})*EEC, wherein EEC is the electrical energy consumed while processing the powder expressed in MJ; V_{powder} is the volume of powder in the container, expressed in dm³; ρ_{powder} is the mean density of the powder in the container, expressed in kg/dm³; V_{processing material} is the volume of the processing material in the container, expressed in dm³; ρ_{processing material} is the mean density of the processing material in the container, expressed in kg/dm³; and Coeff is 0.89. [29]. A method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; shaping the treated powder or powder mixture using an additive manufacturing (AM) technology at a right temperature, wherein a right temperature is a temperature between 0.08*Tm and 0.74*Tm, being Tm the melting temperature in Kelvin of the powder or powder mixture provided, wherein the additive manufacturing (AM) technology employed further comprises the use of an organic material; applying a pressure and/or temperature treatment, said treatment comprising the application of a pressure between 6 and 2100 MPa; applying a debinding treatment to eliminate at least part of the organic material; applying a fixing step for setting the % C, % O, % N, % H and/or % B levels in the metallic part of the component; and applying a consolidation treatment, wherein the consolidation treatment comprises the application of a pressure between 1 mbar and 4900 bar and a temperature between 0.36*Tm and 0.88*Tm, being Tm the melting temperature in Kelvin of the powder or powder mixture provided; wherein the pressure and/or temperature treatment is applied before and/or during the application of the debinding treatment and wherein the step of applying a treatment to the powder or powder mixture comprises a value of the parameter KA2 between 0.3 and 4900, being KA2=Coeff*1/(V_{powder}*ρ_{powder}+V_{processing material}*ρ_{processing material})*EEC, wherein EEC is the electrical energy consumed while processing the powder expressed in MJ; V_{powder} is the volume of powder in the container, expressed in dm³; ρ_{powder} is the mean density of the powder in the container, expressed in kg/dm³; V_{processing material} is the volume of the processing material in the container, expressed in dm³; ρ_{processing material} is the mean density of the processing material in the container, expressed in kg/dm³; and Coeff is 0.89. [30]. A method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; providing a mold at least partly manufactured using an additive manufacturing (AM) technology, wherein the mold is made of a material comprising a polymeric material; filling the mold with the treated powder or powder mixture; applying a pressure and/or temperature treatment to the filled mold; applying a fixing step for setting the % C, % O, % N, % H and/or % B levels in the metallic part of the component; and applying a consolidation treatment, wherein the consolidation treatment comprises the application of a pressure between 1 mbar and 4900 bar and a temperature between 0.36*Tm and 0.88*Tm, being Tm the melting temperature in Kelvin of the powder or powder mixture provided; wherein the step of applying a treatment to the powder or powder mixture comprises a value of the parameter KA2 between 0.3 and 4900, being KA2=Coeff*1/(V_{powder}*ρ_{powder}+V_{processing material}*ρ_{processing material})*EEC, wherein EEC is the electrical energy consumed while processing the powder expressed in MJ; V_{powder} is the volume of powder in the container, expressed in dm³; ρ_{powder} is the mean density of the powder in the container, expressed in kg/dm³; V_{processing material} is the volume of the processing material in the container, expressed in dm³; ρ_{processing material} is the mean density of the processing material in the container, expressed in kg/dm³; and Coeff is 0.89. [31]. A method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; shaping the treated powder or powder mixture using an additive manufacturing (AM) technology at a right temperature, wherein a right temperature is a temperature between 0.08*Tm and 0.74*Tm, being Tm the melting temperature in Kelvin of the powder or powder mixture provided, wherein the additive manufacturing (AM) technology employed further comprises the use of an organic material; applying a pressure and/or temperature treatment, wherein the pressure and/or temperature treatment comprises the following steps: step i) subjecting the component to high pressure, wherein the maximum pressure applied is between 12 MPa and 790 MPa; step ii) while keeping a high pressure level, raising the temperature of the component; step iii) while keeping a high enough temperature between 320K and 790K, releasing at least some of the to the component applied pressure; and applying a debinding treatment to eliminate at least part of the organic material; wherein the pressure and/or temperature treatment is applied before and/or during the application of the debinding treatment and wherein the step of applying a treatment to the powder or powder mixture comprises a value of the parameter KA2 between 0.3 and 4900, being KA2=Coeff*1/(V_{powder}*ρ_{powder}+V_{processing material}*ρ_{processing material})*EEC, wherein EEC is the electrical energy consumed while processing the powder expressed in MJ; V_{powder} is the volume of powder in the container, expressed in dm³; ρ_{powder} is the mean density of the powder in the container, expressed in kg/dm³; V_{processing material} is the volume of the processing material in the container, expressed in dm³; ρ_{processing material} is the mean density of the processing material in the container, expressed in kg/dm³; and Coeff is 0.89. [32]. A method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; providing a mold at least partly manufactured using an additive manufacturing (AM) technology, wherein the mold is made of a material comprising a polymeric material; filling the mold with the treated powder or powder mixture; and applying a pressure and/or temperature treatment to the filled mold, wherein the pressure and/or temperature treatment comprises the following steps: step i) subjecting the mold to high pressure, wherein the maximum pressure applied is between 12 MPa and 790 MPa; step ii) while keeping a high pressure level, raising the temperature of the mold; and step iii) while keeping a high enough temperature between 320K and 690K, releasing at least some of the to the mold applied pressure; wherein the step of applying a treatment to the powder or powder mixture comprises a value of the parameter KA2 between 0.3 and 4900, being KA2=Coeff*1/(V_{powder}*ρ_{powder}+V_{processing material}*ρ_{processing material})*EEC, wherein EEC is the electrical energy consumed while processing the powder expressed in MJ; V_{powder} is the volume of powder in the container, expressed in dm³; ρ_{powder} is the mean density of the powder in the container, expressed in kg/dm³; V_{processing material} is the volume of the processing material in the container, expressed in dm³; ρ_{processing material} is the mean density of the processing material in the container, expressed in kg/dm³; and Coeff is 0.89. [33]. A method of manufacturing metal comprising components, which method comprises the steps of: providing a powder or powder mixture; applying a treatment to the powder or powder mixture, wherein the treatment of the powder or powder mixture comprises applying energy into the powder or powder mixture through mechanical action; and shaping the treated powder or powder mixture using a metal additive manufacturing (MAM) method; wherein there is a significant increase and afterwards a significant decrease in the value of PAD1, being PAD1=1*10⁻⁶*√MDD, wherein MDD is the mean dislocation density in m⁻², during the application of the method steps, wherein a significant increase in PAD1 means adding 2 to the value of PAD1 and a significant decrease in PAD1 means subtracting 2 from to the value of PAD1. [34]. A method of manufacturing metal comprising components, which method comprises the steps of: providing a powder or powder mixture; applying a treatment to the powder or powder mixture, wherein the treatment of the powder or powder mixture comprises applying energy into the powder or powder mixture through mechanical action; shaping the treated powder or powder mixture using an additive manufacturing (AM) technology at a right temperature, wherein a right temperature is a temperature between 0.08*Tm and 0.74*Tm, being Tm the melting temperature in Kelvin of the powder or powder mixture provided, wherein the additive manufacturing (AM) technology employed further comprises the use of an organic material; applying a pressure and/or temperature treatment, said treatment comprising the application of a pressure between 6 and 2100 MPa; and applying a debinding treatment to eliminate at least part of the organic material; wherein the pressure and/or temperature treatment is applied before and/or during the application of the debinding treatment and wherein there is a significant increase and afterwards a significant decrease in the value of PAD1, being PAD1=1*10⁻⁶*√MDD, wherein MDD is the mean dislocation density in m⁻², during the application of the method steps, wherein a significant increase in PAD1 means adding 2 to the value of PAD1 and a significant decrease in PAD1 means subtracting 2 from to the value of PAD1. [35]. A method of manufacturing metal comprising components, which method comprises the steps of: providing a powder or powder mixture; applying a treatment to the powder or powder mixture, wherein the treatment of the powder or powder mixture comprises applying energy into the powder or powder mixture through mechanical action; providing a mold at least partly manufactured using an additive manufacturing (AM) technology, wherein the mold is made of a material comprising a polymeric material; filling the mold with the treated powder or powder mixture; and applying a pressure and/or temperature treatment to the filled mold; wherein there is a significant increase and afterwards a significant decrease in the value of PAD1, being PAD1=1*10⁻⁶*√MDD, wherein MDD is the mean dislocation density in m⁻², during the application of the method steps, wherein a significant increase in PAD1 means adding 2 to the value of PAD1 and a significant decrease in PAD1 means subtracting 2 from to the value of PAD1. [36]. A method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; shaping the treated powder or powder mixture using an additive manufacturing (AM) technology at a right temperature, wherein a right temperature is a temperature between 0.08*Tm and 0.74*Tm, being Tm the melting temperature in Kelvin of the powder or powder mixture provided, wherein the additive manufacturing (AM) technology employed further comprises the use of an organic material; applying a pressure and/or temperature treatment, said treatment comprising the application of a pressure between 6 and 2100 MPa; applying a debinding treatment to eliminate at least part of the organic material; and applying a fixing step for setting the % C, % O, % N, % H and/or % B levels in the metallic part of the component; wherein the pressure and/or temperature treatment is applied before and/or during the application of the debinding treatment and wherein there is a significant increase and afterwards a significant decrease in the value of PAD1, being PAD1=1*10⁻⁶*√MDD, wherein MDD is the mean dislocation density in m⁻², during the application of the method steps, wherein a significant increase in PAD1 means adding 2 to the value of PAD1 and a significant decrease in PAD1 means subtracting 2 from to the value of PAD1. [37]. A method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; providing a mold at least partly manufactured using an additive manufacturing (AM) technology, wherein the mold is made of a material comprising a polymeric material; filling the mold with the treated powder or powder mixture; applying a pressure and/or temperature treatment to the filled mold; and applying a fixing step for setting the % C, % O, % N, % H and/or % B levels in the metallic part of the component; wherein there is a significant increase and afterwards a significant decrease in the value of PAD1, being PAD1=1*10⁻⁶*√MDD, wherein MDD is the mean dislocation density in m⁻², during the application of the method steps, wherein a significant increase in PAD1 means adding 2 to the value of PAD1 and a significant decrease in PAD1 means subtracting 2 from to the value of PAD1. [38]. A method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; shaping the treated powder or powder mixture using an additive manufacturing (AM) technology at a right temperature, wherein a right temperature is a temperature between 0.08*Tm and 0.74*Tm, being Tm the melting temperature in Kelvin of the powder or powder mixture provided, wherein the additive manufacturing (AM) technology employed further comprises the use of an organic material; applying a pressure and/or temperature treatment, said treatment comprising the application of a pressure between 6 and 2100 MPa; applying a debinding treatment to eliminate at least part of the organic material; applying a fixing step for setting the % C, % O, % N, % H and/or % B levels in the metallic part of the component; and applying a consolidation treatment, wherein the consolidation treatment comprises the application of a pressure between 1 mbar and 4900 bar and a temperature between 0.36*Tm and 0.88*Tm, being Tm the melting temperature in Kelvin of the powder or powder mixture provided; wherein the pressure and/or temperature treatment is applied before and/or during the application of the debinding treatment and wherein there is a significant increase and afterwards a significant decrease in the value of PAD1, being PAD1=1*10⁻⁶*√MDD, wherein MDD is the mean dislocation density in m⁻², during the application of the method steps, wherein a significant increase in PAD1 means adding 2 to the value of PAD1 and a significant decrease in PAD1 means subtracting 2 from to the value of PAD1. [39]. A method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; providing a mold at least partly manufactured using an additive manufacturing (AM) technology, wherein the mold is made of a material comprising a polymeric material; filling the mold with the treated powder or powder mixture; applying a pressure and/or temperature treatment to the filled mold; applying a fixing step for setting the % C, % O, % N, % H and/or % B levels in the metallic part of the component; and applying a consolidation treatment, wherein the consolidation treatment comprises the application of a pressure between 1 mbar and 4900 bar and a temperature between 0.36*Tm and 0.88*Tm, being Tm the melting temperature in Kelvin of the powder or powder mixture provided; wherein there is a significant increase and afterwards a significant decrease in the value of PAD1, being PAD1=1*10⁻⁶*√MDD, wherein MDD is the mean dislocation density in m⁻², during the application of the method steps, wherein a significant increase in PAD1 means adding 2 to the value of PAD1 and a significant decrease in PAD1 means subtracting 2 from to the value of PAD1. [40]. A method of manufacturing metal comprising components, which method comprises the steps of: providing a powder or powder mixture; applying a treatment to the powder or powder mixture, wherein the treatment of the powder or powder mixture comprises applying energy into the powder or powder mixture through mechanical action; shaping the treated powder or powder mixture using an additive manufacturing (AM) technology at a right temperature, wherein a right temperature is a temperature between 0.08*Tm and 0.74*Tm, being Tm the melting temperature in Kelvin of the powder or powder mixture provided, wherein the additive manufacturing (AM) technology employed further comprises the use of an organic material; applying a pressure and/or temperature treatment, wherein the pressure and/or temperature treatment comprises the following steps: step i) subjecting the component to high pressure, wherein the maximum pressure applied is between 12 MPa and 790 MPa; step ii) while keeping a high pressure level, raising the temperature of the component; step iii) while keeping a high enough temperature between 320K and 790K, releasing at least some of the to the component applied pressure; and applying a debinding treatment to eliminate at least part of the organic material; wherein the pressure and/or temperature treatment is applied before and/or during the application of the debinding treatment and wherein there is a significant increase and afterwards a significant decrease in the value of PAD1, being PAD1=1*10⁻⁶*√MDD, wherein MDD is the mean dislocation density in m⁻², during the application of the method steps, wherein a significant increase in PAD1 means adding 2 to the value of PAD1 and a significant decrease in PAD1 means subtracting 2 from to the value of PAD1. [41]. A method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; providing a mold at least partly manufactured using an additive manufacturing (AM) technology, wherein the mold is made of a material comprising a polymeric material; filling the mold with the treated powder or powder mixture; and applying a pressure and/or temperature treatment to the filled mold, wherein the pressure and/or temperature treatment comprises the following steps: step i) subjecting the mold to high pressure, wherein the maximum pressure applied is between 12 MPa and 790 MPa; step ii) while keeping a high pressure level, raising the temperature of the mold; and step iii) while keeping a high enough temperature between 320K and 690K, releasing at least some of the to the mold applied pressure; wherein there is a significant increase and afterwards a significant decrease in the value of PAD1, being PAD1=1*10⁻⁶*√MDD, wherein MDD is the mean dislocation density in m⁻², during the application of the method steps, wherein a significant increase in PAD1 means adding 2 to the value of PAD1 and a significant decrease in PAD1 means subtracting 2 from to the value of PAD1. [42]. A method of manufacturing metal comprising components, which method comprises the steps of: providing a powder or powder mixture; applying a treatment to the powder or powder mixture, wherein the treatment of the powder or powder mixture comprises applying energy into the powder or powder mixture through mechanical action; and shaping the treated powder or powder mixture using a metal additive manufacturing (MAM) method; wherein the energy introduced into the powder or powder mixture in the treatment is between 11 and 490 J/(g*hit). [43]. A method of manufacturing metal comprising components, which method comprises the steps of: providing a powder or powder mixture; applying a treatment to the powder or powder mixture, wherein the treatment of the powder or powder mixture comprises applying energy into the powder or powder mixture through mechanical action; shaping the treated powder or powder mixture using an additive manufacturing (AM) technology at a right temperature, wherein a right temperature is a temperature between 0.08*Tm and 0.74*Tm, being Tm the melting temperature in Kelvin of the powder or powder mixture provided, wherein the additive manufacturing (AM) technology employed further comprises the use of an organic material; applying a pressure and/or temperature treatment, said treatment comprising the application of a pressure between 6 and 2100 MPa; and applying a debinding treatment to eliminate at least part of the organic material; wherein the pressure and/or temperature treatment is applied before and/or during the application of the debinding treatment and wherein the step of applying a treatment to the powder or powder mixture comprises a value of the parameter KA1 between 2.88 and 4900, being KA1=EEC/(V_{powder}*ρ_{powder}); wherein: EEC is the electrical energy consumed during the processing of the powder expressed in MJ; V_{powder} is the volume of powder in the container, expressed in dm³; ρ_{powder} is the mean density of the powder in the container, expressed in kg/dm³. [44]. A method of manufacturing metal comprising components, which method comprises the steps of: providing a powder or powder mixture; applying a treatment to the powder or powder mixture, wherein the treatment of the powder or powder mixture comprises applying energy into the powder or powder mixture through mechanical action; providing a mold at least partly manufactured using an additive manufacturing (AM) technology, wherein the mold is made of a material comprising a polymeric material; filling the mold with the treated powder or powder mixture; and applying a pressure and/or temperature treatment to the filled mold; wherein the step of applying a treatment to the powder or powder mixture comprises a value of the parameter KA1 between 2.88 and 4900, being KA1=EEC/(V_{powder}*ρ_{powder}); wherein: EEC is the electrical energy consumed during the processing of the powder expressed in MJ; V_{powder} is the volume of powder in the container, expressed in dm³; ρ_{powder} is the mean density of the powder in the container, expressed in kg/dm³. [45]. A method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; shaping the treated powder or powder mixture using an additive manufacturing (AM) technology at a right temperature, wherein a right temperature is a temperature between 0.08*Tm and 0.74*Tm, being Tm the melting temperature in Kelvin of the powder or powder mixture provided, wherein the additive manufacturing (AM) technology employed further comprises the use of an organic material; applying a pressure and/or temperature treatment, said treatment comprising the application of a pressure between 6 and 2100 MPa; applying a debinding treatment to eliminate at least part of the organic material; and applying a fixing step for setting the % C, % O, % N, % H and/or % B levels in the metallic part of the component; wherein the pressure and/or temperature treatment is applied before and/or during the application of the debinding treatment and wherein there is a significant increase of 1.5 times or more and afterwards a significant decrease of 0.038 times or more in the mean dislocation density during the application of the method steps. [46]. A method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; providing a mold at least partly manufactured using an additive manufacturing (AM) technology, wherein the mold is made of a material comprising a polymeric material; filling the mold with the treated powder or powder mixture; applying a pressure and/or temperature treatment to the filled mold; and applying a fixing step for setting the % C, % O, % N, % H and/or % B levels in the metallic part of the component; wherein the mean dislocation density (MDD) of the powder or powder mixture after applying the treatment is between 1.2*10¹² and 9.8*10¹⁸ m⁻². [47]. A method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; shaping the treated powder or powder mixture using an additive manufacturing (AM) technology at a right temperature, wherein a right temperature is a temperature between 0.08*Tm and 0.74*Tm, being Tm the melting temperature in Kelvin of the powder or powder mixture provided, wherein the additive manufacturing (AM) technology employed further comprises the use of an organic material; applying a pressure and/or temperature treatment, said treatment comprising the application of a pressure between 6 and 2100 MPa; applying a debinding treatment to eliminate at least part of the organic material; applying a fixing step for setting the % C, % O, % N, % H and/or % B levels in the metallic part of the component; and applying a consolidation treatment, wherein the consolidation treatment comprises the application of a pressure between 1 mbar and 4900 bar and a temperature between 0.36*Tm and 0.88*Tm, being Tm the melting temperature in Kelvin of the powder or powder mixture provided; wherein the pressure and/or temperature treatment is applied before and/or during the application of the debinding treatment and wherein there is a significant increase in the value of PAD1 during the application of the method steps, wherein a significant increase in PAD1 means adding 2 to the value of PAD1, being PAD1=1*10⁻⁶*√MDD, wherein MDD is the mean dislocation density in m⁻². [48]. A method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; providing a mold at least partly manufactured using an additive manufacturing (AM) technology, wherein the mold is made of a material comprising a polymeric material; filling the mold with the treated powder or powder mixture; applying a pressure and/or temperature treatment to the filled mold; applying a fixing step for setting the % C, % O, % N, % H and/or % B levels in the metallic part of the component; and applying a consolidation treatment, wherein the consolidation treatment comprises the application of a pressure between 1 mbar and 4900 bar and a temperature between 0.36*Tm and 0.88*Tm, being Tm the melting temperature in Kelvin of the powder or powder mixture provided; wherein there is a significant increase of 1.5 times or more and afterwards a significant decrease of 0.038 times or more in the mean dislocation density during the application of the method steps. [49]. A method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; shaping the treated powder or powder mixture using an additive manufacturing (AM) technology at a right temperature, wherein a right temperature is a temperature between 0.08*Tm and 0.74*Tm, being Tm the melting temperature in Kelvin of the powder or powder mixture provided, wherein the additive manufacturing (AM) technology employed further comprises the use of an organic material; applying a pressure and/or temperature treatment, wherein the pressure and/or temperature treatment comprises the following steps: step i) subjecting the component to high pressure, wherein the maximum pressure applied is between 12 MPa and 790 MPa; step ii) while keeping a high pressure level, raising the temperature of the component; step iii) while keeping a high enough temperature between 320K and 790K, releasing at least some of the to the component applied pressure; and applying a debinding treatment to eliminate at least part of the organic material; wherein the pressure and/or temperature treatment is applied before and/or during the application of the debinding treatment and wherein the mean dislocation density (MDD) of the powder or powder mixture after applying the treatment is between 1.2*10¹² and 9.8*10¹⁸ m⁻². [50]. A method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; providing a mold at least partly manufactured using an additive manufacturing (AM) technology, wherein the mold is made of a material comprising a polymeric material; filling the mold with the treated powder or powder mixture; and applying a pressure and/or temperature treatment to the filled mold, wherein the pressure and/or temperature treatment comprises the following steps: step i) subjecting the mold to high pressure, wherein the maximum pressure applied is between 12 MPa and 790 MPa; step ii) while keeping a high pressure level, raising the temperature of the mold; and step iii) while keeping a high enough temperature between 320K and 690K, releasing at least some of the to the mold applied pressure; wherein there is a significant increase in the value of PAD1 during the application of the method steps, wherein a significant increase in PAD1 means adding 2 to the value of PAD1, being PAD1=1*10⁻⁶*√MDD, wherein MDD is the mean dislocation density in m⁻². [51]. A method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; and shaping the treated powder or powder mixture using a metal additive manufacturing (MAM) method; wherein the energy introduced into the powder or powder mixture in the treatment is between 11 and 490 J/(g*hit) and wherein the metal comprising component manufactured comprises at least a predominantly austenitic steel comprising at least 22% by volume of austenite, with a low % Cr content, wherein a low % Cr content is a chromium content between 0.001 wt % and 11.5 wt %, and a high % N content, wherein a high % N content is a nitrogen content between 0.003 wt % and 4.9 wt %. [52]. A method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; shaping the treated powder or powder mixture using an additive manufacturing (AM) technology at a right temperature, wherein a right temperature is a temperature between 0.08*Tm and 0.74*Tm, being Tm the melting temperature in Kelvin of the powder or powder mixture provided, wherein the additive manufacturing (AM) technology employed further comprises the use of an organic material; applying a pressure and/or temperature treatment, said treatment comprising the application of a pressure between 6 and 2100 MPa; and applying a debinding treatment to eliminate at least part of the organic material; wherein the pressure and/or temperature treatment is applied before and/or during the application of the debinding treatment and wherein the step of applying a treatment to the powder or powder mixture comprises a value of the parameter KA1 between 2.88 and 4900, being KA1=EEC/(V_{powder}*ρ_{powder}); wherein: EEC is the electrical energy consumed during the processing of the powder expressed in MJ; V_{powder} is the volume of powder in the container, expressed in dm³; ρ_{powder} is the mean density of the powder in the container, expressed in kg/dm³, and wherein the metal comprising component manufactured comprises at least a RAFM material having the following composition, all percentages being indicated in weight percent: % C: 0.01-0.29 (preferably from 0.089 to 0.015, more preferably around 0.11); % Cr: 6.6-10.9 (preferably from 8.5 to 9.5); % V: 0.01 to 0.49 (preferably from 0.15 to 0.25); % Ta: 0.001 to 0.8 (preferably from 0.05 to 0.09); % W: 0.1-4.9 (preferably from 1 to 2); % Ti: 0.0001-0.9 (preferably from 0.0001 to 0.09); % Mn: 0.06-1.3 (preferably from 0.3 to 0.6); % P and/or % S: 0.0001 to 0.05 (preferably from 0.0005 to 0.007); % Ni, % Mo, % Cu % Nb, % Al % B, % Co<0.09 (preferably <0.009; more preferably <0.004 and even more preferably <0.0009); % Si: 0.0001-0.29 (preferably from 0.001 to 0.08); % As+% Sn+% Sb+% Zr: 0.0001-0.09 (preferably from 0.005 to 0.05); % N: 0.001-0.12 (preferably from 0.015 to 0.045); % O: 0.0001-1.2 (preferably from 0.0005 to 0.01); % REE+% Sc+% Y: 0-2.9 (preferably from 0 to 0.2); the rest consisting of iron and trace elements, wherein the sum of all trace elements is below 1.4. [53]. A method of manufacturing metal comprising components, which method comprises the steps of: providing a powder or powder mixture comprising at least a metal or a metal-based alloy; applying a treatment to the powder or powder mixture, wherein the treatment of the powder or powder mixture comprises applying energy into the powder or powder mixture through mechanical action; providing a mold at least partly manufactured using an additive manufacturing (AM) technology, wherein the mold is made of a material comprising a polymeric material; filling the mold with the treated powder or powder mixture; and applying a pressure and/or temperature treatment to the filled mold; wherein the step of applying a treatment to the powder or powder mixture comprises a value of the parameter KA1 between 2.88 and 4900, being KA1=EEC/(V_{powder}*ρ_{powder}); wherein: EEC is the electrical energy consumed during the processing of the powder expressed in MJ; V_{powder} is the volume of powder in the container, expressed in dm³; ρ_{powder} is the mean density of the powder in the container, expressed in kg/dm³, and wherein the metal comprising component manufactured comprises at least an ODS-RAFM material having the following composition, all percentages being indicated in weight percent: % C: 0.01-0.29 (preferably from 0.089 to 0.015, more preferably around 0.11); % Cr: 6.6-10.9 (preferably from 8.5 to 9.5); % V: 0.01 to 0.49 (preferably from 0.15 to 0.25); % Ta: 0.001 to 0.8 (preferably from 0.05 to 0.09); % W: 0.1-4.9 (preferably from 1 to 2); % Ti: 0.0001-0.9 (preferably from 0.01 to 0.4); % Mn: 0.06-1.3 (preferably from 0.3 to 0.6); % P and/or % S: 0.0001 to 0.05 (preferably from 0.0005 to 0.007); % Ni, % Mo, % Cu % Nb, % Al % B, % Co<0.09 (preferably <0.009; more preferably <0.004 and even more preferably <0.0009); % Si: 0.0001-0.29 (preferably from 0.001 to 0.08); % As+% Sn+% Sb+% Zr: 0.0001-0.09 (preferably from 0.005 to 0.05); % N: 0.001-0.12 (preferably from 0.015 to 0.045); % O: 0.0001-1.2 (preferably from 0.03 to 0.4); % REE+% Sc+% Y: 0-2.9 (preferably from 0.12 to 1.4); the rest consisting of iron and trace elements, wherein the sum of all trace elements is below 1.4. [54].The method according to any of [1] to [53], wherein the powder of powder mixture provided comprises at least a metal or a metal-based alloy. [55].The method according to any of [1] to [54], wherein the metal or metal-based alloy is selected from: iron, iron-based alloy, carbonyl iron, steel, stainless steel, nickel, nickel-based alloy, copper, copper based alloy, chromium, chromium-based alloy, cobalt, cobalt-based alloy, molybdenum, molybdenum-based alloy, manganese, manganese-based alloy, aluminium, aluminium-based alloy, tungsten, tungsten-based alloy, titanium, titanium-based alloy, lithium, lithium-based alloy, magnesium, magnesium-based alloy, niobium, niobium-based alloy, zirconium, zirconium-based alloy, silicon, silicon-based alloy, tin, tin-based alloy, tantalum, tantalum-based alloy, zinc, zinc-based alloy, lead, lead-based alloy, gold, gold-based alloy, silver, silver-based alloy and/or mixtures thereof. [56].The method according to any of [1] to [55], wherein the overall composition of the powder or powder mixture has the following elements and limitations, all percentages being indicated in weight percent: % C: 0.25-0.8; Mn: 0-1.15; % Si: 0-0.35; Cr: 0.1 max; % Mo: 1.5-6.5; % V: 0-0.6; % W: 0-4; Ni: 0-4; % Co: 0-3; the rest consisting of iron and trace elements, wherein the sum of all trace elements is below 1.4 wt %. [57].The method according to any of [1] to [56], wherein the overall composition of the powder or powder mixture has the following elements and limitations, all percentages being indicated in weight percent: % C: 0.25-0.55; % Mn: 0.10-1.2; % Si: 0.10-1.20; % Cr: 2.5-5.50; % Mo: 1.00-3.30; % V: 0.30-1.20; the rest consisting of iron and trace elements, wherein the sum of all trace elements is below 1.4 wt %. [58].The method according to any of [1] to [57], wherein the overall composition of the powder or powder mixture has the following elements and limitations, all percentages being indicated in weight percent: % C: 0.15-2.35; % Mn: 0.10-2.5; % Si: 0.10-1.0; % Cr: 0.2-17.50; % Mo: 0-1.4; % V: 0-1; % W: 0-2.2; % Ni: 0-4.3; the rest consisting of iron and trace elements, wherein the sum of all trace elements is below 1.4 wt %. [59].The method according to any of [1] to [58], wherein the overall composition of the powder or powder mixture has the following elements and limitations, all percentages being indicated in weight percent: % C: 0-0.4; % Mn: 0.1-1; % Si: 0-0.8; % Cr: 0-5.25; % Mo: 0-1.0; % V: 0-0.25; % Ni: 0-4.25; % Al: 0-1.25; the rest consisting of iron and trace elements, wherein the sum of all trace elements is below 1.4 wt %. [60].The method according to any of [1] to [59], wherein the overall composition of the powder or powder mixture has the following elements and limitations, all percentages being indicated in weight percent: % C: 0.77-1.40; % Si: 0-0.70; % Cr: 3.5-4.5; % Mo: 3.2-10; % V: 0.9-3.60; % W: 0-18.70; % Co: 0-10.50; the rest consisting of iron and trace elements, wherein the sum of all trace elements is below 1.4 wt %. [61].The method according to any of [1] to [60], wherein the overall composition of the powder or powder mixture has the following elements and limitations, all percentages being indicated in weight percent: % C: 0.03 max; % Mn:0.1 max; % Si:0.1 max; % Mo:3.0-5.2; % Ni:18-19; % Co:0-12.5; % Ti: 0-2; the rest consisting of iron and trace elements, wherein the sum of all trace elements is below 1.4 wt %. [62].The method according to any of [1] to [61], wherein the overall composition of the powder or powder mixture has the following elements and limitations, all percentages being indicated in weight percent: % C: 1.5-1.85; % Mn: 0.15-0.5; % Si: 0.15-0.45; % Cr:3.5-5.0; % Mo:0-6.75; % V:4.5-5.25; % W:11.5-13.00; % Co:0-5.25; the rest consisting of iron and trace elements, wherein the sum of all trace elements is below 1.4 wt %. [63].The method according to any of [1] to [62], wherein the overall composition of the powder or powder mixture has the following elements and limitations, all percentages being indicated in weight percent: % C: 0-0.6; % Mn: 0-1.5; % Si: 0-1; % Cr:11.5-17.5; % Mo:0-1.5; % V:0-0.2; % Ni: 0-6.0; the rest consisting of iron and trace elements, wherein the sum of all trace elements is below 1.4 wt %. [64].The method according to any of [1] to [63], wherein the overall composition of the powder or powder mixture has the following elements and limitations, all percentages being indicated in weight percent: % C: 0.015 max; % Mn: 0.5-1.25; % Si: 0.2-1; % Cr:11-18; % Mo:0-3.25; % Ni:3.0-9.5; % Ti:0-1.40; % Al:0-1.5; % Cu:0-5; the rest consisting of iron and trace elements, wherein the sum of all trace elements is below 1.4 wt %. [65].The method according to any of [1] to [64], wherein the overall composition of the powder or powder mixture has the following elements and limitations, all percentages being indicated in weight percent: % Cr: 10-14; % Ni: 5.6-12.5; % Ti: 0.4-2.8% Mo: 0-4.4; % B: 0-4; % Co: 0-12; % Mn: 0-2; % Cu: 0-2; % Al: 0-1; % Nb: 0-0.5; % Ce: 0-0.3; % Si: 0-2; % C, % N, % P, % S, % O each 0.09% max; % C+% N+% P+% S+% O: 0-0.3; % La+% Cs+% Nd+% Gd+% Pr+% Ac+% Th+% Tb+% Dy+% Ho+% Er+% Tm+% Yb+% Y+% Lu+% Sc+% Zr+% Hf: 0-0.4; % V+% Ta+% W: 0-0.8; the rest consisting of iron and trace elements, wherein the sum of all trace elements is below 1.4 wt %. [66].The method according to any of [1] to [65], wherein the overall composition of the powder or powder mixture has the following elements and limitations, all percentages being indicated in weight percent: % Mo: 0-6.8; % W: 0-6.9; % Moeq: 0-6.8; % Ceq: 0.16-1.8; % C: 0-1.29; % N: 0.11-2.09; % B: 0-0.14; % Si: 0-1.5; % Mn: 0-24; % Ni: 0-18.9; % Cr: 12.1-38; % Ti: 0-2.4; % Al: 0-14; % V: 0-4; % Nb: 0-4; % Zr: 0-3; % Hf: 0-3; % Ta: 0-3; % S: 0-0.098; % P: 0-0.098; % Pb: 0-0.9; % Cu: 0-3.9; % Bi: 0-0.08; % Se: 0-0.08; % Co: 0-14; % REE: 0-4; % Y: 0-1.86; % Sc: 0-0.96; % Cs: 0-1.4; % O: 0.00012-0.899; % Y+% Sc+% REE: 0.0022-3.9%; the rest consisting of iron and trace elements, wherein the sum of all trace elements is below 1.4 wt %. [67].The method according to any of [1] to [66], wherein the overall composition of the powder or powder mixture has the following elements and limitations, all percentages being indicated in weight percent: % Mg: 0.006-10.6; % Si: 0.006-23; % Ti: 0.002-0.35; % Cr: 0.01-0.40; % Mn-0.002-1.8; % Fe: 0.006-1.5; % Ni: 0-3.0; % Cu: 0.006-10.7; % Zn: 0.006-7.8; % Sn: 0-7; % Zr:0-0.5; the rest consisting of iron and trace elements, wherein the sum of all trace elements is below 1.4 wt %. [68].The method according to any of [1] to [67], wherein the overall composition of the powder or powder mixture has the following elements and limitations, all percentages being indicated in weight percent: % Zn:0-40; % Ni:0-31; % Al:0-13; % Sn:0-10; % Fe:0-5.5; % Si:0-4; % Pb:0-4; % Mn:0-3; % Co:0-2.7; % Be:0-2.75; % Cr:0-1; the rest consisting of iron and trace elements, wherein the sum of all trace elements is below 1.4 wt %. [69].The method according to any of [1] to [68], wherein the overall composition of the powder or powder mixture has the following elements and limitations, all percentages being indicated in weight percent: % Be:0.15-3.0; % Co: 0-3; % Ni: 0-2.2; % Pb: 0-0.6; % Fe: 0-0.25; % Si: 0-0.35; % Sn: 0-0.25, % Zr 0-0.5; the rest consisting of iron and trace elements, wherein the sum of all trace elements is below 1.4 wt %. [70].The method according to any of [1] to [69], wherein the overall composition of the powder or powder mixture has the following elements and limitations, all percentages being indicated in weight percent: % Cr: 9-33; % W: 0-26; % Mo: 0-29; % C: 0-3.5; % Fe: 0-9; % Ni: 0-35; % Si: 0-3.9; Mn: 0-2.5; % B: 0-1; % V: 0-4.2; % Nb/% Ta: 0-5.5; the rest consisting of iron and trace elements, wherein the sum of all trace elements is below 1.4 wt %. [71].The method according to any of [1] to [70], wherein the overall composition of the powder or powder mixture has the following elements and limitations, all percentages being indicated in weight percent: % Fe:0-42; % Cu:0-34; % Cr:0-31; % Mo:0-24; % Co:0-18; % W:0-14; % Nb:0-5.5; % Mn:0-5.25; % Al:0-5; Ti:0-3; % Zn:0-1; % Si:0-1; % C:0-0.3; % S:0.01 max; the rest consisting of iron and trace elements, wherein the sum of all trace elements is below 1.4 wt %. [72].The method according to any of [1] to [71], wherein the overall composition of the powder or powder mixture has the following elements and limitations, all percentages being indicated in weight percent: % V:0-14.5; % Mo:0-13; % Cr:0-12; % Sn:0-11.5; % Al:0-8; % Mn:0-8; % Zr:0-7.5; % Cu:0-3; % Nb:0-2.5; % Fe: 0-2.5; % Ta:0-1.5; % Si:0-0.5; % C:0.1 max; % N:0.05 max; % O: 0.2 max; % H:0.03 max; the rest consisting of iron and trace elements, wherein the sum of all trace elements is below 1.4 wt %. [73].The method according to any of [1] to [72], wherein the overall composition of the powder or powder mixture has the following elements and limitations, all percentages being indicated in weight percent: % Al:0-10; % Zn: 0-6; % Y:0-5.2; % Cu:0-3; % Ag: 0-2.5, % Th:0-3.3; Si:0-1.1; % Mn:0-0.75; the rest consisting of iron and trace elements, wherein the sum of all trace elements is below 1.4 wt %. [74].The method according to any of [1] to [73], wherein the overall composition of the powder or powder mixture has the following elements and limitations, all percentages being indicated in weight percent: % Al:0-10; % Zn: 0-6; % Y:0-5.2; % Cu:0-3; % Ag: 0-2.5, % Th:0-3.3; Si:0-1.1; % Mn:0-0.75; the rest consisting of iron and trace elements, wherein the sum of all trace elements is below 1.4 wt %. [75].The method according to any of [1] to [74], wherein the powder or powder mixture provided further comprises organic materials, polymers, polymeric materials, fluxes, lubricants, additives, binders, resins, metallic particles, reinforcement particles, whiskers, graphene, nanotubes, carbon nanotubes and/or combinations thereof. [76].The method according to any of [1] to [75], wherein the powder or powder mixture provided has a proper % C content, wherein a proper % C content is a carbon content between 0.0001 and 3.9 wt %. [77].The method according to any of [1] to [76], wherein the powder or powder mixture provided has a proper % O content, wherein a proper % O content is an oxygen content between 20 and 49000 ppm. [78].The method according to any of [1] to [77], wherein the powder or powder mixture provided has a proper % N content, wherein a proper % N content is a nitrogen content between 1.2 ppm and 0.29 wt %. [79].The method according to any of [1] to [78], wherein the powder or powder mixture provided has a proper % H content, wherein a proper % H content is a hydrogen content between 0.1 and 8400 ppm. [80].The method according to any of [1] to [79], wherein the powder or powder mixture provided has a proper % B content, wherein a proper % B content is a boron content between 0.2 ppm and 0.9 wt %. [81].The method according to any of [1] to [80], wherein a nitrogen comprising material is admixed with the powder o powder mixture provided. [82].The method according to any of [1] to [81], wherein the amount of nitrogen comprising material is selected so as to have between 0.02 wt % and 3.9 wt % nitrogen. [83].The method according to any of [1] to [82], wherein the nitrogen comprising material is a nitride and/or a mixture of nitrides. [84].The method according to any of [1] to [83], wherein the powder or powder mixture provided has a proper size, wherein a proper size is a size between 0.8 and 9900 microns. [85].The method according to any of [1] to [84], wherein the powder or powder mixture provided has a proper size, wherein a proper size is a size between 210 and 9900 microns. [86].The method according to any of [1] to [85], wherein the powder or powder mixture provided has a proper size, wherein a proper size is a size between 0.01 and 890 nanometers. [87].The method according to any of [1] to [86], wherein the powder or powder mixture provided has a proper size, wherein a proper size is a size of 1990 microns or less, 1390 microns or less, 940 microns or less, 440 microns or less and even 240 microns or less. [88].The method according to any of [1] to [87], wherein the powder or powder mixture provided is an irregular powder or powder mixture. [89].The method according to any of [1] to [88], wherein the powder or powder mixture provided comprises at least one irregular powder. [90].The method according to any [1] to [89], wherein an irregular powder refers to a powder having a sphericity of 0.79 or less. [91].The method according to any of [1] to [90], wherein the powder or powder mixture provided is a spherical powder or powder mixture. [92].The method according to any of [1] to [91], wherein the powder or powder mixture provided comprises at least one spherical powder [93].The method according to any [1] to [92], wherein a spherical powder refers to a powder having a sphericity of 0.66 or greater. [94].The method according to any of [1] to [93], wherein the percentage of spherical particles in the powder or powder mixture provided is between 21% and 89%. [95].The method according to any [1] to [94], wherein the sphericity is assessed by dynamic image analysis (DIA) [96].The method according to any of [1] to [95], wherein at least part of the powder or powder mixture is obtained by centrifugal atomization, water atomization, gas atomization, droplet atomization, oxide reduction, mechanical action, comminution, grinding, crushing, attrition, milling, energy breaking and/or combinations thereof. [97].The method according to any of [1] to [96], wherein the treatment of the powder or powder mixture comprises applying energy into the powder or powder mixture through mechanical action. [98].The method according to any of [1] to [97], wherein the treatment of the powder or powder mixture comprises introducing the powder or powder mixture in a container comprising a processing material. [99].The method according to any of [1] to [98], wherein the treatment of the powder or powder mixture comprises applying a rotary motion and/or vibration. [100].The method according to any of [1] to [99], wherein the treatment of the powder or powder mixture comprises introducing the powder or powder mixture into a container, wherein the container comprises a processing material, and applying, a rotary motion and/or vibration. [101].The method according to any of [1] to [100], wherein the treatment of the powder or powder mixture comprises mixing, inter-particle diffusion, welding, cold welding, fracturing, and/or re-welding of at least some of the particles of the powder or powder mixture. [102].The method according to any of [1] to [101], wherein the treatment of the powder or powder mixture comprises welding at least part of the particles of the powder or powder mixture. [103].The method according to any of [1] to [102], wherein the treatment of the powder or powder mixture comprises inter-particle diffusion. [104].The method according to any of [1] to [103], wherein the treatment of the powder or powder mixture comprises inter-particle diffusion and/or welding. [105].The method according to any of [1] to [104], wherein the geometry of the container is selected from cylindrical, spherical, conical polygonal, cubic, cuboidal, pyramidal, pentagonal, hexagonal, octahedral, and/or ellipsoidal. [106].The method according to any of [1] to [105], wherein the internal shape of the container is selected from flat-ended types, round-ended types and concave-ended types. [107].The method according to any of [1] to [106], wherein the container is made of a material selected from composite materials, metallic materials metal-based composites, ceramic materials, ceramic-based composites, organic materials and/or mixtures thereof. [108].The method according to any of [1] to [107], wherein the treatment of the powder or powder mixture is performed in a container with a rotation speed between 46 and 11900 rpm. [109].The method according to any of [1] to [108], wherein the circulation rate, defined as the number of circulations of the container a particle of the powder or powder mixture makes per container revolution between 0.1 and 290. [110].The method according to any of [1] to [109], wherein the velocity of the processing material is between 0.001 and 290 m/s. [111].The method according to any of [1] to [110], wherein the average impact frequency is between 0.01 and 39000 Hz. [112].The method according to any of [1] to [111], wherein the velocity of the processing material is between 0.001 and 290 m/s and the average impact frequency is between 0.01 and 39000 Hz. [113].The method according to any of [1] to [112], wherein the shape of the processing material is selected from balls, barrels, rods, cylinders, cylpebs, beads, satellites, pellets and/or combinations thereof. [114].The method according to any of [1] to [113], wherein the composition of the processing material is selected from metallic materials, metallic based composites, ceramic materials, ceramic based composites, polymer-based composites and/or combinations thereof. [115].The method according to any of [1] to [114], wherein at least part of the processing material is composed of ceramic and/or metallic balls, cylpebs and/or rods. [116].The method according to any of [1] to [115], wherein at least part of the processing material has a spherical shape with a sphericity of 0.66 or greater, and a diameter between 1.2 mm and 89 mm. [117].The method according to any of [1] to [116], wherein at least part of the processing material has a spherical shape with a sphericity of 0.66 or greater, a diameter between 1.2 mm and 89 mm, and wherein the rotation speed of the container is between 46 and 11900 rpm. [118].The method according to any of [1] to [117], wherein at least part of the processing material has cylindrical shape with a length and/or diameter between 0.1 mm and 149 mm. [119].The method according to any of [1] to [118], wherein the ratio of processing material-to-container volume, calculated as the volume occupied by the processing material divided by the volume of the container, all volumes being measured in m³ is between 1:190 and 1:1.2. [120].The method according to any of [1] to [119], wherein the percentage of the volume of the container occupied by the processing material, calculated as the volume occupied by the processing material divided by the volume of the container and multiplied by 100, all volumes being measured in m³, is between 6% and 84%. [121].The method according to any of [1] to [120], wherein the percentage of the volume of the container occupied by the processed material, calculated as the volume occupied by the powder or powder mixture being processed divided by the volume of the container and multiplied by 100, all volumes being measured in m³, is between 3% and 81%. [122].The method according to any of [1] to [121], wherein the volume ratio of processed material-to-processing material, which is calculated as the volume occupied by the powder or powder mixture being processed divided by the volume occupied by the processing material, all volumes being measured in m³, is between 0.29 and 2.4. [123].The method according to any of [1] to [122], wherein the volume occupied by the processing and processed material to the volume of the container, which is calculated as the volume occupied by the processing material and the powder or powder mixture being processed, divided by the volume of the container and multiplied by 100, all volumes being measured in m³, is between 31% and 74%. [124].The method according to any of [1] to [123], wherein the weight ratio of processing material-to-processed material, calculated as the weight of processing material divided by the weight of the powder or powder mixture being processed, all weights being in grams, is between 490:1 and 7:1. [125].The method according to any of [1] to [124], wherein the percentage of the volume of the container occupied by the processing material, which is calculated as the volume occupied by the processing material divided by the volume of the container and multiplied by 100, all volumes being measured in m³, is between 6% and 84%, and wherein the percentage of the volume of the container occupied by the processed material, which is calculated as the volume occupied by the powder or powder mixture being processed divided by the volume of the container and multiplied by 100, all volumes being measured in m³, is between 3% and 81%, and wherein the weight ratio of processing material-to-processed material, calculated as the weight of processing material divided by the weight of the powder or powder mixture being processed, all weights being in grams, is between 490:1 and 7:1. [126].The method according to any of [1] to [125], wherein the weight of each element of the processing material individually is between 0.6 and 248 grams. [127].The method according to any of [1] to [126], wherein the mean weight of the processing material is between 3.1 and 248 grams. [128].The method according to any of [1] to [127], wherein the weight ratio of processing material-to-processed material, calculated as the weight of processing material divided by the weight of the powder or powder mixture being processed, all weights being in grams, is between 490:1 and 7:1. [129].The method according to any of [1] to [128], wherein the duration of the treatment is between 1.2 minutes and 2590 hours. [130].The method according to any of [1] to [129], wherein the atmosphere in the container is selected from: air, an inert atmosphere, a reactive atmosphere and/or mixtures thereof. [131].The method according to any of [1] to [130], wherein the atmosphere in the container is a properly designed atmosphere. [132].The method according to any of [1] to [131], wherein the treatment of the powder or powder mixture comprises the application of a vacuum between 510 and 1.6*10⁻¹⁰ mbar. [133].The method according to any of [1] to [132], wherein the treatment of the powder or powder mixture comprises the application of a pressure between 0.12 and 9.8 MPa during at least part of the treatment. [134].The method according to any of [1] to [133], wherein the treatment of the powder or powder mixture comprises the application of a temperature between −20° C. and −270° C. [135].The method according to any of [1] to [134], wherein the treatment of the powder or powder mixture comprises the application of a temperature between 0.16*Tm and 0.74*Tm, being Tm the melting temperature in Kelvin of the powder or powder mixture. [136].The method according to any of [1] to [135], wherein the treatment of the powder or powder mixture comprises the application of a vacuum between 510 and 1.6*10⁻¹⁰ mbar and/or the application of a pressure between 0.12 and 9.8 MPa during at least part of the treatment and/or the application of a temperature between 0.16*Tm and 0.74*Tm, being Tm the melting temperature in Kelvin of the powder or powder mixture. [137].The method according to any of [1] to [136], wherein the raw energy introduced into the powder or powder mixture in the treatment is between 1.1.10-5 and 20 and 490 J/hit. [138].The method according to any of [1] to [137], wherein the energy introduced into the powder or powder mixture in the treatment is between 11 and 490 J/(g*hit). [139].The method according to any of [1] to [138], wherein the step of applying a treatment to the powder or powder mixture comprises a value of the parameter KA1 between 2.88 and 4900, being KA1=EEC/(V_{powder}*ρ_{powder}); wherein: EEC is the electrical energy consumed during the processing of the powder expressed in MJ; V_{powder} is the volume of powder in the container, expressed in dm³; ρ_{powder} is the mean density of the powder in the container, expressed in kg/dm³. [140].The method according to any of [1] to [139], wherein the step of applying a treatment to the powder or powder mixture comprises a value of the parameter KA2 between 0.3 and 4900, being KA2=Coeff*1/(V_{powder}*ρ_{powder}+V_{processing material}*ρ_{processing material})*EEC, wherein EEC is the electrical energy consumed while processing the powder expressed in MJ; V_{powder} is the volume of powder in the container, expressed in dm³; ρ_{powder} is the mean density of the powder in the container, expressed in kg/dm³; V_{processing material} is the volume of the processing material in the container, expressed in dm³; ρ_{processing material} is the mean density of the processing material in the container, expressed in kg/dm³; and Coeff is 0.89. [141].The method according to any of [1] to [140], wherein the mean dislocation density (MDD) of the powder or powder mixture after applying the treatment is between 1.2*10¹² and 9.8*10¹⁸ m⁻². [142].The method according to any of [1] to [141], wherein the mean dislocation density (MDD) at least in some areas of the component surface is between 1.2*10¹² and 9.8*10¹⁸ m⁻². [143].The method according to any of [1] to [142], wherein the mean dislocation density (MDD) of the particles of the treated powder or powder mixture, before, during and/or after the application of any method step is between 1.2*10¹² and 9.8*10¹⁸ m⁻². [144].The method according to any of [1] to [143], wherein there is a significant increase of 1.5 times or more in the mean dislocation density during the treatment of the powder or powder mixture. [145].The method according to any of [1] to [144], wherein there is a significant increase of 1.5 times or more in the mean dislocation density during the application of the method steps. [146].The method according to any of [1] to [145], wherein there is a significant increase of 1.5 times or more in the mean dislocation density at least in some areas of the component surface. [147].The method according to any of [1] to [146], wherein there is a significant increase of 1.5 times or more and afterwards a significant decrease of 0.038 times or more in the mean dislocation density during the treatment of the powder or powder mixture. [148].The method according to any of [1] to [147], wherein there is a significant increase of 1.5 times or more and afterwards a significant decrease of 0.038 times or more in the mean dislocation density during the application of the method steps. [149].The method according to any of [1] to [148], wherein there is a significant increase of 1.5 times or more and afterwards a significant decrease of 0.038 times or more in the mean dislocation density at least in some areas of the component surface. [150].The method according to any of [1] to [149], wherein there is a significant increase of 1.5 times or more, afterwards a significant decrease of 0.038 times or more, and finally a significant increase of 1.5 times or more in the mean dislocation density during the treatment of the powder or powder mixture. [151].The method according to any of [1] to [150], wherein there is a significant increase of 1.5 times or more, afterwards a significant decrease of 0.038 times or more, and finally a significant increase of 1.5 times or more in the mean dislocation density during the application of the method steps. [152].The method according to any of [1] to [151], wherein there is a significant increase of 1.5 times or more, afterwards a significant decrease of 0.038 times or more, and finally a significant increase of 1.5 times or more in the mean dislocation density at least in some areas of the component surface. [153].The method according to any of [1] to [152], wherein the value of the parameter PAD1 before, during and/or after the application of any method step is between 11 and 390, being PAD1=1*10⁻⁶*√MDD, wherein MDD is the mean dislocation density in m⁻². [154].The method according to any of [1] to [153], wherein the value of the parameter PAD1 during and/or at the end of the treatment of the powder or powder mixture is between 11 and 390, being PAD1=1*10⁻⁶*√MDD, wherein MDD is the mean dislocation density in m⁻². [155].The method according to any of [1] to [154], wherein the value of the parameter PAD1 at least in some areas of the areas of the component surface is between 11 and 390, being PAD1=1*10⁻⁶*√MDD, wherein MDD is the mean dislocation density in m⁻². [156].The method according to any of [1] to [155], wherein there is a significant increase in the value of PAD1 during the application of the method steps, wherein a significant increase in PAD1 means adding 2 to the value of PAD1, being PAD1=1*10⁻⁶*41MDD, wherein MDD is the mean dislocation density in m⁻². [157].The method according to any of [1] to [156], wherein there is a significant increase in the value of PAD1 at least in some areas of the component surface, wherein a significant increase in PAD1 means adding 2 to the value of PAD1, being PAD1=1*10⁻⁶*41MDD, wherein MDD is the mean dislocation density in m⁻². [158].The method according to any of [1] to [157], wherein there is a significant increase in the value of PAD1 during the treatment of the powder or powder mixture, wherein a significant increase in PAD1 means adding 2 to the value of PAD1, being PAD1=1*10⁻⁶*41MDD, wherein MDD is the mean dislocation density in m⁻². [159].The method according to any of [1] to [158], wherein there is a significant increase and afterwards a significant decrease in the value of PAD1 during the application of the method steps, wherein a significant increase in PAD1 means adding 2 to the value of PAD1 and a significant decrease in PAD1 means subtracting 2 from to the value of PAD1 being PAD1=1*10⁻⁶*√MDD, wherein MDD is the mean dislocation density in m⁻². [160].The method according to any of [1] to [159], wherein there is a significant increase and afterwards a significant decrease in the value of PAD1, at least in some areas of the component surface, wherein a significant increase in PAD1 means adding 2 to the value of PAD1 and a significant decrease in PAD1 means subtracting 2 from to the value of PAD1, being PAD1=1*10⁻⁶*√MDD, wherein MDD is the mean dislocation density in m⁻². [161].The method according to any of [1] to [160], wherein there is a significant increase and afterwards a significant decrease in the value of PAD1, during the treatment of the powder or powder mixture, wherein a significant increase in PAD1 means adding 2 to the value of PAD1 and a significant decrease in PAD1 means subtracting 2 from to the value of PAD1, being PAD1=1*10⁻⁶*√MDD, wherein MDD is the mean dislocation density in m⁻². [162].The method according to any of [1] to [161], wherein there is a significant increase, afterwards a significant decrease and finally a significant increase in the value of PAD1, being PAD1=1*10⁻⁶*√MDD, wherein MDD is the mean dislocation density in m⁻², during the application of the method steps, wherein a significant increase in PAD1 means adding 2 to the value of PAD1 and a significant decrease in PAD1 means subtracting 2 from to the value of PAD1. [163].The method according to any of [1] to [162], wherein there is a significant increase, afterwards a significant decrease and finally a significant increase in the value of PAD1, at least in some areas of the component surface, wherein a significant increase in PAD1 means adding 2 to the value of PAD1 and a significant decrease in PAD1 means subtracting 2 from to the value of PAD1, being PAD1=1*10⁻⁶*√MDD, wherein MDD is the mean dislocation density in m⁻². [164].The method according to any of [1] to [163], wherein there is a significant increase and afterwards a significant decrease in the value of PAD1, during the application of the method steps, wherein a significant increase in PAD1 means adding 2 to the value of PAD1 and a significant decrease in PAD1 means subtracting 2 from to the value of PAD1, being PAD1=1*10-6*1MDD, wherein MDD is the mean dislocation density in m⁻². [165].The method according to any of [1] to [164], wherein the treated powder or powder mixture has an appropriate % C content, wherein an appropriate % C content is a carbon content between 0.1 wt % and 3.9 wt %. [166].The method according to any of [1] to [165], wherein the treated powder or powder mixture has an appropriate oxygen % O content, wherein an appropriate % O content is an oxygen content between 160 and 49000 ppm. [167].The method according to any of [1] to [166], wherein the treated powder or powder mixture has an appropriate % N content, wherein an appropriate % N content is a nitrogen content between 16 and 19400 ppm. [168].The method according to any of [1] to [167], wherein the treated powder or powder mixture has an appropriate % H content, wherein an appropriate % H content is a hydrogen content between 1 and 8400 ppm. [169].The method according to any of [1] to [168], wherein the treated powder or powder mixture has an appropriate % B content, wherein an appropriate % B content is a boron content between 3 and 44000 ppm. [170].The method according to any of [1] to [169], wherein at least one additional powder is added to the treated powder or powder mixture. [171].The method according to any of [1] to [170], wherein a treatment which comprises applying energy through mechanical action is applied to the mixture of the treated powder or powder mixture and the added powder or powders. [172].The method according to any of [1] to [171], wherein at least part of the treatment is performed in a properly designed atmosphere. [173].The method according to any of [1] to [172], wherein the treatment comprises the use of a properly designed atmosphere. [174].The method according to any of [1] to [173], wherein the method further comprises the step of: applying a preconditioning step to the treated powder or powder mixture. [175].The method according to any of [1] to [174], wherein the carbon (% C) content of the treated powder or powder mixture after the preconditioning step is between 0.096 wt % and 3.9 wt %. [176].The method according to any of [1] to [175], wherein oxygen (% O) content of the treated powder or powder mixture after the preconditioning step is between 56 and 23900 ppm. [177].The method according to any of [1] to [176], wherein the nitrogen (% N) content of the treated powder or powder mixture after the preconditioning step is between 6 ppm and 0.44 wt %. [178].The method according to any of [1] to [177], wherein the hydrogen (% H) content of treated powder or powder mixture after the preconditioning step is between 1 and 29000 ppm. [179].The method according to any of [1] to [178], wherein the boron (% B) content of the treated powder or powder mixture after the preconditioning step is between 1 ppm and 0.9 wt %. [180].The method according to any of [1] to [179], wherein the method further comprises the step of: applying a spheroidization treatment to the treated powder or powder mixture. [181].The method according to any of [1] to [180], wherein the spheroidization treatment is performed at any time between the treatment of the powder or powder mixture and the shaping of the treated powder or powder mixture using a metal additive manufacturing (MAM) method. [182].The method according to any of [1] to [181], wherein the increase in sphericity after the application of the spheroidization treatment is at least 6%. [183].The method according to any of [1] to [182], wherein the sphericity of the treated powder of powder mixture prior to the application of the spheroidization treatment is a low sphericity, wherein a low sphericity is a sphericity of 69% or less and the sphericity of the treated powder of powder mixture after the application of the spheroidization treatment is a right sphericity, wherein a right sphericity is a sphericity of 71% or more. [184].The method according to any of [1] to [183], wherein the spheroidization of the powder is performed by mechanical action. [185].The method according to any of [1] to [184], wherein the spheroidization of the powder is performed without significantly increasing the temperature of the powder. [186].The method according to any of [1] to [185], wherein the temperature in the spheroidization treatment is 0.75*Tm or less, being Tm the melting temperature in Kelvin of the powder being processed. [187].The method according to any of [1] to [186], wherein the method further comprises the step of: applying a spheroidization treatment which is performed at any time between the treatment of the powder or powder mixture and the shaping of the treated powder or powder mixture using a metal additive manufacturing (MAM) method, and wherein the temperature in the spheroidization treatment is 0.75*Tm or less, being Tm the melting temperature in Kelvin of the powder being processed. [188].The method according to any of [1] to [187], wherein the spheroidization treatment comprises placing the powder between two flat parallel plates which have a relative movement between them in the plane of parallelism. [189].The method according to any of [1] to [188], wherein the method further comprises the step of: adding at least one substance or material to the treated powder or powder mixture prior to applying the metal additive manufacturing (MAM) method. [190].The method according to any of [1] to [189], wherein the substance or material added is selected from metallic materials, metals, metal-based alloys, organic materials, polymers, polymeric materials, binders, fluxes, lubricants, additives, graphite, ceramic materials, reinforcement particles, ceramic particles, whiskers, graphene, nanotubes, carbon nanotubes and/or mixtures thereof. [191].The method according to any of [1] to [190], wherein the metal additive manufacturing (MAM) method is performed at a right temperature (as defined in this document). [192].The method according to any of [1] to [191], wherein the metal additive manufacturing (MAM) method is performed at a right temperature, wherein a right temperature is a temperature between 0.08*Tm and 0.74*Tm, being Tm the melting temperature in Kelvin of the powder or powder mixture. [193].The method according to any of [1] to [192], wherein the metal additive manufacturing (MAM) method is performed at a right temperature, wherein a right temperature is a temperature between 0.08*Tm and 0.74*Tm, being Tm the melting temperature in Kelvin of the metallic powder with the lowest melting point in the powder of powder mixture provided. [194].The method according to any of [1] to [193], wherein the melting temperature (Tm) of a metallic powder is the temperature at which the first metal liquid forms under equilibrium conditions. [195].The method according to any of [1] to [194], wherein the step of shaping the treated powder or powder mixture using a metal additive manufacturing (MAM) method is performed at a right temperature, wherein a right temperature is a temperature between 0.08*Tm and 0.74*Tm, being Tm the melting temperature in Kelvin of the metallic powder with the lowest melting point in the powder of powder mixture provided, wherein the melting temperature of such metallic powder is the temperature at which the first metal liquid forms under equilibrium conditions. [196].The method according to any of [1] to [195], wherein the step of shaping the treated powder or powder mixture using a metal additive manufacturing (MAM) method is performed at a right temperature, wherein a right temperature is a temperature between 0.08*Tm and 0.74*Tm, being Tm the melting temperature in Kelvin of the metallic powder, which is at least 2.6% by weight of all the metallic powders in the powder or powder mixture provided, with the lowest melting point, wherein the melting temperature of such metallic powder is the temperature at which the first metal liquid forms under equilibrium conditions. [197].The method according to any of [1] to [196], wherein the step of shaping the treated powder or powder mixture using a metal additive manufacturing (MAM) method is performed at a right temperature, wherein a right temperature is a temperature between 0.08*Tm and 0.74*Tm, being Tm the melting temperature in Kelvin of the metallic powder, which is at least 6% by weight of all the metallic powders in the powder or powder mixture provided, with the lowest melting point, wherein the melting temperature of such metallic powder is the temperature at which the first metal liquid forms under equilibrium conditions. [198].The method according to any of [1] to [197], wherein the step of shaping the treated powder or powder mixture using a metal additive manufacturing (MAM) method is performed at a right temperature, wherein a right temperature is a temperature between 0.08*Tm and 0.74*Tm, being Tm the melting temperature in Kelvin of the metallic powder with the highest melting point in the powder of powder mixture provided, wherein the melting temperature of such metallic powder is the temperature at which the first metal liquid forms under equilibrium conditions. [199].The method according to any of [1] to [198], wherein the step of shaping the treated powder or powder mixture using a metal additive manufacturing (MAM) method is performed at a right temperature, wherein a right temperature is a temperature between 0.08*Tm and 0.74*Tm, being Tm the melting temperature in Kelvin of the metallic powder, which is at least 2.6% by weight of all the metallic powders in the powder or powder mixture provided, with the highest melting point, wherein the melting temperature of such metallic powder is the temperature at which the first metal liquid forms under equilibrium conditions. [200].The method according to any of [1] to [199], wherein the step of shaping the treated powder or powder mixture using a metal additive manufacturing (MAM) method is performed at a right temperature, wherein a right temperature is a temperature between 0.08*Tm and 0.74*Tm, being Tm the melting temperature in Kelvin of the metallic powder, which is at least 6% by weight of all the metallic powders in the powder or powder mixture provided, with the highest melting point, wherein the melting temperature of such metallic powder is the temperature at which the first metal liquid forms under equilibrium conditions. [201].The method according to any of [1] to [200], wherein the step of shaping the treated powder or powder mixture using a metal additive manufacturing (MAM) method is performed at a right temperature and wherein the lower limit of the right temperature is calculated using the following formula:

$$A * [ ( \frac{Tm - Tm ( Fe )}{{Tm ( Fe )}^{3}} ) + Tm ( Fe ] ,$$

wherein Tm (Fe) is the melting temperature of iron (under equilibrium conditions) expressed in Kelvin and A is a parameter selected, in different embodiments, from 3/23, 5/42 and even 4/29. [202].The method according to any of [1] to [201], wherein the step of shaping the treated powder or powder mixture using a metal additive manufacturing (MAM) method is performed at a right temperature and wherein the upper limit of the right temperature is a temperature of 0.74*Tm, being Tm the melting temperature in Kelvin of the powder or powder mixture provided. [203].The method according to any of [1] to [202], wherein the step of shaping the treated powder or powder mixture using a metal additive manufacturing (MAM) method is performed at a right temperature and wherein the upper limit of the right temperature is a temperature of 0.74*Tm, being Tm the melting temperature in Kelvin of the powder or powder mixture provided. [204].The method according to any of [1] to [203], wherein the step of shaping the treated powder or powder mixture using a metal additive manufacturing (MAM) method comprises: providing a mold; filling the mold with the treated powder or powder mixture; and applying a pressure and/or temperature treatment to the filled mold. [205].The method according to any of [1] to [204], wherein the step of shaping the treated powder or powder mixture using a metal additive manufacturing (MAM) method comprises: providing a mold wherein the mold is made of a material comprising a polymeric material; filling the mold with the treated powder or powder mixture; and applying a pressure and/or temperature treatment to the filled mold. [206].The method according to any of [1] to [205], wherein the step of shaping the treated powder or powder mixture using a metal additive manufacturing (MAM) method comprises: providing a mold at least partly manufactured using an additive manufacturing (AM) technology, wherein the mold is made of a material comprising a polymeric material; filling the mold with the treated powder or powder mixture; and applying a pressure and/or temperature treatment to the filled mold. [207].The method according to any of [1] to [206], wherein the mold is made of a material comprising organic materials, polymers, polymeric materials, elastomers, thermosetting polymers, thermoplastic polymers, amorphous polymers, amorphous thermoplastic polymers, non-polar polymers, crystalline polymers, semi-crystalline polymers, semi-crystalline thermoplastic polymers and/or mixtures thereof. [208].The method according to any of [1] to [207], wherein the mold is made of a material comprising a polymeric material. [209].The method according to any of [1] to [208], wherein the mold is made of a material consisting of a polymeric material. [210].The method according to any of [1] to [209], wherein the mold is made of a material comprising a polymer. [211].The method according to any of [1] to [210], wherein the mold is made of a material consisting of a polymer. [212].The method according to any of [1] to [211], wherein the mold is made from at least two different materials. [213].The method according to any of [1] to [212], wherein the technology used to manufacture the mold, or at least part of the mold is selected from additive manufacturing (AM), conventional polymer shaping technologies such as, blow molding, extrusion, injection molding, pultrusion, rotomolding, filament winding, thermoforming, compression molding, and/or combinations thereof. [214].The method according to any of [1] to [213], wherein the technology used to manufacture the mold, or at least part of the mold is a conventional polymer shaping technology and/or an additive manufacturing technology selected from FDM, FFF, SLA, SHS, DLP, CDLP, DLS, a technology based on CLIP, MJ, DOD, MJF, BJ, SLS and/or combinations thereof. [215].The method according to any of [1] to [214], wherein at least part of the mold is manufactured using an additive manufacturing (AM) technology. [216].The method according to any of [1] to [215], wherein at least part of the mold is manufactured using an additive manufacturing (AM) technology selected from FDM, FFF, SLA, SHS, DLP, CDLP, DLS, a technology based on CLIP, MJ, DOD, MJF, BJ, SLS and/or combinations thereof. [217].The method according to any of [1] to [216], wherein the mold is manufactured using at least two different manufacturing technologies. [218].The method according to any of [1] to [217], wherein the mold comprises at least two parts assembled together. [219].The method according to any of [1] to [218], wherein the mold comprises elements that are not required to provide the shape to the powder or powder mixture. [220].The method according to any of [1] to [219], wherein the mold comprises support elements. [221].The method according to any of [1] to [220], wherein the mold comprises support elements made from a different material. [222].The method according to any of [1] to [221], wherein the filling density of the mold is between 51% and 96%. [223].The method according to any of [1] to [222], wherein the mold is vibrated during at least part of the filling with the treated powder or powder mixture. [224].The method according to any of [1] to [223], wherein the filled mold is sealed. [225].The method according to any of [1] to [224], wherein a cover mold is placed over at least part of the filled mold. [226].The method according to any of [1] to [225], wherein a controlled high vacuum is applied to the filled mold using the cover mold as a vacuum tight container, wherein the controlled high vacuum is between 0.9 mbar and 10-10 mbar. [227].The method according to any of [1] to [226], wherein the pressure and/or temperature treatment comprises the application of a pressure between 6 and 2100 MPa. [228].The method according to any of [1] to [227], wherein the maximum pressure applied in the pressure and/or temperature treatment is between 105 and 2100 MPa. [229].The method according to any of [1] to [228], wherein the pressure is applied continuously. [230].The method according to any of [1] to [229], wherein the pressure is applied in a stepwise manner. [231].The method according to any of [1] to [230], wherein the pressure is increased and/or released more than once during the treatment. [232].The method according to any of [1] to [231], wherein the pressure and/or temperature treatment comprises the application of a temperature between 0.16*Tm and 0.94*Tm, being Tm the melting temperature in Kelvin of the powder or powder mixture provided. [233].The method according to any of [1] to [232], wherein the pressure and/or temperature treatment comprises the application of a temperature between 0.16*Tm and 0.94*Tm, being Tm the melting temperature in Kelvin of the metallic powder with the lowest melting point in the powder of powder mixture provided. [234].The method according to any of [1] to [233], wherein the pressure and/or temperature treatment comprises the application of a temperature between 0.16*Tm and 0.94*Tm, being Tm the melting temperature in Kelvin of the metallic powder, which is at least 2.6% by weight of all the metallic powders in the powder or powder mixture provided, with the lowest melting point, wherein the melting temperature of such metallic powder is the temperature at which the first metal liquid forms under equilibrium conditions. [235].The method according to any of [1] to [234], wherein the pressure and/or temperature treatment comprises the application of a temperature between 0.16*Tm and 0.94*Tm, being Tm the melting temperature in Kelvin of the metallic powder, which is at least 6% by weight of all the metallic powders in the powder or powder mixture provided, with the lowest melting point, wherein the melting temperature of such metallic powder is the temperature at which the first metal liquid forms under equilibrium conditions. [236].The method according to any of [1] to [235], wherein the pressure and/or temperature treatment comprises the application of a temperature between 0.16*Tm and 0.94*Tm, being Tm the melting temperature in Kelvin of the metallic powder, which is at least 2.6% by weight of all the metallic powders in the powder or powder mixture provided, with the highest melting point, wherein the melting temperature of such metallic powder is the temperature at which the first metal liquid forms under equilibrium conditions. [237].The method according to any of [1] to [236], wherein the pressure and/or temperature treatment comprises the application of a temperature between 0.16*Tm and 0.94*Tm, being Tm the melting temperature in Kelvin of the metallic powder, which is at least 2.6% by weight of all the metallic powders in the powder or powder mixture provided, with the highest melting point, wherein the melting temperature of such metallic powder is the temperature at which the first metal liquid forms under equilibrium conditions. [238].The method according to any of [1] to [237], wherein the pressure and/or temperature treatment comprises the application of a temperature between −14° C. and 649° C. [239].The method according to any of [1] to [238], wherein the maximum temperature applied in the pressure and/or temperature treatment is between 26° C. and 995° C. [240].The method according to any of [1] to [239], wherein the minimum temperature applied in the pressure and/or temperature treatment is between −51° C. and 99° C. [241].The method according to any of [1] to [240], wherein the temperature is applied continuously. [242].The method according to any of [1] to [241], wherein the temperature is applied in a stepwise manner. [243].The method according to any of [1] to [242], wherein the temperature is increased and/or released more than once during the treatment. [244].The method according to any of [1] to [243], wherein the pressure and/or temperature treatment comprises the application of a temperature between 0.16*Tm and 0.94*Tm, being Tm the melting temperature in Kelvin of the powder or powder mixture provided, and a pressure between 6 and 2100 MPa. [245].The method according to any of [1] to [244], wherein the pressure and/or temperature treatment comprises the application of a temperature between 0.16*Tm and 0.94*Tm, being Tm the melting temperature in Kelvin of the metallic powder with the lowest melting point in the powder of powder mixture provided, and a pressure between 6 and 2100 MPa. [246].The method according to any of [1] to [245], wherein the pressure and/or temperature treatment comprises the application of a temperature between 0.16*Tm and 0.94*Tm, being Tm the melting temperature in Kelvin of the metallic powder, which is at least 2.6% by weight of all the metallic powders in the powder or powder mixture provided, with the lowest melting point, wherein the melting temperature of such metallic powder is the temperature at which the first metal liquid forms under equilibrium conditions, and a pressure between 6 and 2100 MPa. [247].The method according to any of [1] to [246], wherein the pressure and/or temperature treatment comprises the application of a temperature between 0.16*Tm and 0.94*Tm, being Tm the melting temperature in Kelvin of the metallic powder, which is at least 2.6% by weight of all the metallic powders in the powder or powder mixture provided, with the lowest melting point, wherein the melting temperature of such metallic powder is the temperature at which the first metal liquid forms under equilibrium conditions, and a pressure between 6 and 2100 MPa. [248].The method according to any of [1] to [247], wherein the pressure and/or temperature treatment comprises the application of a temperature between 0.16*Tm and 0.94*Tm, being Tm the melting temperature in Kelvin of the metallic powder, which is at least 2.6% by weight of all the metallic powders in the powder or powder mixture provided, with the highest melting point, wherein the melting temperature of such metallic powder is the temperature at which the first metal liquid forms under equilibrium conditions, and a pressure between 6 and 2100 MPa. [249].The method according to any of [1] to [248], wherein the pressure and/or temperature treatment comprises the application of a temperature between 0.16*Tm and 0.94*Tm, being Tm the melting temperature in Kelvin of the metallic powder, which is at least 2.6% by weight of all the metallic powders in the powder or powder mixture provided, with the highest melting point, wherein the melting temperature of such metallic powder is the temperature at which the first metal liquid forms under equilibrium conditions, and a pressure between 6 and 2100 MPa. [250].The method according to any of [1] to [249], wherein the pressure and/or temperature treatment comprises the following steps: step i) subjecting the mold to high pressure; step ii) while keeping a high pressure level, raising the temperature of the mold; step iii) while keeping a high enough temperature, releasing at least some of the to the mold applied pressure. [251].The method according to any of [1] to [250], wherein the maximum pressure applied in step i) is between 12 MPa and 790 MPa. [252].The method according to any of [1] to [251], wherein a high enough temperature in step iii) is between 320K and 790K. [253].The method according to any of [1] to [252], wherein steps ii) and/or iii) are skipped. [254].The method according to any of [1] to [253], wherein the pressure and/or temperature treatment comprises applying the pressure and temperature on a staircase fashion, comprising the following steps: step A1: raising the pressure at a high enough level while keeping the temperature low enough; step B1: raising the temperature to a certain level and keeping it in that level for a given time; step C1: raising the pressure to a certain level and keeping it at that level for a given time; step D1 (optional): repeating step B1, C1 or both one or more times at different levels of pressure and temperature; step E1 (optional): ensuring that the pressure and temperature are at the level defined for general step i) before proceeding with general step ii). [255].The method according to any of [1] to [254], wherein the high enough pressure level in step A1 is between 55 and 6400 bar. [256].The method according to any of [1] to [255], wherein the low enough temperature level in step A1 is the critical temperature. [257].The method according to any of [1] to [256], wherein the low enough temperature level in step A1 is 190° C. or less. [258].The method according to any of [1] to [257], wherein the upper level for the temperature in step B1 is 2.4 times the critical temperature. [259].The method according to any of [1] to [258], wherein the upper level for the temperature in step B1 is 190° C. [260].The method according to any of [1] to [259], wherein the lower level for the temperature in step B1 is 35° C. [261].The method according to any of [1] to [260], wherein the time for which the temperature is kept at the desired level in step B1 is between 3 minutes and 27 hours. [262].The method according to any of [1] to [261], wherein the time for which the pressure is kept at the desired level in step B1 is between 3 minutes and 26 hours. [263].The method according to any of [1] to [262], wherein the upper pressure level in step C1 is 6400 bar. [264].The method according to any of [1] to [263], wherein the step of shaping the treated powder or powder mixture using a metal additive manufacturing (MAM) method comprises the use of an additive manufacturing (AM) technology to form the component or at least a part of the component. [265].The method according to any of [1] to [264], wherein the additive manufacturing (AM) technology is selected from fused deposition (FDM), fused filament fabrication (FFF), stereolithography (SLA), digital light processing (DLP), continuous digital light processing (CDLP), digital light synthesis (DLS), a technology based on continuous liquid interface production (CLIP), material jetting (MJ), drop on demand (DOD), multi jet fusion (MJF), binder jetting (BJ), laser sintering (SLS), Joule Printing and/or combinations thereof. [266].The method according to any of [1] to [265], wherein the additive manufacturing (AM) technology further comprises the use of an organic material. [267].The method according to any of [1] to [266], wherein the method further comprises the step of applying a debinding treatment to eliminate at least part of the organic material. [268].The method according to any of [1] to [267], wherein the debinding treatment comprises the use of a thermal debinding. [269].The method according to any of [1] to [268], wherein the debinding treatment comprises the use of a non-thermal debinding. [270].The method according to any of [1] to [269], wherein the debinding treatment comprises the use of a solvent. [271].The method according to any of [1] to [270], wherein the debinding treatment is performed simultaneously with other method steps. [272].The method according to any of [1] to [271], wherein at least two cycles of the debinding treatment are applied. [273].The method according to any of [1] to [272], wherein the method further comprises the step of: applying a pressure and/or temperature treatment. [274].The method according to any of [1] to [273], wherein the pressure and/or temperature treatment is applied to the component obtained after applying the metal additive manufacturing (MAM) method. [275].The method according to any of [1] to [274], wherein the pressure and/or temperature treatment is applied before the application of a debinding treatment. [276].The method according to any of [1] to [275], wherein the pressure and/or temperature treatment is applied before and/or during the application of a debinding treatment. [277].The method according to any of [1] to [276], wherein the method further comprises the step of applying a pressure and/or temperature treatment after the application of a debinding treatment. [278].The method according to any of [1] to [277], wherein the pressure and/or temperature treatment comprises the application of a pressure between 6 and 2100 MPa. [279].The method according to any of [1] to [278], wherein the maximum pressure applied in the pressure and/or temperature treatment is between 105 and 2100 MPa. [280].The method according to any of [1] to [279], wherein the step of shaping the treated powder or powder mixture using a metal additive manufacturing (MAM) method comprises the use of an additive manufacturing (AM) technology to form the component or at least a part of the component, wherein the additive manufacturing (AM) technology further comprises the use of an organic material, and wherein the method further comprises the step of applying a pressure and/or temperature treatment, said treatment comprising the application of a pressure between 6 and 2100 MPa, and wherein the pressure and/or temperature treatment is applied before and/or during the application of a debinding treatment. [281].The method according to any of [1] to [280], wherein the pressure is applied continuously. [282].The method according to any of [1] to [281], wherein the pressure is applied in a stepwise manner. [283].The method according to any of [1] to [282], wherein the pressure is increased and/or released more than once during the treatment. [284].The method according to any of [1] to [283], wherein the pressure and/or temperature treatment comprises the application of a temperature between 0.16*Tm and 0.94*Tm, being Tm the melting temperature in Kelvin of the powder or powder mixture. [285].The method according to any of [1] to [284], wherein the pressure and/or temperature treatment comprises the application of a temperature between −14° C. and 649° C. [286].The method according to any of [1] to [285], wherein the maximum temperature applied in the pressure and/or temperature treatment is between 26° C. and 995° C. [287].The method according to any of [1] to [286], wherein the minimum temperature applied in the pressure and/or temperature treatment is between −51° C. and 99° C. [288].The method according to any of [1] to [287], wherein the temperature is applied continuously. [289].The method according to any of [1] to [288], wherein the temperature is applied in a stepwise manner. [290].The method according to any of [1] to [289], wherein the temperature is increased and/or released more than once during the treatment. [291].The method according to any of [1] to [290], wherein the pressure and/or temperature treatment comprises the application of a temperature between 0.16*Tm and 0.94*Tm, being Tm the melting temperature in Kelvin of the powder or powder mixture provided, and a pressure between 6 and 2100 MPa. [292].The method according to any of [1] to [291], wherein the pressure and/or temperature treatment comprises the application of a temperature between 0.16*Tm and 0.94*Tm, being Tm the melting temperature in Kelvin of the metallic powder with the lowest melting point in the powder of powder mixture provided, and a pressure between 6 and 2100 MPa. [293].The method according to any of [1] to [292], wherein the pressure and/or temperature treatment comprises the application of a temperature between 0.16*Tm and 0.94*Tm, being Tm the melting temperature in Kelvin of the metallic powder, which is at least 2.6% by weight of all the metallic powders in the powder or powder mixture provided, with the lowest melting point, wherein the melting temperature of such metallic powder is the temperature at which the first metal liquid forms under equilibrium conditions, and a pressure between 6 and 2100 MPa. [294].The method according to any of [1] to [293], wherein the pressure and/or temperature treatment comprises the application of a temperature between 0.16*Tm and 0.94*Tm, being Tm the melting temperature in Kelvin of the metallic powder, which is at least 2.6% by weight of all the metallic powders in the powder or powder mixture provided, with the lowest melting point, wherein the melting temperature of such metallic powder is the temperature at which the first metal liquid forms under equilibrium conditions, and a pressure between 6 and 2100 MPa. [295].The method according to any of [1] to [294], wherein the pressure and/or temperature treatment comprises the application of a temperature between 0.16*Tm and 0.94*Tm, being Tm the melting temperature in Kelvin of the metallic powder, which is at least 2.6% by weight of all the metallic powders in the powder or powder mixture provided, with the highest melting point, wherein the melting temperature of such metallic powder is the temperature at which the first metal liquid forms under equilibrium conditions, and a pressure between 6 and 2100 MPa. [296].The method according to any of [1] to [295], wherein the pressure and/or temperature treatment comprises the application of a temperature between 0.16*Tm and 0.94*Tm, being Tm the melting temperature in Kelvin of the metallic powder, which is at least 2.6% by weight of all the metallic powders in the powder or powder mixture provided, with the highest melting point, wherein the melting temperature of such metallic powder is the temperature at which the first metal liquid forms under equilibrium conditions, and a pressure between 6 and 2100 MPa. [297].The method according to any of [1] to [296], wherein the pressure and/or temperature treatment comprises the following steps: step i) subjecting the component to high pressure; step ii) while keeping a high pressure level, raising the temperature of the component; step iii) while keeping a high enough temperature, releasing at least some of the to the component applied pressure. [298].The method according to any of [1] to [297], wherein the maximum pressure applied in step i) is between 12 MPa and 790 MPa. [299].The method according to any of [1] to [298], wherein a high enough temperature in step iii) is between 320K and 790K. [300].The method according to any of [1] to [299], wherein steps ii) and/or iii) are skipped. [301].The method according to any of [1] to [300], wherein the pressure and/or temperature treatment comprises applying the pressure and temperature on a staircase fashion, comprising the following steps: step A1: raising the pressure at a high enough level while keeping the temperature low enough; step B1: raising the temperature to a certain level and keeping it in that level for a given time; step C1: raising the pressure to a certain level and keeping it at that level for a given time; step D1 (optional): repeating step B1, C1 or both one or more times at different levels of pressure and temperature; step E1 (optional): ensuring that the pressure and temperature are at the level defined for general step i) before proceeding with general step ii). [302].The method according to any of [1] to [301], wherein the high enough pressure level in step A1 is between 55 and 6400 bar. [303].The method according to any of [1] to [302], wherein the low enough temperature level in step A1 is the critical temperature. [304].The method according to any of [1] to [303], wherein the low enough temperature level in step A1 is 190° C. or less. [305].The method according to any of [1] to [304], wherein the upper level for the temperature in step B1 is 2.4 times the critical temperature. [306].The method according to any of [1] to [305], wherein the upper level for the temperature in step B1 is 190° C. [307].The method according to any of [1] to [306], wherein the lower level for the temperature in step B1 is 35° C. [308].The method according to any of [1] to [307], wherein the time for which the temperature is kept at the desired level in step B1 is between 3 minutes and 27 hours. [309].The method according to any of [1] to [308], wherein the time for which the pressure is kept at the desired level in step B1 is between 3 minutes and 26 hours. [310].The method according to any of [1] to [309], wherein the upper pressure level in step C1 is 6400 bar. [311].The method according to any of [1] to [310], wherein the method further comprises the step of applying a fixing step for setting the % C, % O, % N, % H and/or % B levels in the metallic part of the component. [312].The method according to any of [1] to [311], wherein the fixing step is performed in a properly designed atmosphere. [313].The method according to any of [1] to [312], wherein the metallic part of the component comprises a right % C content after the fixing step, wherein a right % C content is a carbon content between 0.06 wt % and 3.9 wt %. [314].The method according to any of [1] to [313], wherein the metallic part of the component comprises a right % O content after the fixing step, wherein a right % O content is an oxygen content is between 16 and 19000 ppm. [315].The method according to any of [1] to [314], wherein the metallic part of the component comprises a right % N after the fixing step, wherein a right % N content is a nitrogen content between 1 ppm and 0.19 wt %. [316].The method according to any of [1] to [315], wherein the metallic part of the component comprises a right % H after the fixing step, wherein a right % H content is a hydrogen content between 0.6 and 5400 ppm. [317].The method according to any of [1] to [316], wherein the metallic part of the component comprises a right % B after the fixing step, wherein a right % B content is a boron content between 0.7 ppm and 0.24 wt %. [318].The method according to any of [1] to [317], wherein the fixing step is performed simultaneously with other method steps. [319].The method according to any of [1] to [318], wherein the method further comprises the step of: applying a treatment selected from carburizing, boriding, nitriding and/or combinations thereof. [320].The method according to any of [1] to [319], wherein the method further comprises the step of: applying a consolidation treatment. [321].The method according to any of [1] to [320], wherein the consolidation treatment comprises the use of a properly designed atmosphere. [322].The method according to any of [1] to [321], wherein the consolidation treatment is performed simultaneously with other method steps. [323].The method according to any of [1] to [322], wherein the consolidation treatment comprises the application of a temperature between 0.36*Tm and 0.88*Tm, being Tm the melting temperature in Kelvin of the powder or powder mixture. [324].The method according to any of [1] to [323], wherein the consolidation treatment comprises the application of a temperature between 0.36*Tm and 0.88*Tm, being Tm the melting temperature in Kelvin of the powder or powder mixture provided. [325].The method according to any of [1] to [324], wherein the consolidation treatment comprises the application of a temperature between 0.36*Tm and 0.88*Tm, being Tm the melting temperature in Kelvin of the metallic powder with the lowest melting point in the powder of powder mixture provided. [326].The method according to any of [1] to [325], wherein the consolidation treatment comprises the application of a temperature between 0.36*Tm and 0.88*Tm, being Tm the melting temperature in Kelvin of the metallic powder, which is at least 2.6% by weight of all the metallic powders in the powder or powder mixture provided, with the lowest melting point, wherein the melting temperature of such metallic powder is the temperature at which the first metal liquid forms under equilibrium conditions. [327].The method according to any of [1] to [326], wherein the consolidation treatment comprises the application of a temperature between 0.36*Tm and 0.88*Tm, being Tm the melting temperature in Kelvin of the metallic powder, which is at least 2.6% by weight of all the metallic powders in the powder or powder mixture provided, with the lowest melting point, wherein the melting temperature of such metallic powder is the temperature at which the first metal liquid forms under equilibrium conditions. [328].The method according to any of [1] to [327], wherein the consolidation treatment comprises the application of a temperature between 0.36*Tm and 0.88*Tm, being Tm the melting temperature in Kelvin of the metallic powder, which is at least 2.6% by weight of all the metallic powders in the powder or powder mixture provided, with the highest melting point, wherein the melting temperature of such metallic powder is the temperature at which the first metal liquid forms under equilibrium conditions. [329].The method according to any of [1] to [328], wherein the consolidation treatment comprises the application of a temperature between 0.36*Tm and 0.88*Tm, being Tm the melting temperature in Kelvin of the metallic powder, which is at least 2.6% by weight of all the metallic powders in the powder or powder mixture provided, with the highest melting point, wherein the melting temperature of such metallic powder is the temperature at which the first metal liquid forms under equilibrium conditions. [330].The method according to any of [1] to [329], wherein the consolidation treatment comprises the application of a temperature between 0.96*Tm and 1.9*Tm, being Tm the melting temperature in Kelvin of the powder or powder mixture. [331].The method according to any of [1] to [330], wherein the consolidation treatment comprises the application of a temperature between 0.96*Tm and 1.9*Tm, being Tm the melting temperature in Kelvin of the metallic powder with the lowest melting point in the powder of powder mixture provided. [332].The method according to any of [1] to [331], wherein the consolidation treatment comprises the application of a temperature between 0.96*Tm and 1.9*Tm, being Tm the melting temperature in Kelvin of the metallic powder, which is at least 2.6% by weight of all the metallic powders in the powder or powder mixture provided, with the lowest melting point, wherein the melting temperature of such metallic powder is the temperature at which the first metal liquid forms under equilibrium conditions. [333].The method according to any of [1] to [332], wherein the consolidation treatment comprises the application of a temperature between 0.96*Tm and 1.9*Tm, being Tm the melting temperature in Kelvin of the metallic powder, which is at least 2.6% by weight of all the metallic powders in the powder or powder mixture provided, with the lowest melting point, wherein the melting temperature of such metallic powder is the temperature at which the first metal liquid forms under equilibrium conditions. [334].The method according to any of [1] to [333], wherein the consolidation treatment comprises the application of a temperature between 0.96*Tm and 1.9*Tm, being Tm the melting temperature in Kelvin of the metallic powder, which is at least 2.6% by weight of all the metallic powders in the powder or powder mixture provided, with the highest melting point, wherein the melting temperature of such metallic powder is the temperature at which the first metal liquid forms under equilibrium conditions. [335].The method according to any of [1] to [334], wherein the consolidation treatment comprises the application of a temperature between 0.96*Tm and 1.9*Tm, being Tm the melting temperature in Kelvin of the metallic powder, which is at least 2.6% by weight of all the metallic powders in the powder or powder mixture provided, with the highest melting point, wherein the melting temperature of such metallic powder is the temperature at which the first metal liquid forms under equilibrium conditions. [336].The method according to any of [1] to [335], wherein the consolidation treatment comprises the application of a temperature between Tm+1 and Tm+290, being Tm the melting temperature in Kelvin of the powder or powder mixture. [337].The method according to any of [1] to [336], wherein the maximum liquid phase during the consolidation treatment is between 0.2% and 39% by volume. [338].The method according to any of [1] to [337], wherein the consolidation treatment comprises the application of a pressure between 1 mbar and 4900 bar. [339].The method according to any of [1] to [338], wherein the consolidation treatment is made under vacuum. [340].The method according to any of [1] to [339], wherein the method further comprises the step of: applying a consolidation treatment, wherein the consolidation treatment comprises the application of a pressure between 1 mbar and 4900 bar and a temperature between 0.36*Tm and 0.88*Tm, being Tm the melting temperature in Kelvin of the powder or powder mixture provided. [341].The method according to any of [1] to [340], wherein the method further comprises the step of: applying a consolidation treatment, wherein the consolidation treatment comprises the application of a pressure between 1 mbar and 4900 bar and a temperature between 0.36*Tm and 0.88*Tm, being Tm the melting temperature in Kelvin of the metallic powder with the lowest melting point in the powder of powder mixture provided [342].The method according to any of [1] to [341], wherein the method further comprises the step of: applying a consolidation treatment, wherein the consolidation treatment comprises the application of a pressure between 1 mbar and 4900 bar and a temperature between 0.36*Tm and 0.88*Tm, being Tm the melting temperature in Kelvin of the metallic powder, which is at least 2.6% by weight of all the metallic powders in the powder or powder mixture provided, with the lowest melting point, wherein the melting temperature of such metallic powder is the temperature at which the first metal liquid forms under equilibrium conditions [343].The method according to any of [1] to [342], wherein the method further comprises the step of: applying a consolidation treatment, wherein the consolidation treatment comprises the application of a pressure between 1 mbar and 4900 bar and a temperature between 0.36*Tm and 0.88*Tm, being Tm the melting temperature in Kelvin of the metallic powder, which is at least 6% by weight of all the metallic powders in the powder or powder mixture provided, with the lowest melting point, wherein the melting temperature of such metallic powder is the temperature at which the first metal liquid forms under equilibrium conditions. [344].The method according to any of [1] to [343], wherein the method further comprises the step of: applying a consolidation treatment, wherein the consolidation treatment comprises the application of a pressure between 1 mbar and 4900 bar and a temperature between 0.36*Tm and 0.88*Tm, being Tm the melting temperature in Kelvin of the metallic powder, which is at least 2.6% by weight of all the metallic powders in the powder or powder mixture provided, with the highest melting point, wherein the melting temperature of such metallic powder is the temperature at which the first metal liquid forms under equilibrium conditions. [345].The method according to any of [1] to [344], wherein the method further comprises the step of: applying a consolidation treatment, wherein the consolidation treatment comprises the application of a pressure between 1 mbar and 4900 bar and a temperature between 0.36*Tm and 0.88*Tm, being Tm the melting temperature in Kelvin of the metallic powder, which is at least 6% by weight of all the metallic powders in the powder or powder mixture provided, with the highest melting point, wherein the melting temperature of such metallic powder is the temperature at which the first metal liquid forms under equilibrium conditions. [346].The method according to any of [1] to [345], wherein the consolidation treatment comprises the following steps: Step 1i: raising the temperature while keeping a low pressure; Step 2i: keeping the temperature at a high level while keeping the pressure at a low level for a long enough time period; Step 3i: raising the pressure to a high level; Step 4i: keeping a high pressure and high temperature for a long enough time period. [347].The method according to any of [1] to [346], wherein the consolidation treatment comprises the use of several cycles. [348].The method according to any of [1] to [347], wherein the method further comprises the step of: joining different parts to make a bigger component. [349].The method according to any of [1] to [348], wherein the method further comprises the step of: joining different parts to make a bigger component after and/or before applying the consolidation treatment. [350].The method according to any of [1] to [349], wherein the method further comprises the step of: applying a densification treatment. [351].The method according to any of [1] to [350], wherein the densification treatment comprises the use of a properly designed atmosphere. [352].The method according to any of [1] to [351], wherein the densification treatment is performed simultaneously with other method steps. [353].The method according to any of [1] to [352], wherein the densification treatment comprises the application of a pressure between 160 and 4900 bar. [354].The method according to any of [1] to [353], wherein the densification treatment comprises the application of a temperature between 0.45*Tm and 0.92*Tm, being Tm the melting temperature in Kelvin of the powder or powder mixture. [355].The method according to any of [1] to [354], wherein the method further comprises the step of: applying a densification treatment, wherein the densification treatment comprises the application of a pressure between 160 and 4900 bar and a temperature between 0.45*Tm and 0.92*Tm, being Tm the melting temperature in Kelvin of the metallic powder with the lowest melting point in the powder of powder mixture provided. [356].The method according to any of [1] to [355], wherein the method further comprises the step of: applying a densification treatment, wherein the densification treatment comprises the application of a pressure between 160 and 4900 bar and a temperature between 0.45*Tm and 0.92*Tm, being Tm the melting temperature in Kelvin of the metallic powder, which is at least 2.6% by weight of all the metallic powders in the powder or powder mixture provided, with the lowest melting point, wherein the melting temperature of such metallic powder is the temperature at which the first metal liquid forms under equilibrium conditions. [357].The method according to any of [1] to [356], wherein the method further comprises the step of: applying a densification treatment, wherein the densification treatment comprises the application of a pressure between 160 and 4900 bar and a temperature between 0.45*Tm and 0.92*Tm, being Tm the melting temperature in Kelvin of the metallic powder, which is at least 6% by weight of all the metallic powders in the powder or powder mixture provided, with the lowest melting point, wherein the melting temperature of such metallic powder is the temperature at which the first metal liquid forms under equilibrium conditions. [358].The method according to any of [1] to [357], wherein the method further comprises the step of: applying a densification treatment, wherein the densification treatment comprises the application of a pressure between 160 and 4900 bar and a temperature between 0.45*Tm and 0.92*Tm, being Tm the melting temperature in Kelvin of the metallic powder, which is at least 2.6% by weight of all the metallic powders in the powder or powder mixture provided, with the highest melting point, wherein the melting temperature of such metallic powder is the temperature at which the first metal liquid forms under equilibrium conditions. [359].The method according to any of [1] to [358], wherein the method further comprises the step of: applying a densification treatment, wherein the densification treatment comprises the application of a pressure between 160 and 4900 bar and a temperature between 0.45*Tm and 0.92*Tm, being Tm the melting temperature in Kelvin of the metallic powder, which is at least 6% by weight of all the metallic powders in the powder or powder mixture provided, with the highest melting point, wherein the melting temperature of such metallic powder is the temperature at which the first metal liquid forms under equilibrium conditions. [360].The method according to any of [1] to [359], wherein the densification treatment comprises the application of at least two cycles. [361].The method according to any of [1] to [360], wherein the method further comprises the step of: infiltrating at least part of the component with an infiltrate material. [362].The method according to any of [1] to [361], wherein the component comprises at least one infiltration barrier. [363].The method according to any of [1] to [362], wherein the method further comprises the step of: applying a densification treatment after the infiltration. [364].The method according to any of [1] to [363], wherein the method further comprises the step of: applying a thermo-mechanical treatment, a surface conditioning, a machining and/or combinations thereof. [365].The method according to any of [1] to [364], wherein the method further comprises the step of: applying a thermo-mechanical treatment. [366].The method according to any of [1] to [365], wherein the method further comprises the step of: applying a surface conditioning. [367].The method according to any of [1] to [366], wherein the surface conditioning comprises physical and/or chemical modification of at least part of the surface of the component. [368].The method according to any of [1] to [367], wherein the method further comprises the step of: applying a machining. [369].The method according to any of [1] to [368], wherein the manufactured component comprises at least 16% of the atoms of the treated powder or powder mixture. [370].The method according to any of [1] to [369], wherein the manufactured component comprises a material with a grain size of 19.5 microns or less. [371].The method according to any of [1] to [370], wherein the metal comprising component comprises a material with a proper % C content, wherein a proper % C content is a carbon content between 0.1 wt % and 3.9 wt %. [372].The method according to any of [1] to [371], wherein the metal comprising component comprises a material with a proper % O content, wherein a proper % O content is an oxygen content between 210 and 49000 ppm. [373].The method according to any of [1] to [372], wherein the metal comprising component comprises a material with a proper % N content, wherein a proper % N content is a nitrogen content between 56 ppm and 0.29 wt %. [374].The method according to any of [1] to [373], wherein the metal comprising component comprises a material with a proper % H content, wherein a proper % H content is a hydrogen content between 2 and 8400 ppm. [375].The method according to any of [1] to [374], wherein the metal comprising component comprises a material with a proper % B content, wherein a proper % B content is a boron content between 6 ppm and 0.9 wt %. [376].The method according to any of [1] to [375], wherein the manufactured component comprises a material with a proper remanent induction (Br) between 0.2 and 2.9 T. [377].The method according to any of [1] to [376], wherein the manufactured component comprises a material selected from AlNiCo, α″Fe₁₆N₂ and/or mixtures thereof. [378].The method according to any of [1] to [377], wherein the manufactured component comprises a material comprising α″Fe₁₆N₂ material and an alloy with a melting point below 1090° C. [379].The method according to any of [1] to [378], wherein the manufactured component a material having high mechanical strength and/or yield strength and a predominantly austenitic microstructure. [380].The method according to any of [1] to [379], wherein a high mechanical strength is a mechanical strength of 610 MPa or more. [381].The method according to any of [1] to [380], wherein a high yield strength is a yield strength of 600 MPa or more. [382].The method according to any of [1] to [381], wherein the manufactured component comprises a predominantly austenitic material with a mechanical strength of 610 MPa or more. [383].The method according to any of [1] to [382], wherein the manufactured component comprises a predominantly austenitic material with a yield strength of 600 MPa or more. [384].The method according to any of [1] to [383], wherein the manufactured component comprises a predominantly austenitic Fe-based alloy. [385].The method according to any of [1] to [384], wherein the manufactured component comprises a predominantly austenitic Ni-based alloy. [386].The method according to any of [1] to [385], wherein the manufactured component comprises a predominantly austenitic steel comprising low % Cr and high % N contents. [387].The method according to any of [1] to [386], wherein a predominantly austenitic microstructure is a microstructure comprising at least 22% by volume austenite. [388].The method according to any of [1] to [387], wherein the manufactured component comprises a material having a microstructure comprising at least 22% by volume of austenite and a mechanical strength of 610 MPa or more and/or a yield strength of 600 MPa or more. [389].The method according to any of [1] to [388], wherein the manufactured component comprises a RAFM material having the following composition, all percentages being indicated in weight percent: % C: 0.01-0.29 (preferably from 0.089 to 0.015, more preferably around 0.11); % Cr: 6.6-10.9 (preferably from 8.5 to 9.5); % V: 0.01 to 0.49 (preferably from 0.15 to 0.25); % Ta: 0.001 to 0.8 (preferably from 0.05 to 0.09); % W: 0.1-4.9 (preferably from 1 to 2); % Ti: 0.0001-0.9 (preferably from 0.0001 to 0.09); % Mn: 0.06-1.3 (preferably from 0.3 to 0.6); % P and/or % S: 0.0001 to 0.05 (preferably from 0.0005 to 0.007); % Ni, % Mo, % Cu % Nb, % Al % B, % Co<0.09 (preferably <0.009; more preferably <0.004 and even more preferably <0.0009); % Si: 0.0001-0.29 (preferably from 0.001 to 0.08); % As+% Sn+% Sb+% Zr: 0.0001-0.09 (preferably from 0.005 to 0.05); % N: 0.001-0.12 (preferably from 0.015 to 0.045); % O: 0.0001-1.2 (preferably from 0.0005 to 0.01); % REE+% Sc+% Y: 0-2.9 (preferably from 0 to 0.2); the rest consisting of iron and trace elements, wherein the sum of all trace elements is below 1.4. [390].The method according to any of [1] to [389], wherein the manufactured component comprises an ODS-RAFM material having the following composition, all percentages being indicated in weight percent: % C: 0.01-0.29 (preferably from 0.089 to 0.015, more preferably around 0.11); % Cr: 6.6-10.9 (preferably from 8.5 to 9.5); % V: 0.01 to 0.49 (preferably from 0.15 to 0.25); % Ta: 0.001 to 0.8 (preferably from 0.05 to 0.09); % W: 0.1-4.9 (preferably from 1 to 2); % Ti: 0.0001-0.9 (preferably from 0.01 to 0.4); % Mn: 0.06-1.3 (preferably from 0.3 to 0.6); % P and/or % S: 0.0001 to 0.05 (preferably from 0.0005 to 0.007); % Ni, % Mo, % Cu % Nb, % Al % B, % Co<0.09 (preferably <0.009; more preferably <0.004 and even more preferably <0.0009); % Si: 0.0001-0.29 (preferably from 0.001 to 0.08); % As+% Sn+% Sb+% Zr: 0.0001-0.09 (preferably from 0.005 to 0.05); % N: 0.001-0.12 (preferably from 0.015 to 0.045); % O: 0.0001-1.2 (preferably from 0.03 to 0.4); % REE+% Sc+% Y: 0-2.9 (preferably from 0.12 to 1.4); the rest consisting of iron and trace elements, wherein the sum of all trace elements is below 1.4. [391].The method according to any of [1] to [390], wherein the manufactured component comprises at least a predominantly austenitic steel comprising at least 22% by volume of austenite, with a low % Cr content, between 0.001 and 11.5 wt %, and a high % N content, between 0.003 and 4.9 wt %. [392].The method according to any of [1] to [391], wherein the manufactured component comprises at least one material selected from: a RAFM material having the following composition, all percentages being indicated in weight percent: % C: 0.01-0.29 (preferably from 0.089 to 0.015, more preferably around 0.11); % Cr: 6.6-10.9 (preferably from 8.5 to 9.5); % V: 0.01 to 0.49 (preferably from 0.15 to 0.25); % Ta: 0.001 to 0.8 (preferably from 0.05 to 0.09); % W: 0.1-4.9 (preferably from 1 to 2); % Ti: 0.0001-0.9 (preferably from 0.0001 to 0.09); % Mn: 0.06-1.3 (preferably from 0.3 to 0.6); % P and/or % S: 0.0001 to 0.05 (preferably from 0.0005 to 0.007); % Ni, % Mo, % Cu % Nb, % Al % B, % Co<0.09 (preferably <0.009; more preferably <0.004 and even more preferably <0.0009); % Si: 0.0001-0.29 (preferably from 0.001 to 0.08); % As+% Sn+% Sb+% Zr: 0.0001-0.09 (preferably from 0.005 to 0.05); % N: 0.001-0.12 (preferably from 0.015 to 0.045); % O: 0.0001-1.2 (preferably from 0.0005 to 0.01); % REE+% Sc+% Y: 0-2.9 (preferably from 0 to 0.2); the rest consisting of iron and trace elements, wherein the sum of all trace elements is below 1.4; or an ODS-RAFM material having the following composition, all percentages being indicated in weight percent: % C: 0.01-0.29 (preferably from 0.089 to 0.015, more preferably around 0.11); % Cr: 6.6-10.9 (preferably from 8.5 to 9.5); % V: 0.01 to 0.49 (preferably from 0.15 to 0.25); % Ta: 0.001 to 0.8 (preferably from 0.05 to 0.09); % W: 0.1-4.9 (preferably from 1 to 2); % Ti: 0.0001-0.9 (preferably from 0.01 to 0.4); % Mn: 0.06-1.3 (preferably from 0.3 to 0.6); % P and/or % S: 0.0001 to 0.05 (preferably from 0.0005 to 0.007); % Ni, % Mo, % Cu % Nb, % Al % B, % Co<0.09 (preferably <0.009; more preferably <0.004 and even more preferably <0.0009); % Si: 0.0001-0.29 (preferably from 0.001 to 0.08); % As+% Sn+% Sb+% Zr: 0.0001-0.09 (preferably from 0.005 to 0.05); % N: 0.001-0.12 (preferably from 0.015 to 0.045); % O: 0.0001-1.2 (preferably from 0.03 to 0.4); % REE+% Sc+% Y: 0-2.9 (preferably from 0.12 to 1.4); the rest consisting of iron and trace elements, wherein the sum of all trace elements is below 1.4; or a predominantly austenitic steel comprising at least 22% by volume of austenite, with a low % Cr content, between 0.001 and 11.5 wt %, and a high % N content, between 0.003 and 4.9 wt %. [393].The method according to any of [1] to [392], wherein the manufactured component comprises a material with a % Ti+% Ni+% Cr+% Mo+% W+% Nb+% Ta+% V content of from 0.06 to 10 wt %. [394].The method according to any of [1] to [393], wherein the manufactured component comprises a reduced activation ferritic martensitic (RAFM) steel, a oxide dispersion strengthened (ODS) RAFM steel and/or combinations thereof. [395].The method according to any of [1] to [394], wherein at least part of the manufactured component is subjected to a surface treatment and/or coating selected from boriding, boronizing, Toyota diffusion, VC, CVD PVD, nitriding, carburization, oxidation, sulfonization and/or combinations thereof. [396]. A component at least partly manufactured with a method according to any of [1] to [395], wherein the component comprises a material with a proper % C content, wherein a proper % C content is a carbon content between 0.1 wt % and 3.9 wt %. [397]. A component at least partly manufactured with a method according to any of [1] to [396], wherein the component comprises a material with a proper % O content, wherein a proper % O content is an oxygen content between 210 and 49000 ppm. [398]. A component at least partly manufactured with a method according to any of [1] to [397], wherein the component comprises a material with a proper % N content, wherein a proper % N content is a nitrogen content between 56 ppm and 0.29 wt %. [399]. A component at least partly manufactured with a method according to any of [1] to [398], wherein the component comprises a material with a proper % H content, wherein a proper % H content is a hydrogen content between 2 and 8400 ppm. [400]. A component at least partly manufactured with a method according to any of [1] to [399], wherein the component comprises at least a material with a proper % B content, wherein a proper % B content is a boron content between 6 ppm and 0.9 wt %. [401]. A component at least partly manufactured with a method according to any of [1] to [400], wherein the component comprises a material with a proper Br, wherein a proper Br is a remanent induction between 0.2 and 2.9 T. [402]. A component at least partly manufactured with a method according to any of [1] to [401], wherein the component comprises a material selected from AlNiCo, α″Fe₁₆N₂ and/or mixtures thereof. [403]. A component at least partly manufactured with a method according to any of [1] to [402], wherein the component comprises a material comprising α″Fe₁₆N₂ material and an alloy with a melting point below 1090° C. [404]. A component at least partly manufactured with a method according to any of [1] to [403], wherein the component comprises a material having high mechanical strength and/or yield strength and a predominantly austenitic microstructure. [405].The component according to any of [1] to [404], wherein a high mechanical strength is a mechanical strength of 610 MPa or more. [406].The component according to any of [1] to [405], wherein a high yield strength is a yield strength of 600 MPa or more. [407]. A component at least partly manufactured with a method according to any of [1] to [406], wherein the component comprises a material having a microstructure comprising at least 22% by volume austenite and having a mechanical strength of 610 MPa or more and/or a yield strength of 600 MPa or more. [408]. A component at least partly manufactured with a method according to any of [1] to [407], wherein the component comprises a predominantly austenitic material with a mechanical strength of 610 MPa or more. [409]. A component at least partly manufactured with a method according to any of [1] to [408], wherein the component comprises a predominantly austenitic material with a yield strength of 600 MPa or more. [410]. A component at least partly manufactured with a method according to any of [1] to [409], wherein the component comprises a predominantly austenitic Fe-based alloy. [411].The method according to any of [1] to [410], wherein the manufactured component comprises a predominantly austenitic Ni-based alloy. [412].The method according to any of [1] to [411], wherein the manufactured component is a metal comprising component. [413].The method according to any of [1] to [412], wherein Tm is the melting temperature in Kelvin of the metallic powder with the lowest melting point in the powder of powder mixture provided. [414].The method according to any of [1] to [413], wherein Tm is the melting temperature in Kelvin of the metallic powder with the lowest melting point in the powder of powder mixture provided, wherein the melting temperature of such metallic powder is the temperature at which the first metal liquid forms under equilibrium conditions. [415].The method according to any of [1] to [414], wherein Tm is the melting temperature in Kelvin of the metallic powder, which is at least 2.6% by weight of all the metallic powders in the powder or powder mixture provided, with the lowest melting point, wherein the melting temperature of such metallic powder is the temperature at which the first metal liquid forms under equilibrium conditions. [416].The method according to any of [1] to [415], wherein Tm is the melting temperature in Kelvin of the metallic powder, which is at least 6% by weight of all the metallic powders in the powder or powder mixture provided, with the lowest melting point, wherein the melting temperature of such metallic powder is the temperature at which the first metal liquid forms under equilibrium conditions. [417].The method according to any of [1] to [416], wherein Tm is the melting temperature in Kelvin of the metallic powder, which is at least 2.6% by weight of all the metallic powders in the powder or powder mixture provided, with the highest melting point, wherein the melting temperature of such metallic powder is the temperature at which the first metal liquid forms under equilibrium conditions. [418].The method according to any of [1] to [417], wherein Tm is the melting temperature in Kelvin of the metallic powder, which is at least 6% by weight of all the metallic powders in the powder or powder mixture provided, with the highest melting point, wherein the melting temperature of such metallic powder is the temperature at which the first metal liquid forms under equilibrium conditions. [419].The method according to any of [1] to [418], wherein Tm is the melting temperature in Kelvin of the metallic with the highest volume percentage in the powder or powder mixture provided, wherein the melting temperature of such metallic powder is the temperature at which the first metal liquid forms under equilibrium conditions. [420].The method according to any of [1] to [419], wherein Tm is the melting temperature in Kelvin of the metallic with the highest weight percentage in the powder or powder mixture provided, wherein the melting temperature of such metallic powder is the temperature at which the first metal liquid forms under equilibrium conditions. [421]. A component at least partly manufactured with a method according to any of [1] to [420], wherein the component comprises a predominantly austenitic steel comprising low % Cr and high % N contents. [422]. A component at least partly manufactured with a method according to any of [1] to [421], wherein the component comprises a predominantly austenitic steel comprising a low % Cr content of 11.5 wt % and a high % N content between 0.03 wt % and 4.9 wt %. [423].The component according to any of [1] to [422], wherein a predominantly austenitic microstructure is a microstructure comprising at least 22% by volume of austenite. [424]. A component at least partly manufactured with a method according to any of [1] to [423], wherein the component comprises a material with a % Ti+% Ni+% Cr+% Mo+% W+% Nb+% Ta+% V content of from 0.06 to 10 wt %. [425]. A component at least partly manufactured with a method according to any of [1] to [424], wherein the component comprises at least a material with a grain size of 19.5 microns or less. [426]. A component at least partly manufactured with a method according to any of [1] to [425], wherein the component comprises a reduced activation ferritic martensitic (RAFM) steel, an oxide dispersion strengthened (ODS) RAFM steel and/or combinations thereof. [427]. A component at least partly manufactured with a method according to any of [1] to [426], wherein the component comprises a RAFM material with the following composition, all percentages being indicated in weight percent: % C: 0.01-0.29 (preferably from 0.089 to 0.015, more preferably around 0.11); % Cr: 6.6-10.9 (preferably from 8.5 to 9.5); % V: 0.01 to 0.49 (preferably from 0.15 to 0.25); % Ta: 0.001 to 0.8 (preferably from 0.05 to 0.09); % W: 0.1-4.9 (preferably from 1 to 2); % Ti: 0.0001-0.9 (preferably from 0.0001 to 0.09); % Mn: 0.06-1.3 (preferably from 0.3 to 0.6); % P and/or % S: 0.0001 to 0.05 (preferably from 0.0005 to 0.007); % Ni, % Mo, % Cu % Nb, % Al % B, % Co<0.09 (preferably <0.009; more preferably <0.004 and even more preferably <0.0009); % Si: 0.0001-0.29 (preferably from 0.001 to 0.08); % As+% Sn+% Sb+% Zr: 0.0001-0.09 (preferably from 0.005 to 0.05); % N: 0.001-0.12 (preferably from 0.015 to 0.045); % O: 0.0001-1.2 (preferably from 0.0005 to 0.01); % REE+% Sc+% Y: 0-2.9 (preferably from 0 to 0.2); the rest consisting of iron and trace elements, wherein the sum of all trace elements is below 1.4. [428]. A component at least partly manufactured with a method according to any of [1] to [427], wherein the component comprises a RAFM material with the following composition, all percentages being indicated in weight percent: % C: 0.01-0.29; % Cr: 6.6-10.9; % V: 0.01 to 0.49; % Ta: 0.001 to 0.8 (preferably from 0.05 to 0.09); % W: 0.1-4.9; % Ti: 0.0001-0.9; % Mn: 0.06-1.3; % P and/or % S: 0.0001 to 0.05; % Ni, % Mo, % Cu % Nb, % Al % B, % Co<0.09; % Si: 0.0001-0.29; % As+% Sn+% Sb+% Zr: 0.0001-0.09; % N: 0.001-0.12; % O: 0.0001-1.2; % REE+% Sc+% Y: 0-2.9 (preferably from 0 to 0.2); the rest consisting of iron and trace elements, wherein all trace elements are below 0.9 wt %. [429]. A component at least partly manufactured with a method according to any of [1] to [428], wherein the component comprises a RAFM material with the following composition, all percentages being indicated in weight percent: % C: 0.089 to 0.015; % Cr: 8.5 to 9.5; % V: 0.15 to 0.25; % Ta: 0.05 to 0.09; % W: 1 to 2; % Ti: 0.0001 to 0.09. % Mn: 0.3 to 0.6; % P and/or % S: 0.0005 to 0.007) % Ni, % Mo, % Cu % Nb, % Al % B, % Co<0.009; more preferably <0.004; % Si: 0.001 to 0.08; % As+% Sn+% Sb+% Zr: 0.005 to 0.05; % N: 0.015 to 0.045; % O: 0.0005 to 0.01; % REE+% Sc+% Y: 0 to 0.2; the rest consisting of iron and trace elements, wherein all trace elements are below 0.9 wt %. [430]. A component at least partly manufactured with a method according to any of [1] to [429], wherein the component comprises a ODS-RAFM material with the following composition, all percentages being indicated in weight percent: % C: 0.01-0.29 (preferably from 0.089 to 0.015, more preferably around 0.11); % Cr: 6.6-10.9 (preferably from 8.5 to 9.5); % V: 0.01 to 0.49 (preferably from 0.15 to 0.25); % Ta: 0.001 to 0.8 (preferably from 0.05 to 0.09); % W: 0.1-4.9 (preferably from 1 to 2); % Ti: 0.0001-0.9 (preferably from 0.01 to 0.4); % Mn: 0.06-1.3 (preferably from 0.3 to 0.6); % P and/or % S: 0.0001 to 0.05 (preferably from 0.0005 to 0.007); % Ni, % Mo, % Cu % Nb, % Al % B, % Co<0.09 (preferably <0.009; more preferably <0.004 and even more preferably <0.0009); % Si: 0.0001-0.29 (preferably from 0.001 to 0.08); % As+% Sn+% Sb+% Zr: 0.0001-0.09 (preferably from 0.005 to 0.05); % N: 0.001-0.12 (preferably from 0.015 to 0.045); % O: 0.0001-1.2 (preferably from 0.03 to 0.4); % REE+% Sc+% Y: 0-2.9 (preferably from 0.12 to 1.4); the rest consisting of iron and trace elements, wherein the sum of all trace elements is below 1.4. [431]. A component at least partly manufactured with a method according to any of [1] to [430], wherein the component comprises a ODS-RAFM material with the following composition, all percentages being indicated in weight percent: % C: 0.01-0.29; % Cr: 6.6-10.9; % V: 0.01 to 0.49; % Ta: 0.001 to 0.8; % W: 0.1-4.9; % Ti: 0.0001-0.9; % Mn: 0.06-1.3; % P and/or % S: 0.0001 to 0.05; % Ni, % Mo, % Cu % Nb, % Al % B, % Co<0.09; % Si: 0.0001-0.29 (preferably from 0.001 to 0.08). % As+% Sn+% Sb+% Zr: 0.0001-0.09; % N: 0.001-0.12; % O: 0.0001-1.2; % REE+% Sc+% Y: 0-2.9; the rest consisting of iron and trace elements, wherein all trace elements are below 0.9 wt %. [432]. A component at least partly manufactured with a method according to any of [1] to [431], wherein the component comprises a ODS-RAFM material with the following composition, all percentages being indicated in weight percent: % C: 0.089 to 0.015; % Cr: 8.5 to 9.5; % V: 0.15 to 0.25; % Ta: 0.05 to 0.09; % W: 1 to 2; % Ti: 0.01 to 0.4; % Mn: 0.3 to 0.6; % P and/or % S: 0.0005 to 0.007; % Ni, % Mo, % Cu % Nb, % Al % B, % Co<0.009; % Si: 0.001 to 0.08. % As+% Sn+% Sb+% Zr: 0.005 to 0.05; % N: 0.015 to 0.045; % O: 0.03 to 0.4; % REE+% Sc+% Y: 0.12 to 1.4; the rest consisting of iron and trace elements, wherein all trace elements are below 0.9 wt %. [433]. A component according to any of [1] to [432], wherein the component is a metal comprising component. [434]. A method of manufacturing ceramic or ceramic comprising components, which method comprises the steps of: providing a ceramic comprising material; and shaping the material using a ceramic additive manufacturing (CAM) method. [435]. A method of manufacturing ceramic comprising components, which method comprises the steps of: providing a powder or powder mixture comprising at least a ceramic material; providing a mold at least partly manufactured by additive manufacturing (AM); filling the mold with the powder or powder mixture; applying a pressure and/or temperature treatment. [436]. A method of manufacturing ceramic comprising components, which method comprises the steps of: providing a powder or powder mixture comprising at least a ceramic material; providing a mold at least partly manufactured by additive manufacturing (AM); filling the mold with the powder or powder mixture; applying a pressure and/or temperature treatment; optionally, applying a debinding treatment; optionally, applying a pressure and/or temperature treatment; optionally, applying a consolidation treatment; optionally, infiltrating at least part of the component with an infiltrate material; and optionally, applying a densification treatment. [437]. A method of manufacturing ceramic comprising components, which method comprises the steps of: providing a powder or powder mixture comprising at least a ceramic material; shaping the powder or powder mixture using an additive manufacturing (AM) technology; applying a pressure and/or temperature treatment; applying a debinding treatment. [438]. A method of manufacturing ceramic comprising components, which method comprises the steps of: providing a powder or powder mixture comprising at least a ceramic material; shaping the powder or powder mixture using an additive manufacturing (AM) technology; applying a pressure and/or temperature treatment; applying a debinding treatment; optionally, applying a pressure and/or temperature treatment; optionally, applying a consolidation treatment; optionally, applying a densification treatment; optionally, infiltrating at least part of the component with an infiltrate material; and optionally, applying a densification treatment. [439].The method according to any of [1] to [438], wherein the material provided comprises a ceramic material. [440].The method according to any of [1] to [439], wherein consist of a ceramic material. [441].The method according to any of [1] to [440], wherein the material provided comprises a powder or powder mixture comprising at least a ceramic material. [442].The method according to any of [1] to [441], wherein the material provided consist of a powder or powder mixture comprising at least a ceramic material. [443].The method according to any of [1] to [442], wherein the ceramic material is selected from boron, crystalline boron, borides (e.g., chromium boride (CrB), chromium diboride (CrB₂), titanium diboride (TiB₂), zirconium diboride (ZrB₂), magnesium diboride (MgB₂), niobium diboride (NbB₂), hafnium diboride (HfB₂), tantalum diboride (TaB₂) . . . ), carbides (e.g., boron carbide (B₄C), chromium carbide (Cr₃C₂), molybdenum carbide (Mo₂C), silicon carbide (SiC), titanium carbide (TiC), tungsten titanium carbide (WTiC), vanadium carbide (VC), zirconium carbide (ZrC), hafnium carbide (HfC), tantalum carbide (TaC), niobium carbide (NbC) . . . ), nitrides (e.g., aluminium nitride (AlN), boron nitride (BN), silicon nitride (Si₃N₄), titanium carbonitride (Ti (C,N)), titanium nitride (TiN), zirconium nitride (ZrN), hafnium nitride (HfN), vanadium nitride (VN), tantalum nitride (TaN), niobium nitride (NbN) . . . ), oxides (e.g., yttrium oxide (Y₂O₃), boron oxide (B₂O₃), zin oxide (ZnO), zirconium oxide (ZrO₂) . . . ), silicon, silicides (e.g., molybdenum disilicide (MoSi₂), . . . ), titanates (e.g., barium titanate (BaTiO₃), strontium titanate (SrTiO₃), lead zirconate, titanate (PZT), . . . ) silicates (e.g., steatite, . . . ), sialon, bioceramics, alumina, ferrite, porcelain and/or mixtures thereof. [444].The method according to any of [1] to [443], wherein the ceramic material is selected from boron, crystalline boron, borides, carbides, nitrides, oxides, silicon, silicides, titanates, silicates, sialon, bio-ceramics, alumina, ferrite, porcelain and/or mixtures thereof. [445].The method according to any of [1] to [444], wherein the ceramic material further comprise other components selected from organic materials, polymers, polymeric materials, fluxes, lubricants, additives, binders, metallic particles, reinforcement particles, whiskers, graphene, nanotubes, carbon nanotubes and/or combinations thereof. [446].The method according to any of [1] to [445], wherein the ceramic material is a powder with a right size between 0.3 and 990 microns. [447].The method according to any of [1] to [446], wherein the material provided comprises at least one powder with a right size, wherein a right size is a size between 0.3 and 990 microns. [448].The method according to any of [1] to [447], wherein the material provided comprises at least one irregular powder. [449].The method according to any of [1] to [448], wherein the material provided comprises at least one spherical powder. [450].The method according to any of [1] to [449], wherein the material provided comprises at least a 21% of spherical particles. In different embodiments, the percentage of spherical particles is 21% or more, 36% or more, 51% or more, 81% or more, 91% or more and even 98% or more. In different embodiments, the percentage of spherical particles is 89% or less, 74% or less, 59% or less and even 44% or less. [451].The method according to any of [1] to [450], wherein the material provided comprises between 21% and 89% of spherical particles. [452].The method according to any of [1] to [451], wherein the material provided comprises at least one powder obtained by mechanical action, comminution, crushing, grinding, attrition, milling, mechanochemical synthesis, chemical, solid state reaction, liquid solution, precipitation, co-precipitation, solvent vaporization, gel routes, non-aqueous liquid reaction, vapor phase reaction, gas-solid reaction, gas-liquid reaction, reaction between gases, gas phase pyrolysis and/or combinations thereof. [453].The method according to any of [1] to [452], wherein the step of shaping the powder or powder mixture using a ceramic additive manufacturing (CAM) method is made at a proper temperature, wherein a proper temperature is a temperature between 26° C. and 340° C. [454].The method according to any of [1] to [453], wherein the step of shaping the powder or powder mixture using a ceramic additive manufacturing (CAM) method is made at a proper temperature, wherein a proper temperature is a temperature of 26° C. or more. [455].The method according to any of [1] to [454], wherein the step of shaping the powder or powder mixture using a ceramic additive manufacturing (CAM) method is made at a proper temperature, wherein a proper temperature is a temperature of 340° C. or less. [456].The method according to any of [1] to [455], wherein the step of shaping the powder or powder mixture using a ceramic additive manufacturing (CAM) method is made at a proper temperature, wherein a proper temperature is a temperature between 26° C. and 340° C. [457].The method according to any of [1] to [456], wherein the step of shaping the treated powder or powder mixture using a ceramic additive manufacturing (CAM) method comprises: providing a mold; filling the mold with the material provided; and applying a pressure and/or temperature treatment to the filled mold. [458].The method according to any of [1] to [457], wherein at least part of the mold is made of a material selected from: organic materials, polymers, polymeric materials, elastomers, thermosetting polymers, thermoplastic polymers, amorphous polymers, amorphous thermoplastic polymers, crystalline polymers, semi-crystalline polymers, semi-crystalline thermoplastic polymers and/or combinations thereof. [459].The method according to any of [1] to [458], wherein at least part of the mold is manufactured using a conventional polymer shaping technology and/or an additive manufacturing technology. [460].The method according to any of [1] to [459], wherein at least part of the mold is manufactured using a conventional polymer shaping technologies selected from: blow molding, extrusion, injection molding, pultrusion, rotomolding, filament winding, thermoforming, compression molding and/or combinations thereof. [461].The method according to any of [1] to [460], wherein at least part of the mold is manufactured using additive manufacturing (AM) technology selected from: fused deposition modelling (FDM) or fused filament fabrication (FFF), stereolithography (SLA), digital light processing (DLP), continuous digital light processing (CDLP), digital light synthesis (DLS), a technology based on continuous liquid interface production (CLIP), material jetting (MJ), drop on demand (DOD), multi jet fusion (MJF), binder jetting (BJ), selective laser sintering (SLS), selective heat sintering (SHS) and/or combinations thereof. [462].The method according to any of [1] to [461], wherein the mold is vibrated during at least part of the filling with the material provided. [463].The method according to any of [1] to [462], wherein the filled mold is sealed. [464].The method according to any of [1] to [463], wherein a cover mold is placed over at least part of the filled mold. [465].The method according to any of [1] to [464], wherein a controlled high vacuum is applied to the filled mold using the cover mold as a vacuum tight container, wherein the controlled high vacuum is between 0.9 mbar and 10-10 mbar. [466].The method according to any of [1] to [465], wherein the pressure and/or temperature treatment comprises the application of a pressure between 1.1 and 640 MPa. [467].The method according to any of [1] to [466], wherein the pressure is applied continuously. [468].The method according to any of [1] to [467], wherein the pressure is applied in a stepwise manner. [469].The method according to any of [1] to [468], wherein the pressure is increased and/or released more than once during the treatment. [470].The method according to any of [1] to [469], wherein the pressure and/or temperature treatment comprises the application of a temperature between 0.1° C. and 480° C. [471].The method according to any of [1] to [470], wherein the temperature is applied continuously. [472].The method according to any of [1] to [471], wherein the temperature is applied in a stepwise manner. [473].The method according to any of [1] to [472], wherein the temperature is increased and/or released more than once during the treatment. [474].The method according to any of [1] to [473], wherein at least part of the heating can be performed using microwaves. [475].The method according to any of [1] to [474], wherein the processing time of the pressure and/or temperature treatment is between 1.2 minutes and 139 hours. [476].The method according to any of [1] to [475], wherein the pressure and/or temperature treatment comprises at least the following steps: step 1) raising the temperature of the mold while maintaining low pressure; step 2) raising the temperature and pressure of the mold; and step 3) raising the temperature and pressure of the mold. [477].The method according to any of [1] to [476], wherein steps 2) and/or 3) are skipped. [478].The method according to any of [1] to [477], wherein step 1) comprises raising the temperature between 0.1° C. and 189° C. [479].The method according to any of [1] to [478], wherein a low pressure in step 1) is a pressure between 0.3 and 49 MPa. [480].The method according to any of [1] to [479], wherein the temperature is raised in step 2) to a temperature between 51° C. and 249° C. [481].The method according to any of [1] to [480], wherein the pressure is raised in step 2) to a pressure between 4.1 and 114 MPa. [482].The method according to any of [1] to [481], wherein the temperature is raised in step 3) to a temperature between 78° C. and 299° C. [483].The method according to any of [1] to [482], wherein the pressure is raised in step 3) to a pressure between 110 and 580 MPa. [484].The method according to any of [1] to [483], wherein the step of shaping the treated powder or powder mixture using a ceramic additive manufacturing (CAM) method comprises the use of an additive manufacturing (AM) technology to form the component or at least a part of the component. [485].The method according to any of [1] to [484], wherein the additive manufacturing (AM) technology is selected from fused deposition (FDM), fused filament fabrication (FFF), stereolithography (SLA), digital light processing (DLP), continuous digital light processing (CDLP), digital light synthesis (DLS), a technology based on continuous liquid interface production (CLIP), material jetting (MJ), drop on demand (DOD), multi jet fusion (MJF), binder jetting (BJ), laser sintering (SLS) and/or combinations thereof. [486].The method according to any of [1] to [485], wherein the additive manufacturing (AM) technology used further comprises the use of an organic material. [487].The method according to any of [1] to [486], wherein the method further comprises the step of: applying a debinding treatment to eliminate the organic material or at least part of the organic material. [488].The method according to any of [1] to [487], wherein the debinding treatment comprises the use of a thermal debinding. [489].The method according to any of [1] to [488], wherein the debinding treatment comprises the use of a non-thermal debinding. [490].The method according to any of [1] to [489], wherein the debinding treatment comprises the use of a solvent. [491].The method according to any of [1] to [490], wherein the debinding treatment is performed simultaneously with other method steps. [492].The method according to any of [1] to [491], wherein the method further comprises the step of applying a pressure and/or temperature treatment before and/or after the application of a debinding treatment. [493].The method according to any of [1] to [492], wherein the pressure and/or temperature treatment comprises the application of a pressure between 1.1 and 640 MPa. [494].The method according to any of [1] to [493], wherein the pressure is applied continuously. [495].The method according to any of [1] to [494], wherein the pressure is applied in a stepwise manner. [496].The method according to any of [1] to [495], wherein the pressure is increased and/or released more than once during the treatment. [497].The method according to any of [1] to [496], wherein the pressure and/or temperature treatment comprises the application of a temperature between 0.1° C. and 480° C. [498].The method according to any of [1] to [497], wherein the temperature is applied continuously. [499].The method according to any of [1] to [498], wherein the temperature is applied in a stepwise manner. [500].The method according to any of [1] to [499], wherein the temperature is increased and/or released more than once during the treatment. [501].The method according to any of [1] to [500], wherein at least part of the heating can be performed using microwaves. [502].The method according to any of [1] to [501], wherein the processing time of the pressure and/or temperature treatment is between 1.2 minutes and 139 hours. [503].The method according to any of [1] to [502], wherein the pressure and/or temperature treatment comprises at least the following steps: step 1) raising the temperature of the component while maintaining low pressure; step 2) raising the temperature and pressure of the component; and step 3) raising the temperature and pressure of the component. [504].The method according to any of [1] to [503], wherein steps 2) and/or 3) are skipped. [505].The method according to any of [1] to [504], wherein step 1) comprises raising the temperature between 0.1° C. and 189° C. [506].The method according to any of [1] to [505], wherein a low pressure in step 1) is a pressure between 0.3 and 49 MPa. [507].The method according to any of [1] to [506], wherein the temperature is raised in step 2) to a temperature between 51° C. and 249° C. [508].The method according to any of [1] to [507], wherein the pressure is raised in step 2) to a pressure between 4.1 and 114 MPa. [509].The method according to any of [1] to [508], wherein the temperature is raised in step 3) to a temperature between 78° C. and 299° C. [510].The method according to any of [1] to [509], wherein the pressure is raised in step 3) to a pressure between 110 and 580 MPa. [511].The method according to any of [1] to [510], wherein the pressure and/or temperature treatment is performed simultaneously with other method steps. [512].The method according to any of [1] to [511], wherein the method further comprises the step of: applying a treatment selected from carburizing treatment, a boriding treatment, a nitriding treatment, a siliciding treatment and/or combinations thereof. [513].The method according to any of [1] to [512], wherein the method further comprises the step of: applying a treatment selected from carburizing treatment, a boriding treatment, a nitriding treatment, a siliciding treatment and/or combinations thereof at any time between the debinding step and the consolidation step. [514].The method according to any of [1] to [513], wherein the method further comprises the step of: applying a consolidation treatment. [515].The method according to any of [1] to [514], wherein the consolidation treatment comprises the use of a properly designed atmosphere. [516].The method according to any of [1] to [515], wherein the consolidation treatment is performed simultaneously with other method steps. [517].The method according to any of [1] to [516], wherein the consolidation treatment comprises the application of a temperature between 1100° C. and 3800° C. [518].The method according to any of [1] to [517], wherein the consolidation treatment comprises the application of a pressure between 12 mbar and 189 bar. [519].The method according to any of [1] to [518], wherein the consolidation treatment comprises the application of vacuum. [520].The method according to any of [1] to [519], wherein the method further comprises the step of: joining different parts to make a bigger component. [521].The method according to any of [1] to [520], wherein the method further comprises the step of: joining different parts to make a bigger component after and/or before applying the consolidation treatment. [522].The method according to any of [1] to [521], wherein the method further comprises the step of: applying a densification treatment. [523].The method according to any of [1] to [522], wherein the densification treatment comprises the use of a properly designed atmosphere. [524].The method according to any of [1] to [523], wherein the densification treatment is performed simultaneously with other method steps. [525].The method according to any of [1] to [524], wherein the densification treatment comprises the application of a pressure between 166 and 5300 bar. [526].The method according to any of [1] to [525], wherein the densification treatment comprises the application of a temperature between 960° C. and 3640° C. [527].The method according to any of [1] to [526], wherein the method further comprises the step of: infiltrating at least part of the component with an infiltrate material. [528].The method according to any of [1] to [527], wherein the component comprises at least one infiltration barrier. [529].The method according to any of [1] to [528], wherein the method further comprises the step of: applying a densification treatment after the infiltration. [530].The method according to any of [1] to [529], wherein the method further comprises the step of: applying a machining step and/or a surface conditioning. [531]. A method of manufacturing polymer comprising components, which method comprises the steps of: providing a material; and shaping the material using a polymer additive manufacturing (PAM) method. [532]. A method of manufacturing polymer comprising components, which method comprises the steps of: providing a material comprising at least a polymer or a polymeric-based composite; providing a mold at least partly manufactured by additive manufacturing (AM); filling the mold with the material; applying a pressure and/or temperature treatment. [533]. A method of manufacturing polymer comprising components, which method comprises the steps of: providing a material comprising at least a polymer or a polymeric-based composite; providing a mold at least partly manufactured by additive manufacturing (AM); filling the mold with the material; applying a pressure and/or temperature treatment; optionally, applying a debinding treatment; optionally, applying a pressure and/or temperature treatment; optionally, applying a consolidation treatment; optionally, infiltrating at least part of the component with an infiltrate material; and optionally, applying a densification treatment. [534]. A method of manufacturing polymer comprising components, which method comprises the steps of: providing a material comprising at least a polymer or a polymeric-based composite; and shaping the material using an additive manufacturing (AM) technology; applying a debinding treatment; applying a pressure and/or temperature treatment. [535]. A method of manufacturing polymer comprising components, which method comprises the steps of: providing a material comprising at least a polymer or a polymeric-based composite; and shaping the material using an additive manufacturing (AM) technology; applying a debinding treatment; applying a pressure and/or temperature treatment; optionally, applying a consolidation treatment; optionally, infiltrating at least part of the component with an infiltrate material; and optionally, applying a densification treatment. [536]. A method of manufacturing polymer comprising components, which method comprises the steps of: providing a material comprising at least a polymer or a polymer-based composite; providing a mold at least partly manufactured by additive manufacturing (AM); filling the mold with the material provided; and applying a pressure and/or temperature treatment. [537]. A method of manufacturing polymer comprising components, which method comprises the steps of: providing a material comprising at least a polymer or a polymer-based composite; shaping the material using an additive manufacturing (AM) technology. [538]. A method of manufacturing polymer comprising components, which method comprises the steps of: providing a material comprising at least a polymer or a polymer-based composite; shaping the material using an additive manufacturing (AM) technology at a proper temperature, wherein a proper temperature is a temperature between 26° C. and 340° C. [539].The method according to any of [1] to [538], wherein the material provided comprises a polymer. [540].The method according to any of [1] to [539], wherein the material provided comprises a polymeric material. [541].The method according to any of [1] to [540], wherein the material provided comprises a polymer-based composite. [542].The method according to any of [1] to [541], wherein the material provided consist of a polymeric material and/or a polymer-based composite. [543].The method according to any of [1] to [542], wherein the polymer-based composite comprises a metallic and/or a ceramic phase. [544].The method according to any of [1] to [543], wherein the polymer is selected from: polyimide (PI), polycarbonate (PC), ether ketone (EK), polyethylene sulfide (PPS), polytetrafluorethylene (PTFE), polyethylene terephthalate (PET), polybutylene terephthalate (PBT), PA6, PA11, polyamide (PA), polyoxymethylene (POM), polymethylmethacrylate (PMMA), polystyrene (PS), acrylonitrile-butadiene-styrene (ABS), styrene-acrylonitrile (SAN), polypropylene (PP), polyethylene (PE), Polyamide-Imide (PAI), Polyethersulfone (PES), olyphenylsulfone (PPSU), polyetherimide (PEI), polysulfone (PSU), polyparaphenylene (PPP), polyether ether ketone (PEEK), polyetherketone (PEK), liquid crystal polymer (LCP), perfluoroalkoxy alkane (PFA), ethylene tetrafluoroethylene (ETFE), polychlorotrifluoroethylene (PCTFE), polyvinylidene fluoride (PVDF), PA6-3-T, PA46, polymethylpentene (PMP), polyphenylene ether (PPE) and/or mixtures thereof. [545].The method according to any of [1] to [544], wherein the polymer-based composite has a ratio between the melting temperature of the metallic phase and the critical temperature of the polymer between 0.5 and 3.8 times, being the melting temperature and the critical temperature expressed in Kelvin. [546].The method according to any of [1] to [545], wherein the polymer-based composite has a ratio between the melting temperature of the metallic phase and the melting temperature of the polymer between 0.5 and 3.8 times, being the melting temperature and the critical temperature expressed in Kelvin. [547].The method according to any of [1] to [546], wherein the polymer-based composite has a ratio between the melting temperature of the metallic phase and the heat deflexion temperature measured with a load of 1.82 MPa of the polymer between 0.5 and 3.8 times, being both temperatures expressed in Kelvin. [548].The method according to any of [1] to [547], wherein the polymer-based composite has a ratio between the melting temperature of the metallic phase and the heat deflexion temperature measured with a load of 0.455 MPa of the polymer between 0.5 and 3.8 times, being both temperatures expressed in Kelvin. [549].The method according to any of [1] to [548], wherein the polymer-based composite has a ratio between the melting temperature of the metallic phase and the glass transition temperature (Tg) of the polymer between 0.5 and 3.8 times, being both temperatures expressed in Kelvin. [550].The method according to any of [1] to [549], wherein the polymer-based composite has a ratio between the melting temperature of the metallic phase and the Vicat temperature of the polymer between 0.5 and 3.8 times, being both temperatures expressed in Kelvin. [551].The method according to any of [1] to [550], wherein the melting temperature of the metallic phase is the temperature at which the first metal liquid forms under equilibrium conditions. [552].The method according to any of [1] to [551], wherein the step of shaping the powder or powder mixture using a polymer additive manufacturing (PAM) method is made at a proper temperature, wherein a proper temperature is a temperature between 26° C. and 340° C. [553].The method according to any of [1] to [552], wherein the step of shaping the treated powder or powder mixture using a polymer additive manufacturing (PAM) method comprises: providing a mold; filling the mold with the material provided; and applying a pressure and/or temperature treatment to the filled mold. [554].The method according to any of [1] to [553], wherein at least part of the mold is made from a material selected from: organic materials, polymers, polymeric materials, elastomers, thermosetting polymers, thermoplastic polymers, amorphous polymers, amorphous thermoplastic polymers, crystalline polymers, semi-crystalline polymers, semi-crystalline thermoplastic polymers and/or combinations thereof. [555].The method according to any of [1] to [554], wherein at least part of the mold is manufactured using a conventional polymer shaping technology and/or an additive manufacturing technology. [556].The method according to any of [1] to [555], wherein at least part of the mold is manufactured using a conventional polymer shaping technologies selected from: blow molding, extrusion, injection molding, pultrusion, rotomolding, filament winding, thermoforming, compression molding and/or combinations thereof. [557].The method according to any of [1] to [556], wherein at least part of the mold is manufactured using additive manufacturing (AM) technology selected from: fused deposition modelling (FDM) or fused filament fabrication (FFF), stereolithography (SLA), digital light processing (DLP), continuous digital light processing (CDLP), digital light synthesis (DLS), a technology based on continuous liquid interface production (CLIP), material jetting (MJ), drop on demand (DOD), multi jet fusion (MJF), binder jetting (BJ), selective laser sintering (SLS), selective heat sintering (SHS) and/or combinations thereof. [558].The method according to any of [1] to [557], wherein the mold is vibrated during at least part of the filling with the material provided. [559].The method according to any of [1] to [558], wherein the filled mold is sealed. [560].The method according to any of [1] to [559], wherein a cover mold is placed over at least part of the filled mold. [561].The method according to any of [1] to [560], wherein a controlled high vacuum is applied to the filled mold using the cover mold as a vacuum tight container, wherein the controlled high vacuum is between 0.9 mbar and 10-10 mbar. [562].The method according to any of [1] to [561], wherein the pressure and/or temperature treatment comprises the application of a pressure between 1.6 and 690 MPa. [563].The method according to any of [1] to [562], wherein the pressure is applied continuously. [564].The method according to any of [1] to [563], wherein the pressure is applied in a stepwise manner. [565].The method according to any of [1] to [564], wherein the pressure is increased and/or released more than once during the treatment. [566].The method according to any of [1] to [565], wherein the pressure and/or temperature treatment comprises the application of a temperature between 0.1° C. and 480° C. [567].The method according to any of [1] to [566], wherein the pressure and/or temperature treatment comprises the application of a temperature between 0.12° C. and 440° C. [568].The method according to any of [1] to [567], wherein the temperature is applied continuously. [569].The method according to any of [1] to [568], wherein the temperature is applied in a stepwise manner. [570].The method according to any of [1] to [569], wherein the temperature is increased and/or released more than once during the treatment. [571].The method according to any of [1] to [570], wherein at least part of the heating can be performed using microwaves. [572].The method according to any of [1] to [571], wherein the processing time of the pressure and/or temperature treatment is between 0.9 minutes and 119 hours. [573].The method according to any of [1] to [572], wherein the pressure and/or temperature treatment comprises at least the following steps: step 1) raising the temperature of the mold while maintaining low pressure; step 2) raising the temperature and pressure of the mold; and step 3) raising the temperature and pressure of the mold. [574].The method according to any of [1] to [573], wherein steps 2) and/or 3) are skipped. [575].The method according to any of [1] to [574], wherein step 1) comprises raising the temperature of the mold between 0.1° C. and 179° C. [576].The method according to any of [1] to [575], wherein a low pressure in step 1) is a pressure between 0.36 and 54 MPa. [577].The method according to any of [1] to [576], wherein the temperature is raised in step 2) to a temperature between 46° C. and 234° C. [578].The method according to any of [1] to [577], wherein the pressure is raised in step 2) to a pressure between 4.6 and 119 MPa. [579].The method according to any of [1] to [578], wherein the temperature is raised in step 3) to a temperature between 76° C. and 279° C. [580].The method according to any of [1] to [579], wherein the pressure is raised in step 3) to a pressure between 110 and 590 MPa. [581].The method according to any of [1] to [580], wherein the step of shaping the treated powder or powder mixture using a polymer additive manufacturing (PAM) method comprises the use of an additive manufacturing (AM) technology to form the component or at least a part of the component. [582].The method according to any of [1] to [581], wherein the additive manufacturing (AM) technology is selected from fused deposition (FDM), fused filament fabrication (FFF), stereolithography (SLA), digital light processing (DLP), continuous digital light processing (CDLP), digital light synthesis (DLS), a technology based on continuous liquid interface production (CLIP), material jetting (MJ), drop on demand (DOD), multi jet fusion (MJF), binder jetting (BJ), laser sintering (SLS) and/or combinations thereof. [583].The method according to any of [1] to [582], wherein the additive manufacturing (AM) technology used further comprises the use of an organic material. [584].The method according to any of [1] to [583], wherein the method further comprises the step of: applying a debinding treatment to eliminate part of the organic material. [585].The method according to any of [1] to [584], wherein the debinding treatment comprises the use of a thermal debinding. [586].The method according to any of [1] to [585], wherein the debinding treatment comprises the use of a non-thermal debinding. [587].The method according to any of [1] to [586], wherein the debinding treatment comprises the use of a solvent. [588].The method according to any of [1] to [587], wherein the debinding treatment is performed simultaneously with other method steps. [589].The method according to any of [1] to [588], wherein the method further comprises the step of: applying a pressure and/or temperature treatment before and/or after the application of a debinding treatment. [590].The method according to any of [1] to [589], wherein the pressure and/or temperature treatment is performed simultaneously with other method steps. [591].The method according to any of [1] to [590], wherein the pressure and/or temperature treatment comprises the application of a pressure between 1.6 and 690 MPa. [592].The method according to any of [1] to [591], wherein the pressure is applied continuously. [593].The method according to any of [1] to [592], wherein the pressure is applied in a stepwise manner. [594].The method according to any of [1] to [593], wherein the pressure is increased and/or released more than once during the treatment. [595].The method according to any of [1] to [594], wherein the pressure and/or temperature treatment comprises the application of a temperature between 0.1° C. and 480° C. [596].The method according to any of [1] to [595], wherein the pressure and/or temperature treatment comprises the application of a temperature between 0.12° C. and 440° C. [597].The method according to any of [1] to [596], wherein the temperature is applied continuously. [598].The method according to any of [1] to [597], wherein the temperature is applied in a stepwise manner. [599].The method according to any of [1] to [598], wherein the temperature is increased and/or released more than once during the treatment. [600].The method according to any of [1] to [599], wherein at least part of the heating can be performed using microwaves. [601].The method according to any of [1] to [600], wherein the processing time of the pressure and/or temperature treatment is between 0.9 minutes and 119 hours. [602].The method according to any of [1] to [601], wherein the pressure and/or temperature treatment comprises at least the following steps: step 1) raising the temperature of the component while maintaining low pressure; step 2) raising the temperature and pressure of the component; and step 3) raising the temperature and pressure of the component. [603].The method according to any of [1] to [602], wherein steps 2) and/or 3) are skipped. [604].The method according to any of [1] to [603], wherein step 1) comprises raising the temperature between 0.1° C. and 179° C. [605].The method according to any of [1] to [604], wherein a low pressure in step 1) is a pressure between 0.36 and 54 MPa. [606].The method according to any of [1] to [605], wherein the temperature is raised in step 2) to a temperature between 46° C. and 234° C. [607].The method according to any of [1] to [606], wherein the pressure is raised in step 2) to a pressure between 4.6 and 119 MPa. [608].The method according to any of [1] to [607], wherein the temperature is raised in step 3) to a temperature between 76° C. and 279° C. [609].The method according to any of [1] to [608], wherein the pressure is raised in step 3) to a pressure between 110 and 590 MPa. [610].The method according to any of [1] to [609], wherein the method further comprises the step of: applying an undercooling treatment. [611].The method according to any of [1] to [610], wherein the undercooling treatment is applied before the application of the pressure and/or temperature treatment. [612].The method according to any of [1] to [611], wherein the undercooling treatment is applied during the pressure and/or temperature treatment. [613].The method according to any of [1] to [612], wherein the undercooling treatment is made by holding the filled mold at low temperature of 19° C. or less. [614].The method according to any of [1] to [613], wherein the undercooling is made by holding the mold at a low temperature of 19° C. or less for more than 10 minutes [615].The method according to any of [1] to [614], wherein the undercooling treatment is made by holding the filled mold at a low temperature of Tg+60° C. or less, Tg being the glass transition temperature of the material of the mold having a low softening point. [616].The method according to any of [1] to [615], wherein the undercooling is made by holding the mold at a low temperature of Tg+60° C. or less for more than 10 minutes, Tg being the glass transition temperature of the material of the mold having a low softening point [617].The method according to any of [1] to [616], wherein the undercooling is limited to a maximum temperature of −273° C. [618].The method according to any of [1] to [617], wherein the undercooling is limited to a maximum temperature of −140° C. [619].The method according to any of [1] to [618], wherein when undercooling is applied, then the maximum relevant temperature in the pressure and/or temperature treatment is reduced in 18° C. [620].The method according to any of [1] to [619], wherein a relevant temperature is a temperature that is maintained for more than 1 second, preferably for more than 20 seconds and even more preferably more than 2 minutes. [621].The method according to any of [1] to [620], wherein the method further comprises the step of: applying a consolidation treatment. [622].The method according to any of [1] to [621], wherein the consolidation treatment comprises the use of a properly designed atmosphere. [623].The method according to any of [1] to [622], wherein the consolidation treatment is performed simultaneously with other method steps. [624].The method according to any of [1] to [623], wherein the consolidation treatment comprises the application of a temperature between 76° C. and 690° C. [625].The method according to any of [1] to [624], wherein the consolidation treatment comprises the application of a pressure between 1 mbar and 189 bar. [626].The method according to any of [1] to [625], wherein the consolidation treatment comprises the application of vacuum. [627].The method according to any of [1] to [626], wherein the method further comprises the step of: joining different parts to make a bigger component. [628].The method according to any of [1] to [627], wherein the method further comprises the step of: joining different parts to make a bigger component after and/or before applying the consolidation treatment. [629].The method according to any of [1] to [628], wherein the method further comprises the step of: applying a densification treatment. [630].The method according to any of [1] to [629], wherein the densification treatment comprises the use of a properly designed atmosphere. [631].The method according to any of [1] to [630], wherein the densification treatment is performed simultaneously with other method steps. [632].The method according to any of [1] to [631], wherein the densification treatment comprises the application of a pressure between 171 and 5390 bar. [633].The method according to any of [1] to [632], wherein the densification treatment comprises the application of a temperature between 46° C. and 490° C. [634].The method according to any of [1] to [633], wherein the method further comprises the step of: infiltrating at least part of the component with an infiltrate material. [635].The method according to any of [1] to [634], wherein the component comprises at least one infiltration barrier. [636].The method according to any of [1] to [635], wherein the method further comprises the step of: applying a densification treatment after the infiltration. [637].The method according to any of [1] to [636], wherein the method further comprises the step of: applying a machining step and/or a surface conditioning.

All the embodiments disclosed throughout this document can be combined among them in any combination, provided that they are not mutually exclusive.

Further embodiments of the present disclosure can be found in examples and in the claims.

EXAMPLE 1. For the manufacturing technologies described in this document where additively manufactured molds are used, several additive manufacturing technologies and materials were tested. Some of those tests are reported in this example along with the properties of some of the polymeric materials used.

The relevant properties of some polymeric materials used to manufacture different types or molds (some of them with complex geometries and internal features) through different technologies, including AM (FDM, FFF; SLA, DLP, DLS based on CLIP, CDLP, SLS, SHS, MJ, DOD; BJ, MJF; DED-; BAAM with a print head similar to FDM, FFF or DED) and in some cases even using conventional polymer shaping technologies were tested as shown in the following Table:

| | | | HDT at | HDT at | | Tensile | Tensile | Elastic |
|---|---|---|---|---|---|---|---|---|
| | Tg | Tm | 0.455 | 1.82 | Vicat | strength | modulus | modulus |
| Polymer | (° C.) | (° C.) | MPa (° C.) | MPa (° C.) | (° C.) | (MPa) | (MPa) | (GPa) |
| Resin | 62 | | | | | 8 | 3500 | <3.5 |
| 1 | | | | | | | | |
| Resin | 62 | | | | | | | <2.14 |
| 2 | | | | | | | | |
| PP | 0 | | 62 | | 107 | | | |
| PP | 0 | 139 ± 2 | | 56 ± 5 | | 29 ± 1 | 1400 ± 100 | 1.15 ± 0.025 |
| *** | | | | | | | | |
| PP | 0 | 139 | 71 | 56 | | 25 | 1400 | 1.15 |
| **** | | | | | | | | |
| PEBA | | 150 | | | | 8 | 80 | |
| PA121 | 50 | 187 | 175 | 95 | | 48 | 1700 | |
| PA122 | 50 | 176 | | | 163 | 52 | 1800 | 1.5 |
| PS | 105 | | | | | 5.5 | 1600 | |
| PCL* | −59 | 79 | 57 | | | 45 | 350 | |
| PCL** | −59 | 58- | | | | 17.5 | 470 | 0.41 |
| | | 60 | | | | | | |
| PLA1 | 57 | 150 | | 65 | 85 | 110 | 3309 | |
| PLA2 | 54- | 145- | | 56 | | 108 | 3600 | |
| | 64 | 160 | | | | | | |
| HIPS | 100 | | | 79 | 100 | 38 | 1750 | |
| LDPE | −125 | 112 | | | 95 | 13.5 | 115 | |
| HDPE | −125 | 132 | | | 79 | 27 | 1100 | |
| PMMA | 90 | 155 | | | 77 | 51 | | 2.3 |
| ABS | 108 | 240 | 96 | 82 | | 31 | 2200 | 2.1 |
| PC | 150 | 225 | 148 | 133 | 145 | 76.4 | 2310 | 2.13 |

*The molecular weight was 75000.
**The molecular weight was 47500-130000
*** Cristallinity >20%
**** Cristalinity >30%.

All melting temperatures (Tm) were measured following test conditions of ISO 11357-1/-3:2016. Moreover, the HDT at 1.82 MPa and glass transition temperature (Tg) were determined following test conditions of ASTM D648-07 and ASTM D3418-12 respectively. HDT at 0.455 MPa was determined following test conditions of ISO 75-1:2013. In all the cases measurements were run in triplicate to ensure the reproducibility of the assay and using a test specimen manufactured using molding method A.

Some examples of polymeric materials used to manufacture molds using different AM technologies, as shown in the Table below:

| AM | |
|---|---|
| technology | Polymers |
| SLA | Resin 1, Resin 2, Epoxy resin, UF, MF |
| DLP | Resin 1, Resin 2, PF, UF, MF |
| CDLP | Resin 1, Resin 2, Epoxy resin, UF, MF |
| SLS | PP, PP***, PP****, PEBA, PA122, PS, PCL2, PVC, |
| | Kollidon VA64, Kollidon 12FP, Epoxi resin, PA6, |
| | PE, PA11, PHA, PHB |
| MJF | PA121, PPO, PA6, PA122, PA11 |
| FDM | PP (homopolymer), PCL1, PLA1, PLA2, HIPS, LDPE, |
| | HDPE, PMMA, ABS, SAN, PPO, PVC, PVA, PC, POM, |
| | PE, PET, PBT, UP, PHA, PHB |
| BJ | PVA, PMMA, PA12, PA6 |
| DOD | Resin 1, Resin 2, Epoxy resin, PF |
| PIM | PET, PP, PA6, HDPE |

***Cristallinity >20%
****Cristalinity >30%.

EXAMPLE 2. Several starting materials were tested. The different strategies in terms of powder and powder mixtures described in this document were tested for every single overall composition in the table below. The list of alloys tested is more than a hundred pages long, for the sake of extension only the composition of the powder tested or the overall composition of the powder mixture, when powder mixtures were employed, is listed in the following Tables and only for a few representative cases.

Several High Thermal Conductivity steels with particular attention to Tool Steels were tested:

| # | % Cr | % Mn | % Si | % Mo | % Co | % W | % Ni | % V | % C | % O | AA | OTHERS |
|---|---|---|---|---|---|---|---|---|---|---|---|---|
| 1 | 0.01 | 0.59 | 0.1 | 1.6 | — | — | — | — | 0.19 | | | |
| 2 | | — | — | 2.7 | | 0.9 | 1.4 | 0.6 | 0.41 | 0.2 | 0.06 | |
| 3 | — | 0.01 | — | 1.5 | — | — | | — | 0.16 | 0.08 | 0.3 | |
| 4 | 0.01 | 0.82 | 0.03 | 3.27 | — | — | — | 0.44 | 0.39 | — | | |
| 5 | — | 0.02 | 0.03 | 1.8 | — | — | | 0.1 | 0.22 | | | |
| 6 | — | 0.68 | — | 3.18 | — | — | — | 0.41 | 0.2 | 1.3 | 5.1 | 0.9% N |
| 7 | 0.019 | 0.022 | 0.04 | 3.36 | | 0.1 | | 0.002 | 0.29 | | | |
| 8 | 0.02 | 0.025 | 0.04 | 3.59 | | 0.6 | | 0.003 | 0.28 | | | |
| 9 | 0.01 | 0.02 | 0.04 | 3.7 | | 1.19 | | <0.005 | 0.28 | 0.864 | 3.2 | |
| 10 | 0.01 | 0.02 | 0.05 | 3.71 | | 1.2 | 0.84. | 0.6 | 0.39 | | | |
| 11 | 0.01 | 0.02 | 0.04 | 3.63 | 3 | 1.63 | | 0.81 | 0.41 | | | Hf, Nb, Zr |
| 12 | 8.2 | 0.14 | 0.11 | 1.15 | 6 | 0.02 | | 0.87 | 0.4 | | | |
| 13 | 0.01 | 0.02 | 0.05 | 3.4 | | 1.08 | | <0.005 | 0.27 | 0.0459 | 1.7 | Al |
| 14 | 0.01 | 0.019 | 0.05 | 3.7 | | 1.01 | | 0.005 | 0.29 | | | |
| 15 | 0.01 | 0.24 | 0.05 | 3.39 | | 1.11 | | 0.43 | 0.33 | | | Hf |
| 16 | 0.01 | 0.12 | 0.05 | 3.36 | | 1.15 | — | 0.44 | 0.32 | | | |
| 17 | 0.01 | 0.02 | 0.05 | 3.62 | | 1.18 | | 0.004 | 0.29 | 0.135 | 0.5 | Nb |
| 18 | 0.01 | 0.14 | 0.05 | 3.58 | | 1.27 | 2.04 | <0.005 | 0.33 | | | |
| 19 | 0.01 | 0.14 | 0.07 | 3.58 | | 1.16 | — | 0.65 | 0.41 | | | |
| 20 | 0.01 | 0.26 | 0.05 | 3.64 | | 1.1 | 3.09 | 0.46 | 0.33 | | | |
| 21 | 0.01 | 0.26 | 0.05 | 3.7 | | 1.36 | | 0.43 | 0.33 | 0.766 | 2.84 | Nb |
| 22 | 0.01 | 0.21 | 0.04 | 3.2 | | 1.04 | | 0.3 | 0.21 | | | Nb |
| 23 | 0.01 | 0.02 | 0.02 | 3.7 | | 2.3 | | <0.005 | 0.31 | | | Nb, Zr |
| 24 | 0.01 | 0.11 | 0.02 | 3.9 | | 2 | — | <0.005 | 0.37 | | | |
| 25 | 0.01 | 0.02 | 0.05 | 3.64 | | 1.97 | 1.86 | 0.7 | 0.44 | 1.28 | 4.73 | |
| 26 | 0.01 | 0.02 | 0.05 | 3.73 | | 1.8 | 2.05 | 0.69 | 0.43 | | | |
| 27 | 0.01 | 0.09 | 0.04 | 3.1 | | 1.68 | Co | <0.005 | 0.32 | | | |
| | | | | | | | 3.00 | | | | | |
| 28 | 0.01 | 0.015 | 0.03 | 3.6 | 3 | 1.09 | | <0.005 | 0.29 | | | |
| 29 | <0.01 | <0.01 | <0.01 | 3.57 | | 1.35 | 2.96 | 0.44 | 0.39 | 1.45 | 5.39 | |
| 30 | 0.1 | 0.17 | 0.1 | 3.1 | | 1.7 | | 0.03 | 0.32 | | | Hf, B, Zr |
| 31 | <0.01 | 0.058 | <0.05 | 3.9 | | 1.4 | | 0.484 | 0.356 | | | Hf, Zr, Nb |
| 32 | <0.01 | 0.061 | <0.05 | 3.81 | | 1.41 | 0.017 | 0.461 | 0.353 | | | |
| 33 | 0.0108 | 0.055 | <0.05 | 3.68 | | 1.49 | 0.47 | 0.44 | 0.326 | 0.58 | 2.17 | |
| 34 | <0.01 | 0.055 | <0.05 | 3.89 | | 1.67 | 0.481 | 0.452 | 0.464 | | | |
| 35 | <0.01 | 0.051 | <0.05 | 3.77 | | 1.31 | 0.488 | 0.452 | 0.299 | | | |
| 36 | <0.01 | 0.061 | <0.05 | 3.8 | | 2.46 | 0.516 | 0.457 | 0.404 | | | |
| 37 | <0.01 | 0.059 | <0.05 | 3.81 | | 1.35 | 0.95 | 0.473 | 0.377 | 0.99 | 3.69 | |
| 38 | 0.012 | 0.054 | <0.05 | 3.89 | | 1.64 | 0.969 | 0.47 | 0.345 | | | |
| 39 | <0.01 | 0.055 | <0.05 | 3.77 | | 1.58 | 1.01 | 0.462 | 0.336 | | | |
| 40 | <0.01 | 0.06 | <0.05 | 3.75 | | 1.36 | 1.41 | 0.451 | 0.409 | | | |
| 41 | <0.01 | 0.06 | <0.05 | 3.73 | | 1.51 | 1.58 | 0.457 | 0.371 | 0.58 | 2.14 | |
| 42 | <0.01 | 0.062 | <0.05 | 3.66 | | 2 | 1.62 | 0.448 | 0.467 | | | |
| 43 | <0.02 | 1.12 | <0.05 | 3.7E−4 | | 2.2 | 2 | <0.001 | 0.36 | | | |
| 44 | <0.01 | 0.062 | <0.05 | 3.67 | | 1.69 | 2.12 | 0.45 | 0.401 | | | |
| 45 | <0.01 | 0.06 | <0.05 | 3.66 | | 1.46 | 2.15 | 0.463 | 0.367 | 0.52 | 1.95 | |
| 46 | 0.066 | 0.145 | <0.05 | 3.03 | | 1.93 | 2.56 | 0.016 | 0.403 | | | |
| 47 | 0.061 | 0.149 | 0.103 | 3.04 | | 1.93 | 2.58 | 0.012 | 0.336 | | | |
| 48 | 0.091 | 0.160 | 0.085 | 2.92 | | 1.97 | 2.84 | 0.017 | 0.24 | | | |
| 49 | 0.0327 | 0.117 | 0.119 | 3.35 | | 1.92 | 2.87 | <0.001 | 0.383 | 1.04 | 3.87 | |
| 50 | 0.094 | 0.15 | 0.08 | 3.02 | | 2.07 | 2.98 | 0.018 | 0.35 | | | |
| 51 | 0.12 | 0.21 | 0 | 2.81 | | 2.1 | 2.98 | 0.08 | 0.32 | | | |
| 52 | 0.071 | 0.144 | <0.05 | 3.01 | | 1.93 | 2.99 | 0.017 | 0.322 | | | |
| 53 | 0.07 | 0.17 | 0.13 | 3.13 | | 1.9 | | 0.03 | 0.32 | 1.42 | 5.26 | Cu, 3.00 |
| 54 | 0.12 | 0.135 | <0.05 | 3.1 | | 1.99 | 3.01 | 0.016 | 0.34 | | | |
| 55 | <0.01 | 0.066 | <0.05 | 3.66 | | 1.39 | 3.04 | 0.465 | 0.371 | | | |
| 56 | 0.085 | 0.166 | <0.05 | 3.06 | | 2.1 | 3.07 | 0.02 | 0.402 | | | |
| 57 | 0.074 | 0.158 | 0.088 | 3.08 | | 2.13 | 3.07 | 0.016 | 0.384 | 0.69 | 2.58 | |
| 58 | 0.1 | 0.16 | 0.14 | 2.92 | | 1.75 | 3.08 | 0.03 | 0.32 | | | |
| 59 | 0.079 | 0.168 | 0.104 | 3.09 | | 2.08 | 3.08 | 0.019 | 0.384 | | | |
| 60 | <0.01 | 0.070 | <0.05 | 3.67 | | 1.5 | 3.1 | 0.459 | 0.392 | | | |
| 61 | 0.07 | 0.24 | 0.01 | 3.2 | | 2.39 | 3.11 | 0.05 | 0.24 | 0.34 | 1.26 | |
| 62 | 0.0832 | 0.213 | 0.0958 | 3.63 | | 2.52 | 3.19 | 0.0216 | 0.392 | | | |
| 63 | <0.01 | 1.98 | 1.59 | 0.25 | | <0.01 | 3.21 | o | 0.8 | | | |
| 64 | <0.01 | 1.98 | 1.59 | 0.25 | | <0.01 | 3.73 | 3.0 | 1.4 | | | |
| 65 | <0.01 | 1.98 | 1.59 | 0.25 | | <0.01 | — | 2.4 | 0.8 | 0.97 | 3.58 | |
| 66 | <0.01 | 1.56 | 1.5 | 0.05 | | <0.01 | — | 0.04 | 0.388 | | | |
| 67 | 0.04 | 1.61 | 1.62 | 0.1 | | <0.01 | — | 0.03 | 0.391 | | | |
| 68 | 2.08 | 1.53 | 1.43 | 0.09 | | <0.01 | 0.06 | 0.05 | 0.388 | | | |
| 69 | 0.01 | 1.61 | 1.52 | 0.05 | | <0.01 | 1.15 | 0.02 | 0.388 | 1.4 | 5.21 | |
| 70 | 0.05 | 0.2 | 0.05 | 4.4 | | 3.4 | 3.1 | | 0.345 | | | |
| 71 | 0.07 | 0.21 | 0.11 | 4.6 | | 3.5 | 3.4 | | 0.357 | 0.837 | 3.19 | |
| 72 | | | | 3.63 | | 1.44 | <0.005 | <0.005 | 0.293 | | | Hf, Zr, B |
| 73 | | | | 3.63 | | 1.44 | <0.005 | <0.005 | 0.59 | | | Hf, Zr, B |
| 74 | | | | 3.229 | | 0.977 | <0.005 | <0.005 | 0.511 | | | Hf, Zr, B |
| 75 | | | | 3.24 | | 0.981 | <0.005 | <0.005 | 0.235 | | | Hf, Zr, B |
| 76 | | | | 3.3 | | 1 | o | o | 0.284 | | | Hf, Zr, B |
| 77 | | | | 3.3 | | 1 | o | o | 0.579 | | | Hf, Zr, B |
| 78 | | | | 3.3 | | 1 | o | o | 0.253 | | | Hf, Zr, B |
| 79 | | | | 3.3 | | 1 | o | o | 0.558 | | | Hf, Zr, B |
| 80 | | | | 3.3 | | o | o | o | 0.53 | | | Hf, Zr, B |

AA—refers to the sum of % Y + % Sc + % REE

Several Ultra High Strength Stainless Steels were rested:

| # | % C | % Cr | % Ni | % Mn | % Nb | % N | % Mo | % Al | % Ti | % O | AA | OTHERS |
|---|---|---|---|---|---|---|---|---|---|---|---|---|
| 1 | | 19 | 14 | | | | | | | | | |
| 2 | | 19 | 8 | | | | | | 0.3 | 0.1 | 0.2 | |
| 3 | | 19 | 11 | | | | | | | 0.1 | 0.3 | |
| 4 | | 19 | 14 | | | | | 0.6 | 1.1 | 0.9 | 1.6 | |
| 5 | | 19 | 17 | | | | | | | 1.4 | 5.8 | |
| 6 | | 19 | 9 | | | 0.9 | | | | | | |
| 7 | | 19 | 4 | | | 0.9 | | 1.1 | | 0.4 | 0.1 | |
| 8 | | 19 | 6 | | | 0.9 | | | | 0.1 | 0.3 | |
| 9 | | 19 | 8 | | | 0.9 | | | 0.8 | 0.8 | 1.7 | |
| 10 | | 19 | 11 | | | 0.9 | | | | 1.5 | 5.6 | |
| 11 | | 18 | | 15 | | 0.9 | | | | 0.05 | 0.2 | |
| 12 | | 19 | 11 | | | 0.9 | | | | | | |
| 13 | | 18 | | 18 | | 0.45 | | | | 0.05 | 0.1 | |
| 14 | | 20 | 8 | 5 | 2 | 0.9 | | | | 0.6 | 2.3 | |
| 15 | | 18 | | 17.5 | | 0.9 | | | 2.1 | 0.6 | | |
| 16 | | 18 | | 15 | | 0.9 | | | | 0.05 | 3.5 | |
| 17 | | 19 | 8 | | | 0.9 | | | | 0.05 | 0.3 | |
| 18 | | 19 | 8 | 5 | | | | | | | | |
| 19 | | 23 | 8 | | | 0.9 | | | | 0.08 | 0.3 | |
| 20 | | 20 | 8 | 5 | 2 | 0.9 | | | | 0.1 | 0.3 | |
| 21 | | 25 | 5 | | | 0.45 | | | | 0.4 | 1.6 | |
| 22 | 0.8 | | | 30 | | | | | | 0.05 | 0.2 | |
| 23 | 0.8 | 5 | | 30 | | 0.1 | | | | | | |
| 24 | 0.8 | | | 30 | | | | | | 0.6 | 2.2 | |
| 25 | | 20 | 8 | 5 | 2 | 0.9 | | | | | | |
| 26 | | 20 | 8 | 5 | 2 | 0.45 | | | | 0.1 | 0.3 | |
| 27 | | 20 | 8 | 5 | 2 | 0.7 | | | | 0.4 | 1.6 | |
| 28 | | 20 | 8 | 5 | 2 | 0.9 | | | | 1.5 | 5.8 | |
| 29 | — | 11.6 | 11.2 | 0.1 | — | — | 1.1 | | 1.6 | 0.1 | 0.3 | |
| 30 | — | 11.4 | 11.2 | 0.1 | 0.25 | — | 1.0 | | 1.2 | | | |
| 31 | — | 11.5 | 11.1 | 0.15 | — | — | 1.0 | 1.1 | 0.9 | 0.15 | 0.5 | |
| 32 | — | 11.4 | 10.9 | — | — | 0.01 | 0.8 | | 1.1 | 0.6 | 2.2 | |
| 33 | % C | % Cr | % Ni | % Mn | % Nb | % N | % Mo | % Al | % Ti | % O | AA | |
| 34 | — | 11.4 | 11.5 | 0.1 | — | 0.8 | 0.9 | — | 2.1 | 0.1 | 0.3 | |
| 35 | — | 10.8 | 10.8 | — | — | — | 0.8 | — | 1.7 | | | |
| 36 | 0.01 | 12.1 | 9.9 | 0.1 | — | 0.1 | 1.1 | 0.6 | 1.1 | 0.1 | 0.3 | |
| 37 | — | 12.0 | 10.2 | — | 0.25 | | 0.9 | 0.8 | 1.2 | | | |
| 38 | 0.01 | 12.3 | 10.0 | 0.1 | | — | 1.1 | 1.1 | 1.0 | | | |
| 39 | — | 12.5 | 10.1 | | | 0.9 | 1.0 | 0.5 | 1.1 | 1.13 | 4.2 | |
| 40 | — | 12.2 | 10.2 | — | | | 1.0 | 0.4 | 2.3 | 0.03 | 0.1 | |
| 41 | — | 12.0 | 8.9 | 4.6 | — | 1.1 | 1.1 | — | 0.4 | 1.7 | 6.2 | |
| 42 | — | 15.1 | 11.1 | — | — | 0.6 | — | 0.4 | — | 0.9 | 3.5 | |
| 43 | — | 16.2 | 8.1 | 5.2 | — | 0.9 | 0.9 | — | 0.3 | 1.4 | 5.2 | |

AA—refers to the sum of % Y + % Sc + % REE

Several Cold Work Tool Steels were tested:

| # | % Cr | % Mn | % Si | % Mo | % Co | % W | % Nb | % V | % C | % O* | AA | OTHERS | |
|---|---|---|---|---|---|---|---|---|---|---|---|---|---|
| 1 | 22.8 | 1.3 | 0.6 | 3.2 | — | — | — | — | 0.02 | 0.62 | 2.3 | | |
| 2 | 25.2 | 0.55 | 0.25 | 3.7 | — | 0.65 | — | — | 0.02 | | | 0.6% | Cu |
| 3 | 25.8 | 0.55 | 0.25 | 3.4 | — | 0.55 | — | — | 0.02 | | | 7% | Ni |
| 4 | 7.8 | 0.2 | 1.1 | 1.6 | — | 1.0 | — | 2.5 | 1.2 | 1.2 | 4.5 | | |
| 5 | 26 | 0.02 | 0.01 | 6.0 | — | — | — | — | 0.01 | | | 1.0% | Cu |
| 6 | 28 | 2 | 0.3 | 7.0 | — | — | — | — | 0.02 | | | 1.4% | Cu |
| 7 | 19.0 | 2.0 | 0.7 | 4.0 | — | — | — | — | 0.02 | | | 24.0% | Ni |
| 8 | 21.0 | 2.0 | 0.7 | 5.0 | — | — | — | — | 0.02 | | | 26% | Ni |
| 9 | 20.3 | 0.65 | 0.18 | 6.3 | — | — | — | — | — | | | 17.8% | Ni |
| 10 | 0.95 | 0.3 | 0.22 | 0.2 | — | — | — | 0.15 | 0.19 | | | 1.25% | Ni |
| 11 | 20.8 | 0.75 | 0.35 | — | — | — | — | — | 0.07 | | | 0.3% | Ti |
| 12 | 11.5 | 0.35 | 0.25 | — | — | — | — | — | 2.0 | 0.2 | 0.8 | | |
| 13 | 11.5 | 0.3 | 0.35 | 0.6 | — | 0.5 | — | 0.3 | 1.6 | | | | |
| 14 | 11.5 | 0.4 | 0.25 | — | — | 0.7 | — | — | 2.1 | | | | |
| 15 | 11.3 | 0.3 | 0.3 | 0.75 | — | — | — | — | 1.55 | | | | |
| 16 | 12.5 | 0.3 | 0.6 | 1.1 | — | — | — | 4.0 | 2.3 | 0.31 | 1.3 | | |
| 17 | 0.6 | 1.1 | 1.1 | — | — | — | — | — | 0.63 | | | | |
| 18 | 5.2 | 0.5 | 0.9 | 1.3 | — | — | — | 9.5 | 2.45 | | | | |
| 19 | 8.2 | 0.4 | 0.7 | 2.1 | — | — | — | 0.5 | 1.1 | | | | |
| 20 | 4.2 | 0.4 | 0.55 | 3.8 | 2.0 | 1.0 | — | 9.0 | 2.47 | 0.82 | 3.2 | | |
| 21 | 0.55 | 1.1 | 0.25 | — | — | 0.55 | — | 0.1 | 0.95 | | | | |
| 22 | 6.4 | — | — | 1.5 | — | 3.5 | — | 3.7 | 1.4 | | | | |
| 23 | 5.3 | 0.5 | 0.65 | — | — | — | — | 9.0 | 1.85 | | | | |
| 24 | 1.3 | 0.4 | 0.23 | 0.25 | — | — | — | — | 0.48 | | | 4.0% | Ni |
| 25 | 4.35 | 0.4 | 0.55 | 2.8 | 4.5 | 2.55 | — | 2.10 | 0.85 | 0.14 | 0.4 | | |
| 26 | 16.1 | — | — | 16.2 | — | 3.75 | — | 0.2 | | | | 58% | Ni |
| 27 | 21.5 | — | — | 9.0 | — | — | 3.65 | — | 0.05 | | | 0.2% | Ti |
| 28 | 19.0 | — | — | 3.05 | — | — | 5.13 | — | 0.04 | | | 52.5% | Ni |
| 29 | 18.0 | — | — | 3.0 | — | — | 5.0 | — | 0.02 | | | | |
| 30 | 1.9 | 1.5 | 0.4 | 0.2 | — | — | — | — | 0.4 | | | | |
| 31 | 2.0 | 1.5 | 0.3 | 0.2 | — | — | — | — | 0.38 | | | 1.1% | Ni |
| 32 | 17.5 | 0.4 | 0.45 | 1.1 | — | — | — | 0.1 | 0.9 | 0.27 | 1.1 | | |
| 33 | 16.2 | — | — | — | — | — | 0.34 | — | 0.04 | | | 4.0% | Ni |
| 34 | — | — | — | 5.0 | 8.8 | — | — | — | — | | | 18.5 | Ni |
| 35 | 5.2 | 0.4 | 0.9 | 1.3 | — | — | — | 0.45 | 0.38 | | | | |
| 36 | 5.2 | 0.4 | 0.9 | 1.4 | — | — | — | 0.95 | 0.39 | 0.17 | 0.78 | | |
| 37 | 4.5 | 0.25 | 0.2 | 3.0 | — | — | — | 0.6 | 0.5 | | | | |
| 38 | 4.6 | 0.45 | 0.2 | 3.0 | — | — | — | 0.75 | 0.5 | | | | |
| 39 | — | — | — | 5.0 | 9.0 | — | — | — | — | | | 18.5% | Ni |
| 40 | — | — | — | 4.9 | 9.3 | — | — | — | — | | | 1.10% | Ti |

AA—refers to the sum of % Y + % Sc + % REE
*in ppm.

Several Steels were tested.

| # | % Cr | % Mn | % Si | % Mo | % Co | % W | % Nb | % V | % C | % O* | AA | OTHERS |
|---|---|---|---|---|---|---|---|---|---|---|---|---|
| 1 | | 0.55 | | | | | | | 0.25 | 0.34 | 1.26 | |
| 2 | | 0.65 | | | | | | | 0.35 | | | |
| 3 | | 0.65 | | | | | | | 0.45 | | | |
| 4 | | 0.75 | | | | | | | 0.55 | | | |
| 5 | | 0.75 | | | | | | | 0.6 | 0.71 | 2.62 | |
| 6 | | <1.4 | | | | | | | <0.22 | | | P, S, N |
| 7 | | <1.6 | <0.55 | | | | | | <0.22 | | | P, S |
| 8 | 1.05 | 0.75 | | | | | | | 0.41 | | | |
| 9 | 1.05 | 0.75 | 0.22 | | | | | | 0.25 | 1.41 | 5.21 | |
| 10 | 1.05 | 0.75 | 0.22 | | | | | | 0.34 | | | |
| 11 | 1.05 | 0.75 | 0.22 | | | | | | 0.42 | | | |
| 12 | 1.05 | 0.75 | 0.22 | | | | | | 0.42 | | | S |
| 13 | 1.5 | 0.65 | 0.22 | | | | | | 0.34 | 1.34 | 4.98 | Ni 1.5 |
| 14 | 2.0 | 0.45 | 0.4 | | | | | | 0.3 | | | Ni 2.0 |
| 15 | 1.8 | 0.45 | 0.35 | | | | | | 0.36 | | | Ni 3.85 |
| 16 | 1.5 | 0.35 | 0.25 | | | | | | 1.0 | | | Al <0.05, Cu |
| 17 | 1.55 | 1.10 | 0.6 | | | | | | 1.0 | 0.24 | 0.9 | Al <0.05, Cu |
| 18 | 1.8 | 0.70 | 0.25 | 0.17 | | | | | 1.0 | | | Al <0.05, Cu |
| 19 | | 0.65 | 1.65 | | | | | | 0.38 | | | Cu, Sn |
| 20 | 0.35 | 0.85 | 1.8 | | | | | | 0.61 | 0.67 | 2.47 | Cu, Sn |
| 21 | 0.85 | 0.85 | | | | | | | 0.55 | | | Cu, Sn |
| 22 | 1.05 | 0.9 | | | | | | 0.17 | 0.55 | | | Cu, Sn |
| 23 | 1.05 | 0.9 | | 0.22 | | | | 0.15 | 0.52 | 1.39 | 5.14 | Cu, Sn |
| 24 | 0.85 | 0.75 | | | | | | | 0.17 | | | |
| 25 | 0.95 | 1.15 | | | | | | | 0.16 | | | |
| 26 | 0.95 | 1.15 | | | | | | | 0.16 | 1.15 | 4.25 | S 0.03 |
| 27 | 1.15 | 1.25 | | | | | | | 0.20 | | | |
| 28 | 0.55 | 0.80 | | 0.2 | | | | | 0.20 | | | Ni 0.55 |
| 29 | 0.55 | 0.80 | | 0.2 | | | | | 0.20 | | | S 0.03, |
| | | | | | | | | | | | | Ni 0.55 |
| 30 | 0.75 | 0.55 | | | | | | | 0.17 | 0.72 | 2.67 | Ni 3.25 |
| 31 | 1.65 | 0.70 | | 0.3 | | | | | 0.18 | | | Ni 1.55 |
| 32 | 1.05 | 0.75 | | 0.2 | | | | | 0.18 | 0.53 | 1.98 | S 0.03 |
| 33 | 1.15 | 0.55 | | 0.2 | | | | | 0.34 | | | Al 1.00 |
| 34 | 1.65 | 0.55 | | 0.3 | | | | | 0.41 | | | Al 1.00 |
| 35 | 2.50 | 0.55 | | 0.2 | | | | 0.15 | 0.31 | 0.28 | 1.05 | |
| 36 | 1.65 | 0.55 | | 0.2 | | | | | 0.34 | | | Al 1.00, Ni |
| | | | | | | | | | | | | 1.00 |
| 37 | <0.11 | 1.10 | <0.05 | | | | | | <0.14 | 1.44 | 5.36 | P, S |
| 38 | <0.11 | 1.10 | <0.05 | | | | | | <0.14 | | | P, S, Pb |
| 39 | 0.04 | 1.40 | 0.50 | | | | | 0.14 | 0.19 | 1.14 | 5.24 | |
| 40 | 0.04 | 1.40 | 0.50 | | | | | 0.14 | 0.38 | | | |
| 41 | 0.04 | 1.40 | 0.50 | | | | | 0.14 | 0.46 | | | |
| 42 | | 1.30 | | | | | | | 0.30 | | | B 0.003 |
| 43 | 0.45 | 1.25 | | | | | | | 0.27 | 1.17 | 4.35 | B 0.003 |
| 44 | 0.45 | 1.35 | | | | | | | 0.33 | | | B 0.003 |

AA—refers to the sum of % Y + % Sc + % REE
*in ppm.

Several Ultra High Strength Iron-Based Alloys were tested:

| # | % Cr | % Mn | % Si | % Mo | % Co | % Ni | % Nb | % V | % C | % O* | AA | OTHERS | |
|---|---|---|---|---|---|---|---|---|---|---|---|---|---|
| 1 | 0.01 | 0.02 | 0.02 | 4.8 | 11.9 | 18.5 | — | — | 0.01 | | | | |
| 2 | 9.9 | — | — | 1.9 | 14.2 | 5.4 | — | 0.28 | 0.21 | 720 | 2.7 | | |
| 3 | 3.4 | — | — | 1.8 | 16.3 | 7.6 | — | 0.03 | 0.12 | | | | |
| 4 | 3.4 | — | — | 1.1 | 18.1 | 9.5 | — | 0.08 | 0.14 | | | | |
| 5 | 0.9 | — | — | 1.9 | 6.9 | 9.9 | — | 0.11 | 0.31 | 1160 | 4.3 | | |
| 6 | 23.0 | 1.0 | 0.5 | — | — | 60 | — | — | 0.1 | | | | |
| 7 | — | — | — | 3 | 8.0 | 17.0 | — | — | — | | | 0.15% | Ti |
| 8 | — | — | — | 3.5 | 9.0 | 19.0 | — | — | — | | | 0.25% | Ti |
| 9 | — | — | — | 4.6 | 7.0 | 17.0 | — | — | — | | | 0.3% | Ti |
| 10 | — | — | — | 5.2 | 8.5 | 19.0 | — | — | — | | | 0.5% | Ti |
| 11 | — | — | — | 4.6 | 8.5 | 18.0 | — | — | — | | | 0.5% | Ti |
| 12 | — | — | — | 5.2 | 9.5 | 19.0 | — | — | — | | | 0.8% | Ti |
| 13 | — | — | — | 4.6 | 11.5 | 18.0 | — | — | — | | | 1.3% | Ti |
| 14 | — | — | — | 5.2 | 12.5 | 19.0 | — | — | — | | | 1.6% | Ti |
| 15 | 1.25 | 0.75 | 0.65 | — | — | 0.5 | — | — | 0.27 | | | | |
| 16 | 1.0 | 0.5 | 0.75 | — | — | 1.0 | — | 0.1 | 0.2 | 200 | 0.8 | | |
| 17 | 5.0 | 0.75 | 0.3 | 1.4 | — | — | — | 0.5 | 0.4 | | | | |
| 18 | 3.75 | 0.3 | 0.5 | 5.0 | — | — | — | 0.5 | 0.8 | | | 5.5% | W |
| 19 | 4.0 | 0.3 | 0.45 | 8.0 | 0.25 | — | — | 1.0 | 0.8 | | | 0.25% | W |
| 20 | 13.0 | 0.5 | 0.5 | 0.5 | — | 2.0 | — | — | 0.2 | | | 3% | W |
| 21 | 11.5 | 1.35 | 0.5 | 2.75 | — | 0.5 | — | 0.25 | 0.3 | 320 | 1.2 | | |
| 22 | 17.5 | 1.0 | 1.0 | — | — | 5.0 | 0.45 | — | 0.07 | | | 5% | Cu |
| 23 | 16.5 | 1.25 | 0.5 | 1.25 | — | 5.0 | — | — | 0.11 | | | | |
| 24 | 17.5 | 1.0 | 1.0 | — | — | 7.5 | — | — | 0.08 | 940 | 3.5 | | |
| 25 | 16.0 | 1.75 | — | 6.0 | — | 25.0 | — | — | 0.05 | | | | |
| 26 | 15.9 | 0.75 | 0.5 | 2.5 | — | 14.1 | 0.45 | — | 0.12 | | | 0.25% | Ti |
| 27 | 24.0 | 3.6 | — | 7.3 | — | 22.0 | — | — | 0.01 | | | 0.6% | Cu |
| 28 | 16.0 | 2.0 | 1.0 | 1.5 | — | 27.0 | — | 0.5 | — | | | 2.35% | Ti |
| 29 | 13.5 | 1.65 | 0.8 | 1.75 | — | 26.0 | — | — | 0.03 | | | 3% | Ti |

AA—refers to the sum of % Y + % Sc + % REE
*in ppm.

Several Hot Work Tool Steels were tested:

| # | % Cr | % Mn | % Si | % Mo | % Co | % W | % Nb | % V | % C | % O* | AA | OTHERS |
|---|---|---|---|---|---|---|---|---|---|---|---|---|
| 1 | 4.5 | — | — | 1.0 | — | — | — | 0.2 | 0.35 | 555 | 2.1 | |
| 2 | 5.0 | 0.3 | 1.0 | 1.1 | — | — | 0.1 | 0.4 | 0.4 | 260 | 0.1 | |
| 3 | 2.6 | 0.2 | 0.3 | 1.2 | — | — | 0.1 | 0.3 | 0.42 | 1430 | 5.3 | |
| 4 | 4.96 | 0.35 | 1.1 | 1.18 | — | — | — | 0.44 | 0.39 | — | | |
| 5 | 5.0 | 0.4 | 1.1 | 1.3 | — | — | — | 0.4 | 0.38 | | | |
| 6 | 5.2 | 0.4 | 1.1 | 1.3 | — | — | — | 0.95 | 0.39 | | | |
| 7 | 5.2 | 0.4 | 0.4 | 2.8 | — | — | — | 0.55 | 0.38 | | | |
| 8 | 2.9 | 0.35 | 0.3 | 2.8 | — | — | — | 0.5 | 0.31 | 1620 | 0.6 | |
| 9 | 5.0 | 0.55 | 0.2 | 1.75 | — | — | — | 0.55 | 0.38 | | | |
| 10 | 4.5 | 0.25 | 0.2 | 3.0 | — | — | — | 0.55 | 0.5 | | | |
| 11 | 5.0 | 0.25 | 0.2 | 1.3 | — | — | — | 0.45 | 0.37 | | | |
| 12 | 5.0 | 0.25 | 0.2 | 2.8 | — | — | — | 0.65 | 0.38 | 1215 | 0.45 | |
| 13 | — | 0.1 | 0.05 | 5.0 | 9.0 | — | — | — | 0.01 | | | 0.7% Ti |
| 14 | — | 0.05 | 0.05 | 4.9 | 9.3 | — | — | — | 0.01 | | | 1.0% Ti |
| 15 | 1.9 | 1.5 | 0.4 | 0.2 | — | — | — | — | 0.4 | | | |
| 16 | 2.0 | 1.5 | 0.3 | 0.2 | — | — | — | — | 0.38 | 785 | 0.29 | |
| 17 | 2.0 | 1.5 | 0.3 | 0.2 | — | — | — | — | 0.38 | | | 1.1% Ni |
| 18 | 0.35 | 2.0 | 0.3 | — | — | — | — | — | 0.13 | | | 3.5% Ni |
| 19 | 2.0 | 1.8 | 0.2 | 0.3 | — | — | — | — | 0.36 | 920 | 0.34 | |
| 20 | 5.3 | 0.4 | 1.0 | 1.3 | — | — | — | 0.9 | 0.39 | | | |
| 21 | 2.6 | 0.75 | 0.3 | 2.25 | — | — | — | 0.9 | 0.38 | | | |
| 22 | 5.0 | 0.5 | 0.2 | 2.3 | — | — | — | 0.6 | 0.35 | | | |
| 23 | 5.2 | 0.4 | 1.0 | 1.4 | — | — | — | 0.9 | 0.39 | 1375 | 0.51 | |
| 24 | 5.2 | 0.4 | 1.0 | 1.3 | — | — | — | 0.9 | 0.41 | | | |
| 25 | 5.2 | 0.6 | 0.3 | 2.7 | — | — | — | 0.9 | 0.35 | | | |
| 26 | 5.2 | 0.6 | 0.2 | 2.2 | — | — | — | 0.8 | 0.4 | | | 0.6% Ni |
| 27 | 5.1 | 0.6 | 0.3 | 1.6 | — | — | — | 0.7 | 0.42 | | | 0.6% Ni |
| 28 | 4.3 | 0.5 | 0.5 | 2.1 | — | 0.7 | — | 0.9 | 0.4 | 2100 | 0.78 | |
| 29 | 3.4 | 0.9 | 0.3 | 2.5 | — | — | — | 0.6 | 0.39 | | | 0.9% Ni |
| 30 | 4.4 | 0.5 | 0.3 | 1.6 | — | 2.0 | — | 1.7 | 0.51 | | | |
| 31 | 5.2 | 0.7 | 1.0 | 1.3 | — | — | — | 0.4 | 0.3 | 570 | 0.21 | |
| 32 | 1.3 | 0.9 | 0.3 | 0.4 | — | — | — | 0.2 | 0.51 | | | 1.8% Ni |
| 33 | 4.2 | 0.5 | 0.2 | 2.0 | — | 1.6 | — | 1.2 | 0.49 | | | |
| 34 | 3.0 | 0.15 | 0.15 | — | — | 8.5 | — | 0.3 | 0.26 | | | |
| 35 | 3.75 | 0.4 | 0.5 | — | — | 10 | — | 0.6 | 0.36 | 1430 | 0.53 | |
| 36 | 4.0 | 0.2 | 0.2 | 0.3 | 4.0 | 3.75 | — | 1.75 | 0.32 | | | |
| 37 | 4.75 | 0.5 | 0.5 | 0.55 | 4.5 | 4.5 | — | 2.2 | 0.45 | | | |
| 38 | 1.1 | 0.75 | 0.25 | 0.45 | — | — | — | 0.1 | 0.32 | | | 1.65% Ni |
| 39 | 13.0 | 0.7 | 1.35 | — | — | 2.15 | — | 0.6 | 0.5 | | | 13% Ni |

AA—refers to the sum of % Y + % Sc + % REE
*in ppm.

Several titanium-based alloys were tested:

| # | % V | % Mo | % Cr | % Sn | % Al | % Mn | % Zr | % Cu | % Nb | % Fe | AA | OTHERS | |
|---|---|---|---|---|---|---|---|---|---|---|---|---|---|
| 1 | 4.1 | — | — | — | 6.2 | — | — | — | — | 0.2 | | 3.9% | W |
| 2 | 5.1 | — | — | 2.4 | 4.8 | — | — | 1.1 | — | 0.2 | 1.4 | 0.3% | O |
| 3 | 3.9 | — | — | 0.01 | 6.3 | — | — | — | — | 0.1 | 1.1 | 0.28% | O |
| 4 | — | — | — | 2.0 | 4.0 | — | — | — | — | 0.5 | | | |
| 5 | — | — | — | 3.0 | 6.0 | — | — | — | — | 0.3 | | | |
| 6 | 3.5 | — | — | — | 6.75 | — | — | — | — | 0.3 | | 0.08% | C |
| 7 | 4.5 | — | — | — | 5.5 | — | — | — | — | 0.3 | | 0.05% | N |
| 8 | 3.75 | — | — | — | 5.8 | — | — | — | — | 0.4 | | 0.01% | H |
| 9 | 3.8 | — | — | — | 5.6 | — | — | — | — | 0.25 | | | |
| 10 | 5.0 | — | — | 2.5 | 4.9 | — | — | 1.0 | — | 1.0 | | | |
| 11 | 6.0 | — | — | 1.5 | 6.1 | — | — | 0.35 | — | 0.35 | | 0.04% | N |
| 12 | — | 2.2 | — | 2.2 | 6.5 | — | 4.4 | — | — | 0.25 | | 0.05% | C |
| 13 | — | 1.8 | — | 1.8 | 5.5 | — | 3.6 | — | — | 0.2 | | 0.04% | N |
| 14 | — | 1.9 | — | 2.0 | 5.8 | — | 3.9 | — | — | 0.23 | 0.8 | 0.21% | O |
| 15 | 8.4 | 4.5 | 6.5 | — | 4.0 | — | 4.5 | — | — | 0.3 | | | |
| 16 | 7.6 | 3.5 | 5.5 | — | 3.0 | — | 3.5 | — | — | 0.27 | | | |
| 17 | 8.0 | 3.9 | 5.8 | — | 3.4 | — | 3.8 | — | — | 0.2 | 0.3 | 0.11% | O |
| 18 | — | 0.25 | 1.2 | — | 2.7 | 1.1 | — | — | — | 1.7 | | | |
| 19 | — | 0.15 | 0.75 | — | 2.1 | 0.65 | — | — | — | 2.3 | | | |
| 20 | — | 0.65 | 1.5 | — | 3.2 | 0.65 | 0.3 | — | — | 0.8 | 1.2 | 0.3% | O |
| 21 | — | — | — | — | — | — | — | 2.8 | — | 0.2 | | | |
| 22 | — | 1.75 | — | 2.25 | 6.5 | — | 3.5 | — | — | 0.25 | | 0.05% | N |
| 23 | — | 2.25 | — | 1.75 | 5.5 | — | 4.5 | — | — | 0.2 | | | |
| 24 | 2.0 | — | — | — | 2.5 | — | — | — | — | 0.15 | | 0.03% | N |
| 25 | 3.0 | — | — | — | 3.5 | — | — | — | — | 0.2 | | 0.015% | H |
| 26 | — | 1.0 | — | 2.5 | 6.0 | — | 1.5 | — | — | 1.3 | 2.5 | 0.45% | O |
| 27 | — | 0.8 | — | — | 6.1 | — | — | — | 2.0 | 0.12 | | 1% | Ta |
| 28 | — | 0.4 | — | — | 5.3 | — | — | — | 2.3 | 0.15 | | 1.3% | Ta |

AA—refers to the sum of % Y + % Sc + % REE

Several nickel-based alloys were tested:

| # | % Fe | % Cu | % Si | % Mo | % Co | % Cr | % Nb | % Mn | % Al | % Zn | AA | OTHERS | |
|---|---|---|---|---|---|---|---|---|---|---|---|---|---|
| 1 | 5.6 | — | 0.04 | 15.8 | 1.2 | 15.7 | — | 0.35 | — | — | | 3.9% | W |
| 2 | 19.2 | 0.01 | 0.1 | 3.2 | 0.05 | 19.5 | 5.2 | 0.15 | 0.7 | — | | 0.92% | Ti |
| 3 | 20.1 | — | — | 2.9 | — | 20.1 | 4.9 | — | 0.6 | — | 0.3 | 0.08% | O |
| 4 | 39.5 | 0.01 | 0.15 | 3.2 | — | 21.3 | — | — | 0.15 | — | | | |
| 5 | 30.6 | 1.7 | 0.35 | 3.2 | — | 23 | — | 0.8 | 0.1 | — | | 0.01% | C |
| 6 | 6.0 | — | 0.08 | 14.5 | 2.5 | 21.4 | — | 0.5 | 0.6 | — | | | |
| 7 | 6.3 | — | — | 13.2 | 2.3 | 21.1 | — | 0.7 | 0.7 | — | 2.1 | 0.56% | O |
| 8 | 3.0 | — | 0.08 | 17.0 | 2.0 | 16.4 | — | 1.0 | — | — | | | |
| 9 | 7.8 | 0.2 | 0.1 | 22.6 | 3.0 | 3.0 | 0.2 | 3.0 | 0.5 | | | 3.0% | W |
| 10 | 5.3 | 0.01 | 0.5 | 9.2 | 1 | 20.1 | | 0.5 | | 0.4 | | | |
| 11 | 5.1 | — | — | 8 | — | 23.0 | — | — | — | | 0.9 | 0.20% | O |
| 12 | 6.0 | 0.3 | 0.08 | 12.8 | 2.5 | 21.3 | — | 0.5 | — | — | | | |
| 13 | 2.0 | — | — | 14.5 | — | 22.5 | — | — | — | — | | 0.01% | C |
| 14 | 1.3 | — | 0.1 | 30.0 | 1.0 | 1.0 | — | 1.0 | — | — | | 0.02% | C |
| 15 | 2.0 | — | — | 26.0 | — | — | — | — | — | — | 0.5 | 0.12% | O |
| 16 | 0.4 | 0.02 | 0.07 | 9.0 | — | 22.0 | 3.6 | 0.01 | 0.1 | — | | | |
| 17 | 5.2 | 0.2 | 0.96 | 1.3 | — | 16.1 | 0.05 | 0.2 | — | — | | 3.4% | W |
| 18 | 1.0 | 0.01 | 0.01 | 16.2 | 0.5 | 20.6 | — | — | 0.2 | — | | 3.9% | W |
| 19 | 0.5 | 0.2 | 0.1 | 9.0 | 12.3 | 22.0 | — | — | 1.0 | | | 0.3% | Ti |
| 20 | 0.2 | 0.14 | — | 8.3 | 11.7 | 25.0 | — | — | — | — | 4 | 1.0% | O |
| 21 | 1.2 | 29.0 | 0.2 | 0.6 | 0.3 | 0.8 | — | 3.2 | 0.1 | | | 2.2% | Ti |
| 22 | 8.6 | 0.01 | 0.2 | 0.01 | — | 29.7 | 0.75 | 0.4 | 0.25 | — | | 0.45% | Ti |
| 23 | 7.0 | — | — | — | | 30.6 | — | — | — | | | 2.56% | Ti |
| 24 | 18.5 | 0.5 | 1.0 | 8.5 | 1.0 | 21.3 | — | 0.5 | 0.1 | — | | 0.5% | W |
| 25 | 18.4 | 0.3 | 0.6 | 8.1 | — | 22.5 | — | — | — | | 3.4 | 0.9% | O |
| 26 | 20.5 | 0.05 | 0.15 | 3.0 | 0.2 | 17.5 | 5.0 | 0.1 | 0.4 | — | | | |
| 27 | 20.8 | — | — | 3.2 | — | 17.3 | 4.75 | — | — | — | 0.7 | 0.15% | O |
| 28 | 7.3 | 0.01 | 0.02 | 0.05 | 0.04 | 16.7 | — | 2.4 | — | — | | | |
| 29 | 1.3 | 0.02 | 0.1 | 0.01 | 0.05 | 20.5 | 2.4 | 3.1 | — | — | | 0.03% | C |
| 30 | 1.2 | — | — | — | — | 22.3 | 2.8 | 4.25 | — | — | 1.9 | 0.5% | O |
| 31 | 1.5 | 0.5 | 0.1 | 16.0 | — | 23.0 | — | 0.5 | 0.4 | — | | | |
| 32 | 13.3 | 0.01 | 0.24 | 0.01 | — | 22.8 | — | 0.55 | 1.4 | — | | 0.04% | C |
| 33 | 1.1 | 0.3 | 0.3 | 0.5 | 1.0 | 30.8 | 0.8 | 0.5 | 1 | — | | 0.7% | Ti |
| 34 | 1.0 | — | — | 0.5 | 0.9 | 30.3 | 0.4 | 0.2 | 0.8 | — | 4.3 | 1.1% | O |

AA—refers to the sum of % Y + % Sc + % REE

Several copper-based alloys were tested:

| # | % Ni | % Zn | % Al | % Sn | % Fe | % Si | % Pb | % Co | % Be | % Mn | AA | OTHERS | |
|---|---|---|---|---|---|---|---|---|---|---|---|---|---|
| 1 | — | 3.0 | — | — | 0.05 | — | 0.05 | — | — | — | | | |
| 2 | — | 6.0 | — | — | 0.03 | — | 0.01 | — | — | — | | | |
| 3 | — | 10 | — | — | — | — | — | — | — | 0.05 | | | |
| 4 | — | 8.7 | — | — | — | — | — | — | — | 0.08 | | | |
| 5 | — | 9.2 | — | — | — | — | — | — | — | 0.06 | 1.2 | 0.3% | O |
| 6 | — | 0.3 | — | 4.9 | 0.1 | — | 0.05 | — | — | — | | | |
| 7 | — | 0.24 | — | 3.5 | 0.05 | — | 0.04 | — | — | — | | | |
| 8 | — | 3.5 | — | 4.5 | 0.1 | — | 4.0 | — | — | — | | 0.5% | P |
| 9 | — | 1.5 | — | 3.5 | 0.08 | — | 3.0 | — | — | — | | 0.01% | P |
| 10 | — | 0.3 | — | 4.2 | 0.1 | — | 0.05 | — | — | — | | | |
| 11 | — | 0.24 | — | 5.8 | 0.03 | — | — | — | — | — | 0.5 | 0.12% | O |
| 12 | — | 14.2 | 3.0 | 0.5 | 2.0 | — | 0.2 | — | — | 2.5 | | | |
| 13 | — | 13.6 | 6.0 | 0.34 | 4.0 | — | 0.05 | — | — | 5.0 | | | |
| 14 | — | 13.8 | 4.3 | 0.41 | 3.1 | — | — | — | — | 3.2 | 2.3 | 0.6% | O |
| 15 | — | 30.2 | — | 0.5 | 0.4 | — | 0.5 | — | — | 0.05 | | | |
| 16 | — | 34.3 | — | 1.5 | 1.3 | — | 1.0 | — | — | 0.5 | | | |
| 17 | — | 0.2 | 7.0 | — | 1.5 | — | 0.01 | — | — | 1.0 | | 0.015% | P |
| 18 | — | 0.25 | 8.2 | — | 3.5 | — | 0.05 | — | — | 1.3 | | | |
| 19 | 4.0 | 0.01 | 8.7 | — | 3.5 | 0.1 | 0.02 | — | — | 1.2 | | | |
| 20 | 4.8 | 0.05 | 9.5 | — | 4.3 | — | — | — | — | 2.0 | 0.8 | 0.16% | O |
| 21 | — | — | 0.2 | — | 0.05 | 0.2 | — | 0.2 | 1.8 | — | | | |
| 22 | — | — | 0.13 | 0.01 | 0.03 | 0.15 | — | 0.36 | 2.0 | — | | | |
| 23 | 0.1 | — | 0.2 | — | 0.3 | 0.2 | — | 0.2 | 1.3 | — | | | |
| 24 | 0.2 | — | 0.14 | — | 0.4 | 0.1 | — | 0.3 | 2.4 | — | 3.2 | 0.9% | O |
| 25 | 16.5 | 20.8 | — | — | 0.25 | — | 0.05 | — | — | 0.5 | | | |
| 26 | 19.5 | 24.8 | 0.05 | — | 0.2 | — | 0.08 | — | — | 0.36 | | | |
| 27 | — | — | 1.5 | 1.0 | 2.5 | 4.0 | — | — | — | 1.5 | | | |
| 28 | — | — | 2.5 | 0.8 | 1.5 | 3.6 | — | — | — | 1.0 | | | |
| 29 | — | 2 | — | 10 | — | — | 0.3 | — | — | — | | | |
| 30 | — | 0.5 | — | 11 | — | — | 0.5 | — | — | — | 0.65 | 0.13% | O |
| 31 | 12.0 | 20.3 | — | 2.3 | — | — | 10.0 | — | — | — | | | |
| 32 | 20.5 | 8.1 | — | 4.6 | — | — | 4.3 | — | — | — | | | |
| 33 | 25.3 | 2.7 | — | 5.1 | — | — | 2.3 | — | — | — | 1.9 | 0.5% | O |
| 34 | 1.0 | 4.1 | 0.05 | 4.2 | 0.3 | 0.05 | 4.2 | — | — | — | | 0.25% | Sb |
| 35 | 0.6 | 3.9 | 0.02 | 3.7 | 0.24 | — | 6.2 | — | — | — | | 0.05% | P |
| 36 | 0.74 | 5.7 | — | 4.1 | 0.32 | — | 5.3 | — | — | — | 3.7 | 1.0% | O |

AA—refers to the sum of % Y + % Sc + % REE

Several cobalt-based alloys were tested:

| # | % Cr | % W | % Mo | % C | % Fe | % Si | % Ni | % V | % Nb | % Mn | AA | OTHERS | |
|---|---|---|---|---|---|---|---|---|---|---|---|---|---|
| 1 | 20.1 | 12.9 | — | 0.05 | 0.01 | 0.2 | 20.3 | — | — | 0.01 | | | |
| 2 | 24.0 | 15.9 | — | 0.02 | 3.0 | 0.5 | 23.9 | — | — | 1.25 | | 0.12% | La |
| 3 | 22.5 | 13.7 | — | 0.03 | 2.1 | 0.34 | 22.5 | — | — | 0.7 | 1.3 | 0.35% | O |
| 4 | 18.7 | 14.2 | — | 0.05 | 0.02 | 0.01 | 8.9 | — | — | 1.0 | | | |
| 5 | 21.2 | 16.7 | — | 0.15 | 3.2 | 0.45 | 11.7 | — | — | 2.0 | | | |
| 6 | 20.4 | 15.3 | — | 0.07 | 1.64 | 0.23 | 10.4 | — | — | 1.45 | 0.8 | 0.2% | O |
| 7 | 27.0 | 3.5 | 1.5 | 0.9 | 3.0 | 1.5 | 3.0 | — | — | 1.0 | | | |
| 8 | 31.1 | 5.5 | 1.4 | 1.4 | 2.7 | 1.3 | 2.8 | — | — | 0.9 | | | |
| 9 | 29.3 | 4.6 | — | 1.2 | — | — | — | — | — | — | 3.1 | 0.8% | O |
| 10 | 30.2 | 4.3 | 1.6 | 1.3 | 3.6 | 2.0 | 3.7 | — | — | 2.0 | | | |
| 11 | 23.2 | 11.1 | — | 1.8 | 2.0 | 0.8 | 3.0 | — | — | 0.5 | | | |
| 12 | 26.3 | 13.2 | — | 2.5 | 0.05 | 1.5 | 0.08 | — | — | 0.01 | | | |
| 13 | 24.7 | 12.1 | — | 2.2 | 1.4 | 1.2 | 0.16 | — | — | 0.32 | 0.5 | 0.12% | O |
| 14 | 26.3 | — | 4.5 | 0.2 | 0.05 | 0.05 | 2.0 | — | — | — | | | |
| 15 | 29.1 | — | 6.0 | 0.35 | 3.0 | 1.5 | 3.0 | — | — | — | | | |
| 16 | 28.3 | 0.01 | 5.7 | 0.28 | 2.4 | 1.1 | 2.4 | — | — | 0.05 | 2.3 | 0.52% | O |
| 17 | 24.5 | 6.9 | — | 0.45 | 0.06 | 0.07 | 9.5 | — | — | 0.04 | | | |
| 18 | 26.5 | 8.1 | — | 0.55 | 2.0 | 1.0 | 11.5 | — | — | 1.0 | 4.3 | 1.0% | O |
| 19 | 0.05 | 0.05 | — | 0.02 | 1.3 | 0.5 | 3.2 | 1.7 | — | 0.8 | | | |
| 20 | 1.3 | 1.2 | — | 0.5 | 2.0 | 1.0 | 4.6 | 2.1 | — | 1.0 | | | |
| 21 | 19.0 | — | 1.2 | 0.02 | 3.0 | 0.4 | 20.3 | — | 2.2 | 5.0 | | | |
| 22 | 20.3 | — | 2.3 | 0.8 | 5.6 | 1.0 | 24.1 | — | 3.1 | 7.2 | 0.8 | 0.2% | O |

AA—refers to the sum of % Y + % Sc + % REE

Several aluminum-based alloys were tested:

| # | % Mg | % Si | % Mn | % Ti | % Cr | % Fe | % Ni | % Cu | % Zn | % Sn | AA | OTHERS |
|---|---|---|---|---|---|---|---|---|---|---|---|---|
| 1 | 0.7 | 0.5 | 0.2 | | | 0.8 | | 0.3 | 0.2 | | 1.44 | 0.39% O |
| 2 | ≤0.05 | | ≤0.05 | ≤0.05 | — | ≤0.40 | — | ≤0.05 | ≤0.07 | — | | |
| 3 | — | | ≤0.05 | ≤0.05 | — | — | — | ≤0.05 | ≤0.10 | — | | |
| 4 | 0.4 | | 0.5 | ≤0.20 | ≤0.10 | ≤0.80 | ≤0.20 | 3.3 | ≤0.80 | ≤0.20 | | |
| 5 | 1.8 | | 1.0 | ≤0.20 | ≤0.10 | ≤0.80 | ≤0.20 | 4.6 | ≤0.80 | ≤0.20 | 2.98 | 0.8% O, |
| | | | | | | | | | | | | Pb, Sn, |
| | | | | | | | | | | | | Bi |
| 6 | — | | — | — | — | ≤0.70 | — | 5.0 | ≤0.30 | — | | Pb, Sn, |
| | | | | | | | | | | | | Bi |
| 7 | 0.2 | | 0.4 | ≤0.15 | ≤0.10 | ≤0.70 | — | 3.9 | ≤0.25 | — | | |
| 8 | 0.8 | | 1.2 | ≤0.15 | ≤0.10 | ≤0.70 | — | 5.0 | ≤0.25 | — | | |
| 9 | 0.2 | | 0.4 | ≤0.15 | ≤0.10 | ≤0.50 | ≤0.10 | 3.9 | ≤0.25 | — | 3.87 | 1.04% O |
| 10 | 0.8 | | 1.2 | ≤0.15 | ≤0.10 | ≤0.50 | ≤0.10 | 5.0 | ≤0.25 | — | | |
| 11 | 0.4 | | 0.4 | — | ≤0.10 | ≤0.70 | — | 3.5 | ≤0.25 | — | | |
| 12 | 1.0 | | 1.0 | — | ≤0.10 | ≤0.70 | — | 4.5 | ≤0.25 | — | | |
| 13 | 1.2 | | 0.3 | ≤0.15 | ≤0.10 | ≤0.50 | — | 3.8 | ≤0.25 | — | 5.42 | 1.46% O |
| 14 | 1.8 | | 0.9 | ≤0.15 | ≤0.10 | ≤0.50 | — | 3.8 | ≤0.25 | | | |
| 15 | 0.5 | | 0.2 | ≤0.20 | ≤0.10 | ≤0.70 | — | 3.3 | ≤0.50 | — | | Bi, Pb |
| 16 | 1.3 | | 1.0 | ≤0.20 | ≤0.10 | ≤0.70 | — | 3.3 | ≤0.50 | | | |
| 17 | — | | 1.0 | — | — | ≤0.70 | — | 0.05 | ≤0.10 | — | 4.63 | 1.25% O |
| 18 | 0.8 | | 1.0 | — | — | ≤0.70 | — | ≤0.25 | ≤0.25 | — | | |
| 19 | 1.3 | | 1.5 | — | — | ≤0.70 | — | ≤0.25 | ≤0.25 | — | | |
| 20 | 0.2 | | 1.0 | ≤0.10 | ≤0.10 | ≤0.70 | — | ≤0.30 | ≤0.25 | — | | |
| 21 | 0.6 | | 1.5 | ≤0.10 | ≤0.10 | ≤0.70 | — | ≤0.30 | ≤0.25 | — | 0.25 | 0.06% O |
| 22 | ≤0.30 | | 0.9 | — | ≤0.10 | ≤0.70 | — | ≤0.10 | ≤0.20 | — | | |
| 23 | ≤0.30 | | 1.5 | — | ≤0.10 | ≤0.70 | — | ≤0.10 | ≤0.20 | — | | |
| 24 | 0.2 | | 0.3 | ≤0.10 | ≤0.20 | ≤0.70 | — | ≤0.30 | ≤0.40 | — | | |
| 25 | 0.8 | | 0.8 | ≤0.10 | ≤0.20 | ≤0.70 | — | ≤0.30 | ≤0.40 | — | 1.05 | 0.28% O |
| 26 | 0.5 | | ≤0.20 | — | ≤0.10 | ≤0.70 | — | ≤0.20 | ≤0.25 | — | | |
| 27 | 1.1 | | ≤0.20 | — | ≤0.10 | ≤0.70 | — | ≤0.20 | ≤0.25 | — | | |
| 28 | 0.7 | | ≤0.15 | — | ≤0.10 | ≤0.45 | — | ≤0.05 | ≤0.20 | — | | |
| 29 | 1.1 | | ≤0.15 | — | ≤0.10 | ≤0.45 | — | ≤0.05 | ≤0.20 | — | 3.09 | 0.83% O |
| 30 | 1.6 | | 0.5 | ≤0.1 | ≤0.30 | ≤0.50 | — | ≤0.10 | ≤0.20 | — | | |
| 31 | 2.5 | | 1.1 | ≤0.1 | ≤0.30 | ≤0.50 | — | ≤0.10 | ≤0.20 | — | | |
| 32 | 2.2 | | ≤0.10 | — | 0.15 | ≤0.40 | — | ≤0.10 | ≤0.10 | — | | |
| 33 | 2.8 | | ≤0.10 | — | 0.35 | ≤0.40 | — | ≤0.10 | ≤0.10 | — | 4.93 | 1.33% O |
| 34 | 4.0 | | 0.4 | ≤0.15 | 0.05 | ≤0.40 | — | ≤0.10 | ≤0.25 | — | | |
| 35 | 4.9 | | 1.0 | ≤0.15 | 0.25 | ≤0.40 | — | ≤0.10 | ≤0.25 | — | | |
| 36 | 3.5 | | 0.2 | ≤0.15 | 0.05 | ≤0.50 | — | ≤0.10 | ≤0.25 | — | | |
| 37 | 4.5 | | 0.7 | ≤0.15 | 0.25 | ≤0.50 | — | ≤0.10 | ≤0.25 | | 5.87 | 1.58% O |
| 38 | 3.1 | | ≤0.50 | ≤0.20 | ≤0.25 | ≤0.50 | — | ≤0.10 | ≤0.20 | — | | |
| 39 | 3.9 | | ≤0.50 | ≤0.20 | ≤0.25 | ≤0.50 | — | ≤0.10 | ≤0.20 | — | | |
| 40 | 4.0 | | 0.2 | ≤0.10 | ≤0.10 | ≤0.35 | — | ≤0.15 | ≤0.25 | — | 2.72 | 0.73% O |
| 41 | 5.0 | | 0.5 | ≤0.10 | ≤0.10 | ≤0.35 | — | ≤0.15 | ≤0.25 | | | |
| 42 | 1.7 | | 0.1 | ≤0.15 | ≤0.15 | ≤0.50 | — | ≤0.15 | ≤0.15 | — | | |
| 43 | 2.6 | | 0.6 | ≤0.20 | 0.1 | ≤0.40 | — | ≤0.10 | ≤0.25 | — | | |
| 44 | 2.9 | | ≤0.50 | ≤0.15 | ≤0.30 | ≤0.40 | — | ≤0.10 | ≤0.20 | — | 4.89 | 1.32% O |
| 45 | 0.6 | | ≤0.50 | ≤0.10 | ≤0.30 | ≤0.35 | — | ≤0.30 | ≤0.20 | — | | |
| 46 | 0.4 | | ≤0.20 | ≤0.15 | ≤0.10 | ≤0.50 | — | ≤0.20 | ≤0.20 | — | | |
| 47 | 0.52 | | ≤0.10 | ≤0.10 | ≤0.05 | 0.2 | — | ≤0.10 | ≤0.15 | — | | |
| 48 | 0.9 | | ≤0.15 | ≤0.15 | 0.1 | ≤0.7 | — | 0.25 | ≤0.25 | — | 5.01 | 1.35% O |
| 49 | 0.6 | | ≤0.10 | ≤0.10 | ≤0.10 | ≤0.35 | — | ≤0.10 | ≤0.10 | — | | |
| 50 | 0.8 | | 0.4 | ≤0.10 | ≤0.25 | ≤0.50 | — | ≤0.10 | ≤0.20 | — | | |
| 51 | 0.7 | | 0.05 | ≤0.10 | ≤0.20 | ≤0.35 | — | ≤0.25 | ≤0.15 | — | | |
| 52 | 2.5 | | ≤0.10 | ≤0.06 | ≤0.05 | ≤0.15 | ≤0.05 | 1.9 | 5.9 | — | 3.28 | 0.88% O |
| 53 | 1.2 | | 0.1 | — | 0.19 | ≤0.40 | — | ≤0.20 | 4.8 | — | | |
| 54 | 2.5 | | ≤0.30 | ≤0.20 | 0.19 | ≤0.50 | — | 1.4 | 5.4 | — | | |
| 55 | ≤0.05 | | ≤0.05 | ≤0.05 | — | ≤0.40 | — | ≤0.05 | ≤0.07 | — | 2.15 | 0.58% O |

AA—refers to the sum of % Y + % Sc + % REE

Several magnesium-based alloys were tested.

| # | % Al | % Fe | % Zn | % Cu | % Si | % Mn | % Ni | % Li | % Ag | AA | OTHERS |
|---|---|---|---|---|---|---|---|---|---|---|---|
| 1 | 8.5 | 0.004 | 0.45 | 0.025 | 0.05 | 0.17 | 0.001 | 0.5 | | 1.29 | 0.35% O |
| 2 | 9.5 | 0.004 | 0.9 | 0.025 | 0.05 | 0.40 | 0.001 | | | | |
| 3 | 5.6 | 0.004 | 0.20 | 0.008 | 0.05 | 0.26 | 0.001 | | | | |
| 4 | 6.4 | 0.004 | 0.20 | 0.008 | 0.05 | 0.5 | 0.001 | | | | |
| 5 | 4.5 | 0.004 | 0.20 | 0.008 | 0.005 | 0.28 | 0.001 | | | 2.49 | 0.67% O |
| 6 | 5.3 | 0.004 | 0.20 | 0.008 | 0.005 | 0.5 | 0.001 | 2.3 | | | |
| 7 | 3.7 | 0.003 | 0.10 | 0.015 | 0.6 | 0.35 | 0.001 | | | | |
| 8 | 4.8 | 0.003 | 0.10 | 0.015 | 1.4 | 0.6 | 0.001 | | | 4.98 | 1.34% O |
| 9 | 5.5 | | | | | | | 12.0 | 1.0 | | |

AA—refers to the sum of % Y + % Sc + % REE

Several metal matrix composites were tested.

| # | % Ni | % Co | % Fe | % Cu | % WC | % MOC | % VC | % TiC | Mixed Carbides | OTHERS |
|---|---|---|---|---|---|---|---|---|---|---|
| 1 | 5.5 | 12.0 | — | — | 80.5 | — | 2 | — | | |
| 2 | — | — | 18.8 | — | 80.0 | 1.2 | — | — | | |
| 3 | 1.1 | 0.5 | 80.3 | — | 2.1 | — | 1 | 15 | | |
| 4 | — | 1.3 | 35 | 5.5 | 15 | 3.2 | — | 40 | | |
| 5 | 2.2 | — | 35.2 | 3.2 | 2.3 | — | 38.9 | — | | |
| 6 | 13.2 | 1.2 | 40.8 | — | 3.1 | | — | — | | |
| 7 | 3.4 | — | 56.4 | — | 12.3 | 4.6 | 41.7 | — | | |
| 8 | — | — | 54.8 | 1.7 | 15.1 | — | 28.7 | — | | |
| 9 | — | 9.8 | 60.5 | — | 23.2 | 6.5 | — | — | | |
| 10 | — | — | 80.2 | 12.5 | 7.3 | — | — | — | | |

AA—refers to the sum of % Y + % Sc + % REE

Several RAFM steels were tested:

| # | % C | % Cr | % V | % Ta | % W | % Ti | % Mn | % P + % S | % Si | % N | % O | BB | AA | OTHERS |
|---|---|---|---|---|---|---|---|---|---|---|---|---|---|---|
| 1 | 0.01- | 6.6- | 0.01- | 0.001- | 0.1- | 0.0001- | 0.06- | 0.0001- | 0.0001- | 0.001- | 0.0001- | 0.0001- | <2.9 | |
| | 0.29 | 10.9 | 0.49 | 0.8 | 4.9 | 0.9 | 1.3 | 0.05 | 0.29 | 0.12 | 1.2 | 0.09 | | |
| 2 | 0.012- | 7.1- | 0.012- | 0.0016- | 0.12- | 0.001- | 0.07- | 0.001- | 0.0002- | 0.0012- | 0.00012- | 0.00012- | — | B |
| | 0.23 | 10.4 | 0.36 | 0.64 | 3.9 | 0.79 | 0.94 | 0.02 | 0.19 | 0.11 | 0.48 | 0.08 | | <0.06; |
| | | | | | | | | | | | | | | Nb |
| | | | | | | | | | | | | | | <0.001 |
| 3 | 0.091- | 8.7- | 0.16- | 0.062- | 1.1- | 0.00012- | 0.32- | 0.0006- | 0.0012- | 0.018- | 0.0006- | 0.006- | <0.19 | |
| | 0.12 | 9.3 | 0.23 | 0.086 | 1.94 | 0.079 | 0.56 | 0.0045 | 0.064 | 0.039 | 0.008 | 0.045 | | |
| 4 | 0.1- | 9.1- | 0.13- | 0.44- | 0.8- | 0.0012- | 0.16- | 0.0004- | 0.012- | 0.01- | 0.0002- | 0.003- | | % Ni |
| | 0.14 | 9.4 | 0.19 | 0.62 | 2.46 | 0.016 | 0.63 | 0.004 | 0.09 | 0.059 | 0.01 | 0.06 | | <0.04 |
| 5 | 0.08- | 7.8- | 0.02- | 0.002- | 0.16- | 0.0002- | 0.08- | 0.0008- | 0.0008- | 0.004- | 0.0016- | 0.00016- | | |
| | 0.012 | 9.4 | 0.11 | 0.43 | 1.64 | 0.44 | 0.49 | 0.041 | 0.14 | 0.09 | 0.94 | 0.084 | | |

AA—refers to the sum of % Y + % Sc + % REE
BB refers to the sum of % As + % Sn + % Sb + % Zr % Ni, % Mo, % Cu % Nb, % Al % B, % Co <0.09

Several ODS-RAFM steels were tested:

| # | % C | % Cr | % V | % Ta | % W | % Ti | % Mn | % P + % S | % Si | % N | % O | BB | AA | OTHERS |
|---|---|---|---|---|---|---|---|---|---|---|---|---|---|---|
| 1 | 0.01- | 6.6- | 0.01 | 0.001 | 0.1- | 0.0001- | 0.06- | 0.0001 | 0.0001- | 0.001- | 0.0001- | 0.0001- | <2.9 | |
| | 0.29 | 10.9 | to | to | 4.9 | 0.9 | 1.3 | to | 0.29 | 0.12 | 1.2 | 0.09 | | |
| | | | 0.49 | 0.8 | | | | 0.05 | | | | | | |
| 2 | 0.016- | 6.9- | 0.016- | 0.0016- | 0.12- | 0.00016- | 0.068- | 0.00012- | 0.00016- | 0.0012- | 0.00016- | 0.00016- | | |
| | 0.19 | 9.4 | 0.31 | 0.48 | 2.4 | 0.34 | 0.94 | 0.045 | 0.14 | 0.09 | 0.93 | 0.084 | | |
| 3 | 0.014- | 8.6- | 0.16- | 0.06- | 0.84- | 0.012- | 0.28- | 0.0004- | 0.0009- | 0.014- | 0.024- | 0.0044- | % Al | |
| | 0.09 | 9.7 | 0.28 | 0.094 | 2.16 | 0.46 | 0.64 | 0.008 | 0.08 | 0.052 | 0.46 | 0.056 | <0.04 | |
| 4 | 0.012- | 7.2- | 0.019- | 0.0016- | 0.9- | 0.001- | 0.09- | 0.00016- | 0.00016- | 0.0012- | 0.0016- | 0.00019- | | |
| | 0.23 | 9.8 | 0.46 | 0.68 | 3.9 | 0.84 | 1.24 | 0.048 | 0.27 | 0.09 | 0.074 | 0.088 | | |

AA—refers to the sum of % Y + % Sc + % REE
BB refers to the sum of % As + % Sn + % Sb + % Zr % Ni, % Mo, % Cu % Nb, % Al % B, % Co <0.09

EXAMPLE 3. Elemental powders and combinations of elemental powders and master-alloys were used for the obtaining of powders with the composition of example 2. In most cases where master-alloys were used, it was more than one master alloy, for example in some powders containing % Cr, % Mo and % V amongst others samples were produced using a triple master alloy (CrMoVFe) but also with simple master alloys (CrFe), (MoFe), (VFe). In some cases, even completely pre-alloyed powders were used. Very often powders were introduced at different points of time into the treatment, that is to say some powders were introduced into the treatment mixing them with other powders that had already been undergoing treatment, and often also powders were introduced after the treatment so that those powders would not undergo treatment with applied energy into the powder but would be part of the powder mix when undergoing the shaping step. Several containers were available (metallic, metal-base composites, ceramics and even polymeric ones). The containers used were selected to minimize the contamination of the processed powders (as an example some of the materials with % Cr>12% were having a strong galling to the stainless steel container leading to much more severe contamination of the processed powder than for example when a tungsten carbide container was used). A similar criteria as described for the container was used for the selection of the processing material. In this case there was even a higher selection because all the materials that were available as containers were available as processing materials and additionally a couple steels more than the ones used as container material (namely one extra managing steel and one super-austenitic steel). In some tests the test parameters were set to a desired level but in most test the parameters were chosen as a result of an objective MDD or PAD1 value, in some experiments what was fixed was a certain evolution of the MDD or PAD1 value throughout the whole method as will be seen in other examples and once more the actual processing parameters described in this example directly resulted from the MDD/PAD1 fixed values. In most tests the processing material had the shape of balls, but also more cylindrical shapes like rods, barrels and even cylinders were used. For some difficult materials even grinding cylpebs were tried. The sizes of the processing materials were in terms of equivalent diameter from 2 mm to more than 20 mm. Different rotations speeds were tested, but in all cases the speed was chosen to be over 51 rpm, exceeding 1600 rpm in some test, and even over 2100 rpm.

The ratio of processing material-to-container volume used was between 1:180 and 1:1.3 with a percentage of volume of the container occupied by the processed material between 4% and 79%, often between 12% and 64%, and a percentage of volume of the container occupied by the processing material between 7% and 84%, although some tests were carried out at a narrower range, between 18% and 52%, and even between 28% and 47%. In any case, the volume ratio of processed material to processing material in the different test was maintained between 0.31 and 2.2, often between 0.43 and 1.36.

The mean weight of the processing materials used ranged from 0.8 g to more than 210 g, with individual processing materials having weights ranging from 0.6 g to more than 510 g, in order to ensure a processing material to processed material weight ratio of between 8:1 and 480:1. Treatments of different durations were tested ranging from few minutes (even less than 14 minutes) to several hours and in some test even longer durations were tested ranging from several days (more than 48 hours) to several weeks.

The circulation rates of the different experiments varied from less than 1 to more than 20. Velocities of the processing materials were tested very thoroughly and thus there was a very wide range of velocities tested ranging from less than 10 cm/s to a way more than 10 m/s. Something similar happened with the average impact frequencies thus some tests resulted in average impact frequency values well below half a Hertz all the way up to experiments with 40 kHz. Another aspect that was very thoroughly tested was the influence of the atmosphere, air, inert (including He, Ar, N₂), reducing (including H2, organic, CO, ammonia) and mixtures (including N2+H2, Ar+H2, N2+CO) atmospheres were tested. Most tests with particular atmospheres were done at overpressure, but some were made at atmospheric pressure and also with lower pressures as partial pressure in a vacuum system.

Most partial pressure treatments were done with a partial vacuum between 1 e-3 mbar and 950 mbar. Most vacuum tests were done with vacuum levels between 1 e-2 and 1 e-6 mbar, although some tests were made at even higher vacuum levels. Most tests with over-pressure were made with pressure levels between atmospheric pressure and 10 bars overpressure. Some tests were performed with a special equipment for extremely high pressure at much higher pressures. The different materials were tested for improvement in the attained properties when the treatment applying energy to the powder was made in cryogenic conditions. Most tests were made between room temperature and immersion in liquid nitrogen. For the tests with temperature regulation of the container only temperatures up to −120° C. were possible. Some combinations of processing material and processed material lead to fracture of the processing material specially for the tests in liquid nitrogen. Many tests were performed at “relatively high” temperatures, relative in the sense that the test temperature was not fixed in absolute terms but as a function of the processed material. In this case the material considered to determine its melting temperature was the material with the final composition, even when departing from elemental powders or mixtures with master-alloys and the melting temperature was the equilibrium temperature (often determined with Termocalc) for the formation of the first liquid droplet. The tests were performed from about 0.10Tm to more than half of the melting temperature, the melting temperature always being determined in degrees Kelvin. The process parameters that were more thoroughly analyzed and tested were: energy introduced into processed powder, KA1, KA2, MDD, PAD1 and levels of % N, % H, % O, % B and for most compositions also % C. In fact a very extensive work has been made to determine the correlation between the levels of % N, % H, % O and % B not only during the treatment which comprises applying energy into the powder but throughout the whole method including the optional steps and the mechanical properties achievable, very interesting and surprising results were found on how different combinations of levels at different method steps lead to very different results even when the final level of % N, % H, % O, % B and % C were the same at the end.

Looking at all experiments and tests performed whether the energy introduced into the powder was the controlled variable or a consequence of other control variables the range of values employed/determined was between 50 and 250 J/(g*hit) for most tests with some tests going even below 15 and some going above 400. In terms of raw energy looking at all the experiments they went from 1 e-5 to more than 10 J/hit.

Looking at all experiments and tests performed whether the KA1 was the controlled variable or a consequence of other control variables the range of values employed/determined for most of the experiments was between 50 and 1000. But some experiments had KA1 values even below 5 and a few others had KA1 values even higher than 4000.

Looking at all experiments and tests performed whether the KA2 was the controlled variable or a consequence of other control variables the range of values employed/determined was in most of the tests between 2.5 and 800. Several tests were made at higher values up to even more than 4000. A few tests were made at lower values even below 0.5.

Looking at all experiments and tests performed whether the MDD was the controlled variable or a consequence of other control variables the range of values employed/determined was between 1 e12 and 1 e19 with most tests made with MDD values between 1 e15 and 1 e18.

Looking at all experiments and tests performed whether the PAD1 was the controlled variable or a consequence of other control variables the range of values employed/determined was between 10 and more than 350.

In many experiments the main control variable was the increase of PAD1 and in several of those experiments the control variable was the increase and further decrease of PAD1 and often a further increase in PAD1 throughout the whole method including the optional steps and the correlation to the mechanical properties was observed, very interesting and surprising results were found on how different combinations of levels at different method steps lead to very different results even when the final level of PAD1 were the same at the end. In the treatment that comprises applying energy into the powder the increases in PAD1 tested ranged from more than 1 to more than 20 (in terms of addition to the PAD1 value), and the further decreases tested in that treatment ranged from more than one to more than 15.

In several experiments the main control variable was the increase of the MDD value and in several of those experiments the control variable was the increase and further decrease of MDD and often a further increase in MDD throughout the whole method including the optional steps and the correlation to the mechanical properties was observed, very interesting and surprising results were found on how different combinations of levels at different method steps lead to very different results even when the final level of MDD were the same at the end. In the treatment that comprises applying energy into the powder the increases in MDD tested ranged from more than 1.5× to more than 20×, and the further decreases tested in that treatment ranged from more 0.03× to more than 0.5×.

The level of % N, % H, % O and % B in the case where different powders were mixed as departing powder, was determined as a weighted mixture of the levels in each one of the powders. In the different experiment made when measured for the original powder or powder mixtures the levels measured/targeted (in many experiments the powders were chosen or pre-oxidized/nitrided/boronized/treated in a % H atmosphere or carburized to have a specific starting concentration) were % O: from less than 0.1 ppm to more than 30,000 ppm. % N: from less than 1 ppm to more than 0.25%. % H: from less than half a ppm to more than 500 ppm; % B: from less than half a ppm to more than 0.5%; % C: from less than 1e-2 ppm to more than 3.5%.

The levels targeted after (or in some cases at a specific point during the treatment) the method step with the treatment comprising applying energy into the powder were set to values within the following ranges when looking at all experiments executed: % O: from less than 200 ppm to more than 40,000 ppm. % N: from less than 20 ppm to more than 15,000 ppm. % H: from less than half a ppm to more than 500 ppm; % B: from less than one ppm to more than 0.5%; % C: from less than 0.1 ppm to more than 3.5%.

EXAMPLE 4. The example 3 encompassed thousands of experiments. One such experiment was:

Departing from the following elemental powders:

% C: 0.5 (which was not added from the beginning); % Mo: 4.5; % Mn: 1.2; % Y: 1%; % Fe: Rest.

In a planetary mill with HSS container and 15 mm tungsten carbide balls a mixing ratio of 8.5 to 1, the volume filling of the container was 27% in volume and the control variable was to achieve a MDD of around 3e15 to then proceed with a PAD1 increase of 10. The total duration of the experiment was 25 h and the rotating speed ranged from 50 to 300 rpm. The temperature was not controlled in this case. The atmosphere in the container was an argon+oxygen mixture. The % Oxygen of the atmosphere was selected to have a % O increase from 1500 ppm as weighted average of the elemental powders to 3800 ppm after the treatment. In this experiment three MAM technologies were tested, one a binder jetting with a GE machine, another with metal FDM using a Makerbot printer and a self made filament with the powder of the experiment and mostly PLA (the metal filling being about 50% in volume) and another through the filling of a mound made with PA12 with a EOS SLS machine (also Binder Jetting and MJF were tested but finally the SLS mound was taken). In some cases, the polymers had carbon black added. After the MAM shaping steps the test pieces underwent the same method steps since they were processed together. A pressure and temperature treatment was applied to all samples consisting in a temperature raise to 80° C., then a pressure raise to 1800 bar, followed by a temperature raise to 150° C. at which point the pressure was released and then the heating stopped. The parts were then debinded and also underwent a fixing step and then were sintered at 1200° C. Finally, the parts underwent a HIP process at 1180° C. and 140 bar. The atmosphere in the debinding process and sintering process were controlled to follow the following % O level pattern: 4000 ppm after debinding and 950 ppm after fixing with no pursued change during sintering or HIP. For comparative purposes, the original powders were reduced to have a weighted average % O around 900 ppm and the whole process was repeated with the mould filling strategy and strict inert atmosphere in all processes which resulted in a final % O content of 900 ppm but a drop in elongation to less than half.

EXAMPLE 5. The molds of EXAMPLE 1 were filled with the powders of EXAMPLE 2 treated as in EXAMPLE 3 and then subjected to various additional steps. For comparative purposes also low temperature MAM technologies were used (employing in all cases temperatures below 450° C.) mostly FDM with metal comprising filaments, binder jetting, ink printing, particle jetting, DOD and some more experimental “hybrid methods” like incorporating metal powders in SLA and even SLS polymer AM systems. The main objective of this set of experiments was to correlate the main mechanical properties to different combinations of MDD and PAD1 levels at different method steps. In most cases the MDD level was below 1 e14. In some cases, the level of MDD of the original powders was fixed as a control variable, but in most cases it was not pre-determined just measured (in the case of powder mixtures as a weighted average). Something similar happened with PAD1 where in most cases the level was below 10. After the treatment comprising applying energy into the powder method step in most steps where the PAD1 level was measured for the original powders there was an increase that ranged from more than 1 to more than 20 (in terms of addition to the PAD1 value), and when further decreases in PAD1 were targeted within the treatment they ranged from more than one to more than 15 (substraction to the PAD1 value). In some of the experiments the controlling value was a decrease of PAD1 between more than one to more than 20 (substraction to the PAD1 value) at the end of the consolidation treatment. In some cases, a further increase in PAD1 was set for the final component, in that case the increases ranged from more than 1 to 25 (in terms of addition to the PAD1 value).

EXAMPLE 6. The example 5 encompassed a lot of experiments. One such experiment was the continuation of example 4. In this case the control variable was a PAD1 increase of 18 in the treatment comprising introducing of energy into the powder method step, a further PAD1 decrease of 7 after the consolidation treatment and a further PAD1 increase of 3 in the final component.

EXAMPLE 7. The molds of EXAMPLE 1 were filled with the powders of EXAMPLE 2 treated as in EXAMPLE 3 and then subjected to various additional steps. For comparative purposes also low temperature MAM technologies were used (employing in all cases temperatures below 450° C.) mostly FDM with metal comprising filaments, binder jetting, ink printing, particle jetting, DOD and some more experimental “hybrid methods” like incorporating metal powders in SLA and even SLS polymer AM systems. The samples from EXAMPLE 5 were also further processed. The main objective of this set of experiments was to correlate the main mechanical properties to different combinations of % O, % N, % H, % B and in some cases % C levels at different method steps. In some cases, the powder was preconditioned right after the treatment comprising applying energy to the powder and the MAM shaping. The levels targeted after the powder preconditioning method step were set to values within the following ranges when looking at all experiments executed: % O: from less than 1 ppm to more than 15,000 ppm. % N: from less than 1 ppm to more than 1%. % H: from less than 0.1 ppm to more than 500 ppm; % B: from less than 0.1 ppm to more than 0.5%; % C: from less than 0.1 ppm to more than 3.5%. The levels targeted after the fixing method step were set to values within the following ranges: % O: from less than 0.01 ppm to more than 15,000 ppm. % N: from less than 0.1 ppm to more than 1%. % H: from less than 0.01 ppm to more than 50 ppm; % B: from less than 0.01 ppm to more than 0.5%; % C: from less than 0.01 ppm to more than 3.5%. The levels targeted after at the final component were set to values within the following ranges: %0: from less than 0.5 ppm to more than 15,000 ppm. % N: from less than 1 ppm to more than 1%. % H: from less than 0.1 ppm to more than 50 ppm; % B: from less than 0.1 ppm to more than 0.5%; % C: from less than 0.01 ppm to more than 3.5%.

EXAMPLE 8. The example 7 encompassed a lot of experiments. One such experiment was:

Departing from the following elemental powders:

% Mo: 3.5; % Mn: 11; % Cr: 18; % Y: 3,3; % Fe:rest. The main control variables were the levels of % N, and % O at different method steps. The levels targeted at the powder after the treatment comprising the introduction of energy into the powder were: % O: 5500 ppm; % N: 600 ppm. The levels targeted after the fixing method step were set to the following values: % O: 9000 ppm; % N: 9000 ppm. The levels targeted after at the final component were set to the following values: % O: 9200 ppm; % N: 9100 ppm.

Another such experiment was:

Departing from the following elemental powders:

% C: 0.02; % Cr: 19; % Ni: 52; % Mo: 3.0; % Nb: 5.2; % Al: 0.5; % Fe: rest. The main control variables were the levels of % N, % O, % C at different method steps. The levels targeted at the powder after the treatment comprising the introduction of energy into the powder were: % O: 2100 ppm; % N: 120 ppm; % C: 600 ppm.

The levels targeted after the powder preconditioning method step were set to the following values: %0:100 ppm; % N: 40 ppm; % C: 800 ppm. The levels targeted after the fixing method step were set to the following values: % O: 10 ppm; % N: 5 ppm; % C: 400 ppm. The levels targeted after at the final component were set to the following values: % O: 12 ppm; % N: 5 ppm; % C: 420 ppm.

EXAMPLE 9. For the manufacturing technologies described in this document where additively manufactured molds filled with ceramics materials in particulate form are used, several filling materials were tested. The mold materials used were those previously described in Example 1, where, in addition, relevant properties of the polymeric materials are reported.

A wide variety of ceramic materials to manufacture different types of ceramic comprising components was used. The materials used include: boron, crystalline boron, chromium boride (CrB), chromium diboride (CrB₂), titanium diboride (TiB₂), zirconium diboride (ZrB₂), magnesium diboride (MgB₂), niobium diboride (NbB₂), hafnium diboride (HfB₂), tantalum diboride (TaB₂), boron carbide (B₄C), chromium carbide (Cr₃C₂), molybdenum carbide (Mo₂C), silicon carbide (SiC), titanium carbide (TiC), tungsten titanium carbide (WTiC), vanadium carbide (VC), zirconium carbide (ZrC), hafnium carbide (HfC), tantalum carbide (TaC), niobium carbide (NbC), aluminium nitride (AlN), boron nitride (BN), silicon nitride (Si₃N₄), titanium carbonitride (Ti (C,N)), titanium nitride (TiN), zirconium nitride (ZrN), hafnium nitride (HfN), vanadium nitride (VN), tantalum nitride (TaN), niobium nitride (NbN), yttrium oxide (Y₂O₃), boron oxide (B₂O₃), zincoxide (ZnO), zirconium oxide (ZrO₂), silicon, molybdenum disilicide (MoSi₂), barium titanate(BaTiO₃), strontium titanate (SrTiO₃), lead zirconate, steatite, sialon, bioceramics, alumina, ferrite and porcelain.

To some of the components a pressure treatment was applied (pressures ranged from 41 MPa to 320 MPa). To some of the components a pressure and/or temperature treatment was applied (maximum temperatures ranging from 0.1° C. to 480° C., with most of the tests performed with a maximum temperature between 36° C. and 390° C., pressures tested raged from 1.1 MPa to 640 MPa with most of the tests performed in the 240 MPa to 320 MPa range). The pressure and/or temperature treatments were applied in some cases prior to the debinding step and in some cases after the debinding step. To some of the components, the pressure was applied continuously. To some of the components, the pressure was applied continuously for a relevant time (as defined in this document). To some of the components, the pressure was applied in a stepwise manner (as defined in this document). To some others components, the pressure is increased and/or released more than once during the treatment. As was the case with pressure, to some of the components the treatment temperature was applied continuously. To some of the components, the temperature was applied continuously for a relevant time (as defined in this document). To some of the components, the temperature was applied in a stepwise manner. To some others components, the temperature is increased and/or released more than once during the treatment. For some especial components, a pressure and temperature treatment was applied consisting in a temperature raise to 81° C., maintaining a low pressure of 1.6 MPa, followed by a temperature raise to 136° C. at which point the pressure was increased to 61 MPa and followed by a temperature raise to 190° C. at which point the pressure was increased to 301 MPa.

EXAMPLE 10. For the manufacturing technologies described in this document where additively manufactured molds filled with polimeryc materials in particulate form are used, several filling materials were tested. The mold materials used were those previously described in Example 1, where, in addition, relevant properties of the polymeric materials are reported.

A wide variety of polymeric materials to manufacture different types of polymeric comprising components was used. The materials used include: polyimide (PI), polycarbonate (PC), ether ketone (EK), polyethylene sulfide (PPS), polytetrafluorethylene (PTFE), polyethylene terephthalate (PET), polybutylene terephthalate (PBT), PA6, PA11, polyamide (PA), polyoxymethylene (POM), polymethylmethacrylate (PMMA), polystyrene (PS), acrylonitrile-butadiene-styrene (ABS), styrene-acrylonitrile (SAN), polypropylene (PP), polyethylene (PE), polyamide-Imide (PAI), polyethersulfone (PES), olyphenylsulfone (PPSU), polyetherimide (PEI), polysulfone (PSU), polypa raphenylene (PPP), polyether ether ketone (PEEK), polyetherketone(PEK), liquid crystal polymer (LCP), perfluoroalkoxy alkane (PFA), ethylene tetrafluoroethylene (ETFE), polychlorotrifluoroethylene (PCTFE), polyvinylidene fluoride (PVDF), PA6-3-T, PA46, polymethylpentene (PMP) and polyphenylene ether (PPE).

In the case of polymeric materials utilized in the production of diverse molds, including those with intricate geometries and internal features, and having a heat deflection temperature (HDT) below 150° C., the majority of the components were manufactured using polyether ether ketone (PEEK) and polyetherketone (PEK) materials, following the described method. The components were then debinded by means a thermal debinding treatment. To some of the components, at least two cycles of a thermal debinding treatment was applied.

For the particular case of the polymeric materials used to manufacture different types of molds (some of them with complex geometries and internal features) having a heat deflection temperature (HDT) lower than 100° C., most the components were manufactured according to the described method using polypropylene (PP) and polyamide (PA) materials. In these cases, the polymer or the polymeric material used to manufacture the mold was polycaprolactone (PCL). In this case, the components were then debinded by means a non-thermal debinding treatment applying a water-based solvent extraction treatment.

To some of the manufactured components a pressure treatment was applied (pressures ranged from 1.6 MPa to 356 MPa). To some of the components a pressure and/or temperature treatment was applied (maximum temperatures ranging from 0.12° C. to 440° C., with most of the tests performed with a maximum temperature between 89° C. and 380° C., pressures tested raged from 1.6 MPa to 690 MPa with most of the tests performed in the 90 MPa to 490 MPa range).For some especial components, a pressure and temperature treatment was applied consisting in a temperature raise to 109° C., maintaining a low pressure of 0.36 MPa, followed by a temperature raise to 149° C. at which point the pressure was increased to 41 MPa and followed by a temperature raise to 210° C. at which point the pressure was increased to 440 MPa.

1. A method of manufacturing metal comprising components, which method comprises the steps of:
providing a powder or powder mixture;
applying a treatment to the powder or powder mixture, wherein the treatment of the powder or powder mixture comprises applying energy into the powder or powder mixture through mechanical action; and
shaping the treated powder or powder mixture using a metal additive manufacturing (MAM) method.

2. The method according to the claim 1, wherein the powder of powder mixture provided comprises at least a metal or a metal-based alloy.

3. (canceled)

4. The method according to claim 1, wherein the metal additive manufacturing (MAM) method is performed at a right temperature, wherein a right temperature is a temperature between 0.08*Tm and 0.74*Tm, being Tm the melting temperature in Kelvin of the powder or powder mixture provided.

5. The method according to claim 1, wherein the treatment of the powder or powder mixture comprises introducing the powder or powder mixture into a container, that comprises a processing material, and applying, a rotary motion and/or vibration.

6. The method according to claim 1, wherein the treatment of the powder or powder mixture comprises inter-particle diffusion and/or welding.

7. (canceled)

8. The method according to claim 5, wherein the velocity of the processing material is between 0.001 and 290 m/s and the average impact frequency is between 0.01 and 39000 Hz.

9. (canceled)

10. The method according to claim 1, wherein the treatment of the powder or powder mixture comprises the application of a vacuum between 510 and 1.6*10⁻¹⁰ mbar and/or the application of a pressure between 0.12 and 9.8 MPa, during at least part of the treatment and/or the application of a temperature between 0.16*Tm and 0.74*Tm, being Tm the melting temperature in Kelvin of the powder or powder mixture provided.

11. The method according to claim 1, wherein the energy introduced into the powder or powder mixture in the treatment is between 11 and 490 J/(g*hit).

12. The method according to claim 1, wherein the step of applying a treatment to the powder or powder mixture comprises a value of the parameter KA1 between 2.88 and 4900, being KA1=EEC/(V_{powder}*ρ_{powder}); wherein: EEC is the electrical energy consumed while processing the powder or powder mixture in MJ; V_{powder} is the volume of the powder or powder mixture in the container in dm³ and ρ_{prowder} is the mean density of the powder or powder mixture in the container in kg/dm³.

13. (canceled)

14. The method according to claim 1, wherein the mean dislocation density (MDD) of the powder or powder mixture after applying the treatment is between 1.2*10¹² and 9.8*10¹⁸ m⁻².

15. The method according to claim 1, wherein there is a significant increase of 1.5 times or more and afterwards a significant decrease of 0.038 times or more in the mean dislocation density during the application of the method steps.

16. The method according to claim 1, wherein there is a significant increase in the value of PAD1 during the application of the method steps, wherein a significant increase in PAD1 means adding 2 to the value of PAD1, being PAD1=1*10⁻⁶*√MDD, wherein MDD is the mean dislocation density in m².

17. The method according to claim 1, wherein there is a significant increase and afterwards a significant decrease in the value of PAD1, being PAD1=1*10⁻⁶*√MDD, wherein MDD is the mean dislocation density in m⁻², during the application of the method steps, wherein a significant increase in PAD1 means adding 2 to the value of PAD1 and a significant decrease in PAD1 means subtracting 2 from to the value of PAD1.

18. (canceled)

19. The method according to claim 1, wherein the method further comprises the step of: applying a spheroidization treatment to the treated powder or powder mixture which spheroidization treatment is performed at any time between the treatment of the powder or powder mixture and the shaping of the treated powder or powder mixture using a metal additive manufacturing (MAM) method, and wherein the temperature in the spheroidization treatment is 0.75*Tm or less, being Tm the melting temperature in Kelvin of the powder being processed.

20. The method according to claim 1, wherein the step of shaping the treated powder or powder mixture using a metal additive manufacturing (MAM) method comprises: providing a mold wherein the mold is made of a material comprising a polymeric material; filling the mold with the treated powder or powder mixture; and applying a pressure and/or temperature treatment to the filled mold.

21. The method according to claim 1, wherein the step of shaping the treated powder or powder mixture using a metal additive manufacturing (MAM) method comprises: providing a mold at least partly manufactured using an additive manufacturing (AM) technology, wherein the mold is made of a material comprising a polymeric material; filling the mold with the treated powder or powder mixture; and applying a pressure and/or temperature treatment to the filled mold.

22. The method according to claim 1, wherein the pressure and/or temperature treatment comprises the application of a temperature between 0.16*Tm and 0.94*Tm, being Tm the melting temperature in Kelvin of the powder or powder mixture provided and a pressure between 6 and 2100 MPa.

23. (canceled)

24. (canceled)

25. The method according to claim 1, wherein the method further comprises the step of: applying a consolidation treatment, wherein the consolidation treatment comprises the application of a pressure between 1 mbar and 4900 bar and a temperature between 0.36*Tm and 0.88*Tm, being Tm the melting temperature in Kelvin of the powder or powder mixture provided.

26. (canceled)

27. The method according to claim 1, wherein the method further comprises the step of: applying a densification treatment, wherein the densification treatment comprises the application of a pressure between 160 and 4900 bar and a temperature between 0.45*Tm and 0.92*Tm, being Tm the melting temperature in Kelvin of the powder or powder mixture provided.

28. (canceled)

29. (canceled)

30. The method according to claim 1, wherein the metal comprising component comprises at least 16% of the atoms of the treated powder or powder mixture.

31. (canceled)

32. (canceled)

33. (canceled)

34. (canceled)

35. (canceled)
